(19) United States
(12) Patent Application Publication
(10) Pub. No.: US 2025/0300703 A1
(43) Pub. Date: Sep. 25, 2025

(54) HIGH-RANK CODEBOOK AND CONTROL SIGNALING DESIGN FOR 8TX UPLINK MIMO

(71) Applicant: QUALCOMM Incorporated, San Diego, CA (US)

(72) Inventors: Hyojin LEE, San Diego, CA (US); Kexin XIAO, Shanghai (CN); Yu ZHANG, San Diego, CA (US); Yi HUANG, San Diego, CA (US); Weimin DUAN, San Diego, CA (US)

(21) Appl. No.: 18/863,322

(22) PCT Filed: May 6, 2022
(86) PCT No.: PCT/CN2022/091312

§ 371 Date: Nov. 5, 2024

(51) Int. Cl. H04B 7/0456; H04W 72/1268

(52) U.S. Cl. CPC H04B 7/0456; H04W 72/1268

(57) ABSTRACT

A user equipment (UE) receives control signaling for an uplink MIMO transmission, the control signaling including a first TPMI field and a second TPMI field and an SRS resource set indicator and transmits the uplink MIMO transmission precoded with an 8 port uplink MIMO precoder, the 8 port uplink MIMO precoder being based on a 4 port uplink MIMO codebook with a mapping indicated by one or more of the first TPMI field, the second TPMI field, or the SRS resource set indicator.

### TECHNICAL FIELD

The present disclosure relates generally to communication systems, and more particularly, to codebook-based uplink transmissions.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is configured to receive control signaling for an uplink MIMO transmission, the control signaling including a first TPMI field and a second TPMI field and an SRS resource set indicator and to transmit the uplink MIMO transmission precoded with an 8 port uplink MIMO precoder, the 8 port uplink MIMO precoder being based on a 4 port uplink MIMO codebook with a mapping indicated by one or more of the first TPMI field, the second TPMI field, or the SRS resource set indicator.

In an aspect of the disclosure, a method, a computer-readable medium, and an apparatus are provided. The apparatus is configured to output for transmission control signaling for an uplink MIMO transmission, the control signaling including a first TPMI field and a second TPMI field and an SRS resource set indicator and to receive the uplink MIMO transmission precoded with an 8 port uplink MIMO precoder, the 8 port uplink MIMO precoder being based on a 4 port uplink MIMO codebook with a mapping indicated by one or more of the first TPMI field, the second TPMI field, or the SRS resource set indicator.

In an aspect of the disclosure, a method, a computer-readable medium, and an apparatus are provided. The apparatus is configured to receive control signaling for an UL MIMO transmission; and transmit the UL MIMO transmission precoded with an 8 port uplink MIMO precoder based on the control signaling and a set of two or more antenna port groups.

In an aspect of the disclosure, a method, a computer-readable medium, and an apparatus are provided. The apparatus is configured to output for transmission control signaling for an UL MIMO transmission; and obtain the UL MIMO transmission precoded with an 8 port uplink MIMO precoder based on the control signaling and a set of two or more antenna port groups.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 illustrates an example UE in communication with a network node, in accordance with various aspects of the present disclosure.

FIG. 5 illustrates an example communication flow between a network node and a UE, in accordance with various aspects of the present disclosure.

FIG. 6 depicts a table illustrating example mappings of the SRS resource set indicator to the SRI fields and the TPMI fields, in accordance with various aspects of the present disclosure

FIG. 7 depicts a table mapping values of the first TPMI field to a rank and a precoding matrix for the first repetition set to facilitate uplink 4Tx MIMO, in accordance with various aspects of the present disclosure.

FIG. 8 depicts a table mapping values of the second TPMI field to a precoding matrix for the second repetition set to facilitate uplink 4Tx MIMO, in accordance with various aspects of the present disclosure.

FIG. 9 depicts a table of a codebook subset storing a precoding matrix W for single-layer transmissions for a UE having four antenna ports, in accordance with various aspects of the present disclosure.

FIG. 10 depicts a table of a codebook subset storing a precoding matrix W for two-layer transmissions for a UE having four antenna ports, as presented herein.

FIG. 11 depicts a table of a codebook subset storing a precoding matrix W for three-layer transmissions for a UE having four antenna ports, as presented herein

FIG. 12 depicts a table of a codebook subset storing a precoding matrix W for four-layer transmissions for a UE having four antenna ports, as presented herein.

FIG. 13 illustrates an example UE in communication with a network node, in accordance with various aspects of the present disclosure.

FIG. 14 depicts a table including example 8Tx precoding matrix types for ranks 1 to 8, as presented herein.

FIG. 15 illustrates a communication flow between a network node and a UE, as presented herein.

FIG. 16 depicts an example table to facilitate mapping type indicator and TPMI fields to an 8Tx precoding matrix, as presented herein.

FIG. 17 illustrates a communication flow between a network node and a UE, as presented herein.

FIG. 18 depicts a table to facilitate mapping a type indicator, a modified SR field, and TPMI fields to an 8Tx precoding matrix, as presented herein.

FIG. 19 depicts a table to facilitate mapping a type indicator, a modified SR field, and TPMI fields to an 8Tx precoding matrix, as presented herein.

FIG. 20 illustrates a communication flow between a network node and a UE, as presented herein

FIG. 21 depicts a table to facilitate mapping a type indicator and TPMI fields to an 8Tx precoding matrix, as presented herein.

FIG. 22 depicts a table to facilitate mapping a type indicator and TPMI fields to an 8Tx precoding matrix, as presented herein.

FIG. 23 illustrates a communication flow between a network node and a UE, as presented herein.

FIG. 24 depicts a table including precoding matrix types for Rank 1 to Rank 4, as presented herein.

FIG. 25 depicts a 2500 including precoding matrix types for Rank 5 to Rank 8, as presented herein.

FIG. 26 illustrates examples of 8Tx fully-coherent (FC) codebook structures, as presented herein.

FIG. 27 depicts a table to facilitate mapping a type indicator and TPMI fields to an 8Tx precoding matrix, as presented herein.

FIG. 28 depicts a table to facilitate mapping a type indicator and TPMI fields to an 8Tx precoding matrix, as presented herein.

FIG. 29 illustrates a communication flow between a network node and a UE, as presented herein.

FIGS. 30 to 47 depict example tables illustrating an uplink precoding matrix indication for Ranks 1 to 8, as presented herein.

FIG. 48 illustrates an example table showing TPMI bit field mapping to codebook subsets.

FIG. 49 illustrates an example table showing TPMI bit field mapping to layers for a transmission.

FIG. 50 illustrates example precoding matrices for rank 5, rank 6, rank 7, and rank 8 UL MIMO transmissions.

FIG. 51 illustrates example precoding matrices for rank 5, rank 6, rank 7, and rank 8 UL MIMO transmissions.

FIG. 52 illustrates example precoding matrices for rank 5, rank 6, rank 7, and rank 8 UL MIMO transmissions.

FIG. 53 illustrates example precoders for rank 5, rank 6, rank 7, and rank 8 UL MIMO transmissions.

FIG. 54 illustrates example precoders for rank 5, rank 6, rank 7, and rank 8 UL MIMO transmissions.

FIG. 55A, FIG. 55B, and FIG. 55C illustrate example antenna port groups.

FIG. 55D illustrates an example bit field mapping to a codebook subset for an UL MIMO transmission.

FIG. 55E illustrates an example communication flow between a UE and a base station in connection with antenna port groups.

FIG. 56A and FIG. 56B illustrate example aspects of SRS resources configured for antenna ports in antenna port groups.

FIG. 57A is a flowchart of a method of wireless communication.

FIG. 57B is a flowchart of a method of wireless communication.

FIG. 58A is a flowchart of a method of wireless communication.

FIG. 58B is a flowchart of a method of wireless communication.

FIG. 59 is a diagram illustrating an example of a hardware implementation for an example apparatus and/or UE.

FIG. 60A is a flowchart of a method of wireless communication.

FIG. 60B is a flowchart of a method of wireless communication.

FIG. 61A is a flowchart of a method of wireless communication.

FIG. 61B is a flowchart of a method of wireless communication.

FIG. 62 is a diagram illustrating an example of a hardware implementation for an example network entity.

### DETAILED DESCRIPTION

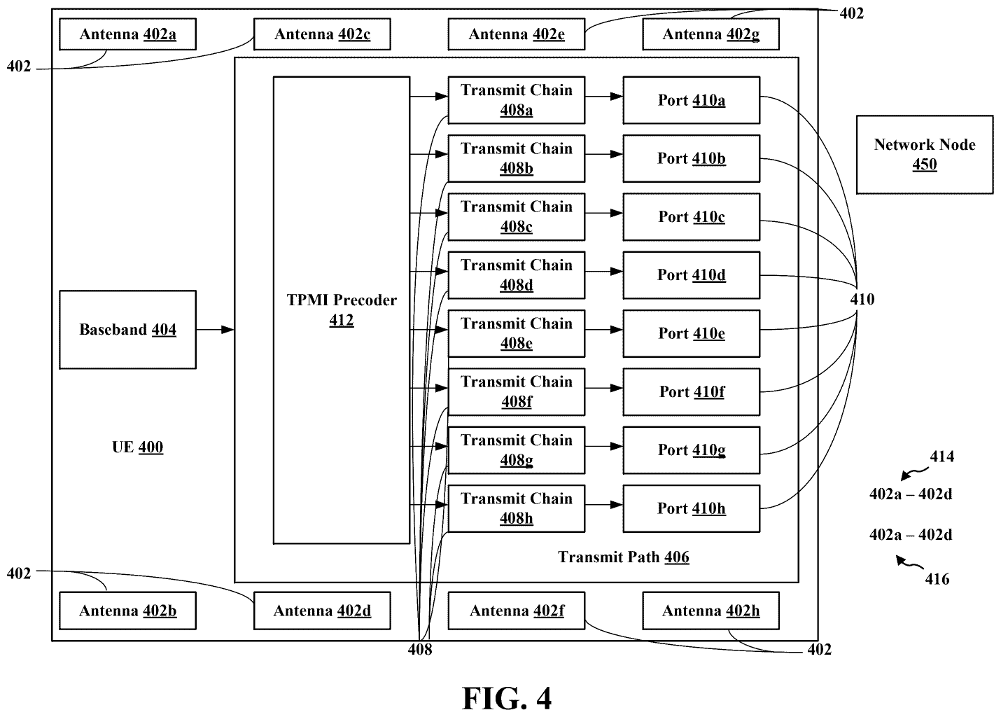

As wireless communication technologies evolve, additional types of UEs may be supported, referred to herein generally as “advanced UEs.” Advanced UEs may include smartphones, indoor Customer Premises Equipment (CPE), outdoor CPEs, laptops, etc. Advanced UEs may be associated with higher reliability and/or improved efficiency than non-advanced UEs. Advanced UEs may include more than four antennas, such as eight antenna elements of the UE 400 of FIG. 4. The advanced UEs may also, or alternatively, have more related power constraints. Additionally, advanced UEs may support greater than four downlink layers and/or four uplink transmit ports. Advanced UEs may also support new DMRS, SRS, and/or codebook designs.

Since an increased quantity of transmit antennas (Tx) (e.g., greater than four transmit antennas) are being considered for advanced UEs (e.g., mobile devices, larger-sized devices, etc.) utilizing 5G technologies, the support of 8-port uplink transmissions may be beneficial for improving 5G performance.

For 8-port uplink transmissions, a new codebook for precoding and relevant precoding scheduling information in DCI may be utilized. A first type of codebook may be for uplink transmissions with precoding disabled. Such a codebook may use a new design for 8-ports. Additionally, a new design may be used for ranks 5 to 8 (e.g., five-layer, six-layer, seven-layer, or eight-layer uplink transmissions). A second type of codebook type may be for uplink transmissions with precoding enabled. Such a codebook may use a new design for 8-ports.

Thus, it may be appreciated that 8Tx uplink MIMO may employ 8Tx uplink operation to support four or more layers per UE in uplink transmissions. To enable the 8Tx uplink operation, uplink DMRS, SRS, SRS resources indicators (SRI), and/or TPMI (including codebooks) may be updated.

Aspects disclosed herein facilitate 8Tx uplink MIMO. Example techniques include reusing 4Tx codebooks and/or TPMI tables, generating new 8Tx codebooks, and control signaling to indicate precoders to a UE to use when employing 8Tx uplink MIMO.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

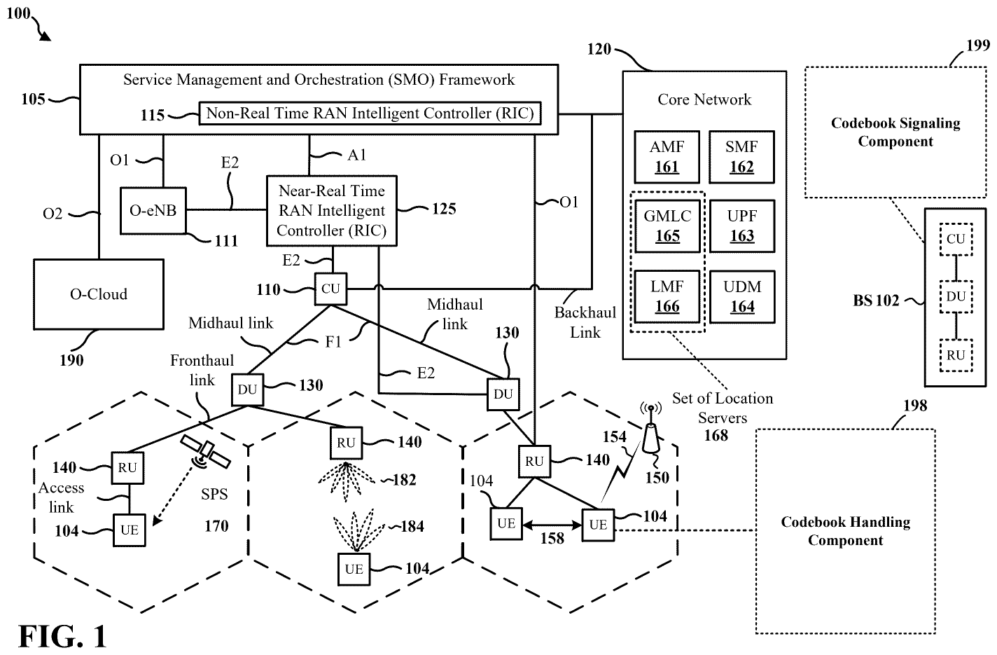

FIG. 1 is a diagram 100 illustrating an example of a wireless communications system and an access network. The illustrated wireless communications system includes a disaggregated base station architecture. The disaggregated base station architecture may include one or more CUs (e.g., a CU 110) that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework (e.g., an SMO Framework 105), or both). A CU 110 may communicate with one or more DUs (e.g., a DU 130) via respective midhaul links, such as an F1 interface. The DU 130 may communicate with one or more RUs (e.g., an RU 140) via respective fronthaul links. The RU 140 may communicate with respective UEs (e.g., a UE 104) via one or more radio frequency (RF) access links. In some implementations, the UE 104 may be simultaneously served by multiple RUs.

Each of the units, i.e., the CUs (e.g., a CU 110), the DUs (e.g., a DU 130), the RUs (e.g., an RU 140), as well as the Near-RT RICs (e.g., the Near-RT RIC 125), the Non-RT RICs (e.g., the Non-RT RIC 115), and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU 140 can be implemented to handle over the air (OTA) communication with one or more UEs (e.g., the UE 104). In some implementations, real-time and non-real-time aspects of control and user plane communication with the RU 140 can be controlled by a corresponding DU. In some scenarios, this configuration can enable the DU(s) and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs, DUs, RUs and Near-RT RICs. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs (e.g., the RU 140) and the UEs (e.g., the UE 104) may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UE 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication (e.g., a D2D communication link 158). The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with a UE 104 (also referred to as Wi-Fi stations (STAs)) via communication link 154, e.g., in a 5 GHz unlicensed frequency spectrum or the like. When communicating in an unlicensed frequency spectrum, the UE 104/Wi-Fi AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz—7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) (e.g., an AMF 161), a Session Management Function (SMF) (e.g., an SMF 162), a User Plane Function (UPF) (e.g., a UPF 163), a Unified Data Management (UDM) (e.g., a UDM 164), one or more location servers 168, and other functional entities. The AMF 161 is the control node that processes the signaling between the UE 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) (e.g., a GMLC 165) and a Location Management Function (LMF) (e.g., an LMF 166). However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station (e.g., the base station 102). The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a device in communication with a base station, such as the UE 104, may be configured to manage one or more aspects of wireless communication by facilitating precoding for 8Tx. For example, the UE 104 may include a codebook handling component 198 configured to receive control signaling for an uplink MIMO transmission, the control signaling including a first TPMI field and a second TPMI field and an SRS resource set indicator and to transmit the uplink MIMO transmission precoded with an 8 port uplink MIMO precoder, the 8 port uplink MIMO precoder being based on a 4 port uplink MIMO codebook with a mapping indicated by one or more of the first TPMI field, the second TPMI field, or the SRS resource set indicator. In some aspects, the codebook handling component 198 may be configured to receive control signaling for an UL MIMO transmission; and transmit the UL MIMO transmission precoded with an 8 port uplink MIMO precoder based on the control signaling and a set of two or more antenna port groups.

In another configuration, a base station 102 may include a codebook signaling component 199 configured to output for transmission control signaling for an uplink MIMO transmission, the control signaling including a first TPMI field and a second TPMI field and an SRS resource set indicator and to receive the uplink MIMO transmission precoded with an 8 port uplink MIMO precoder, the 8 port uplink MIMO precoder being based on a 4 port uplink MIMO codebook with a mapping indicated by one or more of the first TPMI field, the second TPMI field, or the SRS resource set indicator In some aspects, the codebook signaling component 199 may be configured to output for transmission control signaling for an UL MIMO transmission; and obtain the UL MIMO transmission precoded with an 8 port uplink MIMO precoder based on the control signaling and a set of two or more antenna port groups.

Although the following description provides examples directed to 5G NR (and, in particular, to 8Tx transmissions), the concepts described herein may be applicable to other similar areas, such as LTE, LTE-A, CDMA, GSM, and/or other wireless technologies, in which a UE may transmit 8Tx transmissions.

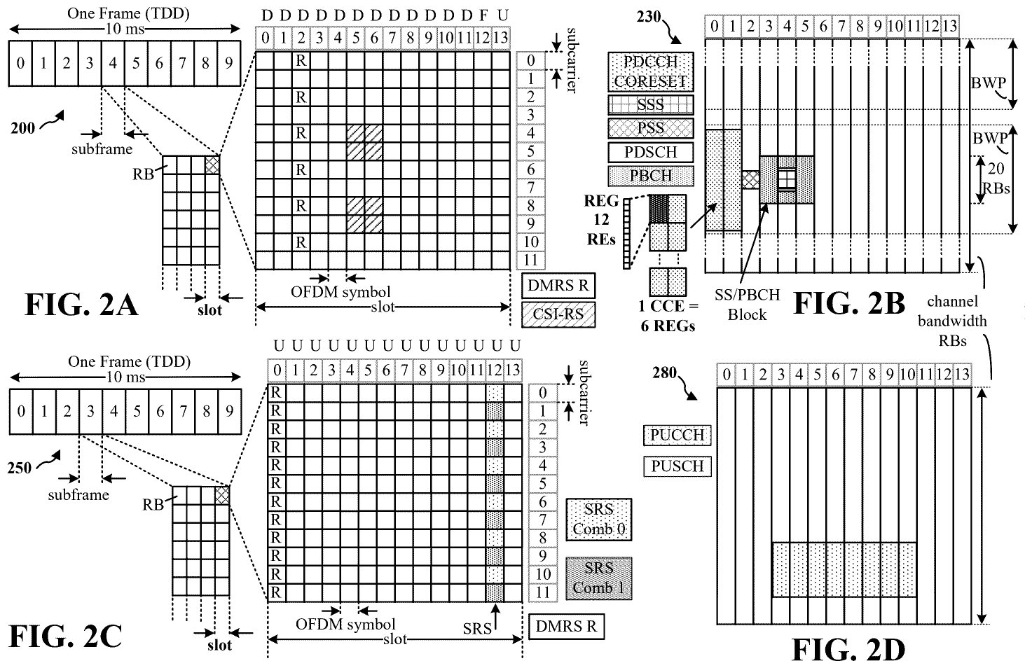

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2 * 15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

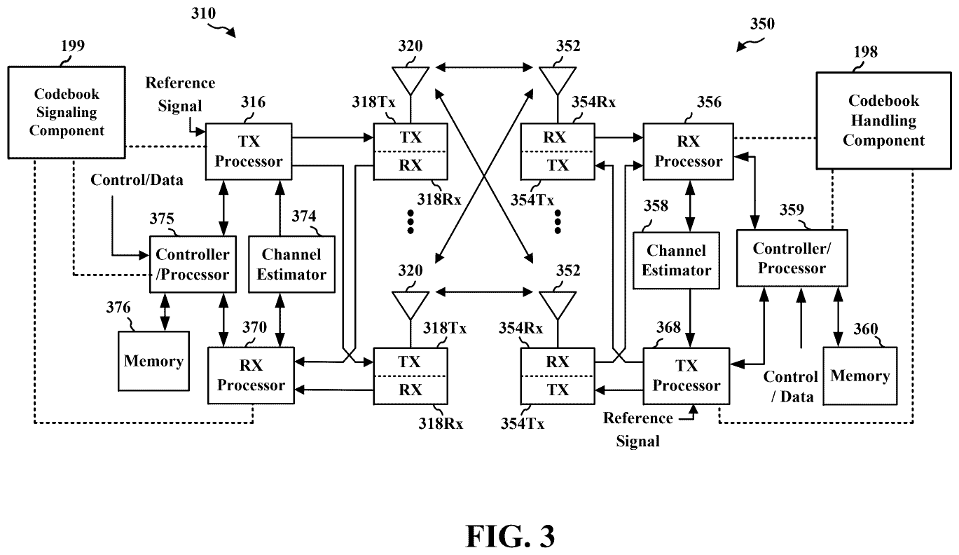

FIG. 3 is a block diagram that illustrates an example of a first wireless device that is configured to exchange wireless communication with a second wireless device. In the illustrated example of FIG. 3, the first wireless device may include a base station 310, the second wireless device may include a UE 350, and the base station 310 may be in communication with the UE 350 in an access network. As shown in FIG. 3, the base station 310 includes a transmit processor (TX processor 316), a transmitter 318Tx, a receiver 318Rx, antennas 320, a receive processor (RX processor 370), a channel estimator 374, a controller/processor 375, and memory 376. The example UE 350 includes antennas 352, a transmitter 354Tx, a receiver 354Rx, an RX processor 356, a channel estimator 358, a controller/processor 359, memory 360, and a TX processor 368. In other examples, the base station 310 and/or the UE 350 may include additional or alternative components.

In the DL, Internet protocol (IP) packets may be provided to the controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 316 and the RX processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna of the antennas 320 via a separate transmitter (e.g., the transmitter 318Tx). Each transmitter 318Tx may modulate a radio frequency (RF) carrier with a respective spatial stream for transmission.

At the UE 350, each receiver 354Rx receives a signal through its respective antenna of the antennas 352. Each receiver 354Rx recovers information modulated onto an RF carrier and provides the information to the RX processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, two or more of the multiple spatial streams may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with the memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna of the antennas 352 via separate transmitters (e.g., the transmitter 354Tx). Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna of the antennas 320. Each receiver 318Rx recovers information modulated onto an RF carrier and provides the information to the RX processor 370.

The controller/processor 375 can be associated with the memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the codebook handling codebook handling component 198 of FIG. 1.

At least one of the TX processor 316, the RX processor 370, and the controller/processor 375 may be configured to perform aspects in connection with the codebook signaling codebook signaling component 199 of FIG. 1.

FIG. 4 illustrates an example UE 400 in communication with a network node 450, as presented herein. The UE 400 may be similar to the UE 104 of FIG. 4 and/or the UE 350 of FIG. 3. The network node 450 may be similar to the base station 102, or a component of the base station 102, such as the CU 110, the DU 130, and/or the RU 140 of FIG. 1.

The example UE 400 includes eight antenna elements (e.g., a first antenna element 402a, a second antenna element 402b, a third antenna element 402c, a fourth antenna element 402d, a fifth antenna element 402e, a sixth antenna element 402f, a seventh antenna element 402g, and an eighth antenna element 402h). The antenna elements may be collectively referred to herein as “antenna elements 402.” An antenna element may be referred to as an antenna, an antenna port, or a port. Although the example UE 400 is illustrated as having eight antenna elements, in other examples, the UE may include fewer antenna elements or more antenna elements.

In the illustrated example of FIG. 4, the antenna elements 402 are located on different parts of the UE 400, thus creating diversity and providing for directional communication. The UE 400 may use at least one of the antenna elements 402 to transmit communication signals (e.g., SRS signals) to enable the network node 450 to estimate an uplink channel. The UE 400 includes a baseband 404 and a transmit path 406 for uplink transmissions using one or more of the antenna elements 402. Aspects of the baseband 404 may be implemented by the TX processor 368 and/or the processor 359 of the UE 350 of FIG. 3. The transmit path 406 includes eight example transmit chains (e.g., a first transmit chain 408a, a second transmit chain 408b, a third transmit chain 408c, a fourth transmit chain 408d, a fifth transmit chain 408e, a sixth transmit chain 408f, a seventh transmit chain 408g, and an eighth transmit chain 408h). A transmit chain also be referred to as an RF chain. The transmit chains of the UE 400 may be collectively referred to “transmit chains 408” herein. Although the example UE 400 is illustrated as having eight transmit chains, in other examples, the UE may include fewer transmit chains or more transmit chains. Each transmit chain may be configured to convert a baseband signal to an RF signal for transmission.

The UE 400 may sound a port by sending an SRS using a combination of transmit chains. In the example of FIG. 4, the UE 400 includes eight example ports (e.g., a first port 410a, a second port 410b, a third port 410c, a fourth port 410d, a fifth port 410e, a sixth port 410f, a seventh port 410g, and an eighth port 410h). The ports may be collectively referred to herein as “ports 410.”

The ports 410 may or may not have a one-to-one mapping to the antenna elements 402. When there is a one-to-one mapping, each antenna element of the antenna elements 402 may map to one of the ports of the ports 410. The UE 400 may report a composite of the signals from the transmit chains 408 to the network node 450 as a virtual port by applying a TPMI precoder 412. Although the TPMI precoder 412 is illustrated in relation to the transmit chains 408, the TPMI precoder 412 may be applied to the baseband 404.

The UE 400 may support three levels of coherence: full coherence, partial coherence, non-coherence. A UE with full coherence may be referred to as a fully-coherent UE and may transmit coherently over all of the antenna elements 402. A fully-coherent UE has the ability to control the relative phase between the transmit chains 408 of the UE 400. Two antenna elements maintain a relative phase if the phases across these two antennas are locked and/or remain the same across uplink transmissions.

A UE with partial coherence may be referred to as a partially-coherent UE and may transmit coherently over pairs of antenna elements. A partially-coherent UE has the ability to maintain a relative phase across multiple subsets of the antenna elements 402. For example, a first coherent antennas pair 414 may include the first antenna element 402a and the fourth antenna element 402d and a second coherent antennas pair 416 may include the second antenna element 402b and the third antenna element 402c. The antenna elements of the respective coherent antenna pairs may be coherent antennas relative to each other and may maintain a relative phase across the two respective antenna elements. However, the partially-coherent UE may be unable to maintain phase coherence across these two pairs.

A UE with non-coherence may be referred to as a non-coherent UE and may not be able to transmit coherently over any pairs or sets of antenna elements. For example, a non-coherent UE may lack the ability to maintain a relative phase across nay of the antenna elements 402.

In the example of FIG. 4, the UE 400 may support multi-layer uplink transmissions. For a non-coherent UE, each layer of the multi-layer uplink transmission is sent to a single antenna element of the antenna elements 402 and there is no combining across layers. For a partially-coherent UE, certain antenna elements are combined and each layer is sent to multiple ports. A partially-coherent UE may be configured as a partially-coherent 2Tx (PC-2) UE or a partially-coherent 4Tx (PC-4) UE. For a PC-2 UE, each layer of the uplink transmission is sent to two antenna elements of the antenna elements 402, and for a PC-4 UE, each layer of the uplink transmission is sent to four antenna elements of the antenna elements 402. For a fully-coherent UE, each layer is sent to each of the antenna elements 402.

The UE 400 may be configured to apply a precoder across all subbands of an uplink transmission or may be configured to apply a plurality of precoders for a plurality of subbands across the uplink transmission. The network node 450 may configure the UE 400 with one or more precoder configurations. Additionally, or alternatively, the network node 450 may activate a precoder configuration at the UE 400. The UE 400 may receive the precoder configuration via RRC signaling, downlink control information (DCI), and/or a MAC—control element (MAC-CE).

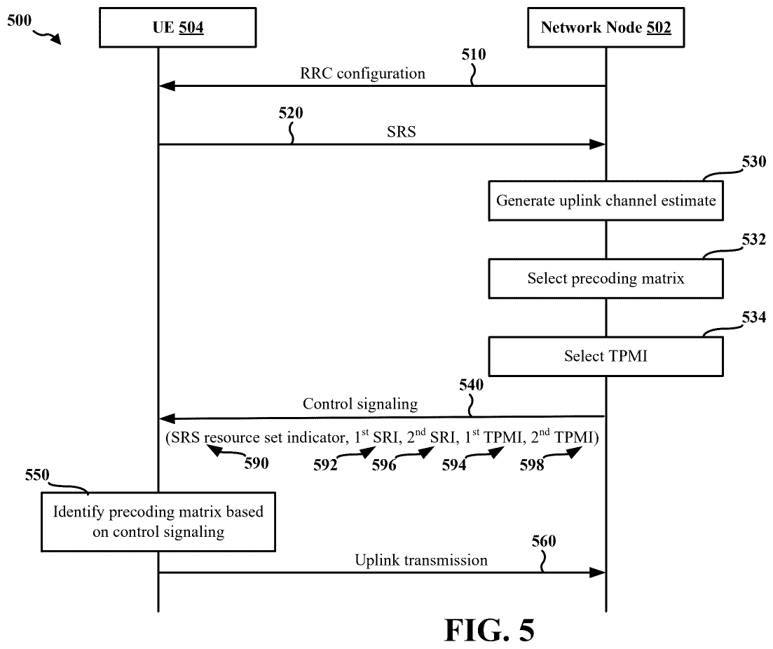

FIG. 5 illustrates an example communication flow 500 between a network node 502 and a UE 504, as presented herein. Aspects of the network node 502 may be implemented by the base station 102 of FIG. 1, the base station 310 of FIG. 3., and/or the network node 450 of FIG. 4. One or more aspects described for the network node 502 may be performed by a component of a base station or a network entity, such as a CU, a DU, and/or an RU. Aspects of the UE 504 may be implemented by the UE 104 of FIG. 1, the UE 350 of FIG. 3, and/or the UE 400 of FIG. 4. Although not shown in the illustrated example of FIG. 5, it may be appreciated that in additional or alternative examples, the network node 502 may be in communication with one or more other network nodes or UEs, and/or the UE 504 may be in communication with one or more other network nodes or UEs.

In the illustrated example, the communication flow 500 facilitates codebook and control signaling for 8Tx uplink MIMO transmissions at the UE 504. The communication flow 500 may utilize an 8Tx codebook design for rank 5 to 8. The control signaling may facilitate signaling a transmit precoding matrix index (TPMI) field and rank information. The control signaling may indicate an 8Tx precoding matrix for rank 1 to 8. The example communication flow 500 may also facilitate dynamic switching between non-coherent precoding, partially-coherent precoding, and fully-coherent precoding. In some examples, the control signaling may reuse 4Tx codebooks and TPMI fields for the 8Tx codebooks.

As shown in FIG. 5, the network node 502 may output an RRC configuration 510 that is received by the UE 504. The network node 502 may output the RRC configuration 510 via RRC signaling. The RRC configuration 510 may configure the UE 504 with one or more parameters associated with transmitting an uplink transmission. For example, the RRC configuration 510 may identify one or more sounding reference signal (SRS) resources.

The UE 504 may transmit an SRS 520 that is received by the network node 502. The SRS 520 may be associated with one or more transmit ports of the UE 504, such as the example antenna elements 402 of FIG. 4. Although the example UE 504 transmits an SRS, in other examples, the UE 504 may transmit any other reference signal that may enable the network node to estimate channel conditions between the UE 504 and the network node 502.

In the example of FIG. 5, the network node 502 uses the SRS 520 to generate an uplink channel estimate 530. The network node 502 may then select a precoding matrix 532 based on the uplink channel estimate 530. The network node 502 may also select a transmit precoding matrix index 534 (TPMI) from a Tx codebook based on the precoding matrix 532.

As shown in FIG. 5, the network node 502 transmits control signaling 540 that is received by the UE 504. The network node 502 may transmit the control signaling 540 via DCI. The UE 504 determines a precoding matrix 550 based on the control signaling 540. The UE 504 may then transmit an uplink transmission 560 using the precoding matrix 550.

For a multiple-TRP (M-TRP) PUSCH repetition, the UE 504 may be configured with two SRS resource sets. The UE 504 may also be configured with one or more SRS resources perf set. The UE 504 may not be expected to be configured with different number of SRS resources in the two SRS resource sets. Additionally, when two SRI are indicated, a “nrofSRS-Ports” parameter for the two indicated SRS resources may be the same.

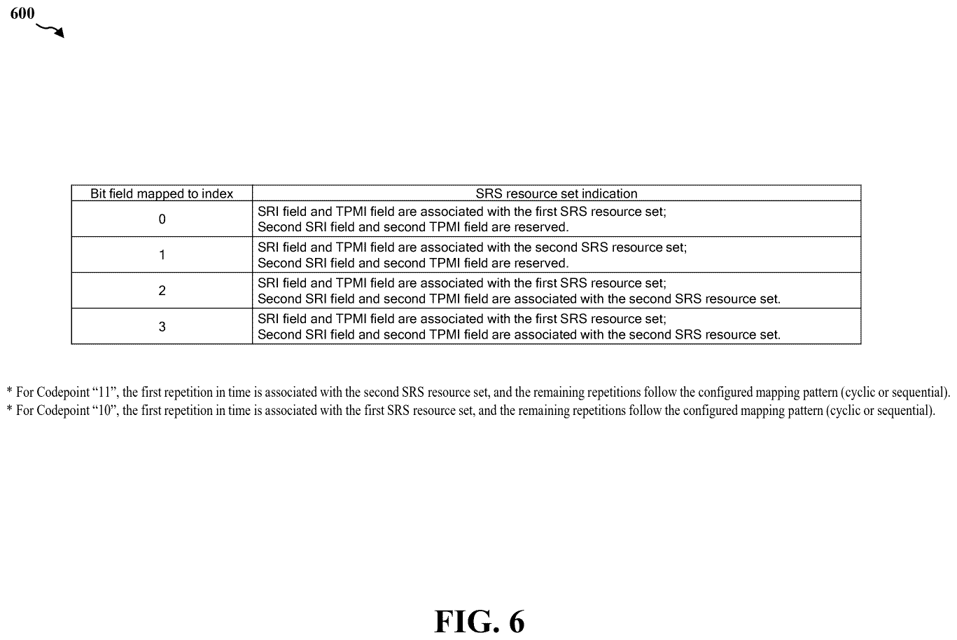

In the example of FIG. 5, the control signaling 540 includes an SRS resource set indicator 590, a first SRS resource indicator (e.g., a first SRI field 592), a first TPMI field 594, a second SRI field 596, and a second TPMI field 598. The SRS resource set indicator 590 may be a 2-bit field and indicate how the SRI fields and TPMI fields are associated with respective SRS resource sets. FIG. 6 depicts a table 600 illustrating example mappings of the SRS resource set indicator 590 to the SRI fields and the TPMI fields. Based on the bit field mapped to the index, the SRI field and the TPMI field may be used for the M-TRP PUSCH repetition.

The first TPMI field 594 may be of size 6-bits and indicate a rank and precoding matrix indication. The first TPMI field 594 may indicate the rank and precoding matrix for the first repetition set. The second TPMI field 598 may be of size 5-bits and indicate a precoding matrix indication for the second repetition set. The second TPMI field 598 may not indicate a rank. Instead, the rank indicated from the first TPMI field 594 may be used for the second repetition set. As used herein, the term “rank” may also be used to refer to “layer.”

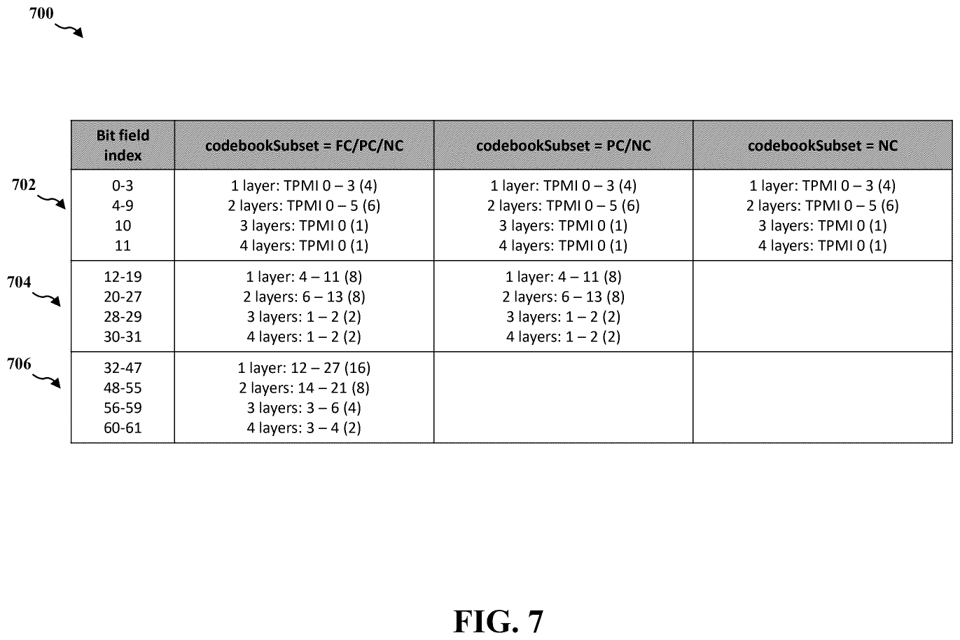

FIG. 7 depicts a table 700 mapping values of the first TPMI field 594 to a rank and a precoding matrix for the first repetition set to facilitate uplink 4Tx MIMO. In the example of FIG. 7, the maximum rank is 2, 3, or 4.

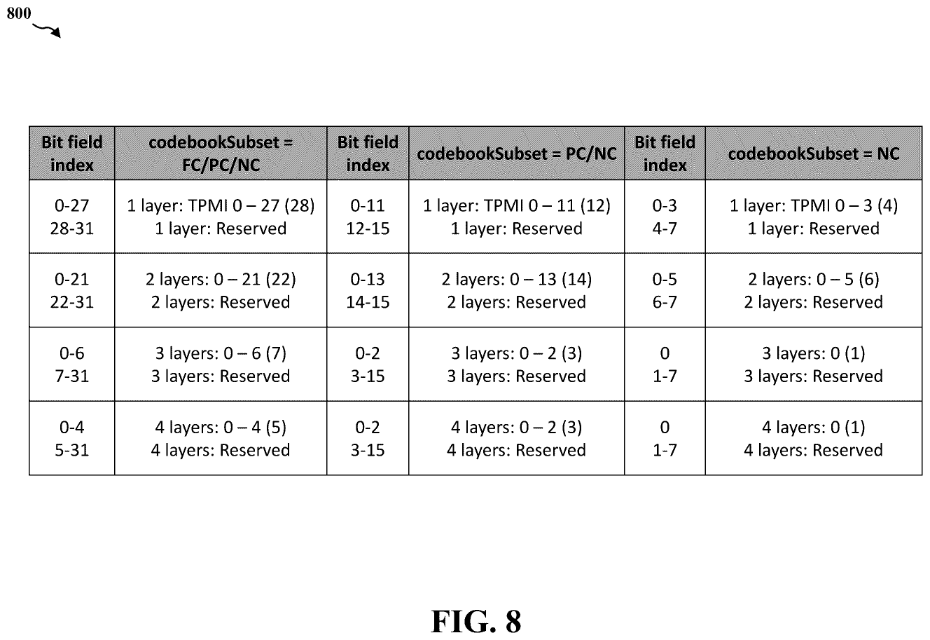

FIG. 8 depicts a table 800 mapping values of the second TPMI field 598 to a precoding matrix for the second repetition set to facilitate uplink 4Tx MIMO. In the example of FIG. 8, the maximum rank is 2, 3, or 4.

In the examples of FIG. 7 and FIG. 8, the first column provides a bit field index that maps to rank information and a matrix. The bit field index may map to a second column, a third column, or a fourth column based on whether a codebook subset indicator, which may be referred to as “codebookSubset” or by any other name, indicates that a full coherent, a partial coherent, and a non-coherent codebook is supported (e.g., the bit field index maps to the second column), indicates that a partial coherent and a non-coherent codebook is supported (e.g., the bit field index maps to the third column), or indicates that a non-coherent codebook is supported (e.g., the bit field index maps to the third column). As shown in FIG. 7, the bit field index column is divided into three portions. A first portion 702 corresponds to a non-coherent matrix in a respective codebook, a second portion 704 corresponds to a partial coherent matrix in a respective codebook, and a third portion 706 corresponds to a full coherent matrix in a respective codebook.

For example, a bit field index of “4” in the table of slide 6 maps to a “1 layer” and a fourth matrix in the corresponding rank 1 codebook. Additionally, the indicated matrix is a non-coherent matrix.

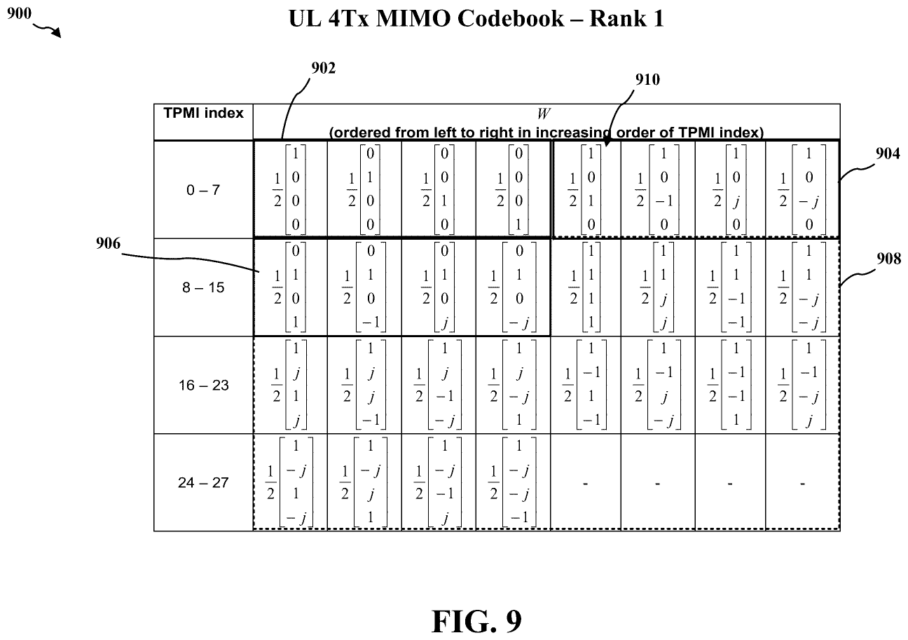

FIGS. 9 to 12 are tables of codebook subsets that may be used in different scenarios and indicate scaling factors for power transmission. The precoders and the scaling factor depend on, for example, the quantity of layers in the uplink transmission, the quantity of antenna ports of the UE, and whether transform precoding is enabled or disabled. The tables include a “TPMI index” column and a precoder matrix “W” column. The TPMI index may reference or indicate a matrix W, which may represent a precoder, and the matrices W are ordered from left to right in increased order of TPMI index. As uses herein, the term “matrix” may be used interchangeably with the term “precoder.”

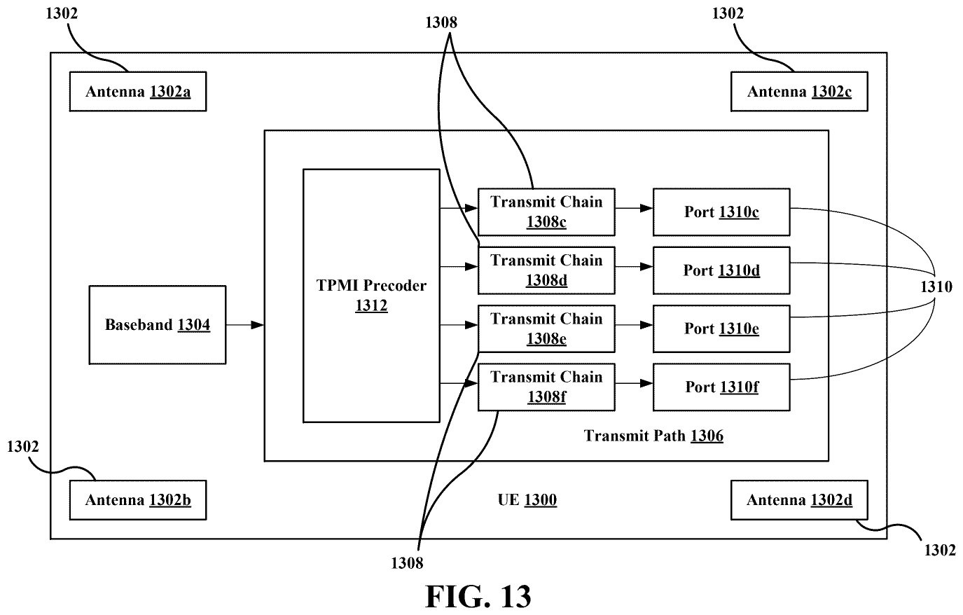

Additionally, FIGS. 9 to 12 may be discussed in relation to an example UE 1300 of FIG. 13 to better understand some aspects disclosed herein. Aspects of the UE 1300 may be similar to the UE 400 of FIG. 4. However, while the UE 400 is configured with eight antenna elements (e.g., the antenna elements 402), the UE 1300 is configured with four antenna elements (e.g., a first antenna element 1302a, a second antenna element 1302b, a third antenna element 1302c, and a fourth antenna element 1302d). The four antenna elements of the UE 1300 may be collectively referred to herein as “antenna elements 1302.” Similar to the example of FIG. 4, the UE 1300 includes a baseband 1304 and a transmit path 1306. The transmit path 1306 of FIG. 13 includes transmit chains 1308 in connection with ports 1310. The ports 1310 may be one-to-one mapped with the antenna ports 1302. The transmit path 1306 also includes a TPMI precoder 1312. Aspects of the baseband 1304 may be similar to the baseband 404. Aspects of the transmit path 1306 may be similar to the transmit path 406. Aspects of the chains 1308 may be similar to the transmit chains 408. Aspects of the ports 1310 may be similar to the ports 410. Aspects of the TPMI precoder 1312 may be similar to the TPMI precoder 412.

In a matrix W, a first row corresponds to a first antenna port of the UE 1300 (e.g., the first antenna element 1302a), a second row corresponds to a second antenna port of the UE 1300 (e.g., the second antenna element 1302b), a third row corresponds to a third antenna port of the UE 1300 (e.g., the third antenna element 1302c), and a fourth row corresponds to a fourth antenna port of the UE 1300 (e.g., the fourth antenna element 1302d). Additionally, the number of columns in the matrix W corresponds to the number of layers. For example, a precoding matrix with a single column corresponds to a single-layer transmission, a precoding matrix with two columns corresponds to a two-layer transmission, a precoding matrix with three columns corresponds to a three-layer transmission, and a precoding matrix with four columns corresponds to a four-layer transmission, where the first column corresponds to the first layer, the second column corresponds to the second layer, the third column corresponds to the third layer, and the fourth column corresponds to the fourth layer. Moreover, a first value (e.g., “0”) in a matrix may indicate that the antenna element corresponding to the first value is not used for an UL transmission. A second value (e.g., “1”) in the matrix may indicate that the antenna element corresponding to the second value is used for the UL transmission.

A network node may select a precoding configuration based channel conditions of the link between the UE and the network node. A network node may additionally, or alternatively select a precoding configuration based on a capability of the UE. For example, the precoding configuration may be based on whether the UE is a fully-coherent UE, a partially-coherent UE, or a non-coherent UE.

FIG. 9 depicts a table 900 of a codebook subset storing a precoding matrix W for single-layer transmissions (e.g., “Rank 1”) for a UE having four antenna ports (e.g., “4Tx”), as presented herein. The table 1900 may be used by a network node and/or a UE to employ the communication flow 500 of FIG. 5. In the example of FIG. 9, a scaling factor for power transmission of “½” is applied for the precoders of the table 900. The table 900 includes a non-coherent precoders set 902 including the first four matrices of the codebook and indicated by TPMI indices 0 to 3, respectively. The table 900 also includes a first partially-coherent precoders set 904 including the next four matrices of the codebook and indicated by TPMI indices 4 to 7, respectively. The table 900 also includes a second partially-coherent precoders set 906 including the next four matrices of the codebook and indicated by TPMI indices 8 to 11, respectively. Additionally, the table 900 includes a fully coherent precoders set 908 including the remaining sixteen matrices and indicated by TPMI indices 12 to 27.

Referring again to the example of FIG. 7, the bit field index of “4” maps to the “1 layer” and a fourth matrix in the corresponding rank 1 codebook. Accordingly, the bit field index of “4” in slide 6 maps to a matrix 910 of FIG. 9.

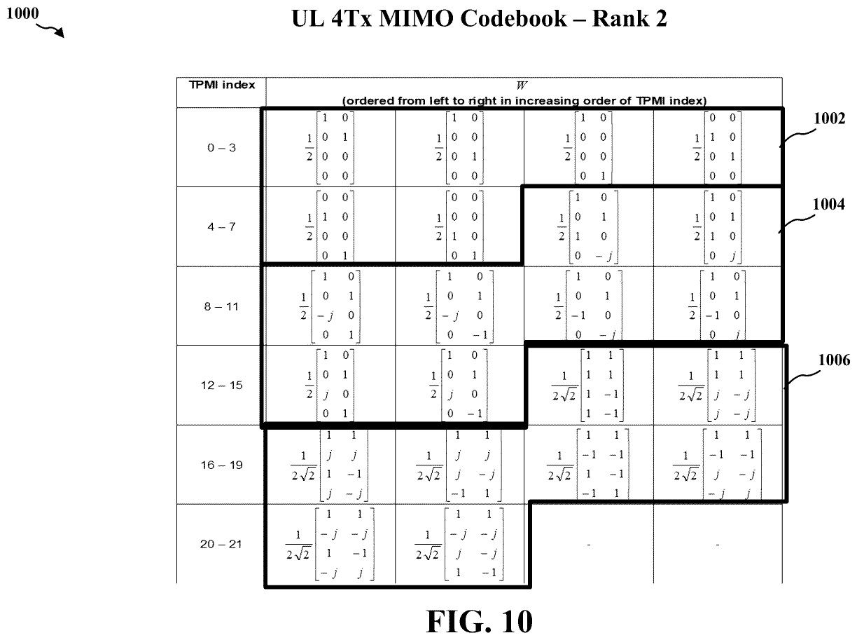

FIG. 10 depicts a table 1000 of a codebook subset storing a precoding matrix W for two-layer transmissions for a UE having four antenna ports, as presented herein. The table 1000 may be used by a network node and/or a UE to employ the communication flow 500 of FIG. 5. In the table 1000, the number of transmission ports is four (e.g., “4Tx”), and the number of layers for PUSCH is two (e.g., “Rank 2”).

The table 1000 includes a non-coherent precoders set 1002 including the first six matrices of the codebook and indicated by TPMI indices 0 to 5, respectively. The table 1000 also includes a partially-coherent precoders set 1004 including the next eight matrices of the codebook and indicated by TPMI indices 6 to 13, respectively. Additionally, the table 1000 includes a fully coherent precoders set 1006 including the remaining eight matrices and indicated by TPMI indices 14 to 21.

In the example of FIG. 10, the scaling factor for power transmission is “½” for the precoders of the non-coherent precoders set 1002 and the precoders of the partially coherent precoders set 1204. The scaling factor power transmission is

$$“ \frac{1}{2 \sqrt{2}} ”$$

for the precoders of the fully coherent precoders set 1006.

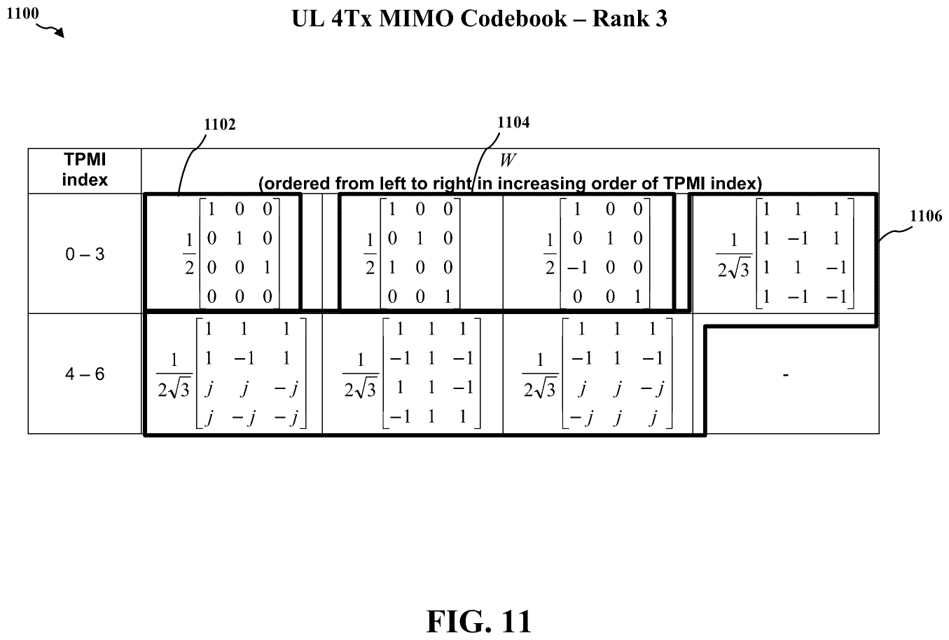

FIG. 11 depicts a table 1100 of a codebook subset storing a precoding matrix W for three-layer transmissions for a UE having four antenna ports, as presented herein. The table 1100 may be used by a network node and/or a UE to employ the communication flow 500 of FIG. 5. In the table 1100, the number of transmission ports is four (e.g., “4Tx”), and the number of layers for PUSCH is three (e.g., “Rank 3”).

The table 1100 includes a non-coherent precoders set 1102 including one matrix of the codebook and indicated by TPMI index 0. The table 100 also includes a partially-coherent precoders set 1104 including the next two matrices of the codebook and indicated by TPMI indices 1 to 2, respectively. Additionally, the table 100 includes a fully coherent precoders set 106 including the remaining four matrices and indicated by TPMI indices 3 to 6.

In the example of FIG. 1, the scaling factor for power transmission is “½” for the precoders of the non-coherent precoders set 1102 and the precoders of the partially coherent precoders set 1104. The scaling factor power transmission is

$$“ \frac{1}{2 \sqrt{3}} ”$$

for the precoders of the fully coherent precoders set 106.

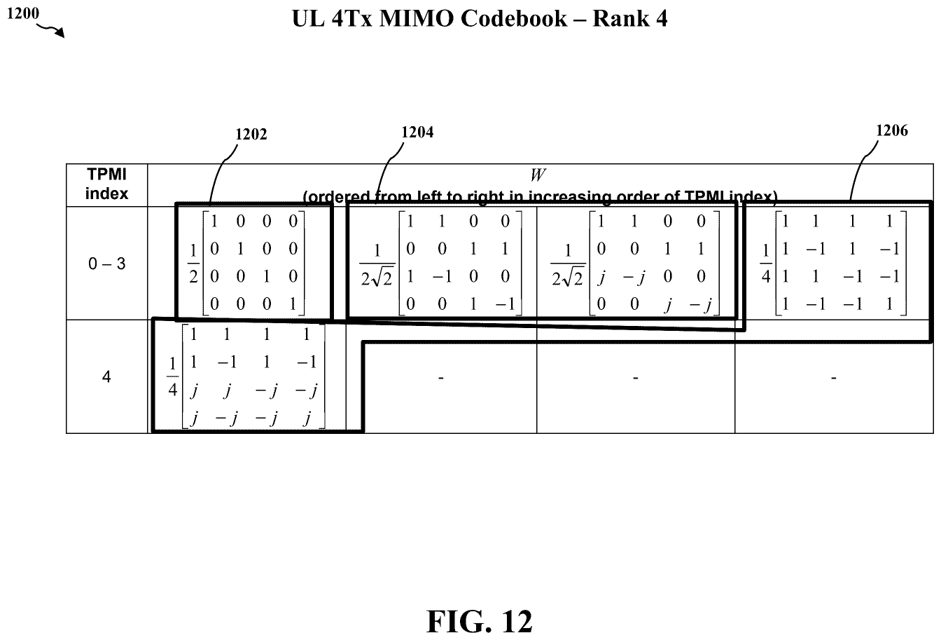

FIG. 12 depicts a table 1200 of a codebook subset storing a precoding matrix W for four-layer transmissions for a UE having four antenna ports, as presented herein. The table 1200 may be used by a network node and/or a UE to employ the communication flow 500 of FIG. 5. In the table 1200, the number of transmission ports is four (e.g., “4Tx”), and the number of layers for PUSCH is four (e.g., “Rank 4”).

The table 1200 includes a non-coherent precoders set 1202 including one matrix of the codebook and indicated by TPMI index 0. The table 1200 also includes a partially-coherent precoders set 1204 including the next two matrices of the codebook and indicated by TPMI indices 1 to 2, respectively. Additionally, the table 1200 includes a fully coherent precoders set 1206 including the remaining two matrices and indicated by TPMI indices 3 to 4.

In the example of FIG. 12, the scaling factor for power transmission is “½” for the precoders of the non-coherent precoders set 1202. The scaling factor power transmission is

$$“ \frac{1}{2 \sqrt{2}} ”$$

for the precoders of the partially-coherent precoders set 1204. The scaling factor power transmission is “¼” for the precoders of the fully coherent precoders set 1206.

As wireless communication technologies evolve, additional types of UEs may be supported, referred to herein generally as “advanced UEs.” Advanced UEs may include smartphones, indoor Customer Premises Equipment (CPE), outdoor CPEs, laptops, etc. Advanced UEs may be associated with higher reliability and/or improved efficiency than non-advanced UEs. Advanced UEs may include more than four antennas, such as eight antenna elements of the UE 400 of FIG. 4. The advanced UEs may also, or alternatively, have more related power constraints. Additionally, advanced UEs may support greater than four downlink layers and/or four uplink transmit ports. Advanced UEs may also support new DMRS, SRS, and/or codebook designs.

Since an increased quantity of transmit antennas (Tx) (e.g., greater than four transmit antennas) are being considered for advanced UEs (e.g., mobile devices, larger-sized devices, etc.) utilizing 5G technologies, the support of 8-port uplink transmissions may be beneficial for improving 5G performance.

For 8-port uplink transmissions, a new codebook for precoding and relevant precoding scheduling information in DCI may be utilized. A first type of codebook may be for uplink transmissions with precoding disabled. Such a codebook may use a new design for 8-ports. Additionally, a new design may be used for ranks 5 to 8 (e.g., five-layer, six-layer, seven-layer, or eight-layer uplink transmissions). A second type of codebook type may be for uplink transmissions with precoding enabled. Such a codebook may use a new design for 8-ports.

Thus, it may be appreciated that 8Tx uplink MIMO may employ 8Tx uplink operation to support four or more layers per UE in uplink transmissions. To enable the 8Tx uplink operation, uplink DMRS, SRS, SRS resources indicators (SRI), and/or TPMI (including codebooks) may be updated.

Aspects disclosed herein facilitate 8Tx uplink MIMO. Example techniques include reusing 4Tx codebooks and/or TPMI tables, generating new 8Tx codebooks, and control signaling to indicate precoders to a UE to use when employing 8Tx uplink MIMO.

It may be appreciated that there are two PUSCH repetition sets. The first repetition set will use the table 700 of FIG. 7 and the second repetition set will use the Table 800 of FIG. 8. These tables support 4Tx. However, aspects disclosed herein facilitate supporting 8Tx MIMO.

In a first example, aspects disclosed herein reuse 4Tx codebooks (e.g., the example codebook subsets of FIGS. 9 to 12) and the TPMI tables (e.g., the TPMI tables of FIGS. 7 and 8) for 8Tx. As described in connection with the UE 400 of FIG. 4, precoders for an 8Tx UE may include a non-coherent (NC) codebook, a partially-coherent codebook for two ports (PC-2), and a partially-coherent codebook for four ports (PC-4). When mapping coherency from a 4Tx codebook to an 8Tx codebook, a 4Tx NC codebook maps to an 8Tx NC codebook, a 4T PC codebook maps to an 8Tx PC-2 codebook, and a 4Tx fully-coherent codebook maps to an 8Tx PC-4 codebook.

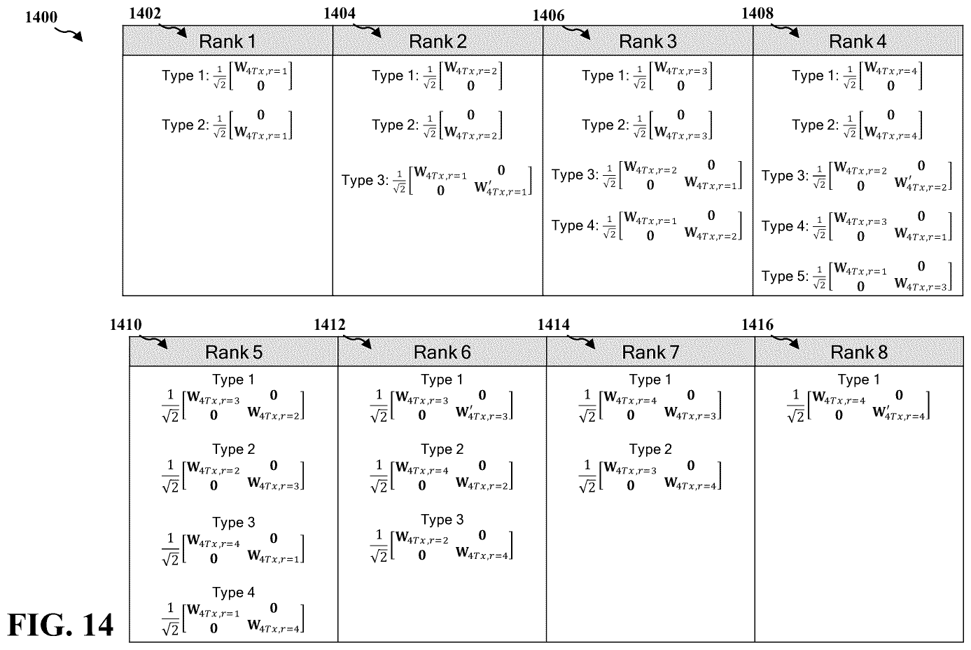

FIG. 14 depicts a table 1400 including example 8Tx precoding matrix types for ranks 1 to 8, as presented herein. In the example of FIG. 14, the 8Tx precoding matrix types are based on reusing the 4Tx precoding matrices described in connection with FIGS. 9 to 12. For example, a Rank 1 precoding matrix 1402 may reuse the 4Tx precoding matrix of rank 1. As shown in FIG. 14, the 4Tx Rank 1 precoding matrix (“W_{4Tx,r=1}”) may be associated with the first four antenna elements of an 8Tx UE (e.g., “Type 1”) or the last four antenna elements of the 8Tx UE (e.g., “Type 2”).

As shown in FIG. 14, a Rank 2 precoding matrix 1404 may be configured in three different types. Similar to the examples of the Rank 1 precoding matrix 1402, the Rank 2 precoding matrix 1404 includes two types in which the corresponding 4Tx matrix (e.g., the “W_{4Tx,r=2}”) is associated with the first four antenna elements of an 8Tx UE (e.g., “Type 1”) or the last four antenna elements of the 8Tx UE (e.g., “Type 2”). The Rank 2 precoding matrix 1404 also includes a third type (e.g., “Type 3”) in which the first layer uses a first 4Tx Rank 1 precoding matrix (“W_{4Tx,r=1}”) in the first four antenna elements of an 8Tx UE and the second layer uses a second 4Tx Rank 1 precoding matrix (“W_{4Tx,r=1}”) in the last four antenna elements of the 8Tx UE.

Similar to the examples of the Rank 1 precoding matrix 1402 and the Rank 2 precoding matrix 1404, a Rank 3 precoding matrix 1406 and a Rank 4 precoding matrix 1408 each include types in which the corresponding 4Tx precoding matrix is used in the first four antenna elements of an 8Tx UE (e.g., “Type 1”) or the last four antenna elements of the 8Tx UE (e.g., “Type 2”).

It may be appreciated that a Rank 3 precoding matrix includes three layers. The example Rank 3 precoding matrix 1406 includes two additional types that use the 4Tx precoding matrix with lower rank for the different layers. For example, a Rank 3 precoding matrix 1406 of “Type 3” may use the 4Tx Rank 2 precoding matrix (“W_{4Tx,r=2}”) for the first four antenna elements of an 8Tx UE for the first layer and the second layer and may use the 4Tx Rank 1 precoding matrix (“W_{4Tx,r=1}”) for the last four antenna elements of the 8Tx UE for the third layer. A Rank 3 precoding matrix 1406 of “Type 4” may use the 4Tx Rank 1 precoding matrix (“W_{4Tx,r=1}”) for the first four antenna elements of the 8Tx UE for the first layer and may use the 4Tx Rank 2 precoding matrix (“W_{4Tx,r=2}”) for the last four antenna elements of an 8Tx UE for the second layer and the third layer.

As shown in FIG. 14, the Rank 4 precoding matrix 1408 includes five different types in which the different types utilize different combinations of 4Tx precoding matrix ranks with different layers. A Rank 5 precoding matrix 1410 includes four different types in which the different types utilize different combinations of 4Tx precoding matrix ranks with different layers. A Rank 6 precoding matrix 1412 includes three different types in which the different types utilize different combinations of 4Tx precoding matrix ranks with different layers. A Rank 7 precoding matrix 1414 includes two different types in which the different types utilize different combinations of 4Tx precoding matrix ranks with different layers. A Rank 8 precoding matrix 1416 includes one type in which a first 4Tx Rank 4 precoding matrix (“W_{4Tx,r=4}”) is used for the first four antenna elements of an 8Tx UE for the first four layers and a second 4Tx Rank 4 precoding matrix (“W_{4Tx,r=4}”) is used in the last four antenna elements of the 8Tx UE for the last four layers.

As described above in connection with FIG. 5, the control signaling 540 to the UE 504 may include an SRS resource set indicator 590, a first SRI field 592, a first TPMI field 594, a second SRI field 596, and a second TPMI field 598. Aspects disclosed herein use the information provided via the control signaling 540 to indicate the rank and type of an 8Tx precoding matrix.

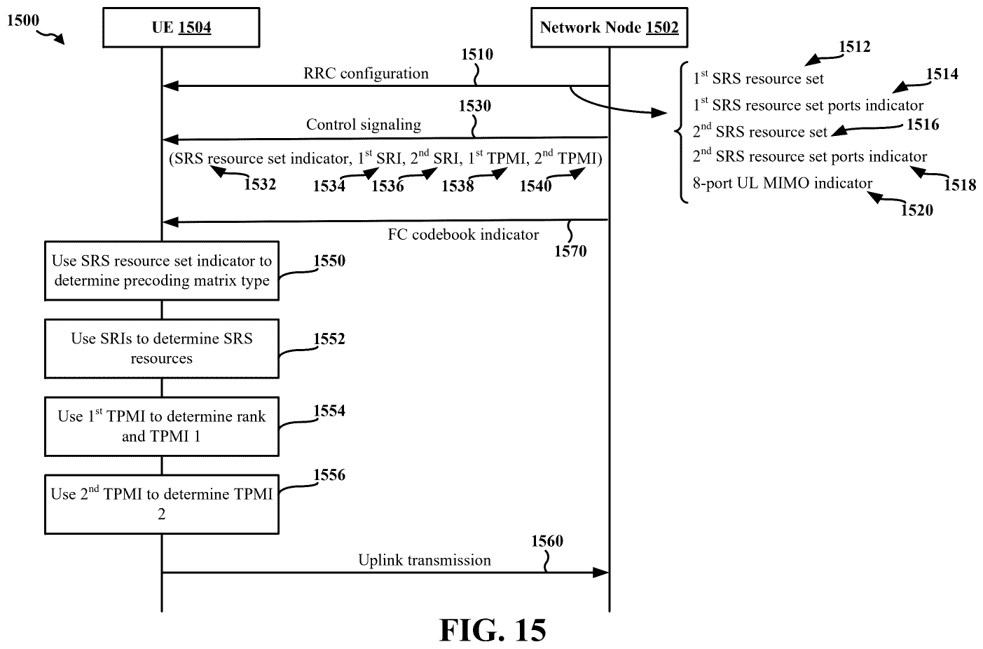

FIG. 15 illustrates a communication flow 1500 between a network node 1502 and a UE 1504, as presented herein. Aspects of the communication flow 1500 may be similar to the communication flow 500 of FIG. 5.

As shown in FIG. 15, the network node 1502 outputs an RRC configuration 1510 that is received by the UE 1504. Aspects of the RRC configuration 1510 may be similar to the RRC configuration 510 of FIG. 5. In the example of FIG. 15, the RRC configuration 1510 includes a first SRS resource set 1512, a first SRS resource set ports indicator 1514, a second SRS resource set 1516, a second SRS resource set ports indicator 1518, and an 8-port uplink MIMO indicator 1520. The first SRS resource set 1512 and the second SRS resource set 1516 may indicate the two SRS resource sets allocated to the UE 1504. Each SRS resource set may be associated with four ports. In the example of FIG. 15, the first SRS resource set ports indicator 1514 may indicate the four ports associated with the first SRS resource set, and the second SRS resource set ports indicator 1518 may indicate the four ports associated with the second SRS resource set. The 8-port uplink MIMO indicator 1520 may configure the UE 1504 to use the indicated SRS resource sets for 8Tx uplink transmissions.

The UE 1504 may use the information provided by the RRC configuration 1510 to determine which two SRS resource sets are associated with the 8-port UL MIMO (e.g., based on the first SRS resource set 1512 and the second SRS resource set 1516).

The network node 1502 may output control signaling 1530 that is received by the UE 1504. The network node 1502 may output the control signaling 1530 after receiving an SRS from the UE 1504, as described in connection with the example SRS 520 of FIG. 5. Aspects of the control signaling 1530 may be similar to the control signaling 540 of FIG. 4. The network node 1502 may provide the control signaling 1530 as DCI. In the example of FIG. 15, the control signaling 1530 includes an SRS resource set indicator 1532, a first SRI field 1534, a second SRI field 1536, a first TPMI field 1538, and a second TPMI field 1540.

The control signaling 1530 may include a precoding matrix type indicator and a precoding matrix indicator. For example, at 1550, the UE 1504 may use the SRS resource set indicator 1532 to determine the precoding matrix type (e.g., type 1, type 2, etc.). The SRS resource set indicator 1532 may be a 2-bit field. At 1552, the UE 1504 may use the two SRI fields (e.g., the first SRI field 1534 and the second SRI field 1536) to determine the respective SRS resource within the two SRS resource sets indicated by the RRC configuration 1510 (e.g., via the first SRS resource set 1512 and the second SRS resource set 1516). At 1554, the UE 1504 may use the first TPMI field 1538 to determine the rank and the first TPMI (“TPMI 1”), as described in connection with the example table 800 of FIG. 8. At 1556, the UE 1504 may use the second TPMI field 1540 to determine the second TPMI (“TPMI 2”). Based on the information provided by the RRC configuration 1510 and the control signaling 1530, the UE 1504 may determine the 8Tx precoding matrix. As shown in FIG. 15, the UE 1504 may transmit an uplink transmission 1560 that is received by the network node 1502. In the example of FIG. 15, the SRS resource set indicator 1532, the first TPMI field 1538, and the second TPMI field 1540 jointly specify the 8Tx precoding matrix used for the uplink transmission 1560.

In the examples of FIG. 5 and FIG. 9, the precoding matrix indicated by the second TPMI field 598 of the control signaling 540 has the same rank as the precoding matrix indicated by the first TPMI field 594. However, in the example of FIG. 15, the rank of the second precoding matrix indicated by the second TPMI field 1540 is determined based on the type indicator and the rank indicated by the first TPMI field 1538.

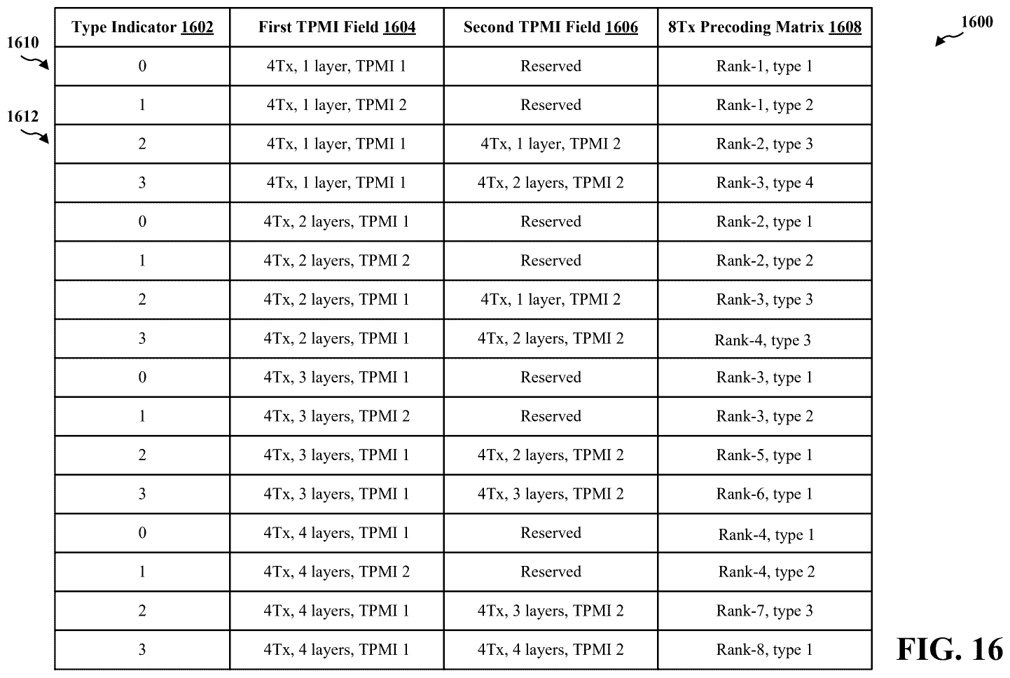

FIG. 16 depicts an example table 1600 to facilitate mapping type indicator and TPMI fields to an 8Tx precoding matrix, as presented herein. The example table 1600 includes a type indicator column 1602, a first TPMI field column 1604, a second TPMI field column 1606, and an 8Tx precoding matrix column 1608. The values of the type indicator column 1602 may correspond to the SRS resource set indicator 1532, the values of the first TPMI field column 1604 may correspond to the first TPMI field 1538, and the values of the second TPMI field column 1606 may correspond to the second TPMI field 1540 of FIG. 15. In the example of FIG. 16, the “TPMI 1” indication included in the first TPMI field column 1604 and/or the second TPMI field column 1606 corresponds to a precoding matrix indication for the first SRS resource set. Additionally, the “TPMI 2” indication included in the first TPMI field column 1604 and/or the second TPMI field column 1606 corresponds to a precoding matrix indication for the second SRS resource set.

In the example of FIG. 16, the values of the type indicator column 1602 correspond to the SRS resource set indicator 1532 of FIG. 16. For example, the SRS resource set indicator 1532 may be a 2-bit field and, thus, the value of the SRS resource set indicator 1532 may correspond to a value of 0, 1, 2, or 3. As shown in the example of FIG. 16, when the type indicator of the type indicator column 1602 is a “0” or a “1,” then the value of the second TPMI field column 1606 may be “reserved” or disregarded when determining the 8Tx precoding matrix. For example, and referring to the example table 1400 of FIG. 14, the Rank 1 precoding matrix 1402, the Rank 2 precoding matrix 1404, the Rank 3 precoding matrix 1406, and the Rank 4 precoding matrix 1408 include a Type 1 and a Typ2 that reference one respective 4Tx precoding matrix. When the value of the type indicator column 1602 is “0,” then the 8Tx precoding matrix is of “Type 1,” and when the value of the type indicator column 1602 is “1,” then the 8Tx precoding matrix is of “Type 2.”

For example, the Rank 1, type 1 precoding matrix of a first row 1610 corresponds to the Rank 1, type 1 precoding matrix of the Rank 1 precoding matrix 1402 of FIG. 14, which references a 4Tx Rank 1 precoding matrix (“W_{4Tx,r=1}”). The TPMI value of the first TPMI field 1538 may indicate which precoding matrix of the 4Tx Rank 1 codebook (e.g., the example table 1100 of FIG. 11) to use for the 4Tx Rank 1 precoding matrix (“W_{4Tx,r=1}”). For example, if the value of the first TPMI field 1538 is “4,” then the UE 1504 may populate the 4Tx Rank 1 precoding matrix (“W_{4Tx,r=1}”) with the matrix 1110 of the table 1100.

An example second row 1612 of the table 1600 includes a type indicator of “2” and the first TPMI indicates a “4Tx, 1 layer, TPMI 1.” In the example of FIG. 16, the type indicator of “2” and the Rank 1 indication (e.g., “1 layer”) via the first TPMI indicates that the rank of the second precoding matrix is also Rank 1 (e.g., “1 layer”). The quantity of layers indicated by the first TPMI and the quantity of layers indicated by the second TPMI correspond to the rank of the 8Tx precoding matrix.

As shown in the example table 1600 of FIG. 16, not all of the precoding matrix types are supported. For example, with respect to Rank 4, the table 1600 supports Types 1 to 3, but not Types 4 and 5. With respect to Ranks 5 to 7, the respective Type 1 is supported, but the remaining types are unsupported. Thus, it may be appreciated that reusing the two SRI fields and two TPMI fields of the control signaling 1530 of FIG. 15 may result in certain types not being represented.

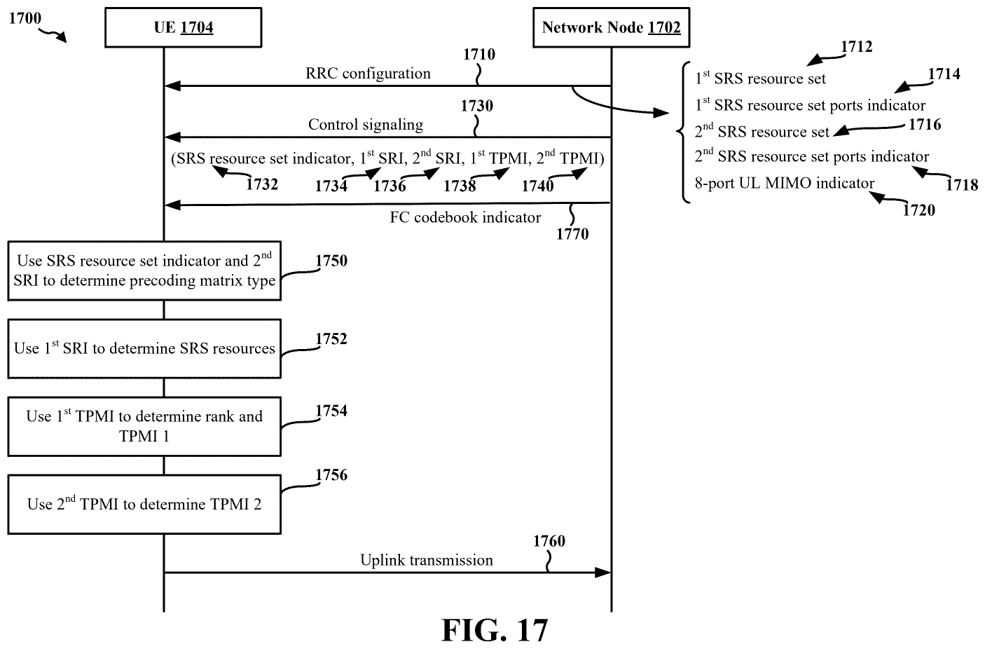

FIG. 17 illustrates a communication flow 1700 between a network node 1702 and a UE 1704, as presented herein. Aspects of the communication flow 1700 may be similar to the communication flow 500 of FIG. 5 and/or the communication flow 1500 of FIG. 15.

Similar to the example of FIG. 15, the network node 1502 outputs an RRC configuration 1710 that is received by the UE 1704. In the example of FIG. 17, the RRC configuration 1710 includes a first SRS resource set 1712, a first SRS resource set ports indicator 1714, a second SRS resource set 1716, a second SRS resource set ports indicator 1718, and an 8-port uplink MIMO indicator 1720. The first SRS resource set 1712 and the second SRS resource set 1716 may indicate the two SRS resource sets allocated to the UE 1704. Each SRS resource set may be associated with four ports. In the example of FIG. 17, the first SRS resource set ports indicator 1714 may indicate the four ports associated with the first SRS resource set, and the second SRS resource set ports indicator 1718 may indicate the four ports associated with the second SRS resource set. The 8-port uplink MIMO indicator 1720 may configure the UE 1704 to use the indicated SRS resource sets for 8Tx uplink transmissions.

The UE 1704 may use the information provided by the RRC configuration 1710 to determine which two SRS resource sets are associated with the 8-port UL MIMO (e.g., based on the first SRS resource set 1712 and the second SRS resource set 1716).

The network node 1702 may output control signaling 1730 that is received by the UE 1704. The network node 1702 may output the control signaling 1730 after receiving an SRS from the UE 1704, as described in connection with the example SRS 520 of FIG. 5. Aspects of the control signaling 1730 may be similar to the control signaling 540 of FIG. 4. The network node 1702 may provide the control signaling 1730 as DCI. Similar to the example of FIG. 15, the control signaling 1730 includes an SRS resource set indicator 1732, a first SRI field 1734, a second SRI field 1736, a first TPMI field 1738, and a second TPMI field 1740.

In the example of FIG. 17, the UE 1704 may use the SRS resource set indicator 1732, the second SRI field 1736, the first TPMI field 1738, and the second TPMI field 1740 to determine the 8Tx precoding matrix to apply for transmitting an uplink transmission 1760. For example, at 1750, the UE 1704 may use the SRS resource set indicator 1732 and the second SRI field 1736 to determine the precoding matrix type (e.g., type 1, type 2, etc.). At 1752, the UE 1704 may use the first SRI field 1734 to determine the respective SRS resource within the two SRS resource sets indicated by the RRC configuration 1710 (e.g., via the first SRS resource set 1712 and the second SRS resource set 1716). For example, when the first SRI field 1734 is set to “0,” then SRS resource 0 in the first SRS resource set, as indicated by the first SRS resource set 1712, and the SRS resource 0 in the second SRS resource set, as indicated by the second SRS resource set 1716, are the indicated SRS resources. Additionally, when the first SRI field 1734 is set to “1,” then SRS resource 1 in the first SRS resource set, as indicated by the first SRS resource set 1712, and the SRS resource 1 in the second SRS resource set, and the second SRS resource set 1716, are the indicated SRS resources.

At 1754, the UE 1704 may use the first TPMI field 1738 to determine the rank and the first TPMI (“TPMI 1”), as described in connection with the example table 800 of FIG. 8. At 1756, the UE 1704 may use the second TPMI field 1740 to determine the second TPMI (“TPMI 2”). Based on the information provided by the RRC configuration 1710 and the control signaling 1730, the UE 1704 may determine the 8Tx precoding matrix. As shown in FIG. 17, the UE 1704 may transmit the uplink transmission 1760 that is received by the network node 1702. The UE 1704 may use the determined 8Tx precoding matrix to transmit the uplink transmission 1760. In the example of FIG. 17, the SRS resource set indicator 1732, the second SRI field 1736, the first TPMI field 1538, and the second TPMI field 1540 jointly specify the 8Tx precoding matrix used for the uplink transmission 1760.

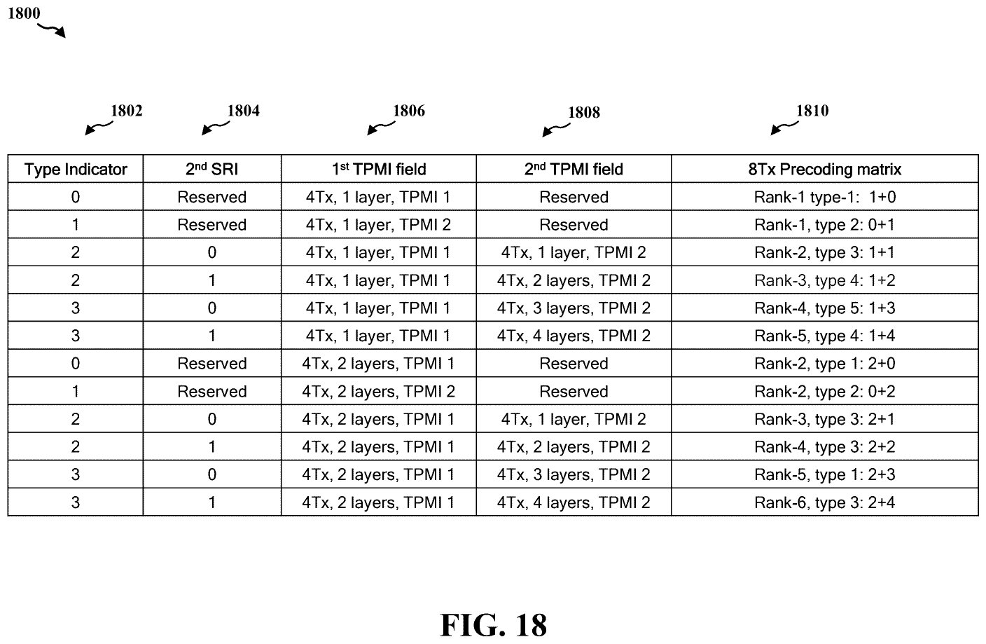

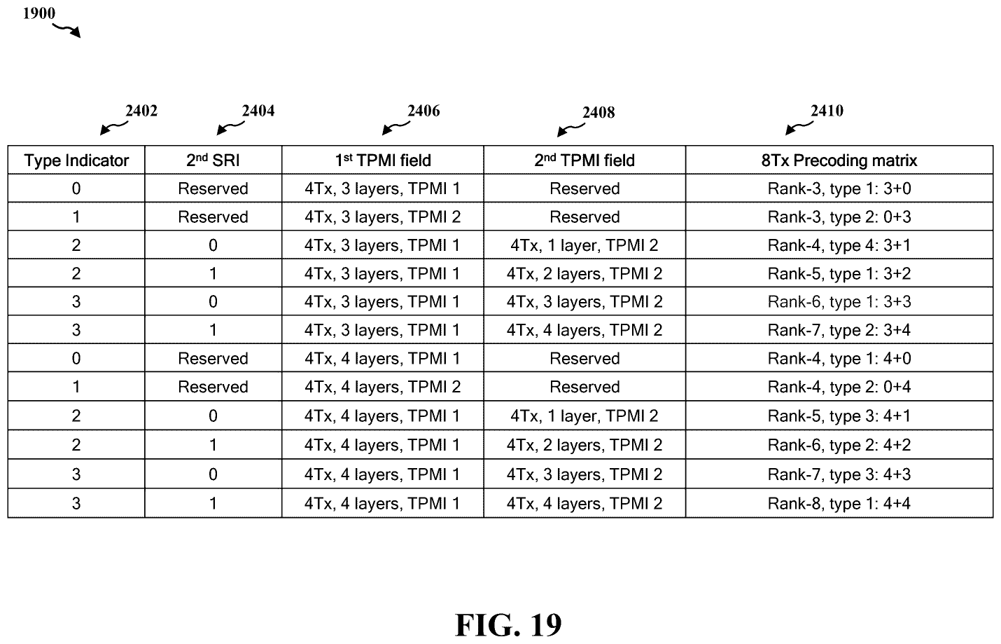

FIG. 18 depicts a table 1800 to facilitate mapping a type indicator, a modified SR field, and TPMI fields to an 8Tx precoding matrix, as presented herein. FIG. 19 depicts a table 1900 to facilitate mapping a type indicator, a modified SR field, and TPMI fields to an 8Tx precoding matrix, as presented herein. The tables of FIG. 18 and FIG. 19 may be read together and illustrate supporting all of the possible precoding matrix types indicated in the example table 1400 of FIG. 14.

The example table 1800 and table 1900 include a type indicator column 1802, a second SRI column 1804, a first TPMI field column 1806, a second TPMI field column 1808, and an 8Tx precoding matrix column 1810. The values of the type indicator column 1802 may correspond to the SRS resource set indicator 1732, the values of the second SRI column 1804 may correspond to the second SRI field 1736, the values of the first TPMI field column 1806 may correspond to the first TPMI field 1738, and the values of the second TPMI field column 1808 may correspond to the second TPMI field 1740 of FIG. 17. In the examples of FIG. 18 and FIG. 19, the “TPMI 1” indication included in the first TPMI field column 1806 and/or the second TPMI field column 1808 corresponds to a precoding matrix indication for the first SRS resource set. Additionally, the “TPMI 2” indication included in the first TPMI field column 1806 and/or the second TPMI field column 1808 corresponds to a precoding matrix indication for the second SRS resource set.

In the examples of FIG. 18 and FIG. 19, the including of the second SRI column 1804 to determine the precoding matrix type allows for additional precoding matrix types to be supported than the precoding matrix types supported by the table 1600 of FIG. 16. Similar to the example table 1600, when the value of the type indicator column 1802 is set to “0” or “1,” then the value of the second TPMI field column 1808 may be disregarded for determining the 8Tx precoding matrix. Additionally, the value of the second SRI column 1804 may also be disregarded for determining the 8Tx precoding matrix. However, when the value of the type indicator column 1802 is set to “2” or “3,” then the value of the second SRI column 1804 is also used in determining the 8Tx precoding matrix. In the examples of FIG. 18 and FIG. 19 the inclusion of the second SRI column 1804 allows eight additional 8Tx precoding matrix types to be supported compared to the 8Tx precoding matrix types supported by the table 1600 of FIG. 16. Thus, all of the precoding matrix types of the example table 20 of FIG. 14 may be supported.

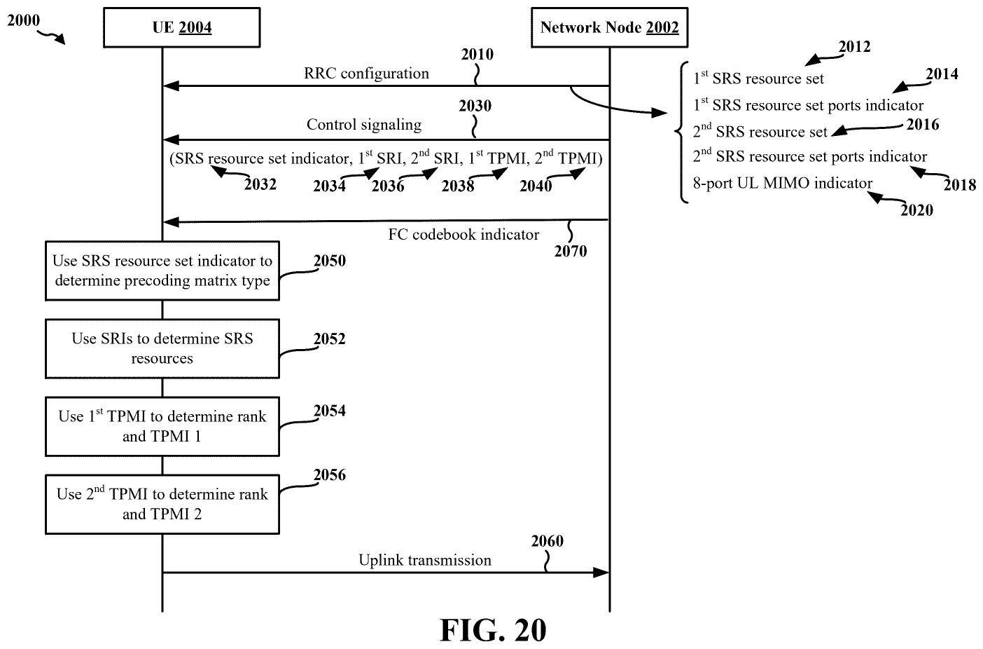

FIG. 20 illustrates a communication flow 2000 between a network node 2002 and a UE 2004, as presented herein. Aspects of the communication flow 2000 may be similar to the communication flow 500 of FIG. 5, the communication flow 1500 of FIG. 15, and/or the communication flow 1700 of FIG. 17.

Similar to the examples of FIG. 15 and FIG. 17, the network node 2002 outputs an RRC configuration 2010 that is received by the UE 2004. In the example of FIG. 20, the RRC configuration 2010 includes a first SRS resource set 2012, a first SRS resource set ports indicator 2014, a second SRS resource set 2016, a second SRS resource set ports indicator 2018, and an 8-port uplink MIMO indicator 2020. The first SRS resource set 2012 and the second SRS resource set 2016 may indicate the two SRS resource sets allocated to the UE 2004. Each SRS resource set may be associated with four ports. The first SRS resource set ports indicator 2014 may indicate the four ports associated with the first SRS resource set, and the second SRS resource set ports indicator 2018 may indicate the four ports associated with the second SRS resource set. The 8-port uplink MIMO indicator 2020 may configure the UE 2004 to use the indicated SRS resource sets for 8Tx uplink transmissions.

The UE 2004 may use the information provided by the RRC configuration 2010 to determine which two SRS resource sets are associated with the 8-port UL MIMO (e.g., based on the first SRS resource set 2012 and the second SRS resource set 2016).

The network node 2002 may output control signaling 2030 that is received by the UE 2004. The network node 2002 may output the control signaling 2030 after receiving an SRS from the UE 2004, as described in connection with the example SRS 520 of FIG. 5. Aspects of the control signaling 2030 may be similar to the control signaling 540 of FIG. 4. The network node 2002 may provide the control signaling 2030 as DCI. Similar to the example of FIG. 15 and FIG. 17, the control signaling 2030 includes an SRS resource set indicator 2032, a first SRI field 2034, a second SRI field 2036, a first TPMI field 2038, and a second TPMI field 2040.

In the example of FIG. 20, the UE 2004 may use the information provided by the RRC configuration 2010 and the control signaling 2030 to determine the 8Tx precoding matrix to use for an uplink transmission 2060. Similar to the example of FIG. 17, the communication flow 2000 supports all of the 8Tx precoding matrix types. In contrast to the examples of FIG. 15 and FIG. 17, the example of 26 includes determining the rank and the TPMI associated with the respective SRS resource sets independently. That is, the UE 2004 may use the first TPMI field 2038 of the control signaling 2030 to determine the rank and the first TPMI (“TPMI 1”). The UE 2004 may also use the second TPMI field 2040 of the control signaling 2030 to determine the rank and the second TPMI (“TPMI 2”).

For example, at 2050, the UE 2004 may use the SRS resource set indicator 2032 to determine the precoding matrix type (e.g., type 1, type 2, etc.). At 2052, the UE 2004 may use the two SRI fields (e.g., the first SRI field 2034 and the second SRI field 2036) of the control signaling 2030 to determine the respective SRS resource within the two SRS resource sets indicated by the RRC configuration 2010 (e.g., via the first SRS resource set 2012 and the second SRS resource set 2016). At 2054, the UE 2004 may use the first TPMI field 2038 of the control signaling 2030 to determine the rank and the first TPMI (“TPMI 1”), as described in connection with the example table 800 of FIG. 8. At 2056, the UE 2004 may use the second TPMI field 2040 of the control signaling 2030 to determine the rank and the second TPMI (“TPMI 2”). The UE 2004 may determine the rank and the second TPMI similar to determining the rank and the first TPMI (e.g., as described in connection with the example table 800 of FIG. 8). Based on the information provided by the RRC configuration 2010 and the control signaling 2030, the UE 2004 may determine the 8Tx precoding matrix. As shown in FIG. 20, the UE 2004 may transmit the uplink transmission 2060 that is received by the network node 2002. In the example of FIG. 20, the SRS resource set indicator 2032, the first TPMI field 2038, and the second TPMI field 2040 jointly specify the 8Tx precoding matrix used for the uplink transmission 2060. However, the TPMI fields are used to independently indicate the first TPMI (“TPMI 1”) and the second TPMI (“TPMI 2”). Additionally, with the second TPMI field 2040 independently indicating the rank of the second TPMI, the size of the second TPMI field 2040 may be 6-bits, similar to the size of the first TPMI field 2038, which is in contrast to the second TPMI field of the examples of FIG. 15 and FIG. 17 in which the size of the second TPMI field is 5-bits.

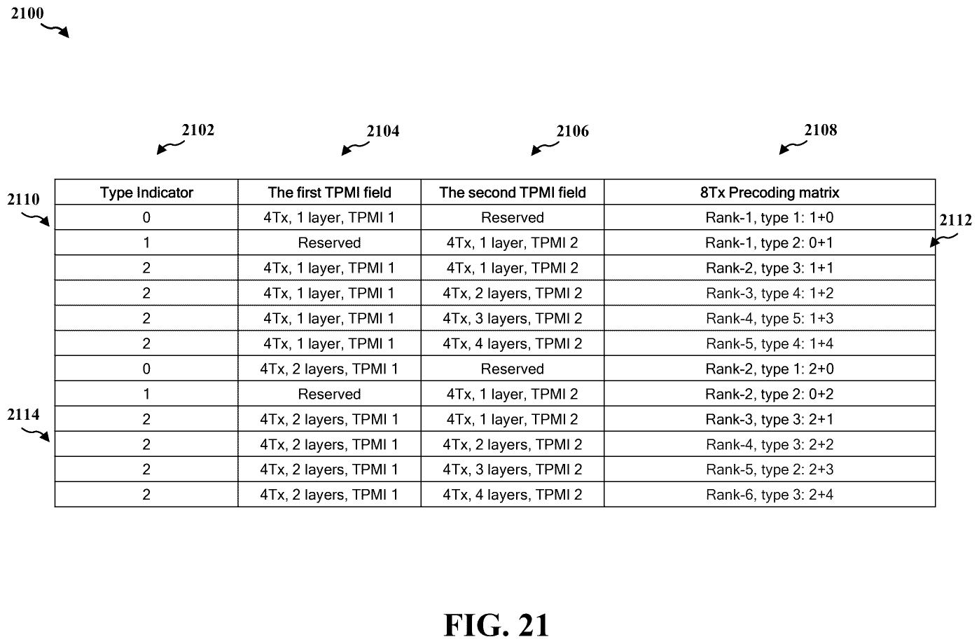

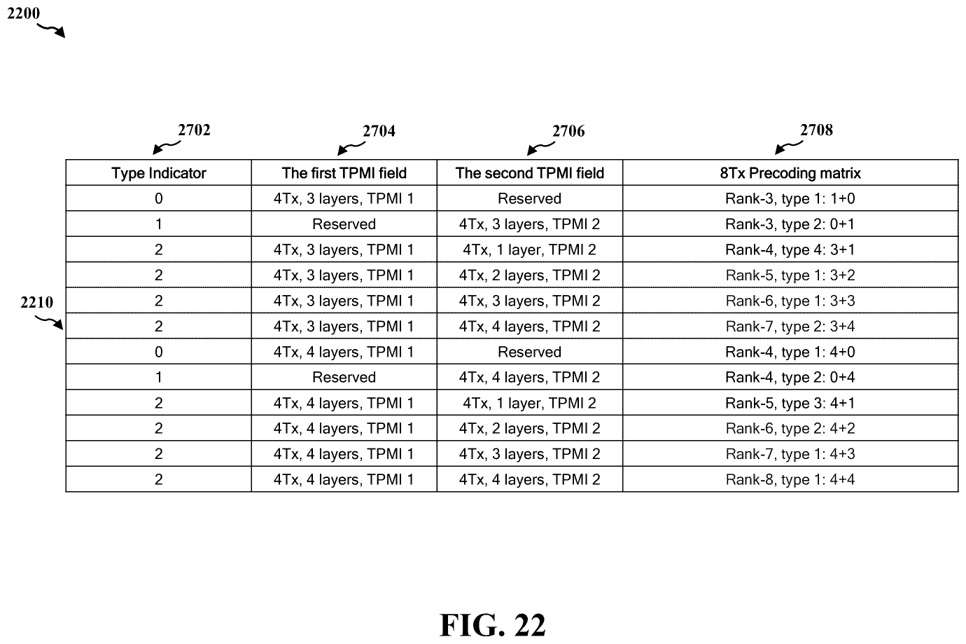

In the example of FIG. 20, the precoding matrix type is determined based on the SRS resource set indicator 2032, as described in connection with the example communication flow 1500 of FIG. 15. In other examples, the precoding matrix type may be determined based on the SRS resource set indicator 2032 and the second SRI field 2036, as described in connection with the example communication flow 1700 of FIG. 17. However, as shown in the examples of FIG. 21 and FIG. 22, all of the different precoding matrix types of the table 1400 of FIG. 14 may be supported.

FIG. 21 depicts a table 2100 to facilitate mapping a type indicator and TPMI fields to an 8Tx precoding matrix, as presented herein. FIG. 22 depicts a table 2200 to facilitate mapping a type indicator and TPMI fields to an 8Tx precoding matrix, as presented herein. The tables of FIG. 21 and FIG. 22 may be read together and illustrate supporting all of the possible precoding matrix types indicated in the example table 1400 of FIG. 14.

The example table 2100 and table 2200 include a type indicator column 2102, a first TPMI field column 2104, a second TPMI field column 2106, and an 8Tx precoding matrix column 2108. The values of the type indicator column 2102 may correspond to the SRS resource set indicator 2032, the values of the first TPMI field column 2104 may correspond to the first TPMI field 2038, and the values of the second TPMI field column 2106 may correspond to the second TPMI field 2040 of FIG. 20. In the examples of FIG. 21 and FIG. 22, the “TPMI 1” indication included in the first TPMI field column 2104 and/or the second TPMI field column 2106 corresponds to a precoding matrix indication for the first SRS resource set. Additionally, the “TPMI 2” indication included in the first TPMI field column 2104 and/or the second TPMI field column 2106 corresponds to a precoding matrix indication for the second SRS resource set.

As described above, the first TPMI field 2038 and the second TPMI field 2040 may independently indicate the rank. In the examples of FIG. 21 and FIG. 22, the combination of the values of the type indicator column 2102, the first TPMI field column 2104, and the second TPMI field column 2106 may indicate precoding matrix type. In the examples of FIG. 21 and FIG. 22, when the type indicator is “0,” then the second TPMI field is reserved and the TPMI indicated by the first TPMI field is used for the 8Tx precoding matrix. When the type indicator is “1,” then the first TPMI field is reserved and the TPMI indicated by the second TPMI field is used for the 8Tx precoding matrix.

For example, in a first row 2110, the type indicator is “0,” the first TPMI field is Rank 1 (“1 layer”), and the second TPMI field is reserved. In such a combination, the 8Tx precoding matrix is of Rank-1, type 1. In a second row 2112, the type indicator is “1,” the first TPMI field is reserved, and the second TPMI field is Rank 1 (“1 layer”). In such a combination, the 8Tx precoding matrix is Rank-1, type 2.

In examples in which the type indicator is “2,” the TPMI indicated by the first TPMI field and the TPMI field are used for the 8Tx precoding matrix. For example, in a third row 2114, the type indicator is “2,” the first TPMI field is Rank 2 (“2 layers”), and the second TPMI field is Rank 2 (“2 layers”). Based on the use of a Rank 2 precoding matrix in the first layer and the second layer of an 8Tx precoding matrix, the UE may determine that the 8Tx precoding matrix is Rank-4, type 3, as indicated by the Rank 4 precoding matrix 1408 of table 20. As another example, in a row 2210 of FIG. 22, the type indicator is “2,” the first TPMI field is Rank 3 (“3 layers”), and the second TPMI field is Rank 4 (“4 layers”). Based on the use of a Rank 3 precoding matrix in the first layer and a Rank 4 precoding matrix in the second layer of an 8Tx precoding matrix, the UE may determine that the 8Tx precoding matrix is Rank-7, type 2, as indicated by the Rank 7 precoding matrix 1414 of table 20 in which the first layer uses a 4Tx Rank-3 precoding matrix and the second layer uses a 4Tx Rank-4 precoding matrix.

In the examples of FIG. 15, FIG. 17, and FIG. 20, the network node outputs an RRC configuration including two SRS resource sets, respective SRS resource set ports, and an 8-port UL MIMO indicator. In some examples, the network node may be configured to output once SRS resource set in which the SRS resources are 8-port resources. In such an example, the network node may be configured to indicate which ports are to use the first precoding matrix and which ports are to use the second precoding matrix.

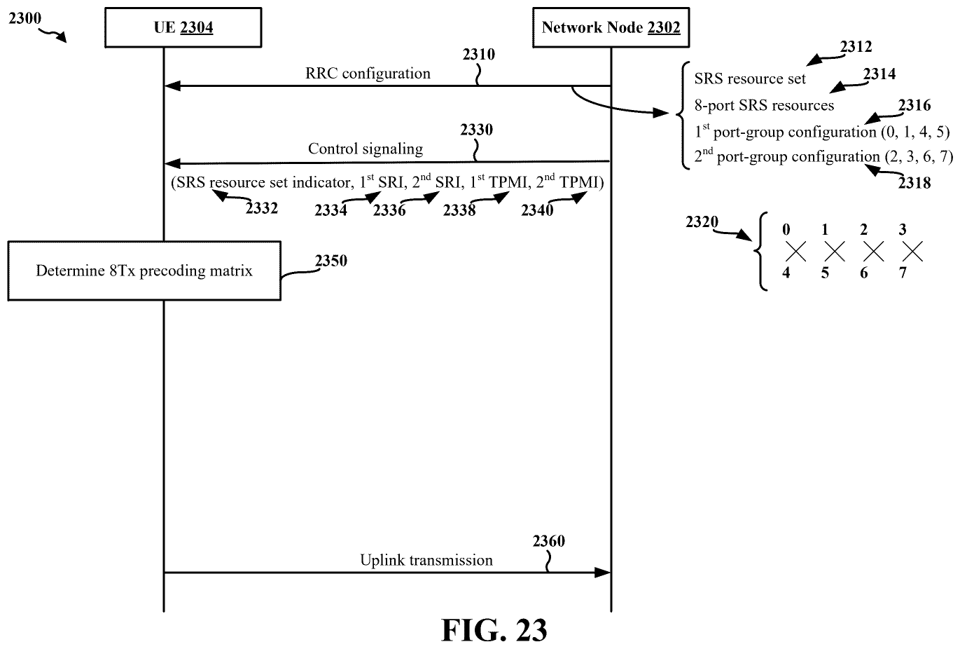

FIG. 23 illustrates a communication flow 2300 between a network node 2302 and a UE 2304, as presented herein. Aspects of the communication flow 2300 facilitate precoding matrix indication when 8-port SRS resources are provided.

In the example of FIG. 23, the network node 2302 outputs an RRC configuration 2310 that is received by the UE 2304. The RRC configuration 2310 includes an SRS resource set 2312, an 8-port SRS resources indicator 2314, a first port-group configuration 2316, and a second port-group configuration 2318. The port-group (PG) configurations indicate which ports are associated with a precoding matrix. For example, the first port-group configuration 2316 may indicate a first subset of ports that are associated with a first precoding matrix, and the second port-group configuration 2318 may indicate a second subset of ports that are associated with a second precoding matrix. In the example of FIG. 23, the first port-group configuration 2316 indicates that ports 0, 1, 4, and 5 are associated with a first precoding matrix, and the second port-group configuration 2318 indicates that ports 2, 3, 6, and 7 are associated with a second precoding matrix. However, other examples may include alternate combinations of ports and port groups. For example a first port-group may include ports 0, 1, 2, and 3, and a second port-group may include ports 4, 5, 6, and 7. The ports of the respective port-groups may correspond to the antenna elements 402 of FIG. 4. For example, a port configuration 2320 may indicate the placement of antenna elements in the UE 2304. In such an example, it may be appreciated that port 0 corresponds to the first antenna element 402a, the port 1, corresponds to the third antenna element 402c, . . . , the port 6 corresponds to the sixth antenna element 402f, and the port 7 corresponds to the eighth antenna element 402h.

After the network node 2302 configures the UE 2304 via the RRC configuration 2310, the network node 2302 may output control signaling 2330 that is received by the UE 2304. The control signaling 2330 may allow the UE 2304 to determine the 8Tx precoding matrix to apply when transmitting an uplink transmission to the network node 2302. Aspects of the control signaling 2330 may be similar to the control signaling of FIG. 15, FIG. 17, and/or FIG. 20 and, thus, the UE 2304 may determine the 8Tx precoding matrix in a similar manner.

In the example of FIG. 23, the control signaling 2330 includes a precoding matrix type indicator 2332, an SRI field 2334, a first TPMI field 2338, and a second TPMI field 2340. The precoding matrix type indicator 2332 may be of size 2-bits and similar to the SRS resource set indicator of FIG. 15, FIG. 17, and/or FIG. 20. The SRI field 2334 may indicate the SRS resource, as described in connection with the examples of FIG. 15 and FIG. 20. In examples in which the UE 2304 employs the techniques described in connection with FIG. 17 to determine the precoding matrix type (e.g., via the SRS resource set indicator and the second SRI field), the control signaling 2330 may include an indicator bit 2336 that may be used with the precoding matrix type indicator 2332 to determine the precoding matrix type. At 2350, the UE 2304 may determine the 8Tx precoding matrix. The UE 2304 may then transmit an uplink transmission 2360 using the 8Tx precoding matrix.

The first TPMI field 2338 and the second TPMI field 2340 may be used to determine the first 4Tx precoding matrix and the second 4Tx precoding matrix, respectively, as described in connection with the examples of FIG. 15, FIG. 17, and FIG. 20. Thus, in the example of FIG. 23, the UE 2304 may use the precoding matrix type indicator 2332, the first TPMI field 2338, and the second TPMI field 2340 to jointly determine the 8Tx precoding matrix, as described in connection with the examples of FIG. 15 and FIG. 20. In other examples, the UE 2304 may use the precoding matrix type indicator 2332, the indicator bit 2336, the first TPMI field 2338, and the second TPMI field 2340 to determine the 8Tx precoding matrix, as described in connection with the example of FIG. 17.

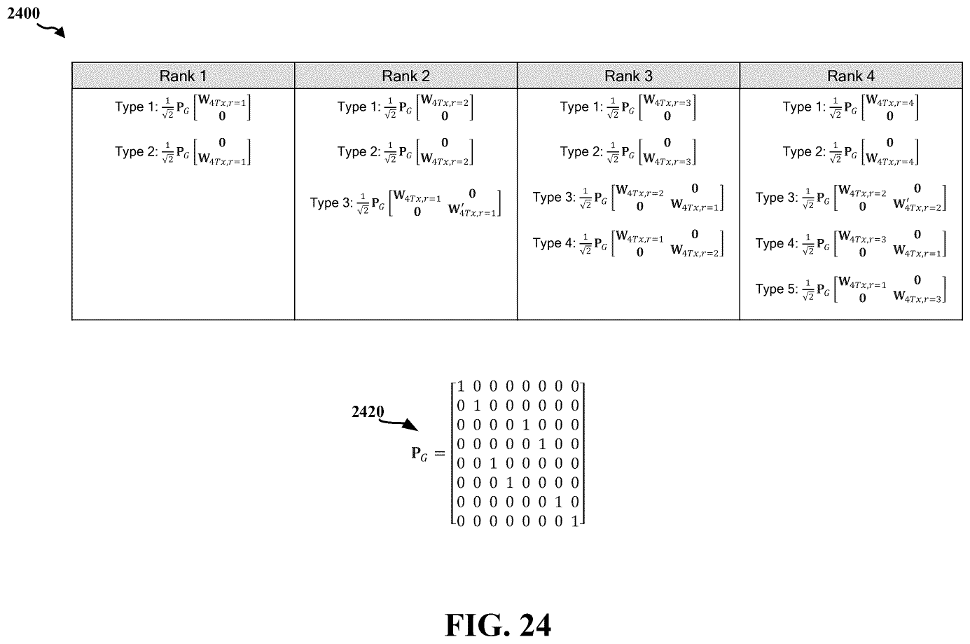

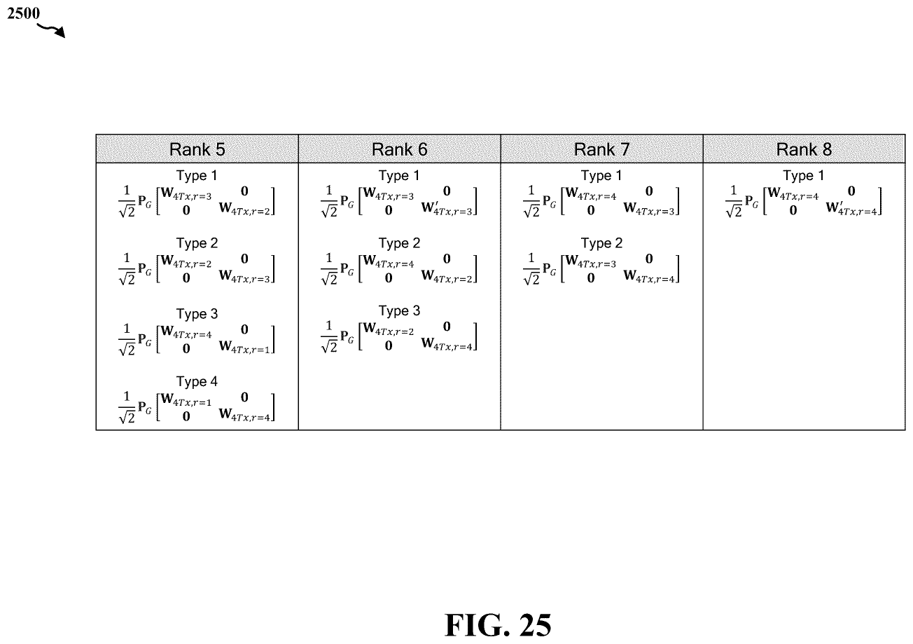

In examples in which an 8-port SRS is used (e.g., the example communication flow 2300 of FIG. 23), precoding matrix types may be re-defined. FIG. 24 depicts a table 2400 including precoding matrix types for Rank 1 to Rank 4, as presented herein. FIG. 25 depicts a table 2500 including precoding matrix types for Rank 5 to Rank 8. Aspects of the precoding matrix types of FIG. 24 and FIG. 25 are similar to the example precoding matrix types of FIG. 14. However, the precoding matrix types of FIG. 24 and FIG. 25 include a permutation matrix (P_{G}). The permutation matrix represents the port-group configuration. The permutation matrix may be defined by Equation 1 (below).

$${P}_{G} = [ {e}_{1 , 1} , {e}_{1 , 2} , {e}_{1 , 3} , {e}_{1 , 4} , {e}_{2 , 1} , {e}_{2 , 2} , {e}_{2 , 3} , {e}_{2 , 4} ] \qquad Equation 1$$

In Equation 1, the term (e_{i,j}) is the unit vector with a single non-zero (unit) element to represent the j-th port in PG i. For example, and with respect to the example of FIG. 23 in which the first port-group configuration 2316 includes the ports 0, 1, 4, and 5, and the second port-group configuration 2318 includes the ports 2, 3, 6, and 7, the permutation matrix may be presented by a permutation matrix 2420. The permutation matrix 2420 defines how the ports (e.g., antenna elements) of the UE 2304 apply the 8Tx precoding matrix.

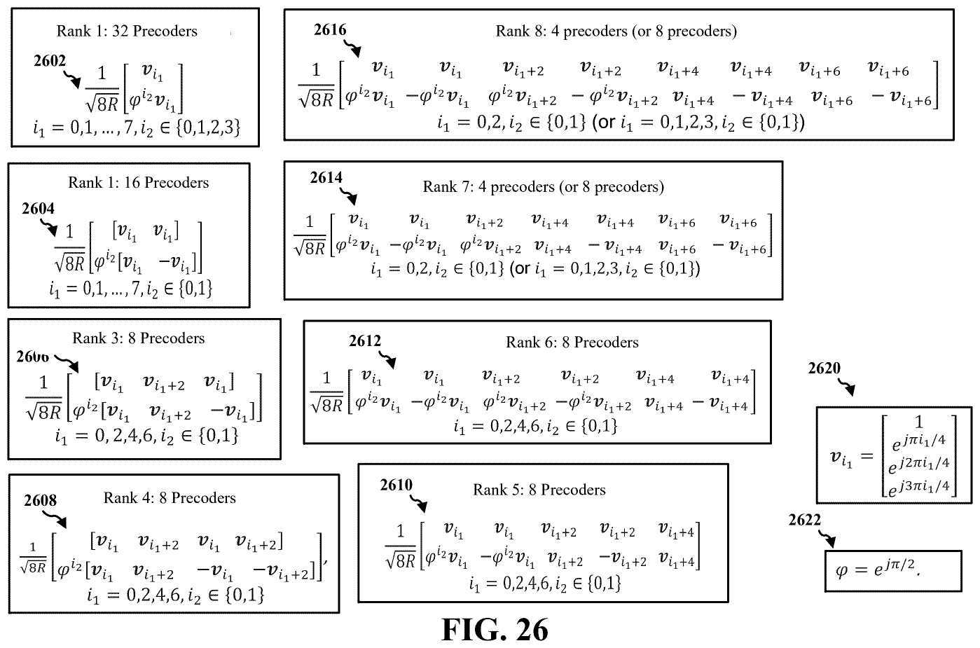

As described above, aspects disclosed herein facilitate reusing 4Tx codebooks for 8Tx MIMO transmissions. For example, a 4Tx non-coherent codebook may map to an 8Tx non-coherent codebook, a 4Tx partial-coherent codebook may map to an 8Tx PC-2 codebook, and a 4Tx fully-coherent codebook may map to an 8Tx PC-4 codebook. However, it may be beneficial to support an 8Tx fully-coherent codebook. Examples of 8Tx fully-coherent (FC) codebook structures are illustrated in FIG. 26.

In the examples of FIG. 26, an 8Tx FC Rank-1 codebook may include 32 precoders and be defined by a Rank-1 structure 2602. An 8Tx FC Rank-2 codebook may include 16 precoders and may be defined by a Rank-2 structure 2604. An 8Tx FC Rank-3 codebook may include 8 precoders and may be defined by a Rank-3 structure 2606. An 8Tx FC Rank-4 codebook may include 8 precoders and may be defined by a Rank-4 structure 2608. An 8Tx FC Rank-5 codebook may include 8 precoders and may be defined by a Rank-5 structure 2610. An 8Tx FC Rank-6 codebook may include 8 precoders and may be defined by a Rank-6 structure 2612. An 8Tx FC Rank-7 codebook may include 4 precoders (or 8 precoders) and may be defined by a Rank-7 structure 2614. An 8Tx FC Rank-8 codebook may include 4 precoders (or 8 precoders) and may be defined by a Rank-8 structure 2616. In the example structures of FIG. 26, the term “vi₁” may be defined by an equation 2620 and the term “φ” may be defined by an equation 2622.

It may be appreciated that the example structures of FIG. 26 are illustrative and that other examples may include additional or alternate structures for defining an 8Tx FC codebook.

In examples in which a precoding matrix from an 8Tx FC codebook is being used, the network node may output an FC codebook indicator to the UE to signal to the UE to use an 8Tx FC codebook to determine the precoding matrix.

In such examples, a network node may signal that a 8Tx fully-coherent codebook is being used by including a fully-coherent (FC) codebook indicator with the control signaling to the UE. In some examples, the network node may include the FC codebook indicator with the control signaling to the UE. For example, in the examples of FIG. 15, FIG. 17, and FIG. 20, the network node may output an FC codebook indicator (e.g., an FC codebook indicator 1570, an FC codebook indicator 1770, or an FC codebook indicator 2070) that may indicate to the UE whether to use an FC codebook to determine to the 8Tx precoding matrix or to use the NC/PC-2/PC-4 codebook to determine to the 8Tx precoding matrix. For example, the FC codebook indicator may be a 1-bit indicator that indicates when the UE is to use an FC codebook. For example, when the FC codebook indicator is set to a first value (e.g., a “0”), then the UE may determine to use the NC/PC-2/PC-4 codebooks as previously described in connection with the examples of FIG. 15, FIG. 17, and FIG. 20. Additionally, when the FC codebook indicator is set to a second value (e.g., a “1”), then the UE may determine to use an FC codebook. In examples in which the FC codebook indicator indicates to use the FC codebook, the UE may use the first TPMI field and the second TPMI field to determine the 8Tx FC precoding matrix.

Although the example FC codebook indicator is illustrated as a separate communication than the control signaling from the network node to the UE in the examples of FIG. 15, FIG. 17, and FIG. 20, in other examples, the FC codebook indicator may be included with the control signaling.

In some examples, the FC codebook indicator may be provided based on the example of FIG. 15 with an SRI modification. For example, and similar to the example of FIG. 17, the UE 1504 may use the first SRI field 1534 to determine the SRS resource. For example, when the first SRI field 1534 is set to “0,” then SRS resource 0 in the first SRS resource set, as indicated by the first SRS resource set 1512, and the SRS resource 0 in the second SRS resource set, as indicated by the second SRS resource set 1516, are the indicated SRS resources. Additionally, when the first SRI field 1534 is set to “1,” then SRS resource 1 in the first SRS resource set, as indicated by the first SRS resource set 1512, and the SRS resource 1 in the second SRS resource set, and the second SRS resource set 1516, are the indicated SRS resources.

The UE 1504 may use the second SRI field 1536 to determine whether to use the FC codebook or the NC/PC-2/PC-4 codebooks. For example, when the second SRI field 1536 is set to a first value (e.g., a “0”), then the UE 1504 may determine to use the NC/PC-2/PC-4 codebooks, as previously described in connection with FIG. 15. In such examples, the UE 1504 may use the two TPMI fields and the SRS resource set indicator 1532 to determine the 8Tx precoding matrix.

Additionally, when the second SRI field 1536 is set to a second value (e.g., a “1”), then the UE 1504 may determine to use the FC codebook. In such examples, the UE 1504 may use the two TPMI fields to determine the 8Tx FC precoding matrix.

In another example, the UE may use the example of FIG. 20 and the SRS resource set indicator 2032 to determine whether to use an FC codebook. For example, when the SRS resource set indicator 2032 is set to a “0,” a “1,” or a “2,” then the UE 2004 may determine to use the NC/PC-2/PC-4 codebooks, as previously described in connection with FIG. 20. In such examples, the UE 2004 may use the two TPMI fields, the SRI fields, and the SRS resource set indicator 2032 to determine the 8Tx precoding matrix.

Additionally, when the SRS resource set indicator 2032 is set to a “3,” then the UE 2004 may determine to use the FC codebook. In such examples, the UE 2004 may use the two TPMI fields to determine the 8Tx FC precoding matrix.

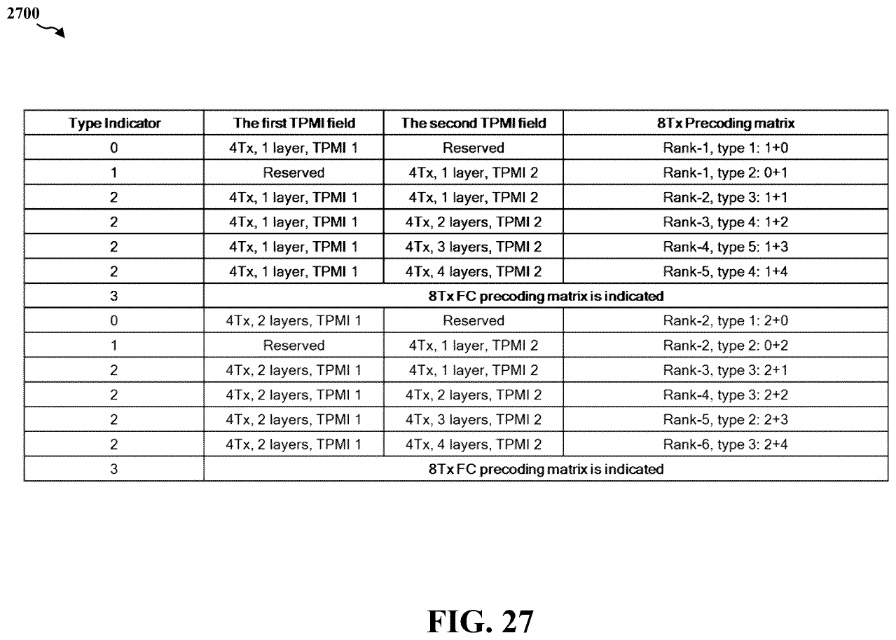

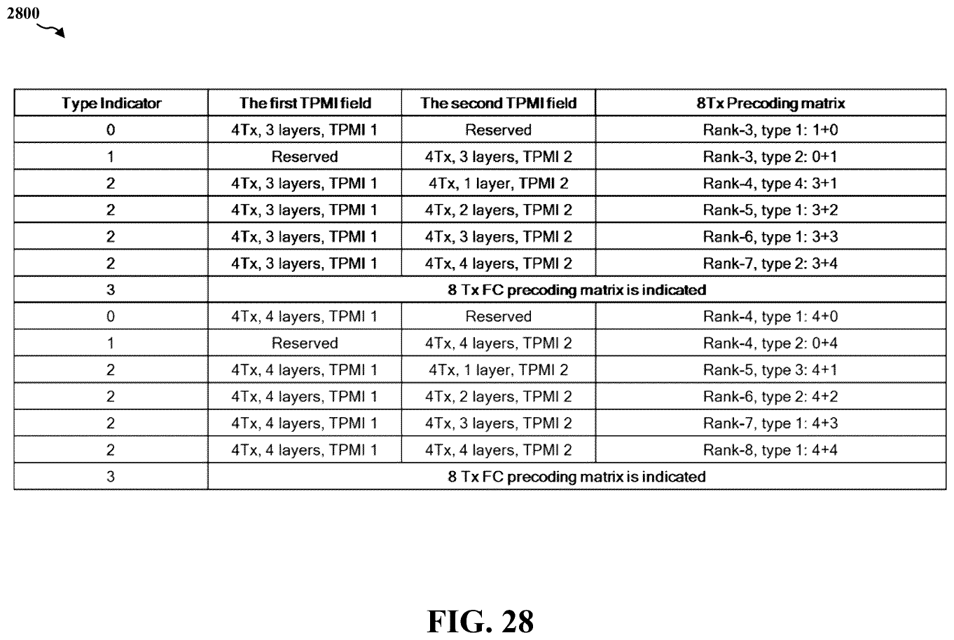

FIG. 27 depicts a table 2700 to facilitate mapping a type indicator and TPMI fields to an 8Tx precoding matrix, as presented herein. FIG. 28 depicts a table 2800 to facilitate mapping a type indicator and TPMI fields to an 8Tx precoding matrix, as presented herein. The tables of FIG. 27 and FIG. 28 may be read together and illustrate supporting all of the possible precoding matrix types indicated in the example table 1400 of FIG. 14 and the 8Tx FC precoding matrices. The example tables of FIG. 27 and FIG. 28 are similar to the tables of FIG. 21 and FIG. 22 except they include additional rows for a type indicator of “3.” In examples in which the type indicator is “3,” the UE 2004 may use the two TPMI fields to determine the 8Tx FC precoding matrix.

In the examples of FIG. 15, FIG. 17, and FIG. 20, the network node outputs control signaling that is similar to the example control signaling 540 of FIG. 5. However, other examples may employ different signaling to indicate the 8Tx precoding matrix.

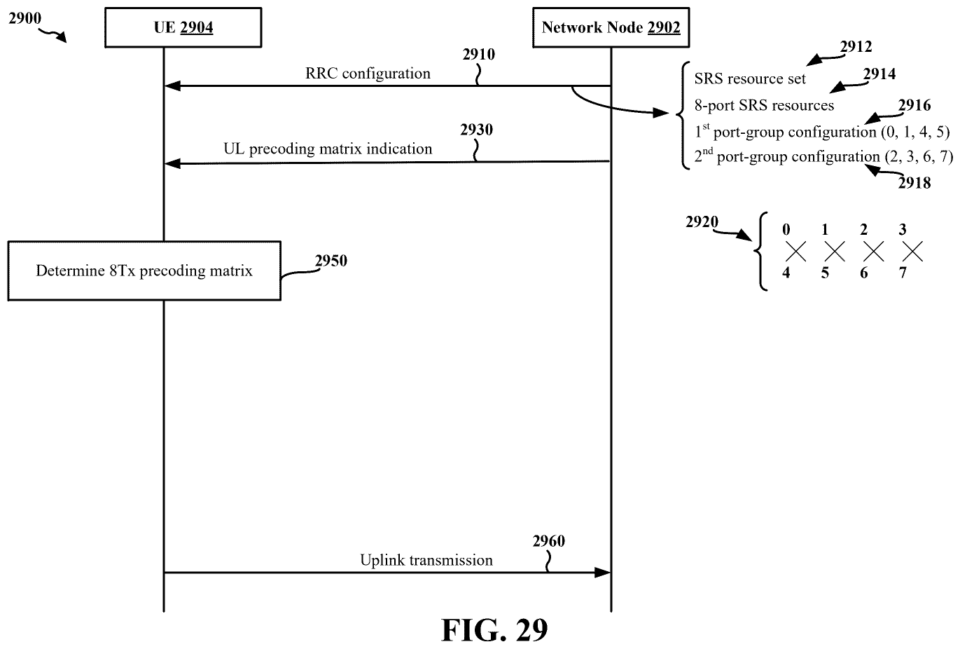

FIG. 29 illustrates a communication flow 2900 between a network node 2902 and a UE 2904, as presented herein. Aspects of the communication flow 2900 may be similar to the communication flow 2300 of FIG. 23. For example, the network node 2902 may output an RRC configuration 2910 that is received by the UE 2904. The RRC configuration 2910 may configure the UE 2904 for 8Tx UL MIMO. In the example of FIG. 29, the RRC configuration 2910 includes an SRS resource set 2912, an 8-port SRS resources indicator 2914, a first port-group configuration 2916, and a second port-group configuration 2918. The PG configurations indicate which ports are associated with a precoding matrix. As shown in FIG. 29, the first port-group configuration 2916 indicates that ports 0, 1, 4, and 5 are associated with a first precoding matrix, and the second port-group configuration 2918 indicates that ports 2, 3, 6, and 7 are associated with a second precoding matrix. However, other examples may include alternate combinations of ports and port groups.

The network node 2902 outputs an uplink precoding matrix indication 2930 that is received by the UE 2904. The network node 2902 may output the uplink precoding matrix indication 2930 via DCI. The uplink precoding matrix indication 2930 may indicate a precoding matrix type and the TPMI. Aspects of the precoding matrix types are described in connection with the example tables of FIG. 24 and FIG. 25.

The UE 2904 may use information from the RRC configuration 2910 and the uplink precoding matrix indication 2930 to determine an 8Tx precoding matrix 2950. As shown in FIG. 29, the UE 2904 may transmit an uplink transmission 2960 that is obtained by the network node 2902. The UE 2904 may use the 8Tx precoding matrix 2950 to transmit the uplink transmission 2960.

As described above, the 8Tx precoding matrix 2950 may be associated with a rank (e.g., Rank-1, Rank-2, . . . , Rank-8). Additionally, the 8Tx precoding matrix 2950 may be associated with a type (e.g., a type 1, a type 2, etc.). The uplink precoding matrix indication 2930 may indicate the precoding matrix type and the TPMI(s) for the 4Tx precoding matrix to use in the 8Tx precoding matrix.

For a Rank-1 8Tx codebook, the precoding matrix may be associated with a Type 1 or a Type 2. Additionally, there are 28 TPMI indices associated with NC precoding matrices, PC-2 precoding matrices, and PC-4 matrices associated with Rank-1, as described in connection with the table 900 of FIG. 9.

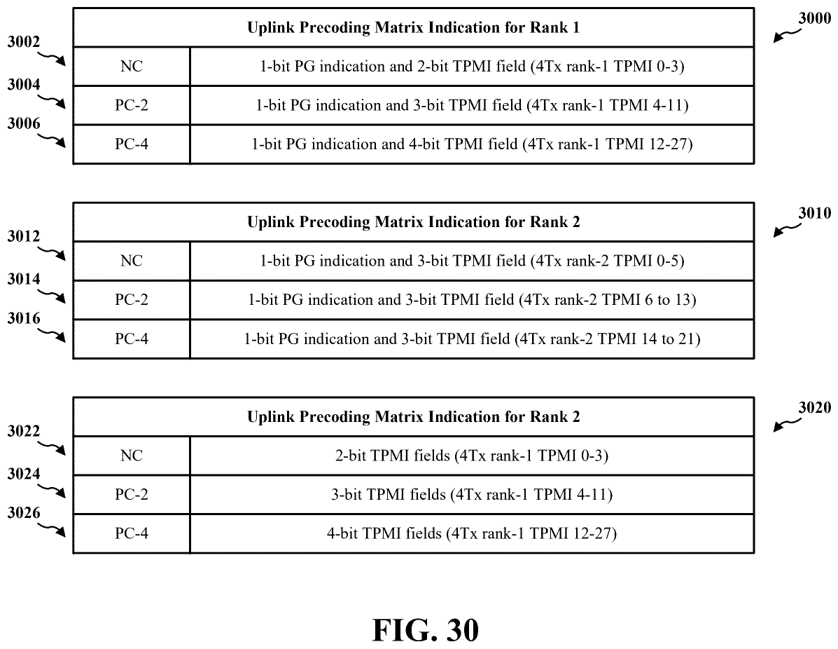

FIGS. 30 to 47 depict example tables illustrating the uplink precoding matrix indication 2930 for Ranks 1 to 8. In the example of FIG. 30, a first table 3000 illustrates the uplink precoding matrix indication 2930 for Rank 1. As shown in the first table 3000, for a Rank-1 NC precoding matrix, an uplink precoding matrix indication 3002 may include a 1-bit PG indication to indicate whether the 8Tx precoding matrix is of Type 1 or Type 2. The uplink precoding matrix indication 3002 may also include a 2-bit TPMI field to indicate one of the four states associated with the 4Tx Rank-1 TPMI indices 0 to 3.

For a Rank-1 PC-2 precoding matrix, an uplink precoding matrix indication 3004 may include a 1-bit PG indication to indicate whether the 8Tx precoding matrix is of Type 1 or Type 2. The uplink precoding matrix indication 3004 may also include a 3-bit TPMI field to indicate one of the eight states associated with the 4Tx Rank-1 TPMI indices 4 to 11.

For a Rank-1 PC-4 precoding matrix, an uplink precoding matrix indication 3006 may include a 1-bit PG indication to indicate whether the 8Tx precoding matrix is of Type 1 or Type 2. The uplink precoding matrix indication 3006 may also include a 2-bit TPMI field to indicate one of the 16 states associated with the 4Tx Rank-1 TPMI indices 12 to 27.

For a Rank-2 8Tx codebook, the precoding matrix may be associated with a Type 1, a Type 2, or a Type 3, as shown in the table 2400. A second table 3010 of FIG. 30 illustrates a first aspect for illustrating the uplink precoding matrix indication 2930 for Rank 2. In the second table 3010, the uplink precoding matrix indication 2930 may be configured to only indicate a Type 1 precoding matrix or a Type 2 precoding matrix. For example, for a Rank-2 NC precoding matrix, an uplink precoding matrix indication 3012 may include a 1-bit PG indication to indicate whether the 8Tx precoding matrix is of Type 1 or Type 2. The uplink precoding matrix indication 3012 may also include a 3-bit TPMI field to indicate one of six states associated with the 4Tx Rank-2 TPMI indices 0 to 5.

For a Rank-2 PC-2 precoding matrix, an uplink precoding matrix indication 3014 may include a 1-bit PG indication to indicate whether the 8Tx precoding matrix is of Type 1 or Type 2. The uplink precoding matrix indication 3014 may also include a 3-bit TPMI field to indicate one of the eight states associated with the 4Tx Rank-2 TPMI indices 6 to 13.

For a Rank-2 PC-4 precoding matrix, an uplink precoding matrix indication 3016 may include a 1-bit PG indication to indicate whether the 8Tx precoding matrix is of Type 1 or Type 2. The uplink precoding matrix indication 3016 may also include a 3-bit TPMI field to indicate one of the eight states associated with the 4Tx Rank-2 TPMI indices 14 to 21.

In another aspect, the uplink precoding matrix indication 2930 may be configured to only indicate a Rank-2 Type 3 precoding matrix. In such examples, the uplink precoding matrix indication 2930 may skip including a PG indication (e.g., the PG indication may be reserved or disabled). The uplink precoding matrix indication 2930 may also include two TPMI fields to indicate the first precoding matrix and the second precoding matrix associated with the Rank-2 Type 3 precoding matrix.

In a third table 3020 of FIG. 30, the uplink precoding matrix indication 2930 may be configured to only indicate a Type 3 precoding matrix. For example, for a Rank-2 NC precoding matrix, an uplink precoding matrix indication 3022 may include two 2-bit TPMI fields to indicate one of four states associated with the 4Tx Rank-1 TPMI indices 0 to 3.

For a Rank-2 PC-2 precoding matrix, an uplink precoding matrix indication 3024 may include two 3-bit TPMI fields to indicate one of eight states associated with the 4Tx Rank-1 TPMI indices 4 to 11.

For a Rank-2 PC-4 precoding matrix, an uplink precoding matrix indication 3026 may include two 4-bit TPMI fields to indicate one of 16 states associated with the 4Tx Rank-1 TPMI indices 12 to 27.

In some examples, a same precoder restriction may apply for the two PG configurations. For example, the first precoding matrix and the second precoding matrix may be configured to be the same (e.g., W_{4Tx,r=1}=W_{4Tx,r=1}). In such examples, the uplink precoding matrix indication 2930 associated with the third table 3020 may include one TPMI field.

In another aspect related to the Rank-2 precoding matrix, the uplink precoding matrix indication 2930 may be configured to indicate any of the Type 1, Type 2, or Type 3 precoding matrix without restriction. In such examples, the uplink precoding matrix indication 2930 may include a 2-bit PG indication to indicate either Type 1, Type 2, or Type 3. For example, a codepoint “00” may indicate Type 1, a codepoint “01” may indicate Type 2, a codepoint “10” may indicate Type 3, and a codepoint “11” may be reserved. In another example, a codepoint “00” may be reserved, a codepoint “10” may indicate Type 1, a codepoint “01” may indicate Type 2, and a codepoint “11” may indicate Type 3. However, other examples may utilize alternate mappings between codepoints and precoding matrix types.

In addition to the 2-bit PG indication, the uplink precoding matrix indication 2930 may include two TPMI fields to indicate the first 4Tx precoding matrix and the second 4Tx precoding matrix.

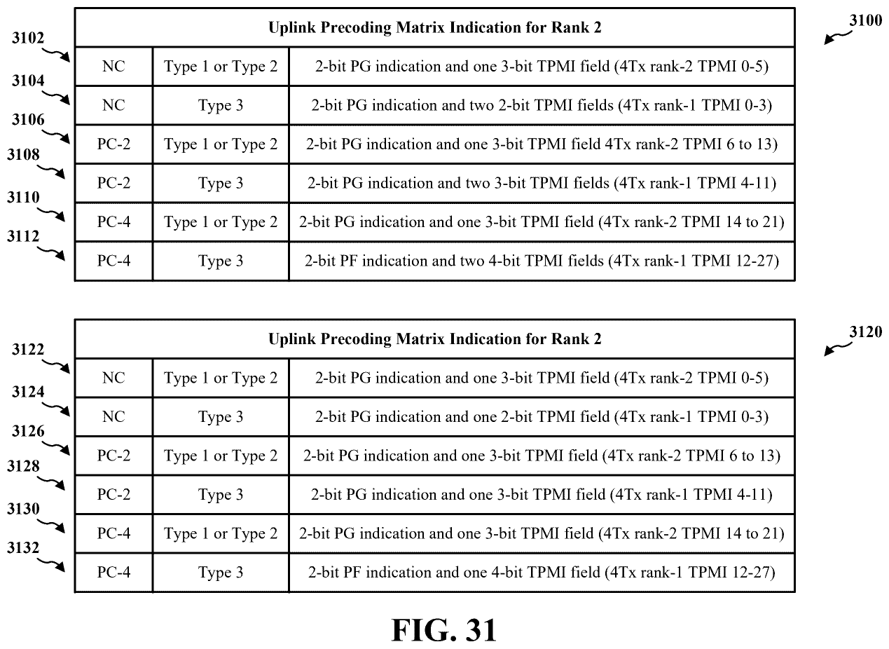

In the example of FIG. 31, a first table 3100 depicts indicating any of the Type 1, Type 2, or Type 3 precoding matrix without restriction. For example, for a Rank-2 NC precoding matrix indicating Type 1 or Type 2 (e.g., based on the PG indication codepoint), an uplink precoding matrix indication 3102 may include a 2-bit PG indication and one 3-bit TPMI field to indicate one of six states associated with the 4Tx Rank-2 TPMI indices 0 to 5. In such examples, the second TPMI field may be reserved. For a Rank-2 NC precoding matrix indicating Type 3 (e.g., based on the PG indication codepoint), an uplink precoding matrix indication 3104 may include a 2-bit PG indication and two 2-bit TPMI fields to indicate one of four states associated with the 4Tx Rank-1 TPMI indices 0 to 3.

For a Rank-2 PC-2 precoding matrix indicating Type 1 or Type 2 (e.g., based on the PG indication codepoint), an uplink precoding matrix indication 3106 may include a 2-bit PG indication and one 3-bit TPMI field to indicate one of eight states associated with the 4Tx Rank-2 TPMI indices 6 to 13. In such examples, the second TPMI field may be reserved. For a Rank-2 PC-2 precoding matrix indicating Type 3 (e.g., based on the PG indication codepoint), an uplink precoding matrix indication 3108 may include a 2-bit PG indication and two 3-bit TPMI fields to indicate one of eight states associated with the 4Tx Rank-1 TPMI indices 4 to 11.

For a Rank-2 PC-4 precoding matrix indicating Type 1 or Type 2 (e.g., based on the PG indication codepoint), an uplink precoding matrix indication 3110 may include a 2-bit PG indication and one 3-bit TPMI field to indicate one of eight states associated with the 4Tx Rank-2 TPMI indices 14 to 21. In such examples, the second TPMI field may be reserved. For a Rank-2 PC-4 precoding matrix indicating Type 3 (e.g., based on the PG indication codepoint), an uplink precoding matrix indication 3112 may include a 2-bit PG indication and two 4-bit TPMI fields to indicate one of 16 states associated with the 4Tx Rank-1 TPMI indices 12 to 27.

In another aspect related to the Rank-2 precoding matrix, the uplink precoding matrix indication 2930 may be configured to indicate any of the Type 1, Type 2, or Type 3 precoding matrix with restriction. In such examples, the uplink precoding matrix indication 2930 may include a 2-bit PG indication to indicate either Type 1, Type 2, or Type 3, as described in connection with the PG indication of the first table 3100.

Additionally, the uplink precoding matrix indication 2930 may include a same precoder restriction so that the first precoding matrix and the second precoding matrix may be configured to be the same (e.g., W_{4Tx,r=1}=W_{4Tx,r=1}). In such examples, the uplink precoding matrix indication 2930 associated with a second table 3120 of FIG. 31 may include one TPMI field in the case of Type 1, Type 2, or Type 3.

In the example of FIG. 31, a second table 3120 depicts indicating any of the Type 1, Type 2, or Type 3 precoding matrix with restriction. For example, for a Rank-2 NC precoding matrix indicating Type 1 or Type 2 (e.g., based on the PG indication codepoint), an uplink precoding matrix indication 3122 may include a 2-bit PG indication and one 3-bit TPMI field to indicate one of six states associated with the 4Tx Rank-2 TPMI indices 0 to 5. For a Rank-2 NC precoding matrix indicating Type 3 (e.g., based on the PG indication codepoint), an uplink precoding matrix indication 3124 may include a 2-bit PG indication and one 2-bit TPMI field to indicate one of four states associated with the 4Tx Rank-1 TPMI indices 0 to 3.

For a Rank-2 PC-2 precoding matrix indicating Type 1 or Type 2 (e.g., based on the PG indication codepoint), an uplink precoding matrix indication 3126 may include a 2-bit PG indication and one 3-bit TPMI field to indicate one of eight states associated with the 4Tx Rank-2 TPMI indices 6 to 13. For a Rank-2 PC-2 precoding matrix indicating Type 3 (e.g., based on the PG indication codepoint), an uplink precoding matrix indication 3128 may include a 2-bit PG indication and one 3-bit TPMI field to indicate one of eight states associated with the 4Tx Rank-1 TPMI indices 4 to 11.

For a Rank-2 PC-4 precoding matrix indicating Type 1 or Type 2 (e.g., based on the PG indication codepoint), an uplink precoding matrix indication 3130 may include a 2-bit PG indication and one 3-bit TPMI field to indicate one of eight states associated with the 4Tx Rank-2 TPMI indices 14 to 21. For a Rank-2 PC-4 precoding matrix indicating Type 3 (e.g., based on the PG indication codepoint), an uplink precoding matrix indication 3132 may include a 2-bit PG indication and one 4-bit TPMI field to indicate one of 16 states associated with the 4Tx Rank-1 TPMI indices 12 to 27.

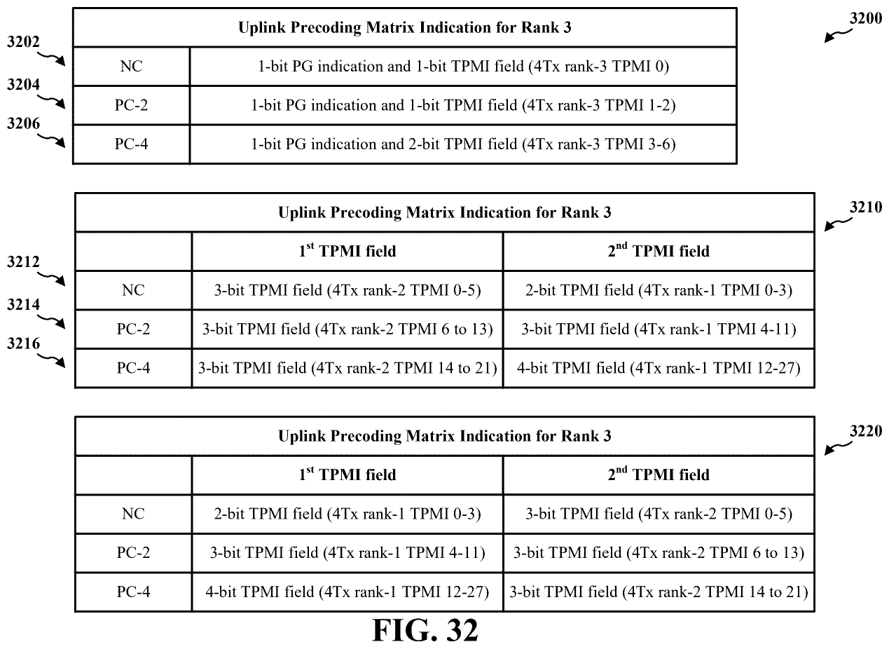

For a Rank-3 8Tx codebook, the precoding matrix may be associated with a Type 1, a Type 2, a Type 3, or a Type 4, as shown in the table 2400. A first table 3200 of FIG. 32 illustrates a first aspect for illustrating the uplink precoding matrix indication 2930 for Rank 3. In the first table 3200, the uplink precoding matrix indication 2930 may be configured to only indicate a Type 1 precoding matrix or a Type 2 precoding matrix. For example, for a Rank-3 NC precoding matrix, an uplink precoding matrix indication 3202 may include a 1-bit PG indication to indicate whether the 8Tx precoding matrix is of Type 1 or Type 2. The uplink precoding matrix indication 3202 may also include a 1-bit TPMI field to indicate the one state associated with the 4Tx Rank-3 TPMI index 0.

For a Rank-3 PC-2 precoding matrix, an uplink precoding matrix indication 3204 may include a 1-bit PG indication to indicate whether the 8Tx precoding matrix is of Type 1 or Type 2. The uplink precoding matrix indication 3204 may also include a 1-bit TPMI field to indicate one of two states associated with the 4Tx Rank-3 TPMI indices 1 to 2.

For a Rank-3 PC-4 precoding matrix, an uplink precoding matrix indication 3206 may include a 1-bit PG indication to indicate whether the 8Tx precoding matrix is of Type 1 or Type 2. The uplink precoding matrix indication 3206 may also include a 2-bit TPMI field to indicate one of four states associated with the 4Tx Rank-3 TPMI indices 3 to 6.

In another aspect, the uplink precoding matrix indication 2930 may be configured to only indicate a Rank-3 Type 3 precoding matrix. In such examples, the uplink precoding matrix indication 2930 may skip including a PG indication (e.g., the PG indication may be reserved or disabled). The uplink precoding matrix indication 2930 may also include two TPMI fields to indicate the first precoding matrix and the second precoding matrix associated with the Rank-3 Type 3 precoding matrix.

In a second table 3210 of FIG. 32, the uplink precoding matrix indication 2930 may be configured to only indicate a Type 3 precoding matrix. For example, for a Rank-3 NC precoding matrix, an uplink precoding matrix indication 3212 may include a first TPMI field of 3-bits to indicate one of six states associated with the 4Tx Rank-2 TPMI indices 0 to 5. The uplink precoding matrix indication 3212 may also include a second TPMI field of 2-bits to indicate one of four states associated with the 4Tx Rank-1 TPMI indices 0 to 3.

For a Rank-3 PC-2 precoding matrix, an uplink precoding matrix indication 3214 may include a first TPMI field of 3-bits to indicate one of eight states associated with the 4Tx Rank-2 TPMI indices 6 to 13. The uplink precoding matrix indication 3214 may also include a second TPMI field of 3-bits to indicate one of eight states associated with the 4Tx Rank-1 TPMI indices 4 to 11.

For a Rank-3 PC-4 precoding matrix, an uplink precoding matrix indication 3216 may include a first TPMI field of 3-bits to indicate one of eight states associated with the 4Tx Rank-2 TPMI indices 14 to 21. The uplink precoding matrix indication 3216 may also include a second TPMI field of 4-bits to indicate one of sixteen states associated with the 4Tx Rank-1 TPMI indices 12 to 27.

In some examples, a single TPMI field may be used in the second table 3210 of FIG. 32 when the following restriction is applied:

$${W}_{4 Tx , r = 1} = {[ {W}_{4 Tx , r = 2} ]}_{1}$$

In the above restriction, the term “[ ]x” means that the first x columns of a matrix [ ] are used. Thus, in the above restriction, the first 1 column of the precoding matrix (W_{4Tx,r=2}) are used for the second precoding matrix.

In another aspect related to indicating the Rank-3 matrix, the uplink precoding matrix indication 2930 may be configured to only indicate a Rank-3 Type 4 precoding matrix. In such examples, the description related to the first TPMI field and the second TPMI field of the second table 3210 may be swapped, as depicted in a third table 3220 of FIG. 32.

In another aspect related to indicating the Rank-3 matrix, the uplink precoding matrix indication 2930 may be configured to indicate any of Types 1 to 3 precoding matrices without restriction. For example, the uplink precoding matrix indication 2930 may include a 2-bit PG indication to indicate either Type 1, Type 2, or Type 3, as described in connection with the PG indication of the first table 3100 of FIG. 31.

In addition to the 2-bit PG indication, the uplink precoding matrix indication 2930 may include two TPMI fields to indicate the first 4Tx precoding matrix and the second 4Tx precoding matrix.

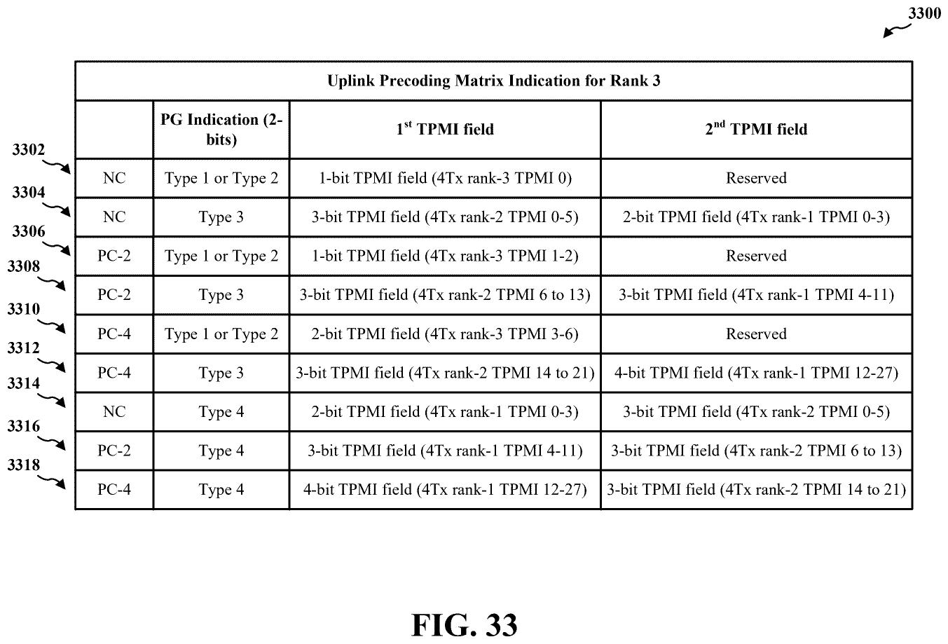

In the example of FIG. 33, a table 3300 depicts indicating any of the Type 1, Type 2, or Type 3 precoding matrix without restriction. For example, for a Rank-3 NC precoding matrix indicating Type 1 or Type 2 (e.g., based on the PG indication codepoint), an uplink precoding matrix indication 3302 may include the 2-bit PG indication and one 1-bit TPMI field to indicate the one state associated with the 4Tx Rank-3 TPMI index 0. In such examples, the second TPMI field may be reserved. For a Rank-3 NC precoding matrix indicating Type 3 (e.g., based on the PG indication codepoint), an uplink precoding matrix indication 3304 may include a 2-bit PG indication, a first 3-bit TPMI field to indicate one of six states associated with the 4Tx Rank-2 TPMI indices 0 to 5, and a second 2-bit TPMI field to indicate one of four states associated with the 4Tx Rank-1 TPMI indices 0 to 3.

For a Rank-3 PC-2 precoding matrix indicating Type 1 or Type 2 (e.g., based on the PG indication codepoint), an uplink precoding matrix indication 3306 may include a 2-bit PG indication and one 1-bit TPMI field to indicate one of two states associated with the 4Tx Rank-3 TPMI indices 1 to 2. In such examples, the second TPMI field may be reserved. For a Rank-3 PC-2 precoding matrix indicating Type 3 (e.g., based on the PG indication codepoint), an uplink precoding matrix indication 3308 may include a 2-bit PG indication, a first 3-bit TPMI field to indicate one of eight states associated with the 4Tx Rank-2 TPMI indices 6 to 13, and a second 3-bit TPMI field to indicate one of eight states associated with the 4Tx Rank-1 TPMI indices 4 to 11.

For a Rank-3 PC-4 precoding matrix indicating Type 1 or Type 2 (e.g., based on the PG indication codepoint), an uplink precoding matrix indication 3310 may include a 2-bit PG indication and one 2-bit TPMI field to indicate one of four states associated with the 4Tx Rank-3 TPMI indices 3 to 6. In such examples, the second TPMI field may be reserved. For a Rank-3 PC-4 precoding matrix indicating Type 3 (e.g., based on the PG indication codepoint), an uplink precoding matrix indication 3312 may include a 2-bit PG indication, a first 3-bit TPMI field to indicate one of eight states associated with the 4Tx Rank-2 TPMI indices 14 to 21, and a second 4-bit TPMI field to indicate one of 16 states associated with the 4Tx Rank-1 TPMI indices 12 to 27.

In another aspect related to indicating the Rank-3 matrix, the uplink precoding matrix indication 2930 may be configured to indicate any of Types 1 to 4 precoding matrices without restriction. For example, the uplink precoding matrix indication 2930 may include a 2-bit PG indication to indicate either Type 1, Type 2, Type 3, or Type 4 based on a codepoint.

In addition to the 2-bit PG indication, the uplink precoding matrix indication 2930 may include two TPMI fields to indicate the first 4Tx precoding matrix and the second 4Tx precoding matrix. In such examples, the indicating of the Type 1, Type 2 or Type 3 precoding matrix may be the same as indicated in the table 3300 of FIG. 33.

To indicate the Type 4 precoding matrix, the description related to the first TPMI field and the second TPMI field of the table 3300 related to the Type 3 precoding matrix may be swapped.

For example, for a Rank-3 NC precoding matrix indicating Type 4 (e.g., based on the PG indication codepoint), an uplink precoding matrix indication 3314 may include the 2-bit PG indication, a first 2-bit TPMI field to indicate one of four states associated with the 4Tx Rank-1 TPMI indices 0 to 3, and a second 3-bit TPMI field to indicate one of six states associated with the 4Tx Rank-2 TPMI indices 0 to 5.

For a Rank-3 PC-2 precoding matrix indicating Type 4 (e.g., based on the PG indication codepoint), an uplink precoding matrix indication 3316 may include a 2-bit PG indication, a first 3-bit TPMI field to indicate one of eight states associated with the 4Tx Rank-1 TPMI indices 4 to 11, and a second 3-bit TPMI field to indicate one of eight states associated with the 4Tx Rank-2 TPMI indices 6 to 13.

For a Rank-3 PC-4 precoding matrix indicating Type 4 (e.g., based on the PG indication codepoint), an uplink precoding matrix indication 3318 may include a 2-bit PG indication, a first 4-bit TPMI field to indicate one of 16 states associated with the 4Tx Rank-1 TPMI indices 12 to 27, and a second 3-bit TPMI field to indicate one of eight states associated with the 4Tx Rank-2 TPMI indices 14 to 21.

In another aspect related to the Rank-3 precoding matrix, the uplink precoding matrix indication 2930 may be configured to indicate any of the Types 1 to 3 precoding matrices with restriction or any of the Types 1 to 4 precoding matrices with restriction. In such examples, the uplink precoding matrix indication 2930 may include a 2-bit PG indication to indicate the precoding matrix type via the codepoint.

Additionally, the uplink precoding matrix indication 2930 may include single TPMI field with the same restriction described in connection with the second table 3210 of FIG. 32 (reproduced below):

$${W}_{4 Tx , r = 1} = {[ {W}_{4 Tx , r = 2} ]}_{1}$$

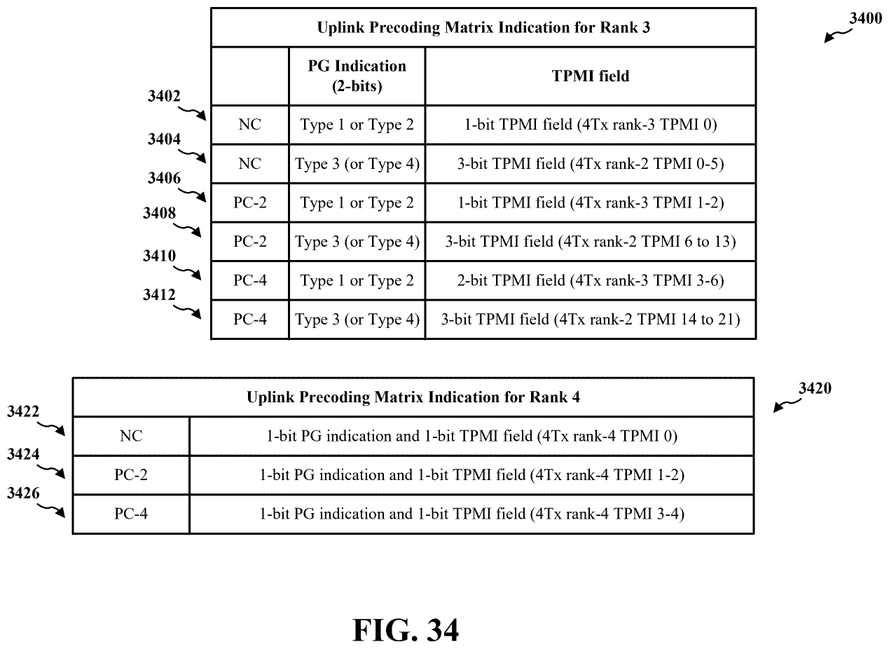

same precoder restriction so that the first precoding matrix and the second precoding matrix may be configured to be the same (e.g., W_{4Tx,r=1}=W_{4Tx,r=1}). In such examples, the uplink precoding matrix indication 2930 associated with a first table 3400 of FIG. 34 may include one TPMI field in the case of Types 1 to 3 or Types 1 to 4.

In the example of FIG. 34, the first table 3400 depicts indicating any of precoding matrix Types 1 to 3 with restriction or precoding matrix Types 1 to 4 with restriction. For example, for a Rank-3 NC precoding matrix indicating Type 1 or Type 2 (e.g., based on the PG indication codepoint), an uplink precoding matrix indication 3402 may include a 2-bit PG indication and one 1-bit TPMI field to indicate the one state associated with the 4Tx Rank-3 TPMI index 0. For a Rank-3 NC precoding matrix indicating Type 3 (or Type 4) (e.g., based on the PG indication codepoint), an uplink precoding matrix indication 3404 may include a 2-bit PG indication and one 3-bit TPMI field to indicate one of six states associated with the 4Tx Rank-2 TPMI indices 0 to 5.

For a Rank-3 PC-2 precoding matrix indicating Type 1 or Type 2 (e.g., based on the PG indication codepoint), an uplink precoding matrix indication 3406 may include a 2-bit PG indication and one 1-bit TPMI field to indicate one of two states associated with the 4Tx Rank-3 TPMI indices 1 to 2. For a Rank-3 PC-2 precoding matrix indicating Type 3 (or Type 4) (e.g., based on the PG indication codepoint), an uplink precoding matrix indication 3408 may include a 2-bit PG indication and one 3-bit TPMI field to indicate one of eight states associated with the 4Tx Rank-2 TPMI indices 6 to 13.

For a Rank-3 PC-4 precoding matrix indicating Type 1 or Type 2 (e.g., based on the PG indication codepoint), an uplink precoding matrix indication 3410 may include a 2-bit PG indication and one 2-bit TPMI field to indicate one of four states associated with the 4Tx Rank-3 TPMI indices 3 to 6. For a Rank-3 PC-4 precoding matrix indicating Type 3 (or Type 4) (e.g., based on the PG indication codepoint), an uplink precoding matrix indication 3412 may include a 2-bit PG indication and one 3-bit TPMI field to indicate one of eight states associated with the 4Tx Rank-2 TPMI indices 14 to 21.

For a Rank-4 8Tx codebook, the precoding matrix may be associated with a Type 1, a Type 2, or a Type 3, as shown in the table 2400. A second table 3420 of FIG. 34 illustrates a first aspect for illustrating the uplink precoding matrix indication 2930 for Rank 4. In the second table 3420, the uplink precoding matrix indication 2930 may be configured to only indicate a Type 1 precoding matrix or a Type 2 precoding matrix. For example, for a Rank-4 NC precoding matrix, an uplink precoding matrix indication 3422 may include a 1-bit PG indication to indicate whether the 8Tx precoding matrix is of Type 1 or Type 2. The uplink precoding matrix indication 3422 may also include a 1-bit TPMI field to indicate the one state associated with the 4Tx Rank-4 TPMI index 0.

For a Rank-4 PC-2 precoding matrix, an uplink precoding matrix indication 3424 may include a 1-bit PG indication to indicate whether the 8Tx precoding matrix is of Type 1 or Type 2. The uplink precoding matrix indication 3424 may also include a 1-bit TPMI field to indicate one of two states associated with the 4Tx Rank-4 TPMI indices 1 to 2.

For a Rank-4 PC-4 precoding matrix, an uplink precoding matrix indication 3426 may include a 1-bit PG indication to indicate whether the 8Tx precoding matrix is of Type 1 or Type 2. The uplink precoding matrix indication 3426 may also include a 1-bit TPMI field to indicate one of two states associated with the 4Tx Rank-4 TPMI indices 3 to 4.

In another aspect, the uplink precoding matrix indication 2930 may be configured to only indicate a Rank-4 Type 3 precoding matrix. In such examples, the uplink precoding matrix indication 2930 may skip including a PG indication (e.g., the PG indication may be reserved or disabled). The uplink precoding matrix indication 2930 may also include two TPMI fields to indicate the first precoding matrix and the second precoding matrix associated with the Rank-4 Type 3 precoding matrix.

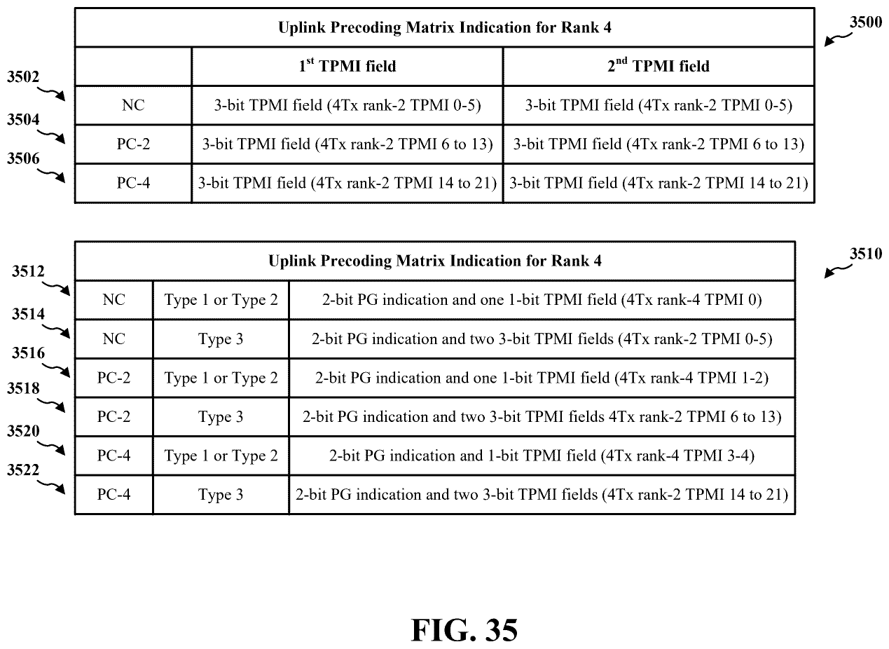

In a first table 3500 of FIG. 35, the uplink precoding matrix indication 2930 may be configured to only indicate a Type 3 precoding matrix. For example, for a Rank-4 NC precoding matrix, an uplink precoding matrix indication 3502 may include two 3-bit TPMI fields to indicate one of six states associated with the 4Tx Rank-2 TPMI indices 0 to 5.

For a Rank-4 PC-2 precoding matrix, an uplink precoding matrix indication 3504 may include two 3-bit TPMI fields to indicate one of eight states associated with the 4Tx Rank-2 TPMI indices 6 to 13.

For a Rank-4 PC-4 precoding matrix, an uplink precoding matrix indication 3506 may include two 3-bit TPMI fields to indicate one of eight states associated with the 4Tx Rank-2 TPMI indices 14 to 21.

In some examples, a same precoder restriction may apply for the two PG configurations. For example, the first precoding matrix and the second precoding matrix may be configured to be the same (e.g., W_{4Tx,r=2}=W_{4Tx,r=2}). In such examples, the uplink precoding matrix indication 2930 associated with the first table 3500 may include one TPMI field.

In another aspect related to the Rank-4 precoding matrix, the uplink precoding matrix indication 2930 may be configured to indicate any of the Type 1, Type 2, or Type 3 precoding matrix without restriction. In such examples, the uplink precoding matrix indication 2930 may include a 2-bit PG indication to indicate either Type 1, Type 2, or Type 3 based on a codepoint, as described in connection with the first table 3100 of FIG. 31.

In addition to the 2-bit PG indication, the uplink precoding matrix indication 2930 may include two TPMI fields to indicate the first 4Tx precoding matrix and the second 4Tx precoding matrix.

In the example of FIG. 35, a second table 3510 depicts indicating any of the Type 1, Type 2, or Type 3 precoding matrix without restriction. For example, for a Rank-4 NC precoding matrix indicating Type 1 or Type 2 (e.g., based on the PG indication codepoint), an uplink precoding matrix indication 3512 may include a 2-bit PG indication and one 1-bit TPMI field to indicate the one state associated with the 4Tx Rank-4 TPMI index 0. In such examples, the second TPMI field may be reserved. For a Rank-2 NC precoding matrix indicating Type 3 (e.g., based on the PG indication codepoint), an uplink precoding matrix indication 3514 may include a 2-bit PG indication and two 3-bit TPMI fields to indicate one of six states associated with the 4Tx Rank-2 TPMI indices 0 to 5.

For a Rank-4 PC-2 precoding matrix indicating Type 1 or Type 2 (e.g., based on the PG indication codepoint), an uplink precoding matrix indication 3516 may include a 2-bit PG indication and one 1-bit TPMI field to indicate one of two states associated with the 4Tx Rank-4 TPMI indices 1 to 2. In such examples, the second TPMI field may be reserved. For a Rank-4 PC-2 precoding matrix indicating Type 3 (e.g., based on the PG indication codepoint), an uplink precoding matrix indication 3518 may include a 2-bit PG indication and two 3-bit TPMI fields to indicate one of eight states associated with the 4Tx Rank-2 TPMI indices 6 to 13.

For a Rank-4 PC-4 precoding matrix indicating Type 1 or Type 2 (e.g., based on the PG indication codepoint), an uplink precoding matrix indication 3520 may include a 2-bit PG indication and one 1-bit TPMI field to indicate one of two states associated with the 4Tx Rank-4 TPMI indices 3 to 4. In such examples, the second TPMI field may be reserved. For a Rank-4 PC-4 precoding matrix indicating Type 3 (e.g., based on the PG indication codepoint), an uplink precoding matrix indication 3522 may include a 2-bit PG indication and two 3-bit TPMI fields to indicate one of eight states associated with the 4Tx Rank-2 TPMI indices 14 to 21.

In another aspect related to the Rank-4 precoding matrix, the uplink precoding matrix indication 2930 may be configured to indicate any of the Type 1, Type 2, or Type 3 precoding matrix with restriction. In such examples, the uplink precoding matrix indication 2930 may include a 2-bit PG indication to indicate either Type 1, Type 2, or Type 3, as described in connection with the PG indication of the first table 3100.

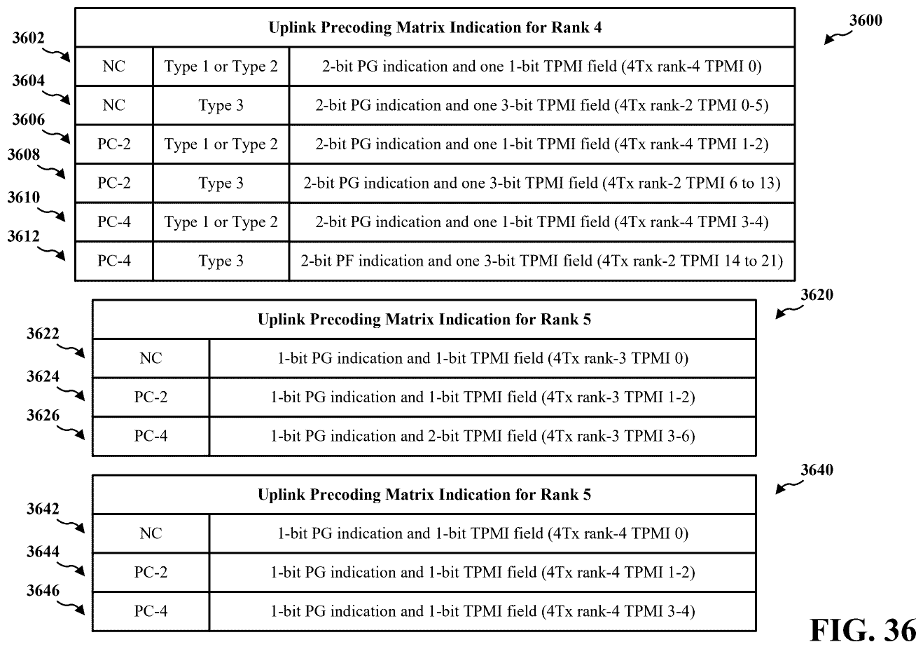

Additionally, the uplink precoding matrix indication 2930 may include a same precoder restriction so that the first precoding matrix and the second precoding matrix may be configured to be the same (e.g., W_{4Tx,r=2}=W_{4Tx,r=2}). In such examples, the uplink precoding matrix indication 2930 associated with a first table 3600 of FIG. 36 may include one TPMI field in the case of Type 1, Type 2, or Type 3.

In the example of FIG. 36, a first table 3600 depicts indicating any of the Type 1, Type 2, or Type 3 precoding matrix with restriction. For example, for a Rank-4 NC precoding matrix indicating Type 1 or Type 2 (e.g., based on the PG indication codepoint), an uplink precoding matrix indication 3602 may include a 2-bit PG indication and one 1-bit TPMI field to indicate the one state associated with the 4Tx Rank-4 TPMI index 0. For a Rank-4 NC precoding matrix indicating Type 3 (e.g., based on the PG indication codepoint), an uplink precoding matrix indication 3604 may include a 2-bit PG indication and one 3-bit TPMI field to indicate one of six states associated with the 4Tx Rank-2 TPMI indices 0 to 5.

For a Rank-4 PC-2 precoding matrix indicating Type 1 or Type 2 (e.g., based on the PG indication codepoint), an uplink precoding matrix indication 3606 may include a 2-bit PG indication and one 1-bit TPMI field to indicate one of two states associated with the 4Tx Rank-4 TPMI indices 1 to 2. For a Rank-4 PC-2 precoding matrix indicating Type 3 (e.g., based on the PG indication codepoint), an uplink precoding matrix indication 3608 may include a 2-bit PG indication and one 3-bit TPMI field to indicate one of eight states associated with the 4Tx Rank-2 TPMI indices 6 to 13.

For a Rank-4 PC-4 precoding matrix indicating Type 1 or Type 2 (e.g., based on the PG indication codepoint), an uplink precoding matrix indication 3610 may include a 2-bit PG indication and one 1-bit TPMI field to indicate one of two states associated with the 4Tx Rank-4 TPMI indices 3 to 4. For a Rank-4 PC-4 precoding matrix indicating Type 3 (e.g., based on the PG indication codepoint), an uplink precoding matrix indication 3612 may include a 2-bit PG indication and one 3-bit TPMI field to indicate one of eight states associated with the 4Tx Rank-2 TPMI indices 14 to 21.

For a Rank-5 8Tx codebook, the precoding matrix may be associated with a Type 1, a Type 2, a Type 3, or a Type 4, as shown in the table 2400. A second table 3620 of FIG. 36 illustrates a first aspect for illustrating the uplink precoding matrix indication 2930 for Rank 5. In the second table 3620, the uplink precoding matrix indication 2930 may be configured to only indicate a Type 1 precoding matrix or a Type 2 precoding matrix with restriction similar to the example restriction described in connection with the second table 3210 of FIG. 32. For example, the following restriction may be applied so that only one TPMI field is included in the uplink precoding matrix indication 2930:

$${W}_{4 Tx , r = 2} = {[ {W}_{4 Tx , r = 3} ]}_{2}$$

In the above restriction, the first 2 columns of the precoding matrix (W_{4Tx,r=3}) are used for the second precoding matrix. For a Rank-5 NC precoding matrix, an uplink precoding matrix indication 3622 may include a 1-bit PG indication to indicate whether the 8Tx precoding matrix is of Type 1 or Type 2. The uplink precoding matrix indication 3622 may also include a 1-bit TPMI field to indicate the one state associated with the 4Tx Rank-3 TPMI index 0.

For a Rank-5 PC-2 precoding matrix, an uplink precoding matrix indication 3624 may include a 1-bit PG indication to indicate whether the 8Tx precoding matrix is of Type 1 or Type 2. The uplink precoding matrix indication 3624 may also include a 1-bit TPMI field to indicate one of two states associated with the 4Tx Rank-3 TPMI indices 1 to 2.

For a Rank-5 PC-4 precoding matrix, an uplink precoding matrix indication 3626 may include a 1-bit PG indication to indicate whether the 8Tx precoding matrix is of Type 1 or Type 2. The uplink precoding matrix indication 3206 may also include a 2-bit TPMI field to indicate one of four states associated with the 4Tx Rank-3 TPMI indices 3 to 6.

In examples in which only Type 1 is allowed, the PG indication may be disabled or reserved.

In another aspect related to the Rank-5 8Tx codebook, the uplink precoding matrix indication 2930 may be configured to only indicate a Type 3 precoding matrix or a Type 4 precoding matrix with restriction similar to the example restriction described in connection with the second table 3210 of FIG. 32. For example, the following restriction may be applied so that only one TPMI field is included in the uplink precoding matrix indication 2930:

$${W}_{4 Tx , r = 1} = {[ {W}_{4 Tx , r = 4} ]}_{1}$$

In the above restriction, the first 1 column of the precoding matrix (W_{4Tx,r=4}) are used for the second precoding matrix, as shown in a third table 3640 of FIG. 36. For a Rank-5 NC precoding matrix, an uplink precoding matrix indication 3642 may include a 1-bit PG indication to indicate whether the 8Tx precoding matrix is of Type 3 or Type 4. The uplink precoding matrix indication 3642 may also include a 1-bit TPMI field to indicate the one state associated with the 4Tx Rank-4 TPMI index 0.

For a Rank-5 PC-2 precoding matrix, an uplink precoding matrix indication 3644 may include a 1-bit PG indication to indicate whether the 8Tx precoding matrix is of Type 3 or Type 4. The uplink precoding matrix indication 3644 may also include a 1-bit TPMI field to indicate one of two states associated with the 4Tx Rank-4 TPMI indices 1 to 2.

For a Rank-5 PC-4 precoding matrix, an uplink precoding matrix indication 3646 may include a 1-bit PG indication to indicate whether the 8Tx precoding matrix is of Type 3 or Type 4. The uplink precoding matrix indication 3646 may also include a 1-bit TPMI field to indicate one of two states associated with the 4Tx Rank-4 TPMI indices 3 to 4.

In examples in which only Type 3 is allowed, the PG indication may be disabled or reserved.

In another aspect related to the Rank-5 8Tx codebook, the uplink precoding matrix indication 2930 may be configured to only indicate a Type 1 precoding matrix or a Type 2 precoding matrix with restriction similar to the example restriction described in connection with the second table 3210 of FIG. 32. For example, the following restriction may be applied so that the second precoding matrix may be derived from the first precoding matrix included in the uplink precoding matrix indication 2930:

$${W}_{4 Tx , r = 2} = {[ {W}_{4 Tx , r = 3}^{′} ]}_{2}$$

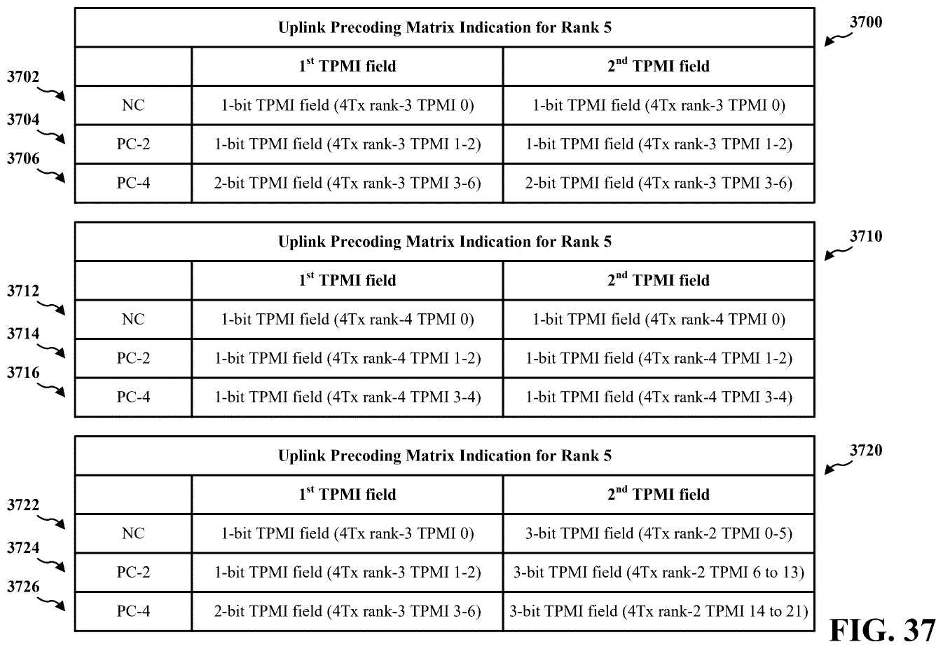

In the above restriction, the first 2 columns of the precoding matrix (W_{4Tx,r=3}) are used for the second precoding matrix. For example, the first TPMI field may indicate the precoding matrix “W_{4Tx,r=3}” and the second TPMI field may indicate the precoding matrix “W_{4Tx,r=3}” to use for a first table 3700 of FIG. 37.

For a Rank-5 NC precoding matrix, an uplink precoding matrix indication 3702 may include a 1-bit PG indication to indicate whether the 8Tx precoding matrix is of Type 1 or Type 2. The uplink precoding matrix indication 3622 may also include a first 1-bit TPMI field to indicate the one state associated with the 4Tx Rank-3 TPMI index 0, and a second 1-bit TPMI field to indicate the one state associated with the 4Tx Rank-3 TPMI index 0.

For a Rank-5 PC-2 precoding matrix, an uplink precoding matrix indication 3704 may include a 1-bit PG indication to indicate whether the 8Tx precoding matrix is of Type 1 or Type 2. The uplink precoding matrix indication 3704 may also include a first 1-bit TPMI field to indicate one of two states associated with the 4Tx Rank-3 TPMI indices 1 to 2, and a second 1-bit TPMI field to indicate one of two states associated with the 4Tx Rank-3 TPMI indices 1 to 2.

For a Rank-5 PC-4 precoding matrix, an uplink precoding matrix indication 3706 may include a 1-bit PG indication to indicate whether the 8Tx precoding matrix is of Type 1 or Type 2. The uplink precoding matrix indication 3706 may also include a first 2-bit TPMI field to indicate one of four states associated with the 4Tx Rank-3 TPMI indices 3 to 6, and a second 2-bit TPMI field to indicate one of four states associated with the 4Tx Rank-3 TPMI indices 3 to 6.

In examples in which only Type 1 is allowed, the PG indication may be disabled or reserved.

In another aspect related to the Rank-5 8Tx codebook, the uplink precoding matrix indication 2930 may be configured to only indicate a Type 3 precoding matrix or a Type 4 precoding matrix with restriction similar to the example restriction described in connection with the second table 3210 of FIG. 32. For example, the following restriction may be applied so that the second precoding matrix may be derived from the first precoding matrix included in the uplink precoding matrix indication 2930:

$${W}_{4 Tx , r = 1} = {[ {W}_{4 Tx , r = 4}^{′} ]}_{1}$$

In the above restriction, the first 1 column of the precoding matrix (W_{4Tx,r=4}) are used for the second precoding matrix. For example, the first TPMI field may indicate the precoding matrix “W_{4Tx,r=4}” and the second TPMI field may indicate the precoding matrix “W_{4Tx,r=4}” to use for a second table 3710 of FIG. 37.

For a Rank-5 NC precoding matrix, an uplink precoding matrix indication 3712 may include a 1-bit PG indication to indicate whether the 8Tx precoding matrix is of Type 3 or Type 4. The uplink precoding matrix indication 3712 may also include a first 1-bit TPMI field to indicate the one state associated with the 4Tx Rank-4 TPMI index 0, and a second 1-bit TPMI field to indicate the one state associated with the 4Tx Rank-4 TPMI index 0.

For a Rank-5 PC-2 precoding matrix, an uplink precoding matrix indication 3714 may include a 1-bit PG indication to indicate whether the 8Tx precoding matrix is of Type 3 or Type 4. The uplink precoding matrix indication 3714 may also include a first 1-bit TPMI field to indicate one of two states associated with the 4Tx Rank-4 TPMI indices 1 to 2, and a second 1-bit TPMI field to indicate one of two states associated with the 4Tx Rank-4 TPMI indices 1 to 2.

For a Rank-5 PC-4 precoding matrix, an uplink precoding matrix indication 3716 may include a 1-bit PG indication to indicate whether the 8Tx precoding matrix is of Type 3 or Type 4. The uplink precoding matrix indication 3716 may also include a first 1-bit TPMI field to indicate one of two states associated with the 4Tx Rank-4 TPMI indices 3 to 4, and a second 1-bit TPMI field to indicate one of two states associated with the 4Tx Rank-4 TPMI indices 3 to 4.

In examples in which only Type 3 is allowed, the PG indication may be disabled or reserved.

In another aspect related to the Rank-5 8Tx codebook, the uplink precoding matrix indication 2930 may be configured to only indicate a Type 1 precoding matrix or a Type 2 precoding matrix with different TPMIs indicated by a first TPMI field and a second TPMI field of the uplink precoding matrix indication 2930. For example, the first TPMI field may indicate the precoding matrix “W_{4Tx,r=3}” and the second TPMI field may indicate the precoding matrix “W_{4Tx,r=2}” to use for a third table 3720 of FIG. 37.

For a Rank-5 NC precoding matrix, an uplink precoding matrix indication 3722 may include a 1-bit PG indication to indicate whether the 8Tx precoding matrix is of Type 1 or Type 2. The uplink precoding matrix indication 3722 may also include a first 1-bit TPMI field to indicate the one state associated with the 4Tx Rank-3 TPMI index 0, and a second 3-bit TPMI field to indicate one of six states associated with the 4Tx Rank-2 TPMI indices 0 to 5.

For a Rank-5 PC-2 precoding matrix, an uplink precoding matrix indication 3724 may include a 1-bit PG indication to indicate whether the 8Tx precoding matrix is of Type 1 or Type 2. The uplink precoding matrix indication 3724 may also include a first 1-bit TPMI field to indicate one of two states associated with the 4Tx Rank-3 TPMI indices 1 to 2, and a second 3-bit TPMI field to indicate one of eight states associated with the 4Tx Rank-2 TPMI indices 6 to 13.

For a Rank-5 PC-4 precoding matrix, an uplink precoding matrix indication 3726 may include a 1-bit PG indication to indicate whether the 8Tx precoding matrix is of Type 1 or Type 2. The uplink precoding matrix indication 3726 may also include a first 2-bit TPMI field to indicate one of four states associated with the 4Tx Rank-3 TPMI indices 3 to 6, and a second 3-bit TPMI field to indicate one of eight states associated with the 4Tx Rank-3 TPMI indices 14 to 21.

In examples in which only Type 1 is allowed, the PG indication may be disabled or reserved.

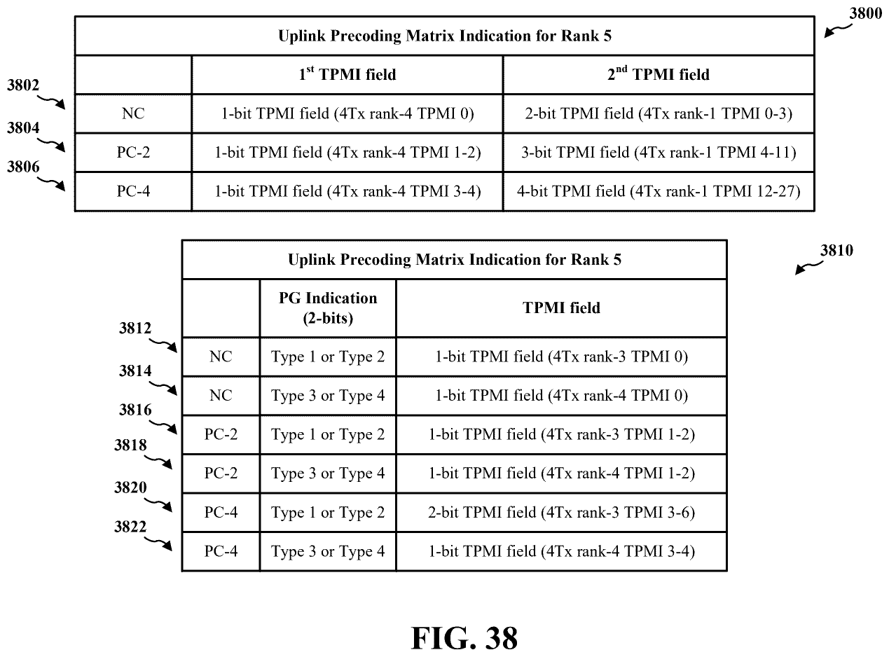

In another aspect related to the Rank-5 8Tx codebook, the uplink precoding matrix indication 2930 may be configured to only indicate a Type 3 precoding matrix or a Type 4 precoding matrix with different TPMIs indicated by a first TPMI field and a second TPMI field of the uplink precoding matrix indication 2930. For example, the first TPMI field may indicate the precoding matrix “W_{4Tx,r=1}=4” and the second TPMI field may indicate the precoding matrix “W_{4Tx,r=1}” to use for a first table 3800 of FIG. 38.

For a Rank-5 NC precoding matrix, an uplink precoding matrix indication 3802 may include a 1-bit PG indication to indicate whether the 8Tx precoding matrix is of Type 3 or Type 4. The uplink precoding matrix indication 3802 may also include a first 1-bit TPMI field to indicate the one state associated with the 4Tx Rank-4 TPMI index 0, and a second 2-bit TPMI field to indicate one of four states associated with the 4Tx Rank-1 TPMI indices 0 to 3.

For a Rank-5 PC-2 precoding matrix, an uplink precoding matrix indication 3804 may include a 1-bit PG indication to indicate whether the 8Tx precoding matrix is of Type 3 or Type 4. The uplink precoding matrix indication 3804 may also include a first 1-bit TPMI field to indicate one of two states associated with the 4Tx Rank-4 TPMI indices 1 to 2, and a second 3-bit TPMI field to indicate one of eight states associated with the 4Tx Rank-2 TPMI indices 4 to 11.

For a Rank-5 PC-4 precoding matrix, an uplink precoding matrix indication 3806 may include a 1-bit PG indication to indicate whether the 8Tx precoding matrix is of Type 3 or Type 4. The uplink precoding matrix indication 3806 may also include a first 1-bit TPMI field to indicate one of two states associated with the 4Tx Rank-4 TPMI indices 3 to 4, and a second 4-bit TPMI field to indicate one of 16 states associated with the 4Tx Rank-1 TPMI indices 12 to 27.

In examples in which only Type 3 is allowed, the PG indication may be disabled or reserved.

In another aspect related to the Rank-5 precoding matrix, the uplink precoding matrix indication 2930 may be configured to indicate any of the Types 1 to 4 precoding matrices with restriction. In such examples, the uplink precoding matrix indication 2930 may include a 2-bit PG indication to indicate the precoding matrix type via the codepoint.

Additionally, the uplink precoding matrix indication 2930 may include a single TPMI field with the same restrictions described in connection with the first table 3700 and the second table 3710 of FIG. 37.

In the example of FIG. 38, a second table 3810 depicts indicating any of precoding matrix Types 1 to 4 with restriction. For example, for a Rank-5 NC precoding matrix indicating Type 1 or Type 2 (e.g., based on the PG indication codepoint), an uplink precoding matrix indication 3812 may include a 2-bit PG indication and one 1-bit TPMI field to indicate the one state associated with the 4Tx Rank-3 TPMI index 0. For a Rank-5 NC precoding matrix indicating Type 3 or Type 4 (e.g., based on the PG indication codepoint), an uplink precoding matrix indication 3814 may include a 2-bit PG indication and one 1-bit TPMI field to indicate the one state associated with the 4Tx Rank-4 TPMI index 0.

For a Rank-5 PC-2 precoding matrix indicating Type 1 or Type 2 (e.g., based on the PG indication codepoint), an uplink precoding matrix indication 3816 may include a 2-bit PG indication and one 1-bit TPMI field to indicate one of two states associated with the 4Tx Rank-3 TPMI indices 1 to 2. For a Rank-5 PC-2 precoding matrix indicating Type 3 or Type 4 (e.g., based on the PG indication codepoint), an uplink precoding matrix indication 3818 may include a 2-bit PG indication and one 1-bit TPMI field to indicate one of two states associated with the 4Tx Rank-4 TPMI indices 1 to 2.

For a Rank-5 PC-4 precoding matrix indicating Type 1 or Type 2 (e.g., based on the PG indication codepoint), an uplink precoding matrix indication 3820 may include a 2-bit PG indication and one 2-bit TPMI field to indicate one of four states associated with the 4Tx Rank-3 TPMI indices 3 to 6. For a Rank-5 PC-4 precoding matrix indicating Type 3 or Type 4 (e.g., based on the PG indication codepoint), an uplink precoding matrix indication 3822 may include a 2-bit PG indication and one 1-bit TPMI field to indicate one of two states associated with the 4Tx Rank-4 TPMI indices 3 to 4.

In another aspect related to indicating the Rank-5 matrix, the uplink precoding matrix indication 2930 may be configured to indicate any of Types 1 to 4 precoding matrices with restriction. For example, the uplink precoding matrix indication 2930 may include a 2-bit PG indication to indicate either Type 1, Type 2, Type 3, or Type 4 based on the PG indication codepoint.

In addition to the 2-bit PG indication, the uplink precoding matrix indication 2930 may include two TPMI fields to indicate the first 4Tx precoding matrix and the second 4Tx precoding matrix. In examples in which the uplink precoding matrix indication 2930 is indicating a Type 1 or Type 2 precoding matrix, the following restriction may apply:

$${W}_{4 Tx , r = 2} = {[ {W}_{4 Tx , r = 3}^{′} ]}_{2}$$

In examples in which the uplink precoding matrix indication 2930 is indicating a Type 3 or Type 4 precoding matrix, the following restriction may apply:

$${W}_{4 Tx , r = 1} = {[ {W}_{4 Tx , r = 4}^{′} ]}_{1} .$$

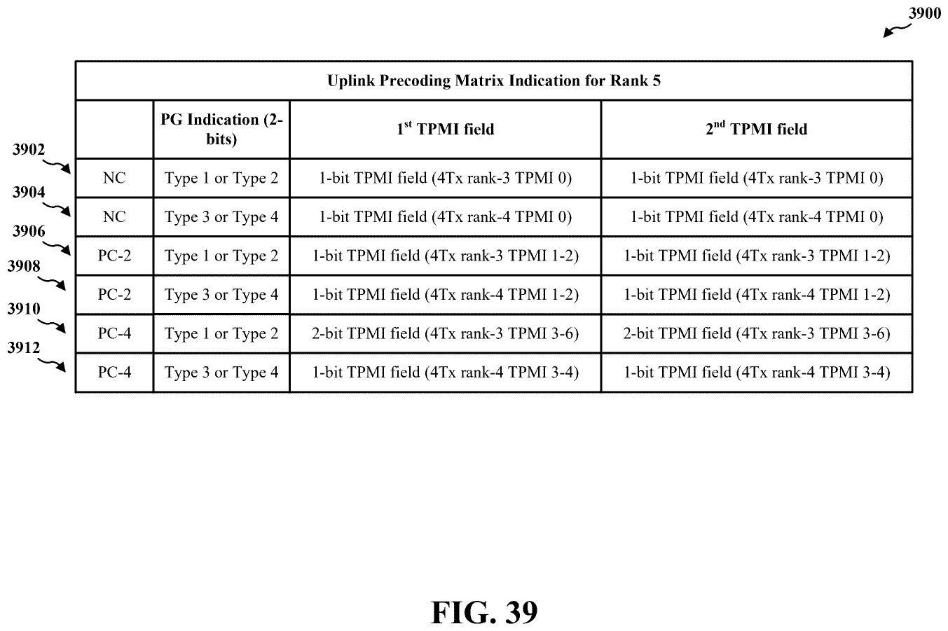

In the example of FIG. 39, a table 3900 depicts indicating any of the Type 1, Type 2, Type 3, or Type 4 precoding matrix with restriction. For example, for a Rank-5 NC precoding matrix indicating Type 1 or Type 2 (e.g., based on the PG indication codepoint), an uplink precoding matrix indication 3902 may include the 2-bit PG indication, a first 1-bit TPMI field to indicate the one state associated with the 4Tx Rank-3 TPMI index 0, and a second 1-bit TPMI field to indicate the one state associated with the 4Tx Rank-3 TPMI index 0. For a Rank-5 NC precoding matrix indicating Type 3 or Type 4 (e.g., based on the PG indication codepoint), an uplink precoding matrix indication 3904 may include a 2-bit PG indication, a first 1-bit TPMI field to indicate the one state associated with the 4Tx Rank-4 TPMI index 0, and a second 1-bit TPMI field to indicate the one state associated with the 4Tx Rank-4 TPMI index 0.

For a Rank-5 PC-2 precoding matrix indicating Type 1 or Type 2, an uplink precoding matrix indication 3906 may include a 2-bit PG indication, a first 1-bit TPMI field to indicate one of two states associated with the 4Tx Rank-3 TPMI indices 1 to 2, and a second 1-bit TPMI field to indicate one of two states associated with the 4Tx Rank-3 TPMI indices 1 to 2. For a Rank-5 PC-2 precoding matrix indicating Type 3 or Type 4, an uplink precoding matrix indication 3908 may include a 2-bit PG indication, a first 1-bit TPMI field to indicate one of two states associated with the 4Tx Rank-4 TPMI indices 1 to 2, and a second 1-bit TPMI field to indicate one of two states associated with the 4Tx Rank-4 TPMI indices 1 to 2.

For a Rank-5 PC-4 precoding matrix indicating Type 1 or Type 2, an uplink precoding matrix indication 3910 may include a 2-bit PG indication, a first 2-bit TPMI field to indicate one of four states associated with the 4Tx Rank-3 TPMI indices 3 to 6, and a second 2-bit TPMI field to indicate one of four states associated with the 4Tx Rank-3 TPMI indices 3 to 6. For a Rank-5 PC-4 precoding matrix indicating Type 3 or Type 4, an uplink precoding matrix indication 3912 may include a 2-bit PG indication, a first 1-bit TPMI field to indicate one of two states associated with the 4Tx Rank-4 TPMI indices 3 to 4, and a second 1-bit TPMI field to indicate one of two states associated with the 4Tx Rank-4 TPMI indices 3 to 4.

In another aspect related to indicating the Rank-5 matrix, the uplink precoding matrix indication 2930 may be configured to indicate any of Types 1 to 4 precoding matrices without restriction. For example, the uplink precoding matrix indication 2930 may include a 2-bit PG indication to indicate either Type 1, Type 2, Type 3, or Type 4 based on the PG indication codepoint.

In addition to the 2-bit PG indication, the uplink precoding matrix indication 2930 may include two TPMI fields to indicate the first 4Tx precoding matrix and the second 4Tx precoding matrix.

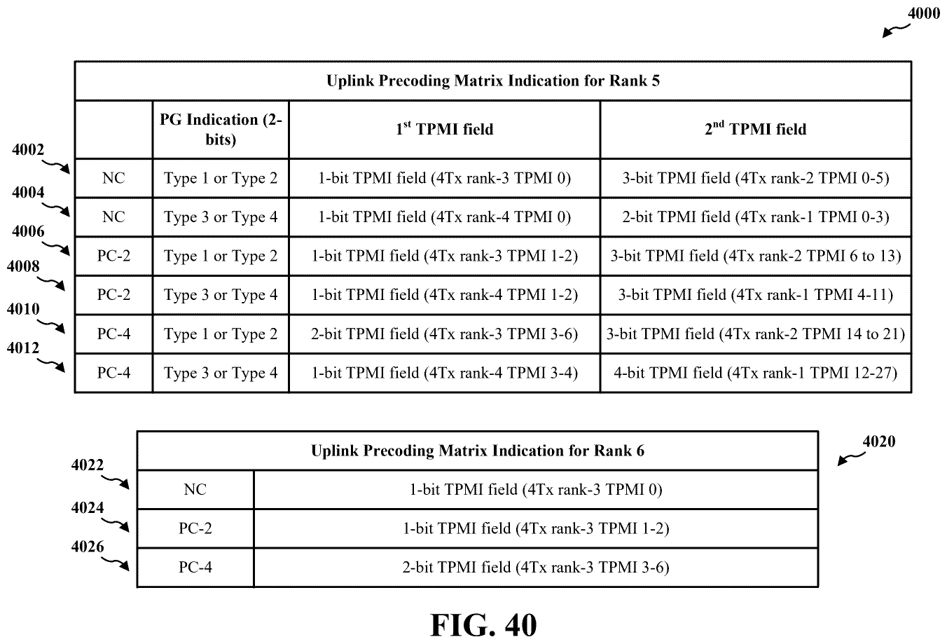

In the example of FIG. 40, a first table 4000 depicts indicating any of the Type 1, Type 2, Type 3, or Type 4 precoding matrix without restriction. For example, for a Rank-5 NC precoding matrix indicating Type 1 or Type 2 (e.g., based on the PG indication codepoint), an uplink precoding matrix indication 4002 may include the 2-bit PG indication, a first 1-bit TPMI field to indicate the one state associated with the 4Tx Rank-3 TPMI index 0, and a second 3-bit TPMI field to indicate one of six states associated with the 4Tx Rank-2 TPMI indices 0 to 5. For a Rank-5 NC precoding matrix indicating Type 3 or Type 4 (e.g., based on the PG indication codepoint), an uplink precoding matrix indication 4004 may include a 2-bit PG indication, a first 1-bit TPMI field to indicate the one state associated with the 4Tx Rank-4 TPMI index 0, and a second 2-bit TPMI field to indicate one or four states associated with the 4Tx Rank-1 TPMI indices 0 to 3.

For a Rank-5 PC-2 precoding matrix indicating Type 1 or Type 2, an uplink precoding matrix indication 4006 may include a 2-bit PG indication, a first 1-bit TPMI field to indicate one of two states associated with the 4Tx Rank-3 TPMI indices 1 to 2, and a second 3-bit TPMI field to indicate one of eight states associated with the 4Tx Rank-2 TPMI indices 6 to 13. For a Rank-5 PC-2 precoding matrix indicating Type 3 or Type 4, an uplink precoding matrix indication 4008 may include a 2-bit PG indication, a first 1-bit TPMI field to indicate one of two states associated with the 4Tx Rank-4 TPMI indices 1 to 2, and a second 3-bit TPMI field to indicate one of eight states associated with the 4Tx Rank-1 TPMI indices 4 to 11.

For a Rank-5 PC-4 precoding matrix indicating Type 1 or Type 2, an uplink precoding matrix indication 4010 may include a 2-bit PG indication, a first 2-bit TPMI field to indicate one of four states associated with the 4Tx Rank-3 TPMI indices 3 to 6, and a second 3-bit TPMI field to indicate one of eight states associated with the 4Tx Rank-2 TPMI indices 14 to 21. For a Rank-5 PC-4 precoding matrix indicating Type 3 or Type 4, an uplink precoding matrix indication 4012 may include a 2-bit PG indication, a first 1-bit TPMI field to indicate one of two states associated with the 4Tx Rank-4 TPMI indices 3 to 4, and a second 4-bit TPMI field to indicate one of 16 states associated with the 4Tx Rank-1 TPMI indices 12 to 27.

For a Rank-6 8Tx codebook, the precoding matrix may be associated with a Type 1, a Type 2, or a Type 3, as shown in the table 2400. A second table 4020 of FIG. 40 illustrates a first aspect for illustrating the uplink precoding matrix indication 2930 for Rank 6. In the second table 4020, the uplink precoding matrix indication 2930 may be configured to only indicate a Type 1 precoding matrix. In such examples, the uplink precoding matrix indication 2930 may skip including a PG indication (e.g., the PG indication may be reserved or disabled). The uplink precoding matrix indication 2930 may also include one TPMI field. Additionally, the uplink precoding matrix indication 2930 may include a same precoder restriction so that the first precoding matrix and the second precoding matrix may be configured to be the same (e.g., W_{4Tx,r=3}=W_{4Tx,r=3}). In such examples, the uplink precoding matrix indication 2930 associated with the second table 4020 of FIG. 40 may include one TPMI field.

As shown in the second table 4020 of FIG. 40, for a Rank-6 NC precoding matrix, an uplink precoding matrix indication 4022 may include a 1-bit TPMI field to indicate the one state associated with the 4Tx Rank-3 TPMI index 0.

For a Rank-6 PC-2 precoding matrix, an uplink precoding matrix indication 4024 may include one 1-bit TPMI field to indicate one of two states associated with the 4Tx Rank-3 TPMI indices 1 to 2.

For a Rank-6 PC-4 precoding matrix, an uplink precoding matrix indication 4026 may include one 2-bit TPMI field to indicate one of four states associated with the 4Tx Rank-3 TPMI indices 3 to 6.

In another aspect related to the Rank-6 8Tx codebook, the uplink precoding matrix indication 2930 may be configured to only indicate a Type 2 precoding matrix or a Type 3 precoding matrix with a single TPMI field included in the uplink precoding matrix indication 2930. The uplink precoding matrix indication 2930 may include a 1-bit PG indicator to indicate whether the 8Tx precoding matrix is of Type 2 or Type 3. In examples in which only Type 2 is allowed, the PG indication may be disabled or reserved.

Additionally, the TPMI field of the uplink precoding matrix indication 2930 may include the following restriction so that a single TPMI field may be included in the uplink precoding matrix indication 2930:

$${W}_{4 Tx , r = 2} = {[ {W}_{4 Tx , r = 4} ]}_{2}$$

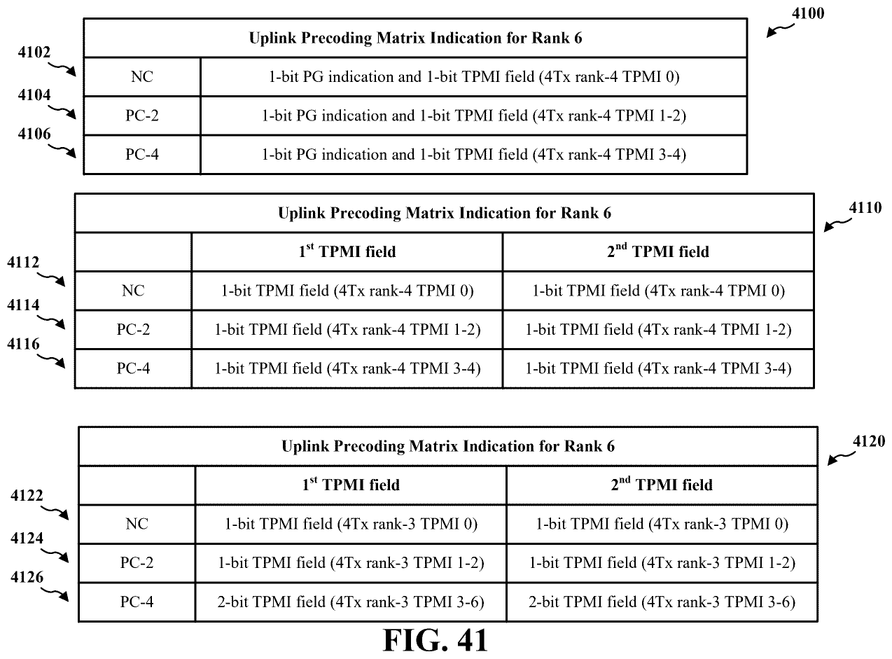

In the above restriction, the first 2 columns of the precoding matrix (W_{4Tx,r=4}) are used for the second precoding matrix, as shown in a first table 4100 of FIG. 41. For a Rank-6 NC precoding matrix, an uplink precoding matrix indication 4102 may include a 1-bit PG indication to indicate whether the 8Tx precoding matrix is of Type 2 or Type 3. The uplink precoding matrix indication 4102 may also include a 1-bit TPMI field to indicate the one state associated with the 4Tx Rank-4 TPMI index 0.

For a Rank-6 PC-2 precoding matrix, an uplink precoding matrix indication 4104 may include a 1-bit PG indication to indicate whether the 8Tx precoding matrix is of Type 2 or Type 3. The uplink precoding matrix indication 4104 may also include a 1-bit TPMI field to indicate one of two states associated with the 4Tx Rank-4 TPMI indices 1 to 2.

For a Rank-6 PC-4 precoding matrix, an uplink precoding matrix indication 4106 may include a 1-bit PG indication to indicate whether the 8Tx precoding matrix is of Type 2 or Type 3. The uplink precoding matrix indication 4106 may also include a 1-bit TPMI field to indicate one of two states associated with the 4Tx Rank-4 TPMI indices 3 to 4.

In another aspect related to the Rank-6 8Tx codebook, the uplink precoding matrix indication 2930 may be configured to only indicate a Type 2 precoding matrix or a Type 3 precoding matrix with restriction similar to the example restriction described in connection with the second table 3210 of FIG. 32. For example, the following restriction may be applied so that the second precoding matrix may be derived from the first precoding matrix included in the uplink precoding matrix indication 2930:

$${W}_{4 Tx , r = 2} = {[ {W}_{4 Tx , r = 4}^{′} ]}_{2}$$

In the above restriction, the first 2 columns of the precoding matrix (W_{4Tx,r=4}) are used for the second precoding matrix. For example, the first TPMI field may indicate the precoding matrix “W_{4Tx,r=4}” and the second TPMI field may indicate the precoding matrix “W_{4Tx,r=4}” to use for a second table 4110 of FIG. 41.

For a Rank-6 NC precoding matrix, an uplink precoding matrix indication 4112 may include a 1-bit PG indication to indicate whether the 8Tx precoding matrix is of Type 2 or Type 3. The uplink precoding matrix indication 4112 may also include a first 1-bit TPMI field to indicate the one state associated with the 4Tx Rank-4 TPMI index 0, and a second 1-bit TPMI field to indicate the one state associated with the 4Tx Rank-4 TPMI index 0.

For a Rank-6 PC-2 precoding matrix, an uplink precoding matrix indication 4114 may include a 1-bit PG indication to indicate whether the 8Tx precoding matrix is of Type 2 or Type 3. The uplink precoding matrix indication 4114 may also include a first 1-bit TPMI field to indicate one of two states associated with the 4Tx Rank-4 TPMI indices 1 to 2, and a second 1-bit TPMI field to indicate one of two states associated with the 4Tx Rank-4 TPMI indices 1 to 2.

For a Rank-6 PC-4 precoding matrix, an uplink precoding matrix indication 4116 may include a 1-bit PG indication to indicate whether the 8Tx precoding matrix is of Type 2 or Type 3. The uplink precoding matrix indication 4116 may also include a first 1-bit TPMI field to indicate one of two states associated with the 4Tx Rank-4 TPMI indices 3 to 4, and a second 1-bit TPMI field to indicate one of two states associated with the 4Tx Rank-4 TPMI indices 3 to 4.

In examples in which only Type 2 is allowed, the PG indication may be disabled or reserved.

In another aspect related to the Rank-6 8Tx codebook, the uplink precoding matrix indication 2930 may be configured to only indicate a Type 1 precoding matrix with a restriction similar to the precoder restriction described in connection with the second table 3120 of FIG. 31. For example, two TPMI fields may be included in the uplink precoding matrix indication 2930, in which the first TPMI field may correspond to the precoding matrix (“W_{4Tx,r=3}”) and the second TPMI field may correspond to the precoding matrix (“W_{4Tx,r=3}”).

In a third table 4120 of FIG. 41, the uplink precoding matrix indication 2930 may skip the PG indication (e.g., the PG indication field may be reserved or disabled). For a Rank-6 NC precoding matrix, an uplink precoding matrix indication 4122 may include a first 1-bit TPMI field to indicate the one state associated with the 4Tx Rank-3 TPMI index 0, and a second 1-bit TPMI field to indicate the one state associated with the 4Tx Rank-3 TPMI index 0.

For a Rank-6 PC-2 precoding matrix, an uplink precoding matrix indication 4124 may include a first 1-bit TPMI field to indicate one of two states associated with the 4Tx Rank-3 TPMI indices 1 to 2, and a second 1-bit TPMI field to indicate one of two states associated with the 4Tx Rank-3 TPMI indices 1 to 2.

For a Rank-6 PC-4 precoding matrix, an uplink precoding matrix indication 4126 may include a first 2-bit TPMI field to indicate one of four states associated with the 4Tx Rank-3 TPMI indices 3 to 6, and a second 2-bit TPMI field to indicate one of four states associated with the 4Tx Rank-3 TPMI indices 3 to 6.

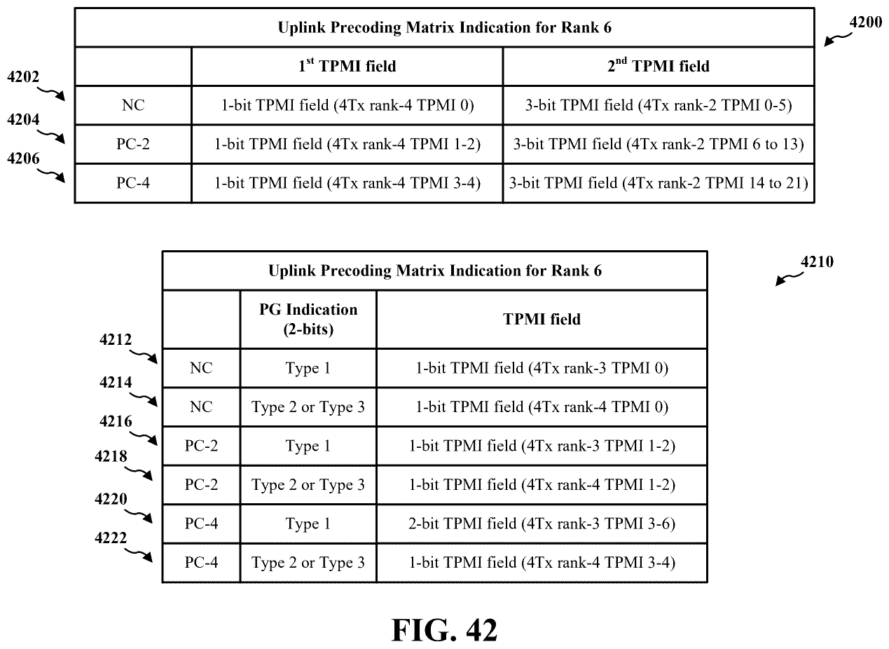

In another aspect related to the Rank-6 8Tx codebook, the uplink precoding matrix indication 2930 may be configured to only indicate a Type 2 precoding matrix or a Type 3 precoding matrix with different TPMIs indicated by a first TPMI field and a second TPMI field of the uplink precoding matrix indication 2930. For example, the first TPMI field may indicate the precoding matrix “W_{4Tx},1=₄” and the second TPMI field may indicate the precoding matrix “W_{4Tx,r=2}” to use for a first table 4200 of FIG. 42.

For a Rank-6 NC precoding matrix, an uplink precoding matrix indication 4202 may include a 1-bit PG indication to indicate whether the 8Tx precoding matrix is of Type 2 or Type 3. The uplink precoding matrix indication 4202 may also include a first 1-bit TPMI field to indicate the one state associated with the 4Tx Rank-4 TPMI index 0, and a second 3-bit TPMI field to indicate one of six states associated with the 4Tx Rank-2 TPMI indices 0 to 5.

For a Rank-6 PC-2 precoding matrix, an uplink precoding matrix indication 4204 may include a 1-bit PG indication to indicate whether the 8Tx precoding matrix is of Type 2 or Type 3. The uplink precoding matrix indication 4204 may also include a first 1-bit TPMI field to indicate one of two states associated with the 4Tx Rank-4 TPMI indices 1 to 2, and a second 3-bit TPMI field to indicate one of eight states associated with the 4Tx Rank-2 TPMI indices 6 to 13.

For a Rank-6 PC-4 precoding matrix, an uplink precoding matrix indication 4206 may include a 1-bit PG indication to indicate whether the 8Tx precoding matrix is of Type 2 or Type 3. The uplink precoding matrix indication 4206 may also include a first 1-bit TPMI field to indicate one of two states associated with the 4Tx Rank-4 TPMI indices 3 to 4, and a second 3-bit TPMI field to indicate one of eight states associated with the 4Tx Rank-3 TPMI indices 14 to 21.

In examples in which only Type 2 is allowed, the PG indication may be disabled or reserved.

In another aspect related to the Rank-6 precoding matrix, the uplink precoding matrix indication 2930 may be configured to indicate any of the Types 1 to 3 precoding matrices with restriction. In such examples, the uplink precoding matrix indication 2930 may include a 2-bit PG indication to indicate the precoding matrix type via the codepoint.

Additionally, the uplink precoding matrix indication 2930 may include a single TPMI field with a first restriction (e.g., W_{4Tx,r=3}=W_{4Tx,r=3}) and a second restriction (e.g., W_{4Tx,r=2}=[W_{4Tx,r=4}]₂).

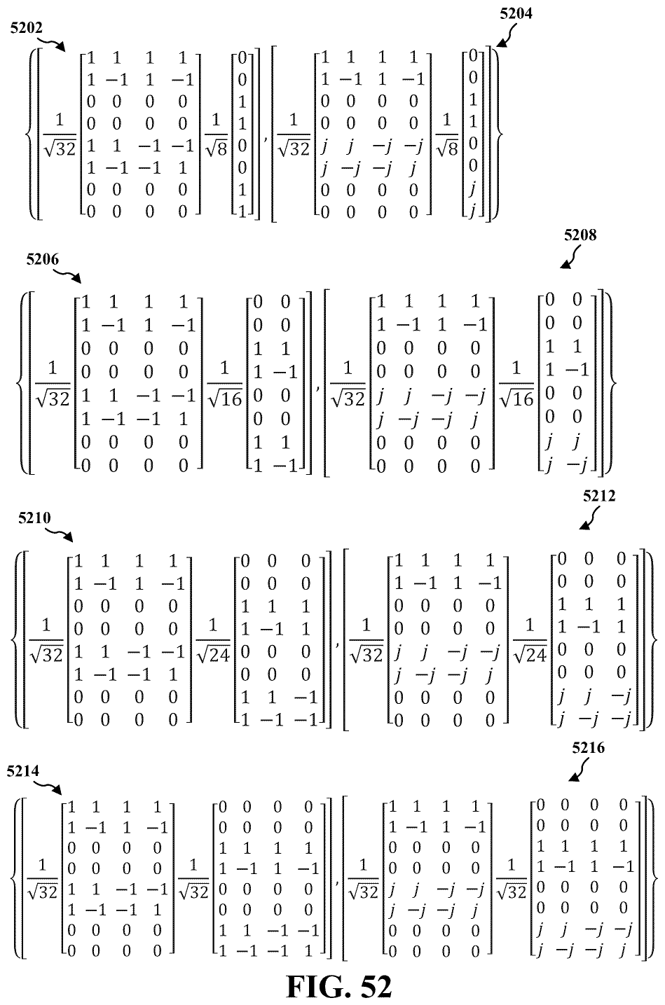

In the example of FIG. 52, a second table 4210 depicts indicating any of precoding matrix Types 1 to 3 with restriction. For example, for a Rank-6 NC precoding matrix indicating Type 1 (e.g., based on the PG indication codepoint), an uplink precoding matrix indication 4212 may include a 2-bit PG indication and one 1-bit TPMI field to indicate the one state associated with the 4Tx Rank-3 TPMI index 0. For a Rank-6 NC precoding matrix indicating Type 2 or Type 3 (e.g., based on the PG indication codepoint), an uplink precoding matrix indication 4214 may include a 2-bit PG indication and one 1-bit TPMI field to indicate the one state associated with the 4Tx Rank-4 TPMI index 0.

For a Rank-6 PC-2 precoding matrix indicating Type 1, an uplink precoding matrix indication 4216 may include a 2-bit PG indication and one 1-bit TPMI field to indicate one of two states associated with the 4Tx Rank-3 TPMI indices 1 to 2. For a Rank-6 PC-2 precoding matrix indicating Type 2 or Type 3, an uplink precoding matrix indication 4218 may include a 2-bit PG indication and one 1-bit TPMI field to indicate one of two states associated with the 4Tx Rank-4 TPMI indices 1 to 2.

For a Rank-6 PC-4 precoding matrix indicating Type 1, an uplink precoding matrix indication 4220 may include a 2-bit PG indication and one 2-bit TPMI field to indicate one of four states associated with the 4Tx Rank-3 TPMI indices 3 to 6. For a Rank-6 PC-4 precoding matrix indicating Type 2 or Type 3, an uplink precoding matrix indication 4222 may include a 2-bit PG indication and one 1-bit TPMI field to indicate one of two states associated with the 4Tx Rank-4 TPMI indices 3 to 4.

In another aspect related to indicating the Rank-6 precoding matrix, the uplink precoding matrix indication 2930 may be configured to indicate any of Types 1 to 3 precoding matrices with restriction. For example, the uplink precoding matrix indication 2930 may include a 2-bit PG indication to indicate either Type 1, Type 2, or Type 3 based on the PG indication codepoint.

In addition to the 2-bit PG indication, the uplink precoding matrix indication 2930 may include two TPMI fields to indicate the first 4Tx precoding matrix and the second 4Tx precoding matrix. In examples in which the uplink precoding matrix indication 2930 is indicating a Type 1 precoding matrix, a first restriction (e.g., W_{4Tx,r=3}=W_{4Tx,r=3}) may apply. In examples in which the uplink precoding matrix indication 2930 is indicating a Type 2 or Type 3 precoding matrix, a second restriction (e.g., W_{4Tx,r=2}=[W_{4Tx,r=4}]₂) may apply.

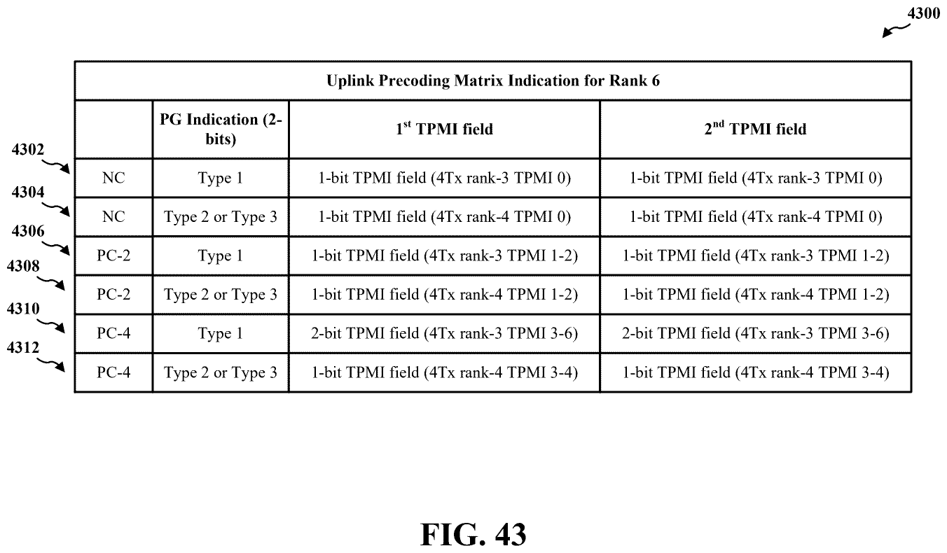

In an example of FIG. 43, a table 4300 depicts indicating any of the Type 1, Type 2, or Type 3 precoding matrix with restriction. For example, for a Rank-6 NC precoding matrix indicating Type 1 (e.g., based on the PG indication codepoint), an uplink precoding matrix indication 4302 may include the 2-bit PG indication, a first 1-bit TPMI field to indicate the one state associated with the 4Tx Rank-3 TPMI index 0, and a second 1-bit TPMI field to indicate the one state associated with the 4Tx Rank-3 TPMI index 0. For a Rank-6 NC precoding matrix indicating Type 2 or Type 3 (e.g., based on the PG indication codepoint), an uplink precoding matrix indication 4304 may include a 2-bit PG indication, a first 1-bit TPMI field to indicate the one state associated with the 4Tx Rank-4 TPMI index 0, and a second 1-bit TPMI field to indicate the one state associated with the 4Tx Rank-4 TPMI index 0.

For a Rank-6 PC-2 precoding matrix indicating Type 1, an uplink precoding matrix indication 4306 may include a 2-bit PG indication, a first 1-bit TPMI field to indicate one of two states associated with the 4Tx Rank-3 TPMI indices 1 to 2, and a second 1-bit TPMI field to indicate one of two states associated with the 4Tx Rank-3 TPMI indices 1 to 2. For a Rank-6 PC-2 precoding matrix indicating Type 2 or Type 3, an uplink precoding matrix indication 4308 may include a 2-bit PG indication, a first 1-bit TPMI field to indicate one of two states associated with the 4Tx Rank-4 TPMI indices 1 to 2, and a second 1-bit TPMI field to indicate one of two states associated with the 4Tx Rank-4 TPMI indices 1 to 2.

For a Rank-6 PC-4 precoding matrix indicating Type 1, an uplink precoding matrix indication 4310 may include a 2-bit PG indication, a first 2-bit TPMI field to indicate one of four states associated with the 4Tx Rank-3 TPMI indices 3 to 6, and a second 2-bit TPMI field to indicate one of four states associated with the 4Tx Rank-3 TPMI indices 3 to 6. For a Rank-6 PC-4 precoding matrix indicating Type 2 or Type 3, an uplink precoding matrix indication 4312 may include a 2-bit PG indication, a first 1-bit TPMI field to indicate one of two states associated with the 4Tx Rank-4 TPMI indices 3 to 4, and a second 1-bit TPMI field to indicate one of two states associated with the 4Tx Rank-4 TPMI indices 3 to 4.

In another aspect related to indicating the Rank-6 matrix, the uplink precoding matrix indication 2930 may be configured to indicate any of Types 1 to 3 precoding matrices without restriction. For example, the uplink precoding matrix indication 2930 may include a 2-bit PG indication to indicate either Type 1, Type 2, or Type 3 based on the PG indication codepoint.

In addition to the 2-bit PG indication, the uplink precoding matrix indication 2930 may include two TPMI fields to indicate the first 4Tx precoding matrix and the second 4Tx precoding matrix.

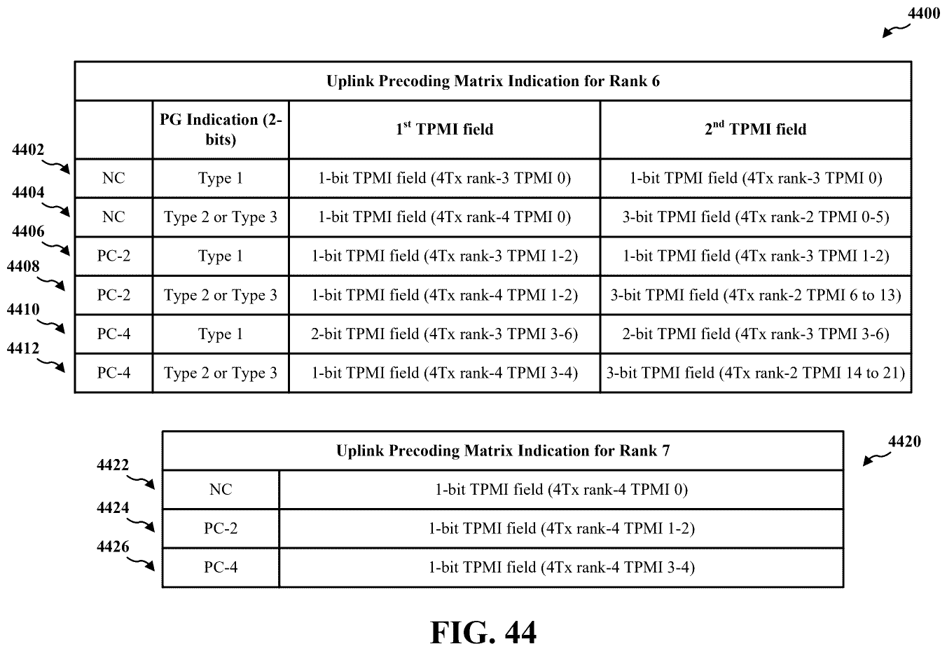

In the example of FIG. 44, a first table 4400 depicts indicating any of the Type 1, Type 2, or Type 3 precoding matrix without restriction. For example, for a Rank-6 NC precoding matrix indicating Type 1 (e.g., based on the PG indication codepoint), an uplink precoding matrix indication 4402 may include the 2-bit PG indication, a first 1-bit TPMI field to indicate the one state associated with the 4Tx Rank-3 TPMI index 0, and a second 1-bit TPMI field to indicate the one state associated with the 4Tx Rank-3 TPMI index 0. For a Rank-6 NC precoding matrix indicating Type 2 or Type 3 (e.g., based on the PG indication codepoint), an uplink precoding matrix indication 4404 may include a 2-bit PG indication, a first 1-bit TPMI field to indicate the one state associated with the 4Tx Rank-4 TPMI index 0, and a second 3-bit TPMI field to indicate one or six states associated with the 4Tx Rank-2 TPMI indices 0 to 5.

For a Rank-6 PC-2 precoding matrix indicating Type 1, an uplink precoding matrix indication 4406 may include a 2-bit PG indication, a first 1-bit TPMI field to indicate one of two states associated with the 4Tx Rank-3 TPMI indices 1 to 2, and a second 1-bit TPMI field to indicate one of two states associated with the 4Tx Rank-3 TPMI indices 1 to 2. For a Rank-6 PC-2 precoding matrix indicating Type 2 or Type 3, an uplink precoding matrix indication 4408 may include a 2-bit PG indication, a first 1-bit TPMI field to indicate one of two states associated with the 4Tx Rank-4 TPMI indices 1 to 2, and a second 3-bit TPMI field to indicate one of eight states associated with the 4Tx Rank-2 TPMI indices 6 to 13.

For a Rank-6 PC-4 precoding matrix indicating Type 1, an uplink precoding matrix indication 4410 may include a 2-bit PG indication, a first 2-bit TPMI field to indicate one of four states associated with the 4Tx Rank-3 TPMI indices 3 to 6, and a second 2-bit TPMI field to indicate one of four states associated with the 4Tx Rank-3 TPMI indices 3 to 6. For a Rank-6 PC-4 precoding matrix indicating Type 2 or Type 3, an uplink precoding matrix indication 4412 may include a 2-bit PG indication, a first 1-bit TPMI field to indicate one of two states associated with the 4Tx Rank-4 TPMI indices 3 to 4, and a second 3-bit TPMI field to indicate one of eight states associated with the 4Tx Rank-2 TPMI indices 14 to 21.

For a Rank-7 8Tx codebook, the precoding matrix may be associated with a Type 1 or a Type 2, as shown in the table 2400. A second table 4420 of FIG. 44 illustrates a first aspect for illustrating the uplink precoding matrix indication 2930 for Rank 7. In the second table 4420, the uplink precoding matrix indication 2930 may be configured to only indicate a Type 1 precoding matrix. In such examples, the uplink precoding matrix indication 2930 may skip including a PG indication (e.g., the PG indication may be reserved or disabled). The uplink precoding matrix indication 2930 may also include one TPMI field. Additionally, the uplink precoding matrix indication 2930 may include the following restriction with respect to the TPMI field:

$${W}_{4 Tx , r = 3} = {[ {W}_{4 Tx , r = 4} ]}_{3}$$

In the above restriction, the first 3 columns of the precoding matrix (W_{4Tx,r=4}) are used for the second precoding matrix, as shown in the second table 4420 of FIG. 44. For a Rank-7 NC precoding matrix, an uplink precoding matrix indication 4422 may include a 1-bit TPMI field to indicate the one state associated with the 4Tx Rank-4 TPMI index 0.

For a Rank-7 PC-2 precoding matrix, an uplink precoding matrix indication 4424 may include one 1-bit TPMI field to indicate one of two states associated with the 4Tx Rank-4 TPMI indices 1 to 2.

For a Rank-7 PC-4 precoding matrix, an uplink precoding matrix indication 4426 may include one 1-bit TPMI field to indicate one of two states associated with the 4Tx Rank-4 TPMI indices 3 to 4.

In another aspect related to the Rank-7 8Tx codebook, the uplink precoding matrix indication 2930 may be configured to only indicate a Type 1 precoding matrix or a Type 2 precoding matrix with a single TPMI field included in the uplink precoding matrix indication 2930. The uplink precoding matrix indication 2930 may include a 1-bit PG indicator to indicate whether the 8Tx precoding matrix is of Type 1 or Type 2.

Additionally, the TPMI field of the uplink precoding matrix indication 2930 may include the following restriction so that a single TPMI field may be included in the uplink precoding matrix indication 2930:

$${W}_{4 Tx , r = 3} = {[ {W}_{4 Tx , r = 4} ]}_{3}$$

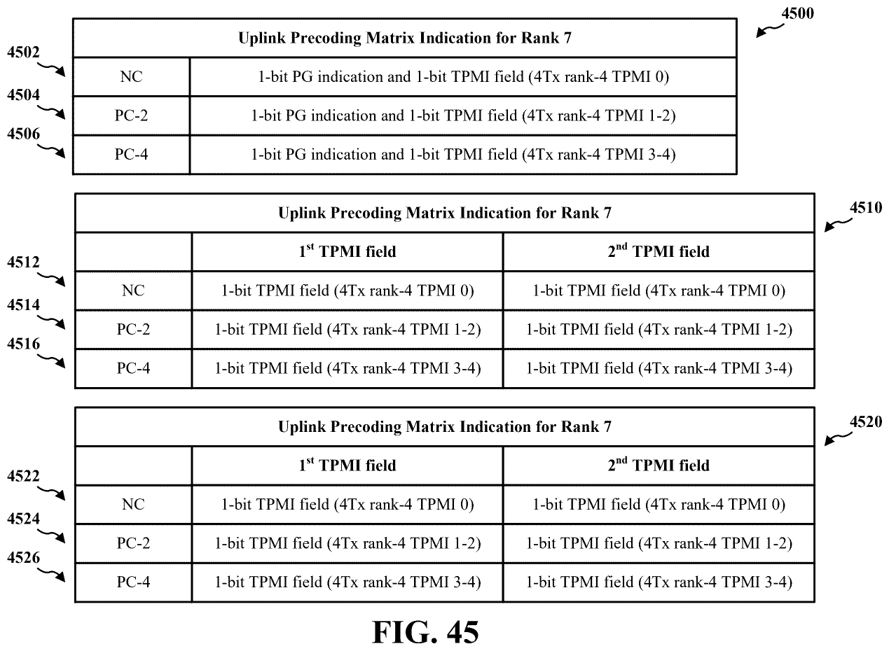

In the above restriction, the first 3 columns of the precoding matrix (W_{4Tx,r=4}) are used for the second precoding matrix, as shown in a first table 4500 of FIG. 45. For a Rank-7 NC precoding matrix, an uplink precoding matrix indication 4502 may include a 1-bit PG indication to indicate whether the 8Tx precoding matrix is of Type 1 or Type 2. The uplink precoding matrix indication 4502 may also include a 1-bit TPMI field to indicate the one state associated with the 4Tx Rank-4 TPMI index 0.

For a Rank-7 PC-2 precoding matrix, an uplink precoding matrix indication 4504 may include a 1-bit PG indication to indicate whether the 8Tx precoding matrix is of Type 1 or Type 2. The uplink precoding matrix indication 4504 may also include a 1-bit TPMI field to indicate one of two states associated with the 4Tx Rank-4 TPMI indices 1 to 2.

For a Rank-7 PC-4 precoding matrix, an uplink precoding matrix indication 4506 may include a 1-bit PG indication to indicate whether the 8Tx precoding matrix is of Type 1 or Type 2. The uplink precoding matrix indication 4506 may also include a 1-bit TPMI field to indicate one of two states associated with the 4Tx Rank-4 TPMI indices 3 to 4.

In another aspect related to the Rank-7 8Tx codebook, the uplink precoding matrix indication 2930 may be configured to only indicate a Type 1 precoding matrix with restriction similar to the example restriction described in connection with the second table 3210 of FIG. 32. For example, the following restriction may be applied so that the second precoding matrix may be derived from the first precoding matrix included in the uplink precoding matrix indication 2930:

$${W}_{4 Tx , r = 3} = {[ {W}_{4 Tx , r = 4}^{′} ]}_{3}$$

In the above restriction, the first 3 columns of the precoding matrix (W_{4Tx,r=4}) are used for the second precoding matrix. For example, the first TPMI field may indicate the precoding matrix “W_{4Tx,r=4}” and the second TPMI field may indicate the precoding matrix “W_{4Tx,r=4}” to use for a second table 4510 of FIG. 45. In the second table 4510, the PG indication may be disabled or reserved.

For a Rank-7 NC precoding matrix, an uplink precoding matrix indication 4512 may include a first 1-bit TPMI field to indicate the one state associated with the 4Tx Rank-4 TPMI index 0, and a second 1-bit TPMI field to indicate the one state associated with the 4Tx Rank-4 TPMI index 0.

For a Rank-7 PC-2 precoding matrix, an uplink precoding matrix indication 4514 may include a first 1-bit TPMI field to indicate one of two states associated with the 4Tx Rank-4 TPMI indices 1 to 2, and a second 1-bit TPMI field to indicate one of two states associated with the 4Tx Rank-4 TPMI indices 1 to 2.

For a Rank-7 PC-4 precoding matrix, an uplink precoding matrix indication 4516 may include a first 1-bit TPMI field to indicate one of two states associated with the 4Tx Rank-4 TPMI indices 3 to 4, and a second 1-bit TPMI field to indicate one of two states associated with the 4Tx Rank-4 TPMI indices 3 to 4.

In another aspect related to the Rank-7 8Tx codebook, the uplink precoding matrix indication 2930 may be configured to indicate a Type 1 precoding matrix or a Type 2 precoding matrix with restriction similar to the example restriction described in connection with the second table 4510 of FIG. 45. For example, the following restriction may be applied so that the second precoding matrix may be derived from the first precoding matrix included in the uplink precodin matrix indication 2930:

$${W}_{4 Tx , r = 3} = {[ {W}_{4 Tx , r = 4}^{′} ]}_{3}$$

In the above restriction, the first 3 columns of the precoding matrix (W_{4Tx,r=4}) are used for the second precoding matrix. For example, the first TPMI field may indicate the precoding matrix “W_{4Tx,r=4}” and the second TPMI field may indicate the precoding matrix “W_{4Tx,r=4}” to use for a third table 4520 of FIG. 45.

For a Rank-7 NC precoding matrix, an uplink precoding matrix indication 4522 may include a 1-bit PG indication to indicate whether the 8Tx precoding matrix is of Type 1 or Type 2. The uplink precoding matrix indication 4522 may also include a first 1-bit TPMI field to indicate the one state associated with the 4Tx Rank-4 TPMI index 0, and a second 1-bit TPMI field to indicate the one state associated with the 4Tx Rank-4 TPMI index 0.

For a Rank-7 PC-2 precoding matrix, an uplink precoding matrix indication 4524 may include a 1-bit PG indication to indicate whether the 8Tx precoding matrix is of Type 1 or Type 2. The uplink precoding matrix indication 4524 may also include a first 1-bit TPMI field to indicate one of two states associated with the 4Tx Rank-4 TPMI indices 1 to 2, and a second 1-bit TPMI field to indicate one of two states associated with the 4Tx Rank-4 TPMI indices 1 to 2.

For a Rank-7 PC-4 precoding matrix, an uplink precoding matrix indication 4526 may include a 1-bit PG indication to indicate whether the 8Tx precoding matrix is of Type 1 or Type 2. The uplink precoding matrix indication 4526 may also include a first 1-bit TPMI field to indicate one of two states associated with the 4Tx Rank-4 TPMI indices 3 to 4, and a second 1-bit TPMI field to indicate one of two states associated with the 4Tx Rank-4 TPMI indices 3 to 4.

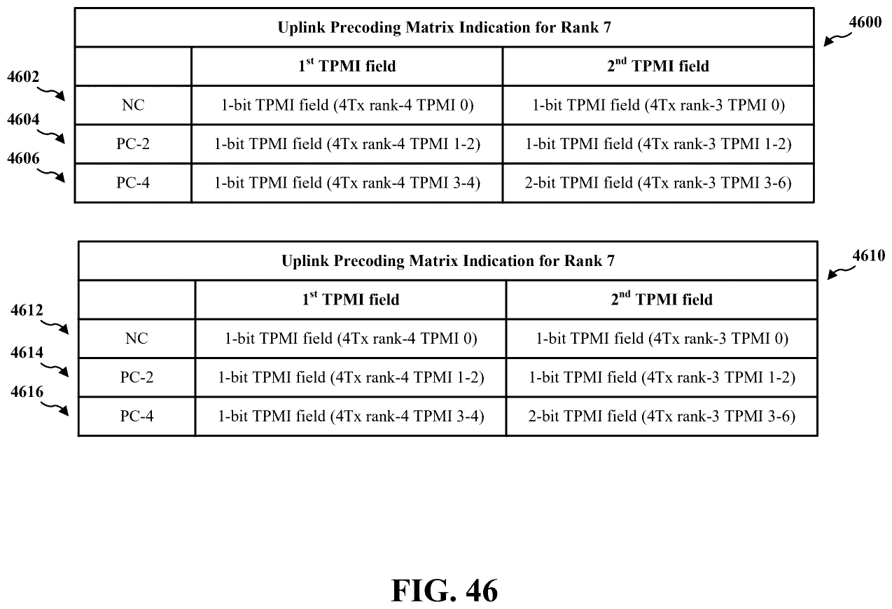

In another aspect related to the Rank-7 8Tx codebook, the uplink precoding matrix indication 2930 may be configured to only indicate a Type 1 precoding matrix without restriction. For example, the first TPMI field may indicate the precoding matrix “W_{4Tx,r=4}” and the second TPMI field may indicate the precoding matrix “W_{4Tx,r=3}” to use for a first table 4600 of FIG. 46. In the first table 4600, the PG indication may be disabled or reserved.

For a Rank-7 NC precoding matrix, an uplink precoding matrix indication 4602 may include a first 1-bit TPMI field to indicate the one state associated with the 4Tx Rank-4 TPMI index 0, and a second 1-bit TPMI field to indicate the one state associated with the 4Tx Rank-3 TPMI index 0.

For a Rank-7 PC-2 precoding matrix, an uplink precoding matrix indication 4604 may include a first 1-bit TPMI field to indicate one of two states associated with the 4Tx Rank-4 TPMI indices 1 to 2, and a second 1-bit TPMI field to indicate one of two states associated with the 4Tx Rank-3 TPMI indices 1 to 2.

For a Rank-7 PC-4 precoding matrix, an uplink precoding matrix indication 4606 may include a first 1-bit TPMI field to indicate one of two states associated with the 4Tx Rank-4 TPMI indices 3 to 4, and a second 1-bit TPMI field to indicate one of four states associated with the 4Tx Rank-3 TPMI indices 3 to 6.

In another aspect related to the Rank-7 8Tx codebook, the uplink precoding matrix indication 2930 may be configured to only indicate a Type 1 precoding matrix without restriction. For example, the first TPMI field may indicate the precoding matrix “W_{4Tx,r=4}” and the second TPMI field may indicate the precoding matrix “W_{4Tx,r=3}” to use for a second table 4610 of FIG. 46.

For a Rank-7 NC precoding matrix, an uplink precoding matrix indication 4612 may include a 1-bit PG indication to indicate whether the 8Tx precoding matrix is of Type 1 or Type 2. The uplink precoding matrix indication 4612 may also include a first 1-bit TPMI field to indicate the one state associated with the 4Tx Rank-4 TPMI index 0, and a second 1-bit TPMI field to indicate the one state associated with the 4Tx Rank-3 TPMI index 0.

For a Rank-7 PC-2 precoding matrix, an uplink precoding matrix indication 4614 may include a 1-bit PG indication to indicate whether the 8Tx precoding matrix is of Type 1 or Type 2. The uplink precoding matrix indication 4614 may also include a first 1-bit TPMI field to indicate one of two states associated with the 4Tx Rank-4 TPMI indices 1 to 2, and a second 1-bit TPMI field to indicate one of two states associated with the 4Tx Rank-3 TPMI indices 1 to 2.

For a Rank-7 PC-4 precoding matrix, an uplink precoding matrix indication 4616 may include a 1-bit PG indication to indicate whether the 8Tx precoding matrix is of Type 1 or Type 2. The uplink precoding matrix indication 4616 may also include a first 1-bit TPMI field to indicate one of two states associated with the 4Tx Rank-4 TPMI indices 3 to 4, and a second 2-bit TPMI field to indicate one of four states associated with the 4Tx Rank-3 TPMI indices 3 to 6.

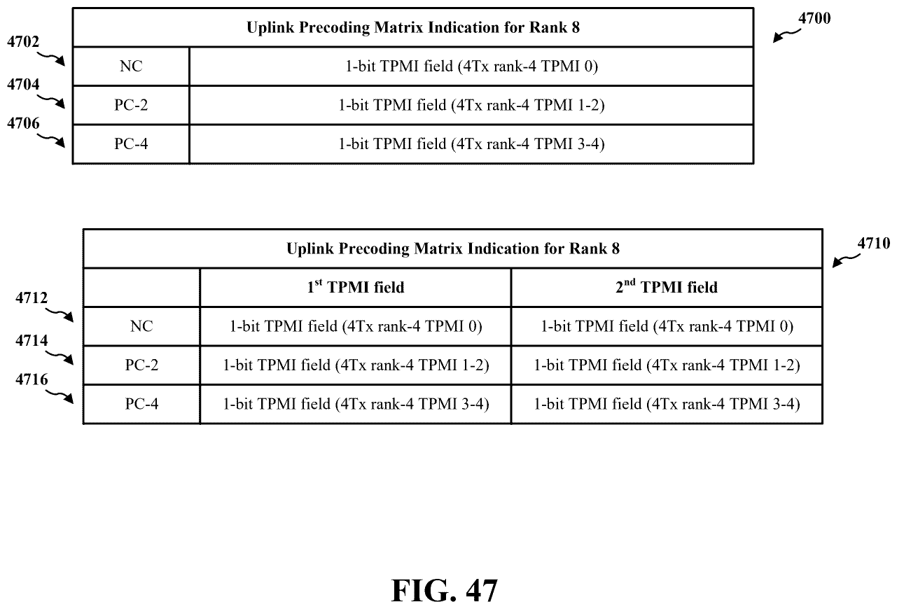

For a Rank-8 8Tx codebook, the precoding matrix may be associated with a Type 1, as shown in the table 2400. A first table 4710 of FIG. 47 illustrates a first aspect for illustrating the uplink precoding matrix indication 2930 for Rank 8. With respect to indicating a precoding matrix from the Rank-8 8Tx codebook, a PG indication is not needed (e.g., the PG indication may be reserved or disabled). In the first table 4710, the uplink precoding matrix indication 2930 may be configured with a restriction (e.g., W_{4Tx,r=4}=W_{4Tx,r=4}). The restriction may facilitate reducing signaling overhead as the uplink precoding matrix indication 2930 may be configured to include one TPMI field to indicate the first precoding matrix and the second precoding matrix.

For a Rank-8 NC precoding matrix, an uplink precoding matrix indication 4702 may include a 1-bit TPMI field to indicate the one state associated with the 4Tx Rank-4 TPMI index 0.

For a Rank-8 PC-2 precoding matrix, an uplink precoding matrix indication 4704 may include one 1-bit TPMI field to indicate one of two states associated with the 4Tx Rank-4 TPMI indices 1 to 2.

For a Rank-8 PC-4 precoding matrix, an uplink precoding matrix indication 4706 may include one 1-bit TPMI field to indicate one of two states associated with the 4Tx Rank-4 TPMI indices 3 to 4.

In another aspect related to the Rank-8 8Tx codebook, the uplink precoding matrix indication 2930 may be configured without restriction with respect to the first precoding matrix and the second precoding matrix, as described in connection with a second table 4710 of FIG. 47. In such examples, the uplink precoding matrix indication 2930 may be configured to include two TPMI fields to indicate the first precoding matrix and the second precoding matrix.

For a Rank-8 NC precoding matrix, an uplink precoding matrix indication 4712 may include a first 1-bit TPMI field to indicate the one state associated with the 4Tx Rank-4 TPMI index 0, and a second 1-bit TPMI field to indicate the one state associated with the 4Tx Rank-4 TPMI index 0.

For a Rank-8 PC-2 precoding matrix, an uplink precoding matrix indication 4714 may include a first 1-bit TPMI field to indicate one of two states associated with the 4Tx Rank-4 TPMI indices 1 to 2, and a second 1-bit TPMI field to indicate one of two states associated with the 4Tx Rank-4 TPMI indices 1 to 2.

For a Rank-8 PC-4 precoding matrix, an uplink precoding matrix indication 4716 may include a first 1-bit TPMI field to indicate one of two states associated with the 4Tx Rank-4 TPMI indices 3 to 4, and a second 1-bit TPMI field to indicate one of two states associated with the 4Tx Rank-4 TPMI indices 3 to 4.a

In some aspects, non-coherent and partially coherent codebook designs may include a base station sending radio resource control (RRC) and medium access control-control element (MAC-CE) down selecting four antenna ports to be used, and then the base station sends a DCI that indicates the precoding matrix for PUSCH. Thus, four ports are selected from among 8 antenna ports via RRC and/or MAC-CE signaling, and then a 4 port codebook is applied to the selected four antenna ports. As an example, for a rank 1 transmission,

$$( \begin{matrix}8 \\ 1\end{matrix} ) matrices$$

with the RRC/MAC-CE 4-port down-selection becomes

$$( \begin{matrix}4 \\ 1\end{matrix} ) = 4 matrices .$$

Similarly, for a rank 2 transmission,

$$( \begin{matrix}8 \\ 2\end{matrix} ) matrices$$

with the RRC/MAC-CE 4-port down-selection becomes

$$( \begin{matrix}4 \\ 2\end{matrix} ) = 6 matrices .$$

For a rank 3 transmission,

$$( \begin{matrix}8 \\ 3\end{matrix} ) = matrices$$

with the RRC/MAC-CE 4-port down-selection becomes

$$( \begin{matrix}4 \\ 3\end{matrix} ) = 4 matrices$$

(or single matrix with subsampling). For a rank 4 transmission,

$$( \begin{matrix}8 \\ 4\end{matrix} ) matrices$$

with the RRC/MAC-CE 4-port down-selection becomes a single matrix.

For a DFT codebook with an oversampling factor of 2 and co-phasing, rank 1 may have 32, rank 2 may have 16 matrices, rank 3 may have 8 matrices, and rank 4 may have 8 matrices 8. In some aspects, the matrices may be extended from 4×4 Householder design.

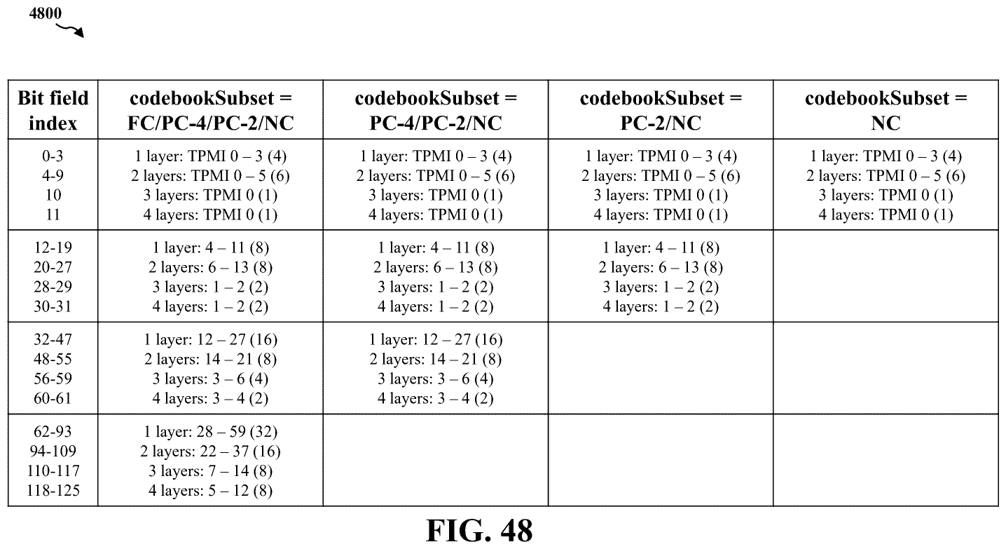

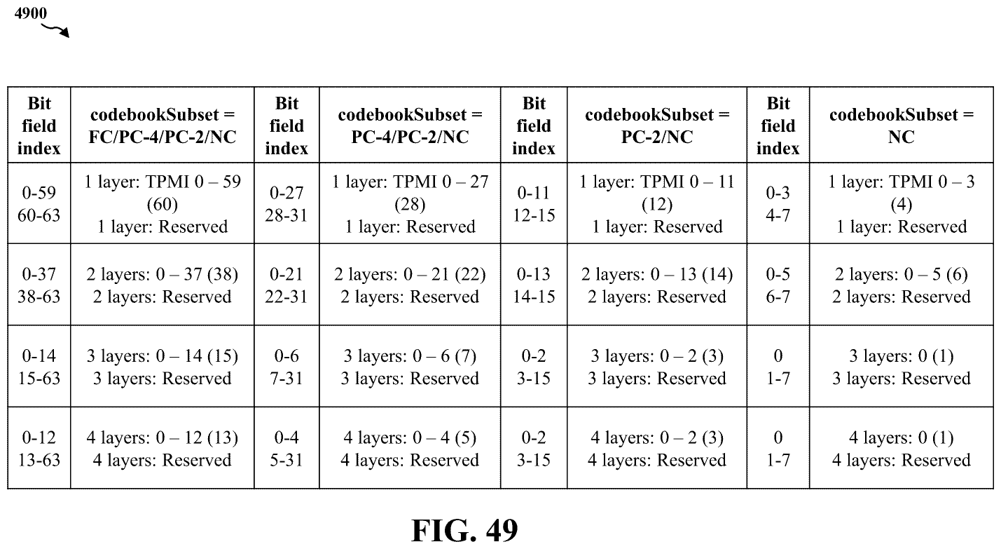

FIG. 48 illustrates an example table 4800 showing example TPMI bit fields for UL 8Tx MIMO when the maximum rank is 2, 3, or 4. The table illustrates examples for fully coherent (FC), four antenna partially coherent (PC-4), two antenna partially coherent (PC-2) and non-coherent (NC) transmissions. FIG. 49 illustrates example table 4900 showing example bit fields for a second TPMI field for 8Tx ranks 1-4, when the maximum rank is 2, 3, or 4. The second TPMI field may include information to be used with the same number of layers indicated by the first TPMI field in DCI scheduling the PUSCH.

As presented herein, a single precoder may be used for each of rank 5-8. In some aspects, for a rank of “R”, a non-coherent single precoder may be applied for the 4 ports selected out of 8 ports in RRC signaling or a MAC-CE, and may use one or more additional ports based on a port selection mechanism. The one or more additional ports may correspond to the rank R-4, e.g., for the 4 ports indicated by the network. For the additional antenna ports, the UE may select the ports having the lowest indices that were not selected in the RRC signaling or MAC-CE.

For example, if the UE receives signaling from a base station selecting antenna ports 2-3-6-7, of 8 antenna ports, for a rank 5, the UE may select antenna port 0, which has the lowest index and was not in the four selected antenna ports. The selection may be represented as:
Rank-5 selects 2-3-6-7-0, and the rank 5 precoder may be

$$\frac{1}{\sqrt{8}} [ \begin{matrix}1 & 0 & 0 & 0 & 0 \\ 0 & 0 & 0 & 0 & 0 \\ 0 & 1 & 0 & 0 & 0 \\ 0 & 0 & 1 & 0 & 0 \\ 0 & 0 & 0 & 0 & 0 \\ 0 & 0 & 0 & 0 & 0 \\ 0 & 0 & 0 & 1 & 0 \\ 0 & 0 & 0 & 0 & 1\end{matrix} ]$$

Similarly, for a rank 6 transmission, the UE may select antenna port 0 and antenna port 1 as having the lowest indices. This may be represented as:
Rank-6 selects 2-3-6-7-0-1, and the rank 6 precoder may be

$$\frac{1}{\sqrt{8}} [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 0 & 0 \\ 0 & 0 & 0 & 0 & 0 & 0 \\ 0 & 0 & 0 & 0 & 1 & 0 \\ 0 & 0 & 0 & 0 & 0 & 1\end{matrix} ]$$

Similarly, for a rank 7 transmission, the UE may select antenna port 0, antenna port 1, and antenna port 2 as having the lowest indices. This may be represented as:
Rank-7 selects 2-3-6-7-0-1-4, and the rank 7 precoder may be

$$\frac{1}{\sqrt{8}} [ \begin{matrix}1 & 0 & 0 & 0 & 0 & 0 & 0 \\ 0 & 1 & 0 & 0 & 0 & 0 & 0 \\ 0 & 0 & 1 & 0 & 0 & 0 & 0 \\ 0 & 0 & 0 & 1 & 0 & 0 & 0 \\ 0 & 0 & 0 & 0 & 1 & 0 & 0 \\ 0 & 0 & 0 & 0 & 0 & 0 & 0 \\ 0 & 0 & 0 & 0 & 0 & 1 & 0 \\ 0 & 0 & 0 & 0 & 0 & 0 & 1\end{matrix} ]$$

Similarly, for a rank 8 transmission, the UE may select antenna port 0, antenna port 1, antenna port 4, and antenna port 5 in order of lowest indices. This may be represented as:
Rank-8 selects 2-3-6-7-0-1-4-5 and the rank 8 precoder may be

$$\frac{1}{\sqrt{8}} [ \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1\end{matrix} ]$$

In another example, the four antenna ports may be indicated to the UE by RRC signaling or a MAC-CE, and the UE may select one or more additional antenna ports up to the corresponding rank based on an order indicated by the network. For example, the antenna ports may be grouped into antenna port groups or sets of antenna ports, and each group may have a particular order of antenna ports. For a rank “R” non-coherent transmission a single precoder may selects 4 ports in the first set+(R−4) ports in a second set according to an order of the antenna ports within the set.

For example, if the first set is 0-4-1-5 and the second set is 2-6-3-7, for a rank 5 transmission, and the first set is indicated in the RRC signaling or MAC-CE, the UE may select antenna port 0, antenna port 4, antenna port 1, antenna port 5, and antenna port 2 because antenna port 2 is the first antenna port in the second set. The selection may be represented as:

Rank-5 selects 0-4-1-5-2, and the rank 5 precoder may be

$$\frac{1}{\sqrt{8}} [ \begin{matrix}1 & 0 & 0 & 0 & 0 \\ 0 & 1 & 0 & 0 & 0 \\ 0 & 0 & 1 & 0 & 0 \\ 0 & 0 & 0 & 0 & 0 \\ 0 & 0 & 0 & 1 & 0 \\ 0 & 0 & 0 & 0 & 1 \\ 0 & 0 & 0 & 0 & 0 \\ 0 & 0 & 0 & 0 & 0\end{matrix} ]$$

For a rank 6 transmission, the UE may select antenna ports 0-4-1-5-2-6. For a rank 7 transmission, the UE may select antenna ports 0-4-1-5-2-6-3. For a rank 8 transmission, the UE may select antenna ports 0-4-1-5-2-6-3-7. Examples, of the precoder for rank 6, 7, and 8 may be:

$$\begin{matrix}Rank 6 \\ \frac{1}{\sqrt{8}} [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1 \\ 0 & 0 & 0 & 0 & 0 & 0\end{matrix} ] \text{}\end{matrix}$$

$$\begin{matrix}Rank 7 \\ \frac{1}{\sqrt{8}} [ \begin{matrix}1 & 0 & 0 & 0 & 0 & 0 & 0 \\ 0 & 1 & 0 & 0 & 0 & 0 & 0 \\ 0 & 0 & 1 & 0 & 0 & 0 & 0 \\ 0 & 0 & 0 & 1 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1 \\ 0 & 0 & 0 & 0 & 0 & 0 & 0\end{matrix} ]\end{matrix}$$

$$\begin{matrix}Rank 8 \\ \text{} \frac{1}{\sqrt{8}} [ \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1\end{matrix} ]\end{matrix}$$

In some aspects, there may be two default sets of four antenna ports. The UE may apply the default sets unless the antenna port sets are configured for the UE, e.g., signaling to the UE by a base station. In some aspects, the default sets may be antenna ports 0-4-1-5 and antenna ports 2-6-3-7.

In some aspects, coherent port pairs may be provided. The port pairs may be configured, defined, or fixed. As an example, for 8 antenna ports, a first coherent antenna port pair may be 0-4, a second coherent antenna port pair may be 1-5, a third coherent antenna port pair may be 2-6, and a fourth coherent antenna port pair may be 3-7. Two precoders may be provided for each rank in rank 5-8.

In some aspects, 4-layer precoders may be applied on the 4 antenna ports down-selected by RRC signaling or a MAC-CE+additional (R-4) layers using port-pairs which are not included in the down-selected 4 ports and following a particular order. For example, the order of selection in the port-pairs may be 0-4, 1-5, 2-6, 3-7.

There may be co-phasing applied. For example, a co-phasing of,

$$\frac{1}{\sqrt{8}} [ 1 ; 1 ] , \frac{1}{\sqrt{8}} [ 1 ; j ]$$

may be applied for additional one layer, and a co-phasing of

$$\frac{1}{4} [ [ 1 ; 1 ] , [ 1 ; - 1 ] ] , \frac{1}{4} [ [ 1 ; j ] , [ 1 ; - j ] ]$$

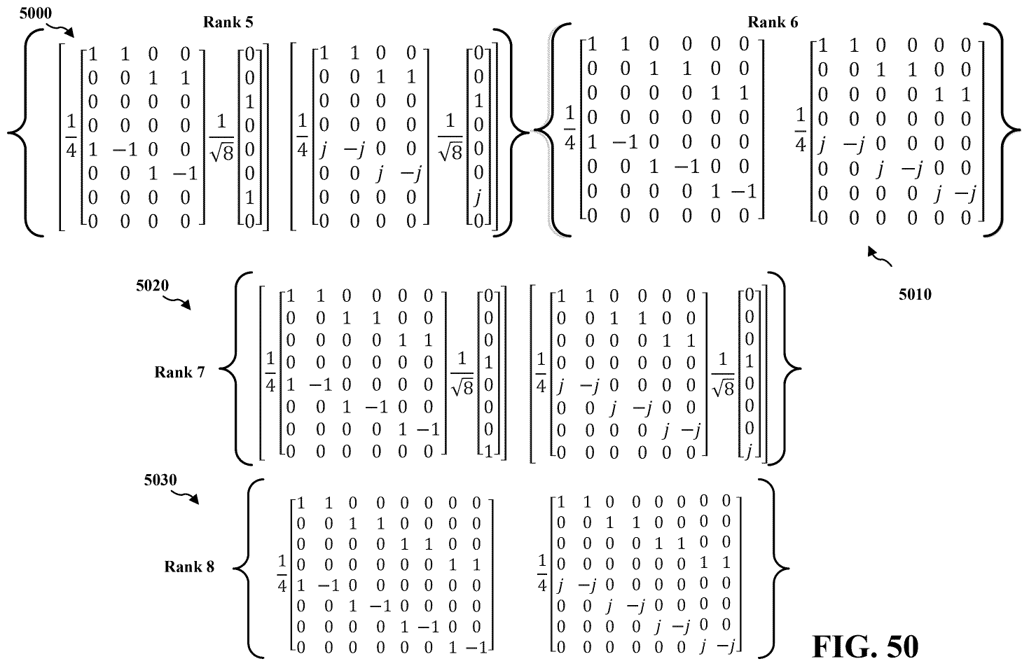

may be applied for an additional two layers. In an example in which the down-selected ports are 0-4-1-5, then for a rank 5 transmission, the UE may use the 4 layer precoder for antenna ports 0-4-1-5 and may use an additional one layer on port 2-6, which is the next port pair in the order of port pairs. For a rank 6 transmission, the UE may use the 4-layer precoder for antenna ports 0-4-1-5 and may use an additional two layers on ports 2-6, which is the next port pair in the order of port pairs. For a rank 7 transmission, the UE may use the 4-layer precoder for antenna ports 0-4-1-5 and may use an additional two layers on ports 2-6 and one layer on port 3-7, which is the next port pair. For a rank 8 transmission, the UE may use a 4-layer precoder for antenna ports 0-4-1-5 and may use an additional two layers on ports 2-6 and an additional two layers on ports 3-7. FIG. 50 illustrates example precoding matrices for the rank 5-8 examples, e.g., including a precoding matrix 5000 for rank 5, a precoding matrix 5010 for rank 6, a precoding matrix 5020 for rank 7, and a precoding matrix 5030 for rank 8.

In some aspects, two 4-port sets may be configured for the UE via RRC signaling and/or a MAC-CE. For a transmission of rank R, the UE may apply the 4-layer precoder for the 4 ports in the first set signaled to the UE and may transmit R-4 layers using antenna port-pairs in the second set in order. As an example, the first set may be antenna ports 0-4, 1-5 and the second set, in order, may be antenna ports 2-6, 3-7.

In some aspects, there may fixed or configured coherent antenna port groups. As an example a first group, or set, of coherent antenna ports may be antenna ports 0-4-1-5, and a second group of coherent antenna ports may be antenna ports 2-6-3-7. Two precoders may be provided for each of rank 5, 6, 7, and 8. The UE may apply coherent combining with length-4 orthogonal sequences for the antenna port groups. As an example, the length-4 orthogonal sequences for the antenna port groups may be:
{[1; 1; 1; 1], [1; −1; 1; −1], [1; 1; −1; −1], [1; −1, −1, 1]} or
{[1; 1; j; j], [1; −1; j; −J], [1; 1; −J; −J], [1; −1, −J, j]}

For transmission having a rank of R, a ceil(R/2) layers may be transmitted for the first port-group and a floor(R/2) layers may be transmitted for the second port group.

As an example, for a rank 5 transmission, the UE may transmit 3 layers using antenna ports from the first antenna port group, and 2 layers from the second antenna port group. For a rank 6 transmission, the UE may transmit 3 layers using antenna ports from the first antenna port group, and may transmit 3 layers using antenna ports from the second antenna port group. For a rank 7 transmission, the UE may transmit 4 layers using antenna ports from the first antenna port group, and may transmit 3 layers using antenna ports from the second antenna port group. For a rank 8 transmission, the UE may transmit 4 layers using antenna ports from the first antenna port group and may transmit 4 layers from the second antenna port group. The UE may apply scaling to the transmissions. The UE may apply a first scaling to the transmission from the antennas in the first antenna port group and may apply a second scaling to the transmission from the antennas in the second antenna port group. As an example, the UE may apply a first scaling of

$$\frac{1}{\sqrt{8 * ceil ( \frac{R}{2} )}}$$

for the first antenna port-group and may apply a second scaling of

$$\frac{1}{\sqrt{8 * floor ( \frac{R}{2} )}}$$

for the second port group. The scaling is based on the number of layers, or number of antenna ports, used from the corresponding antenna port groups e.g.,

$$8 * ceil ( \frac{R}{2} )$$

for the antenna port group and

$$8 * floor ( \frac{R}{2} )$$

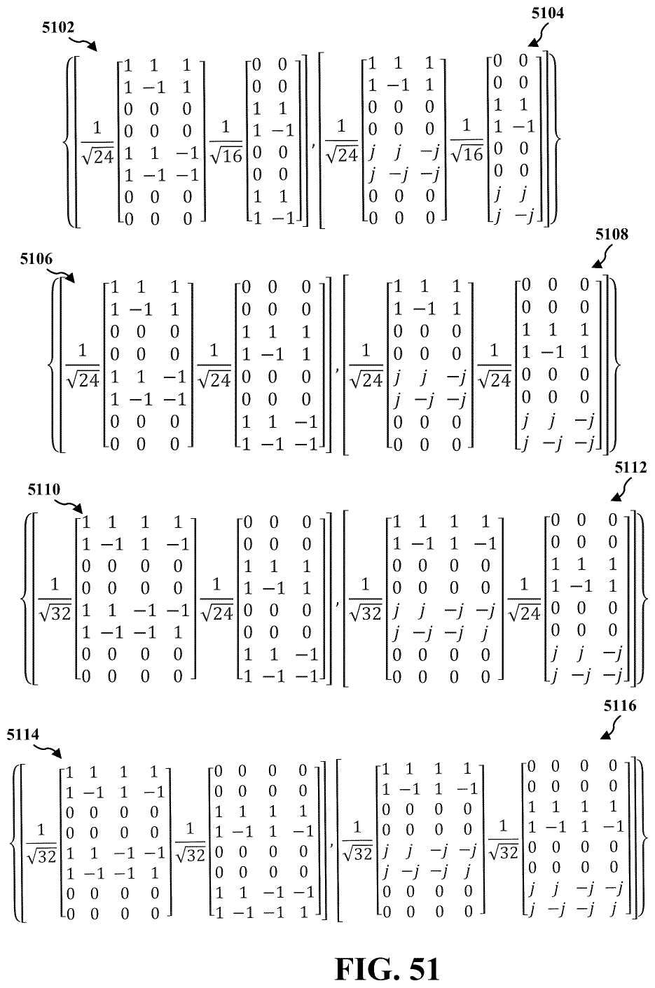

for the second antenna port group. FIG. 51 illustrates two example precoders for each of rank 5, 6, 7, and 8, e.g., including precoders 5102 and 5104 for rank 5, precoders 5106 and 5108 for rank 6, precoders 5110 and 5112 for rank 7 and precoders 5114 and 5116 for rank 8.

In some aspects, for rank R, the UE may transmit using 4 layers for the first antenna port group and R-4 layers for the second antenna port group. In this example, for a rank 5 transmission, the UE may transmit 4 layers using antenna ports from the first antenna port group and 1 layer from the second antenna port group. For a rank 6 transmission, the UE may transmit 4 layers using antenna ports from the first antenna port group and 2 layer2 from the second antenna port group. For a rank 7 transmission, the UE may transmit 4 layers using antenna ports from the first antenna port group and 3 layers from the second antenna port group. For a rank 8 transmission, the UE may transmit 4 layers using antenna ports from the first antenna port group and 4 layers from the second antenna port group. In this example, the UE may apply scaling factor of

$$\frac{1}{\sqrt{32}}$$

for the transmission using the antennas in the first port-group and a scaling factor of

$$\frac{1}{\sqrt{8 * ( R - 4 )}}$$

for the antennas in the second port group. FIG. 52 illustrates two example precoders for each of rank 5, 6, 7, and 8, e.g., including precoders 5202 and 5204 for rank 5, precoders 5206 and 5208 for rank 6, precoders 5210 and 5212 for rank 7 and precoders 5214 and 5216 for rank 8.

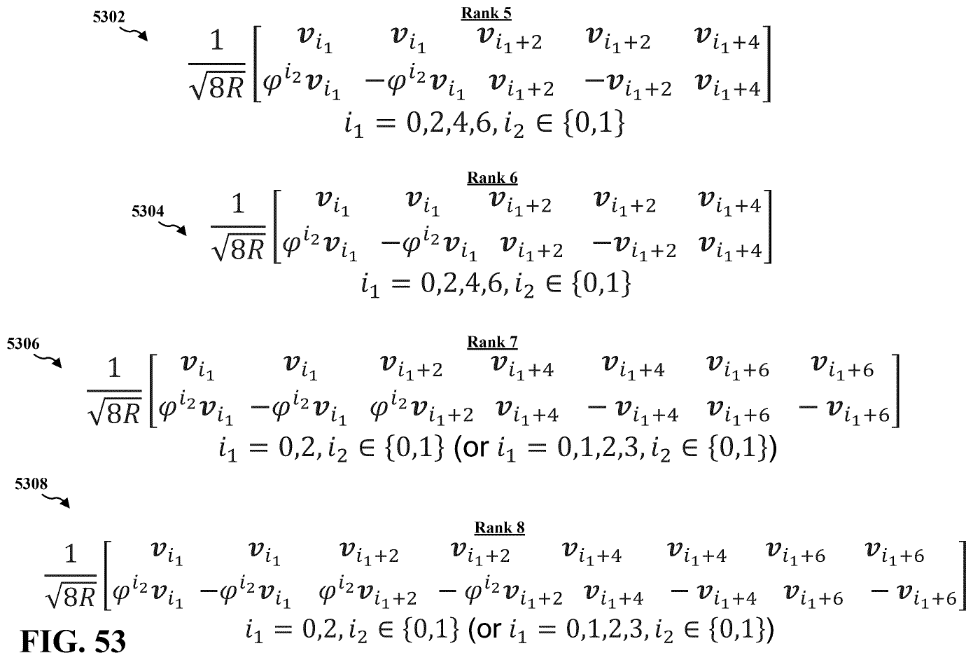

In some aspects, a DFT codebook may be used for the 8Tx UL MIMO with an oversampling factor of 2 and using co-phasing. As an example, the precoding of the 8 Tx UL MIMO transmission may be based on a subsampled version of an 8Tx downlink codebook, e.g., in which N₁=4, N₂=1, O₁=² O₂=1. For QPSK elements, even i₁ values may be used, which provides 8 precoders for ranks 5 and 6, and provides 4 precoders for ranks 7 and 8. Alternatively, if 8-PSK is used, the rank 7 and rank 8 codebooks may also each have 8 precoders. FIG. 53 illustrates the 8 precoders for rank 5 5302, the 8 precoders for rank 6 5304, the 4 or 8 precoders for rank 7 5306, and the 4 or 8 precoders for rank 8 5308. In the examples in FIG. 53,

$${v}_{{i}_{1}} = [ \begin{matrix}1 \\ {e}^{j π {i}_{1} / 4} \\ {e}^{j 2 π {i}_{1} / 4} \\ {e}^{j 3 π {i}_{1} / 4}\end{matrix} ] and φ = {e}^{j π / 2} .$$

In another example, a codebook for rank 5-8 may be based on a codebook that is optimized for spatially uncorrelated channels. As an example, the codebook may be based on a combination, which may be referred to as a stacking, of two 4×4 Householder matrices which may be used for DL 4Tx. The UE may apply co-phasing between two different antenna groups. A co-phasing parameter may be represented as φ.

As an example, the codebook for the rank 5-8 transmissions may be based on:

$${W}_{l , n}^{r} = \frac{1}{\sqrt{2}} [ \begin{matrix}[ {H}_{4 , l} ] & {[ {H}_{4 , l} ]}^{( r )} \\ {φ}_{n} [ {H}_{4 , l} ] & - {{φ}_{n} [ {H}_{4 , l} ]}^{( r )}\end{matrix} ] .$$

In this matrix,

$${H}_{4 , l} = {l}_{4} - \frac{2}{{u}_{l}^{H} {u}_{l}} {u}_{l} {u}_{l}^{H} ,$$

φ∈{1, j} or{1, −1}, and [H_{4,l}^{(r)} is the 4× r matrix with r columns which are selected from 4 columns of H_{4,l}, r=1,2,3,4 which corresponding to the rank 5,6,7, 8.

To construct such a Householder based codebook, the co-phasing parameter φₙ=e^{j2πn/N}, n=0, . . . N−1 and uᵢ,l=0, . . . , L−1 are based on a selection of a set of good rank −1 vectors wₗ, l=0, . . . , L−1.

Then, the corresponding Householder vector uₗ is obtained so that the first column of the Householder matrix is equal to wₗ. Then, the rank 4 codebook is obtained with 4×4 Householder matrices with the Householder vectors H₄ₗ. The UE may use 4Tx downlink precoding matrices with elements in L=16 with the following Householder matrices/vectors, for example.

| Index l | Householder vector (uₗ) |
|---|---|
| 0 | [1, −1, −1, −1]^{T} |
| 1 | [1, −j, 1, j]^{T} |
| 2 | [1, 1, −1, 1]^{T} |
| 3 | [1, j, 1, −j]^{T} |
| 4 | [1, −1, 1, 1]^{T} |
| 5 | [1, −j, −1, −j]^{T} |
| 6 | [1, (−1 − j)/\sqrt{2}, −j, (1 − j)/\sqrt{2}]^{T} |
| 7 | [1, (1 − j)/\sqrt{2} j, (−1 − j)/\sqrt{2}]^{T} |
| 8 | [1, (1 + j)/\sqrt{2}, −j, (−1 + j)/\sqrt{2}]^{T} |
| 9 | [1, (−1 + j)/\sqrt{2}, j, (1 + j)/\sqrt{2}]^{T} |
| 10 | [1, 1, 1, −1]^{T} |
| 11 | [1, j, −1, j]^{T} |
| 12 | [1, −1, −1, 1]^{T} |
| 13 | [1, −1, 1, −1]^{T} |
| 14 | [1, 1, −1, −1]^{T} |
| 15 | [1, 1, 1, 1]^{T} |
| 15 | [1, 1, 1, 1]^{T} |

In some aspects, the UE may use a subset of 4 Tx precoders with a co-phase to build 8Tx precoders for 8 Tx UL MIMO transmission. In some aspects, the 4 Tx precoders, e.g., Xᵢ, can be DL 4Tx or other precoders. In some aspects, the 4 Tx precoders may be a precoder for a different RAT than for the UL MIMO transmission. As an example, a UE may transmit an NR UL MIMO transmission using an 8 Tx precoder that uses a subset of LTE DL 4 Tx precoders with a co-phase to build the 8 Tx precoders for the NR 8 Tx UL MIMO transmission. As shown below, there may be

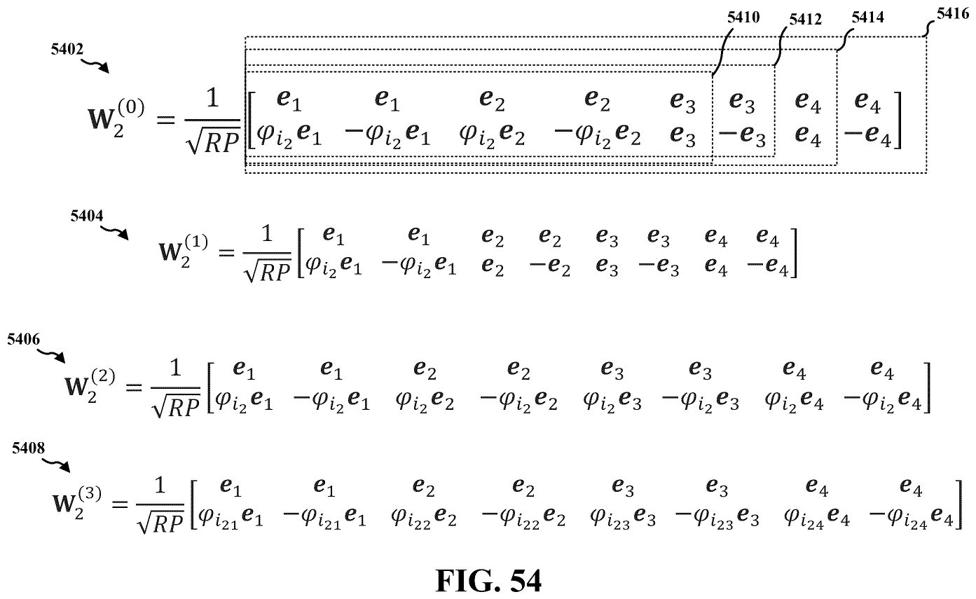

For Co-phasing, there may be four options. FIG. 54 illustrates examples of W 5402 for a first option (0), e.g., W₂⁽⁰⁾ W for a second option (1), e.g., W₂⁽¹⁾, W for a third option (2), e.g., W₂⁽²⁾, and W for a fourth option (3), e.g., W₂⁽³⁾. In this example:

$${W}_{1}^{( {i}_{1} )} = [ \begin{matrix}{X}_{{i}_{1}} & 0 \\ 0 & {X}_{{i}_{1}}\end{matrix} ]$$

For options (0), (1) and (2), a one-bit co-phasing report may be used. For option (3), a four-bit co-phasing report may be used. FIG. 54 shows that a first portion 5410 may be used for rank 5 transmissions, an expanded portion 5412 may be used for rank 6 transmissions, a further expanded portion 5414 may be used for rank 7 transmissions, and the full set 5416 of precoders may be used for rank 8 transmissions. Although illustrated for the first option, the use of portions of the precoder based on rank may be applied similarly to 5404, 5406, and 5408.

The following table provides a mapping for a first TPMI field for UL 8 Tx MIMO having a rank greater than 4, e.g., rank 5, rank 6, rank 7, or rank 8.

In some aspects, 4-6-7-8 bits for codebook subset restrictions NC, NC/PC-2, NC/PC-2/PC-4, and NC/PC-2/PC-4/FC are shown. As illustrated, for the rank 7 and 8 fully coherent (FC) codebook, four precoders are used for each.

| | codebookSubset = | CodebookSubset = | codebookSubset = | codebookSubset = |
|---|---|---|---|---|
| Field | FC/PC-4/PC-2/NC | PC-4/PC-2/NC | PC-2/NC | NC |
| 0-3 | 1 layer: TPMI 0-3 (4) | 1 layer: TPMI 0-3 (4) | 1 layer: TPMI 0-3 (4) | 1 layer: TPMI 0-3 (4) |
| 4-9 | 2 layers: TPMI 0-5 (6) | 2 layers: TPMI 0-5 (6) | 2 layers: TPMI 0-5 (6) | 2 layers: TPMI 0-5 (6) |
| 10 | 3 layers: TPMI 0 (1) | 3 layers: TPMI 0 (1) | 3 layers: TPMI 0 (1) | 3 layers: TPMI 0 (1) |
| 11 | 4 layers: TPMI 0 (1) | 4 layers: TPMI 0 (1) | 4 layers: TPMI 0 (1) | 4 layers: TPMI 0 (1) |
| 12 | 5 layers: TPMI 0 (1) | 5 layers: TPMI 0 (1) | 5 layers: TPMI 0 (1) | 5 layers: TPMI 0 (1) |
| 13 | 6 layers: TPMI 0 (1) | 6 layers: TPMI 0 (1) | 6 layers: TPMI 0 (1) | 6 layers: TPMI 0 (1) |
| 14 | 7 layers: TPMI 0 (1) | 7 layers: TPMI 0 (1) | 7 layers: TPMI 0 (1) | 7 layers: TPMI 0 (1) |
| 15 | 8 layers: TPMI 0 (1) | 8 layers: TPMI 0 (1) | 8 layers: TPMI 0 (1) | 8 layers: TPMI 0 (1) |
| 16-23 | 1 layer: 4-11 (8) | 1 layer: 4-11 (8) | 1 layer: 4-11 (8) | 1 layer: 4-11 (8) |
| 24-31 | 2 layers: 6-13 (8) | 2 layers: 6-13 (8) | 2 layers: 6-13 (8) | 2 layers: 6-13 (8) |
| 32-33 | 3 layers: 1-2 (2) | 3 layers: 1-2 (2) | 3 layers: 1-2 (2) | 3 layers: 1-2 (2) |
| 34-35 | 4 layers: 1-2 (2) | 4 layers: 1-2 (2) | 4 layers: 1-2 (2) | 4 layers: 1-2 (2) |
| 36-37 | 5 layers: 1-2 (2) | 5 layers: 1-2 (2) | 5 layers: 1-2 (2) | 5 layers: 1-2 (2) |
| 38-39 | 6 layers: 1-2 (2) | 6 layers: 1-2 (2) | 6 layers: 1-2 (2) | 6 layers: 1-2 (2) |
| 40-41 | 7 layers: 1-2 (2) | 7 layers: 1-2 (2) | 7 layers: 1-2 (2) | 7 layers: 1-2 (2) |
| 42-43 | 8 layers: 1-2 (2) | 8 layers: 1-2 (2) | 8 layers: 1-2 (2) | 8 layers: 1-2 (2) |
| 44-59 | 1 layer: 12-27 (16) | 1 layer: 12-27 (16) | | |
| 60-67 | 2 layers: 14-21 (8) | 2 layers: 14-21 (8) | | |
| 68-71 | 3 layers: 3-6 (4) | 3 layers: 3-6 (4) | | |
| 72-73 | 4 layers: 3-4 (2) | 4 layers: 3-4 (2) | | |
| 74-75 | 5 layers: 3-4 (2) | 5 layers: 3-4 (2) | | |
| 76-77 | 6 layers: 3-4 (2) | 6 layers: 3-4 (2) | | |
| 78-79 | 7 layers: 3-4 (2) | 7 layers: 3-4 (2) | | |
| 80-81 | 8 layers: 3-4 (2) | 8 layers: 3-4 (2) | | |
| 82-113 | 1 layer: 28-59 (32) | | | |
| 114-129 | 2 layers: 22-37 (16) | | | |
| 130-137 | 3 layers: 7-14 (8) | | | |
| 138-145 | 4 layers: 5-8 (4) | | | |
| 146-153 | 5 layers: 5-8 (4) | | | |
| 154-161 | 6 layers: 5-8 (4) | | | |
| 162-165 | 7 layers: 5-8 (4) | | | |
| 166-169 | 8 layers: 5-8 (4) | | | |

The following table illustrates a bit mapping for a second TPMI field for 8 Tx rank 1-8 UL MIMO transmissions, e.g., when maxRank >4 (e.g., maxRank=5, 6, 7, or 8). The mapping is with the same number of layers indicated by the first TPMI field. For a rank 7-8 fully coherent codebook, four precoders are used.

| Bit field | codebookSubset = | Bit field | CodebookSubset = |
|---|---|---|---|
| index | FC/PC-4/PC-2/NC | index | PC-4/PC-2/NC |
| 0-59 | 1 layer: TPMI 0-59 (60) | 0-27 | 1 layer: TPMI 0-27 (28) |
| 60-63 | 1 layer: Reserved | 28-31 | 1 layer: Reserved |
| 0-37 | 2 layers: 0-37 (38) | 0-21 | 2 layers: 0-21 (22) |
| 38-63 | 2 layers: Reserved | 22-31 | 2 layers: Reserved |
| 0-14 | 3 layers: 0-14 (15) | 0-6 | 3 layers: 0-6 (7) |
| 15-63 | 3 layers: Reserved | 7-31 | 3 layers: Reserved |
| 0-12 | 4 layers: 0-12 (13) | 0-4 | 4 layers: 0-4 (5) |
| 13-63 | 4 layers: Reserved | 5-31 | 4 layers: Reserved |
| 0-12 | 5 layers: 0-12 (13) | 0-4 | 5 layers: 0-4 (5) |
| 13-63 | 5 layers: Reserved | 5-31 | 5 layers: Reserved |
| 0-12 | 6 layers: 0-12 (13) | 0-4 | 6 layers: 0-4 (5) |
| 13-63 | 6 layers: Reserved | 5-31 | 6 layers: Reserved |
| 0-8 | 7 layers: 0-8 (9) | 0-4 | 7 layers: 0-4 (5) |
| 9-63 | 7 layers: Reserved | 5-31 | 7 layers: Reserved |
| 0-8 | 8 layers: 0-8 (9) | 0-4 | 8 layers: 0-4 (5) |
| 9-63 | 8 layers: Reserved | 5-31 | 8 layers: Reserved |

| Bit field | codebookSubset = | Bit field | codebookSubset = |
|---|---|---|---|
| index | PC-2/NC | index | NC |
| 0-11 | 1 layer: TPMI 0-11 (12) | 0-3 | 1 layer: TPMI 0-3(4) |
| 12-15 | 1 layer: Reserved | 4-7 | 1 layer: reserved |
| 0-13 | 2 layers: 0-13 (14) | 0-5 | 2 layers: TPMI 0-5(6) |
| 14-15 | 2 layers: Reserved | 6-7 | 2 layers: reserved |
| 0-2 | 3 layers: 0-2 (3) | 0 | 3 layers: 0 (1) |
| 3-15 | 3 layers: Reserved | 1-7 | 3 layers: Reserved |
| 0-2 | 4 layers: 0-2 (3) | 0 | 3 layers: 0 (1) |
| 3-15 | 4 layers: Reserved | 1-7 | 3 layers: Reserved |
| 0-2 | 5 layers: 0-2 (3) | 0 | 3 layers: 0 (1) |
| 3-15 | 5 layers: Reserved | 1-7 | 3 layers: Reserved |
| 0-2 | 6 layers: 0-2 (3) | 0 | 3 layers: 0 (1) |
| 3-15 | 6 layers: Reserved | 1-7 | 3 layers: Reserved |
| 0-2 | 7 layers: 0-2 (3) | 0 | 3 layers: 0 (1) |
| 3-15 | 7 layers: Reserved | 1-7 | 3 layers: Reserved |
| 0-2 | 8 layers: 0-2 (3) | 0 | 3 layers: 0 (1) |
| 3-15 | 8 layers: Reserved | 1-7 | 3 layers: Reserved |

The following table illustrates another example, bit field mapping for a First TPMI field for UL 8Tx MIMO when maxRank >4 (maxRank=5, 6, 7, or 8). In this example, the 4-6-7-8 bits are for the codebook subset restrictions NC, NC/PC-2, NC/PC-2/PC-4, and NC/PC-2/PC-4/FC. For a rank 7-8 fully coherent codebook, eight precoders may be used.

| | codebookSubset = | CodebookSubset = | codebookSubset = | codebookSubset = |
|---|---|---|---|---|
| Field | FC/PC-4/PC-2/NC | PC-4/PC-2/NC | PC-2/NC | NC |
| 0-3 | 1 layer: TPMI 0-3 (4) | 1 layer: TPMI 0-3 (4) | 1 layer: TPMI 0-3 (4) | 1 layer: TPMI 0-3 (4) |
| 4-9 | 2 layers: TPMI 0-5 (6) | 2 layers: TPMI 0-5 (6) | 2 layers: TPMI 0-5 (6) | 2 layers: TPMI 0-5 (6) |
| 10 | 3 layers: TPMI 0 (1) | 3 layers: TPMI 0 (1) | 3 layers: TPMI 0 (1) | 3 layers: TPMI 0 (1) |
| 11 | 4 layers: TPMI 0 (1) | 4 layers: TPMI 0 (1) | 4 layers: TPMI 0 (1) | 4 layers: TPMI 0 (1) |
| 12 | 5 layers: TPMI 0 (1) | 5 layers: TPMI 0 (1) | 5 layers: TPMI 0 (1) | 5 layers: TPMI 0 (1) |
| 13 | 6 layers: TPMI 0 (1) | 6 layers: TPMI 0 (1) | 6 layers: TPMI 0 (1) | 6 layers: TPMI 0 (1) |
| 14 | 7 layers: TPMI 0 (1) | 7 layers: TPMI 0 (1) | 7 layers: TPMI 0 (1) | 7 layers: TPMI 0 (1) |
| 15 | 8 layers: TPMI 0 (1) | 8 layers: TPMI 0 (1) | 8 layers: TPMI 0 (1) | 8 layers: TPMI 0 (1) |
| 16-23 | 1 layer: 4-11 (8) | 1 layer: 4-11 (8) | 1 layer: 4-11 (8) | 1 layer: 4-11 (8) |
| 24-31 | 2 layers: 6-13 (8) | 2 layers: 6-13 (8) | 2 layers: 6-13 (8) | 2 layers: 6-13 (8) |
| 32-33 | 3 layers: 1-2 (2) | 3 layers: 1-2 (2) | 3 layers: 1-2 (2) | 3 layers: 1-2 (2) |
| 34-35 | 4 layers: 1-2 (2) | 4 layers: 1-2 (2) | 4 layers: 1-2 (2) | 4 layers: 1-2 (2) |
| 36-37 | 5 layers: 1-2 (2) | 5 layers: 1-2 (2) | 5 layers: 1-2 (2) | 5 layers: 1-2 (2) |
| 38-39 | 6 layers: 1-2 (2) | 6 layers: 1-2 (2) | 6 layers: 1-2 (2) | 6 layers: 1-2 (2) |
| 40-41 | 7 layers: 1-2 (2) | 7 layers: 1-2 (2) | 7 layers: 1-2 (2) | 7 layers: 1-2 (2) |
| 42-43 | 8 layers: 1-2 (2) | 8 layers: 1-2 (2) | 8 layers: 1-2 (2) | 8 layers: 1-2 (2) |
| 44-59 | 1 layer: 12-27 (16) | 1 layer: 12-27 (16) | | |
| 60-67 | 2 layers: 14-21 (8) | 2 layers: 14-21 (8) | | |
| 68-71 | 3 layers: 3-6 (4) | 3 layers: 3-6 (4) | | |
| 72-73 | 4 layers: 3-4 (2) | 4 layers: 3-4 (2) | | |
| 74-75 | 5 layers: 3-4 (2) | 5 layers: 3-4 (2) | | |
| 76-77 | 6 layers: 3-4 (2) | 6 layers: 3-4 (2) | | |
| 78-79 | 7 layers: 3-4 (2) | 7 layers: 3-4 (2) | | |
| 80-81 | 8 layers: 3-4 (2) | 8 layers: 3-4 (2) | | |
| 82-113 | 1 layer: 28-59 (32) | | | |
| 114-129 | 2 layers: 22-37 (16) | | | |
| 130-137 | 3 layers: 7-14 (8) | | | |
| 138-145 | 4 layers: 5-8 (4) | | | |
| 146-153 | 5 layers: 5-8 (4) | | | |
| 154-161 | 6 layers: 5-8 (4) | | | |
| 162-165 | 7 layers: 5-12 (8) | | | |
| 166-169 | 8 layers: 5-12 (8) | | | |

The following table illustrates a bit mapping for a second TPMI field for 8 Tx rank 1-8 UL MIMO transmissions, e.g., when maxRank >4 (e.g., maxRank=5, 6, 7, or 8). The mapping is with the same number of layers indicated by the first TPMI field, e.g., in the table above. For a rank 7-8 fully coherent codebook, eight precoders are used.

| Bit field | codebookSubset = | Bit field | CodebookSubset = |
|---|---|---|---|
| index | FC/PC-4/PC-2/NC | index | PC-4/PC-2/NC |
| 0-59 | 1 layer: TPMI 0-59 (60) | 0-27 | 1 layer: TPMI 0-27 (28) |
| 60-63 | 1 layer: Reserved | 28-31 | 1 layer: Reserved |
| 0-37 | 2 layers: 0-37 (38) | 0-21 | 2 layers: 0-21 (22) |
| 38-63 | 2 layers: Reserved | 22-31 | 2 layers: Reserved |
| 0-14 | 3 layers: 0-14 (15) | 0-6 | 3 layers: 0-6 (7) |
| 15-63 | 3 layers: Reserved | 7-31 | 3 layers: Reserved |
| 0-12 | 4 layers: 0-12 (13) | 0-4 | 4 layers: 0-4 (5) |
| 13-63 | 4 layers: Reserved | 5-31 | 4 layers: Reserved |
| 0-12 | 5 layers: 0-12 (13) | 0-4 | 5 layers: 0-4 (5) |
| 13-63 | 5 layers: Reserved | 5-31 | 5 layers: Reserved |
| 0-12 | 6 layers: 0-12 (13) | 0-4 | 6 layers: 0-4 (5) |
| 13-63 | 6 layers: Reserved | 5-31 | 6 layers: Reserved |
| 0-8 | 7 layers: 0-12 (13) | 0-4 | 7 layers: 0-4 (5) |
| 9-63 | 7 layers: Reserved | 5-31 | 7 layers: Reserved |
| 0-8 | 8 layers: 0-12 (13) | 0-4 | 8 layers: 0-4 (5) |
| 9-63 | 8 layers: Reserved | 5-31 | 8 layers: Reserved |

| Bit field | codebookSubset = | Bit field | codebookSubset = |
|---|---|---|---|
| index | PC-2/NC | index | NC |
| 0-11 | 1 layer: TPMI 0-11 (12) | 0-3 | 1 layer: TPMI 0-3(4) |
| 12-15 | 1 layer: Reserved | 4-7 | 1 layer: reserved |
| 0-13 | 2 layers: 0-13 (14) | 0-5 | 2 layers: TPMI 0-5(6) |
| 14-15 | 2 layers: Reserved | 6-7 | 2 layers: reserved |
| 0-2 | 3 layers: 0-2 (3) | 0 | 3 layers: 0 (1) |
| 3-15 | 3 layers: Reserved | 1-7 | 3 layers: Reserved |
| 0-2 | 4 layers: 0-2 (3) | 0 | 3 layers: 0 (1) |
| 3-15 | 4 layers: Reserved | 1-7 | 3 layers: Reserved |
| 0-2 | 5 layers: 0-2 (3) | 0 | 3 layers: 0 (1) |
| 3-15 | 5 layers: Reserved | 1-7 | 3 layers: Reserved |
| 0-2 | 6 layers: 0-2 (3) | 0 | 3 layers: 0 (1) |
| 3-15 | 6 layers: Reserved | 1-7 | 3 layers: Reserved |
| 0-2 | 7 layers: 0-2 (3) | 0 | 3 layers: 0 (1) |
| 3-15 | 7 layers: Reserved | 1-7 | 3 layers: Reserved |
| 0-2 | 8 layers: 0-2 (3) | 0 | 3 layers: 0 (1) |
| 3-15 | 8 layers: Reserved | 1-7 | 3 layers: Reserved |

Different types of devices may have different antenna layouts to support 8Tx. For example, a UE may have a different antenna layout than an indoor customer premises equipment (CPE) The 8Tx antennas may be constructed with multiple groups due to the coherent capability. Aspects presented herein help to enable more antenna port configurations for UL 8Tx transmission, such as 8 Tx PUSCH transmission. For example, 8 Tx transmissions may be based on multiple antenna groups. The port number in each antenna group may be the same or may be different. The group number may be larger than 2 in some aspects. The TPMI and RI indications may be based on the active antenna groups.

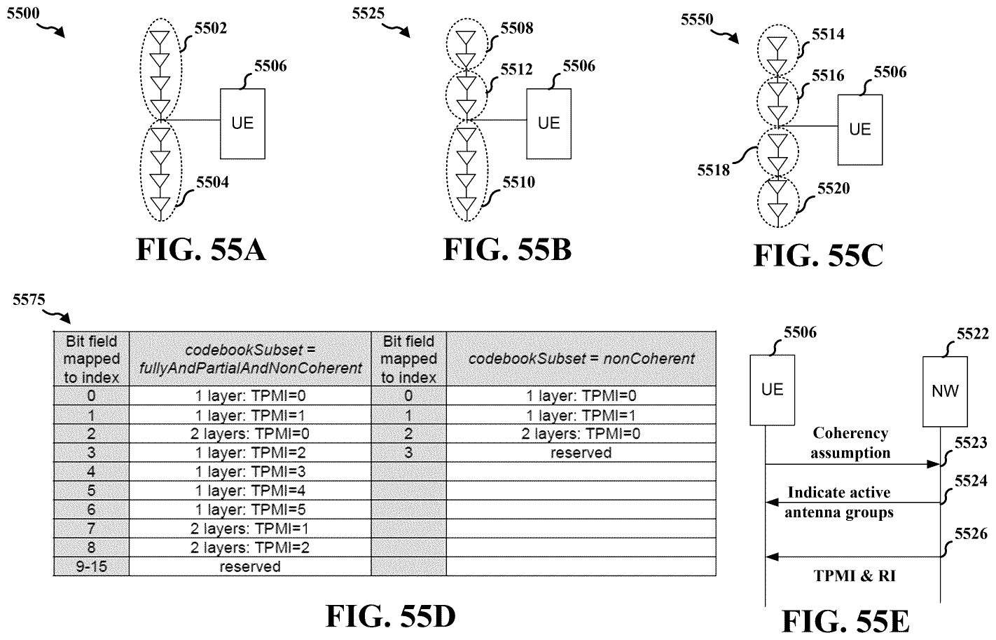

Multiple layers of an UL MIMO transmission may be transmitted with multiple subsets of coherent Tx. As an example, 8Tx may be based on two Tx subsets, e.g., a combination of 4Tx+4Tx. For example, 4Tx+4Tx may refer to a first group of four antenna ports and a second set of four antenna ports. FIG. 55A illustrates an example grouping of 8 antenna ports for a UE 5506 into a first group of four antennas 5502 and a second group of four antennas 5504. The transmissions from antenna ports in each subset of the 8 antenna ports may be coherent, e.g., transmissions within the group of antennas 5502 may be coherent, and the transmissions within the group of antennas 5504 may be coherent. Multiple layers from rank 5 to rank 8 can be transmitted with the different combinations of antenna port groups.

For example, for a 1 layer transmission, using the 4Tx+4Tx antenna port grouping in 5500 of FIG. 55A, 1 layer may be transmitted from one antenna port group, e.g., 5502, and no layers may be transmitted from the other antenna port group, e.g., 5504. Similarly, 1 layer may be transmitted from one antenna port group, e.g., 5504, and no layers may be transmitted from the other antenna port group, e.g., 5502. This option may be represented as:
1 layer: 1 layer->4 Tx, 0 layers->4Tx

In a 2 layer example, 2 layers may be transmitted from one antenna port group with no layers transmitted from the other antenna port group, or 1 layer may be transmitted from each of the antenna port groups. This example may be represented as:
2 layer: 0 layer->4 Tx, 2 layers->4Tx; 1 layer->4 Tx, 1 layers->4Tx

In a 3 layer example, 3 layers may be transmitted from one antenna port group with no layers transmitted from the other antenna port group, or 1 layer may be transmitted from one of the antenna port groups and 2 layers may be transmitted from the other antenna port group. This example may be represented as:
3 layer: 0 layer->4 Tx, 3 layers->4Tx; 1 layer->4 Tx, 2 layers->4Tx

In a 4 layer example, 4 layers may be transmitted from one antenna port group with no layers transmitted from the other antenna port group, or 1 layer may be transmitted from one of the antenna port groups, 3 layers may be transmitted from the other antenna port group, or 2 layers may be transmitted from each antenna port group. This example may be represented as:
4 layer: 0 layer->4 Tx, 4 layers->4Tx; 1 layer->4 Tx, 3 layers->4Tx; 2 layer->4 Tx, 2 layers->4Tx

In a 5 layer example, 1 layer may be transmitted from one of the antenna port groups and 4 layers may be transmitted from the other antenna port group, or 2 layers may be transmitted from one antenna port group and 3 may be transmitted from the other antenna port group. This example may be represented as:
5 layer: 1 layer->4 Tx, 4 layers->4Tx; 2 layer->4 Tx, 3 layers->4Tx

In a 6 layer example, 2 layers may be transmitted from one of the antenna port groups and 4 layers may be transmitted from the other antenna port group, or 3 layers may be transmitted from each of the antenna port groups. This example may be represented as:
6 layer: 2 layer->4 Tx, 4 layers->4Tx; 3 layer->4 Tx, 3 layers->4Tx

In a 7 layer example, 3 layers may be transmitted from one antenna port group and 4 layers may be transmitted from the other antenna port group. This example may be represented as:
7 layer: 3 layer->4 Tx, 4 layers->4Tx

In an 8 layer example, 4 layers may be transmitted from one antenna port group and 4 layers may be transmitted from the other antenna port group. This example may be represented as:
8 layer: 4 layer->4 Tx, 4 layers->4Tx

FIG. 55B illustrates another example of antenna port grouping 5525 for a device with 8 antenna ports in which a first group of antenna ports 5508 has two antenna ports, a second group of antenna ports, e.g., 5512, has two antenna ports, and a third group of antenna ports, e.g., 5510, has four antenna ports. Similar to the example in FIG. 55A, multiple layers can be transmitted with multiple subsets of coherent Tx. However, in FIG. 55B, the 8Tx includes three Tx subsets, 2Tx+2Tx+4Tx. In each subset of antenna ports, the transmissions are coherent. Multiple layers from rank 5 to rank 8 can be transmitted with various possible combinations of layers from the different antenna groups.

A 1 layer transmission may be transmitted without layers being transmitted from one of the two antenna groups, e.g., 5508 and 5512, and the 1 layer being transmitted from the four antenna group, e.g., 5510. Alternatively, the 1 layer may be transmitted from one of the two antenna groups, e.g., 5508 or 5512, and not from the four antenna group. This example may be represented as:
1 layer: 0 layer->2 Tx, 0 layers->2Tx, 1 layers->4Tx; 0 layer->2 Tx, 1 layers->2Tx, 0 layers->4Tx

A 2 layer transmission may be transmitted without layers being transmitted from one of the two antenna groups, e.g., 5508 and 5512, and 2 layers being transmitted from the four antenna group, e.g., 5510. Alternatively, the 1 layer may be transmitted from one of the two antenna groups, e.g., 5508 or 5512, and 1 layer may be transmitted from the four antenna group. Alternatively, 1 layer may be transmitted from each of the two antenna groups, e.g., 5508 or 5512, and without layers being transmitted from the four antenna group, e.g., 5510. This example may be represented as:
2 layer: 0 layer->2 Tx, 0 layers->2Tx, 2 layers->4Tx; 0 layer->2 Tx, 1 layers->2Tx, 1 layers->4Tx; 1 layer->2 Tx, 1 layers->2Tx, 0 layers->4Tx

A 3 layer transmission may be transmitted without layers being transmitted from one of the two antenna groups, e.g., 5508 and 5512, and 3 layers being transmitted from the four antenna group, e.g., 5510. Alternatively, the 1 layer may be transmitted from one of the two antenna groups, e.g., 5508 or 5512, and 2 layers may be transmitted from the four antenna group. Alternatively, 1 layer may be transmitted from each of the antenna groups, e.g., 5508, 5512, and 5510. This example may be represented as:
3 layer: 0 layer->2 Tx, 0 layers->2Tx, 3 layers->4Tx; 0 layer->2 Tx, 1 layers->2Tx, 2 layers->4Tx; 1 layer->2 Tx, 1 layers->2Tx, 1 layers->4Tx

A 4 layer transmission may be transmitted without layers being transmitted from one of the two antenna groups, e.g., 5508 and 5512, and 4 layers being transmitted from the four antenna group, e.g., 5510. Alternatively, the 1 layer may be transmitted from one of the two antenna groups, e.g., 5508 or 5512, and 3 layers may be transmitted from the four antenna group. Alternatively, 1 layer may be transmitted from each of the two antenna groups, e.g., 5508 and 5512, and 2 layers may be transmitted from the four antenna group 5510. This example may be represented as:
4 layer: 0 layer->2 Tx, 0 layers->2Tx, 4 layers->4Tx; 0 layer->2 Tx, 1 layers->2Tx, 3 layers->4Tx; 1 layer->2 Tx, 1 layers->2Tx, 2 layers->4Tx

A 5 layer transmission may be transmitted with 1 layer being transmitted from one of the two antenna groups, e.g., 5508 or 5512, and 4 layers being transmitted from the four antenna group, e.g., 5510. Alternatively, the 1 layer may be transmitted from each one of the two antenna groups, e.g., 5508 and 5512, and 3 layers may be transmitted from the four antenna group 5510. Alternatively, 1 layer may be transmitted from one the two antenna groups, e.g., 5508, 2 layers may be transmitted from the other two antenna group, e.g., 5512, and 2 layers may be transmitted from the four antenna group 5510. This example may be represented as:
5 layer: 0 layer->2 Tx, 1 layers->2Tx, 4 layers->4Tx; 1 layer->2 Tx, 1 layers->2Tx, 3 layers->4Tx; 1 layer->2 Tx, 2 layers->2Tx, 2 layers->4Tx

A 6 layer transmission may be transmitted with 2 layers being transmitted from one of the two antenna groups, e.g., 5508 or 5512, and 4 layers being transmitted from the four antenna group, e.g., 5510. Alternatively, the 1 layer may be transmitted from each one of the two antenna groups, e.g., 5508 and 5512, and 4 layers may be transmitted from the four antenna group 5510. Alternatively, 2 layers may be transmitted from each of the two antenna groups, e.g., 5508 and 5512, and 2 layers may be transmitted from the four antenna group 5510. This example may be represented as:
6 layer: 0 layer->2 Tx, 2 layers->2Tx, 4 layers->4Tx; 1 layer->2 Tx, 1 layer->2Tx, 4 layers->4Tx; 2 layer->2 Tx, 2 layers->2Tx,2 layers->4Tx

A 7 layer transmission may be transmitted with 1 layer transmitted from one of the two antenna groups, e.g., 5508, 2 layers transmitted from the other two antenna group 5512, and 4 layers may be transmitted from the four antenna group 5510. This example may be represented as:
7 layer: 1 layer->2 Tx, 2 layers->2Tx, 4 layers->4Tx

An 8 layer transmission may be transmitted with 2 layer transmitted from each of the two antenna groups, e.g., 5508 and 5512, and 4 layers transmitted from the four antenna group 5510. This example may be represented as:
8 layer: 2 layers->2 Tx, 2 layers->2Tx, 4 layers->4Tx

FIG. 55C illustrates another example of antenna port grouping 5550 for a device with 8 antenna ports into four groups of two antenna ports, e.g., 5514, 5516, 5518, and 5520. Similar to the example in FIGS. 55A and 55B, multiple layers can be transmitted with multiple subsets of coherent Tx. The 8Tx may include three Tx subsets, 2Tx+2Tx+2Tx+2Tx. In each subset of antenna ports, the transmissions are coherent. Multiple layers from rank 5 to rank 8 can be transmitted with various possible combinations of layers from the different antenna groups.

A 1 layer transmission may be transmitted with the 1 layer transmitted from one of the four antenna groups. This example may be represented as: 1 layer: 0 layer->2 Tx, 0 layers->2Tx, 0 layers->2Tx, 1 layers->2Tx

A 2 layer transmission may be transmitted with 2 layers transmitted from one of the four antenna groups, or with 1 layer transmitted from a first group and 1 layer transmitted from a second group. This example may be represented as:
2 layer: 0 layer->2 Tx, 0 layers->2Tx, 1 layers->2Tx, 1 layers->2Tx

A 3 layer transmission may be transmitted with 1 layer transmitted from a first group, 1 layer transmitted from a second group, and 1 layer transmitted from a third group. This example may be represented as:
3 layer: 0 layer->2 Tx, 1 layers->2Tx, 1 layers->2Tx, 1 layers->2Tx

A 4 layer transmission may be transmitted with 1 layer transmitted from each of the antenna groups. This example may be represented as:
4 layer: 1 layer->2 Tx, 1 layers->2Tx, 1 layers->2Tx, 1 layers->2Tx;

A 5 layer transmission may be transmitted with 1 layer transmitted from a first group, 2 layers transmitted from a second group, and 2 layers transmitted from a third group. Alternately, the 5 layer transmission may be transmitted with 1 layer from a first, second, and third group and 2 layers transmitted from a fourth group. This example may be represented as:
5 layer: 0 layer->2 Tx, 1 layers->2Tx, 2 layers->2Tx, 2 layers->2Tx; 1 layer->2 Tx, 1 layers->2Tx, 1 layers->2Tx, 2 layers->2Tx

A 6 layer transmission may be transmitted with 2 layer transmitted from a first group, 2 layers transmitted from a second group, and 2 layers transmitted from a third group. Alternately, the 5 layer transmission may be transmitted with 1 layer from a first group, 1 layer from a second, 2 layers from a third group and 2 layers transmitted from a fourth group. This example may be represented as:
6 layer: 0 layer->2 Tx, 2 layers->2Tx, 2 layers->2Tx, 2 layers->2Tx; 1 layer->2 Tx, 1 layers->2Tx, 2 layers->2Tx, 2 layers->2Tx

A 7 layer transmission may be transmitted with 1 layer transmitted from a first group, 2 layers transmitted from a second group, and 2 layers transmitted from a third group, and 2 layers from a fourth group. This example may be represented as:
7 layer: 1 layer->2 Tx, 2 layers->2Tx, 2 layers->2Tx, 2 layers->2Tx;

An 8 layer transmission may be transmitted with 2 layer transmitted from a first group, 2 layers transmitted from a second group, and 2 layers transmitted from a third group, and 2 layers from a fourth group. This example may be represented as:
8 layer: 2 layer->2 Tx, 2 layers->2Tx, 2 layers->2Tx, 2 layers->2Tx;

In some aspects, multiple layers can be transmitted with multiple subsets of coherent transmissions. In some aspects, an 8Tx may include mixed partial-coherent and non-coherent transmissions. For example, 8Tx=1Tx+1Tx+2Tx+4Tx. Multiple layers from rank 5 to rank 8 can be transmitted using various combinations of antenna groups.

A 1 layer transmission may be transmitted with the 1 layer transmitted from one of the two antenna port groups. This example may be represented as:
1 layer: 0 layer->2 Tx, 0 layers->2Tx, 0 layers->2Tx, 1 layers->2Tx; 0 layer->2 Tx, 0 layers->2Tx, 1 layers->2Tx, 0 layers->2Tx; 0 layer->2 Tx, 1 layers->2Tx, 0 layers->2Tx, 0 layers->2Tx;

A 2 layer transmission may be transmitted with the 2 layers transmitted from one of the two antenna port groups. This example may be represented as:
2 layer: 0 layer->2 Tx, 0 layers->2Tx, 0 layers->2Tx, 2 layers->2Tx;

A 3 layer transmission may be transmitted with 1 layer transmitted from one of the two antenna port groups and 2 layers transmitted from another one of the two antenna port groups. This example may be represented as:
3 layer: 0 layer->2 Tx, 0 layers->2Tx, 1 layers->2Tx, 2 layers->2Tx;

A 4 layer transmission may be transmitted with 1 layer transmitted from a first two antenna port groups, 1 layer transmitted from a second two antenna port group, and 2 layers transmitted from a third two antenna port group. This example may be represented as:
4 layer: 0 layer->2 Tx, 1 layers->2Tx, 1 layers->2Tx, 2 layers->2Tx

A 5 layer transmission may be transmitted with 1 layer transmitted from a two antenna port and four layer from another antenna port group. Alternatively, 2 layers may be transmitted from a two antenna port group, and three layers may be transmitted from a four antenna port group. Alternately, 1 layer may be transmitted from a first two antenna port group, 1 layer may be transmitted from a second antenna port group, and 3 layers may be transmitted from a third antenna port group. Alternately, the 5 layer transmission may be transmitted with 1 layer transmitted from a first two antenna port groups, 1 layer transmitted from a second two antenna port group, 1 layer transmitted from a third two antenna port, and 2 layers transmitted from the fourth two antenna port group. This example may be represented as:
5 layer: 0 layer->2 Tx, 0 layers->2Tx, 1 layers->2Tx, 4 layers->2Tx; 0 layer->2 Tx, 0 layers->2Tx, 2 layers->2Tx, 3 layers->2Tx; 0 layer->2 Tx, 1 layers->2Tx, 1 layers->2Tx, 3 layers->2Tx; 0 layer->2 Tx, 1 layers->2Tx, 2 layers->2Tx, 2 layers->2Tx; 1 layer->2 Tx, 1 layers->2Tx, 1 layers->2Tx, 2 layers->2Tx;

A 6 layer transmission may be transmitted with 2 layers transmitted from a two antenna port and four layers from another antenna port group. Alternately, 1 layer may be transmitted from a first two antenna port group, 1 layer may be transmitted from a second antenna port group, and 4 layers may be transmitted from a third antenna port group. Alternatively, 1 layer may be transmitted from a first two antenna port group, 2 layers may be transmitted from a second antenna port group, and 3 layers may be transmitted from a third antenna port group. Alternately, the 5 layer transmission may be transmitted with 1 layer transmitted from a first two antenna port groups, 1 layer transmitted from a second two antenna port group, 1 layer transmitted from a third two antenna port, and 3 layers transmitted from the fourth two antenna port group. Alternately, the 5 layer transmission may be transmitted with 1 layer transmitted from a first two antenna port groups, 1 layer transmitted from a second two antenna port group, 2 layers transmitted from a third two antenna port, and 2 layers transmitted from the fourth two antenna port group. This example may be represented as:
6 layer: 0 layer->2 Tx, 0 layers->2Tx, 2 layers->2Tx, 4 layers->2Tx; 0 layer->2 Tx, 1 layers->2Tx, 1 layers->2Tx, 4 layers->2Tx; 0 layer->2 Tx, 1 layers->2Tx, 2 layers->2Tx, 3 layers->2Tx; 1 layer->2 Tx, 1 layers->2Tx, 1 layers->2Tx, 3 layers->2Tx; 1 layer->2 Tx, 1 layers->2Tx, 2 layers->2Tx, 2 layers->2Tx;

As an example, a 7 layer transmission may be transmitted with 1 layer transmitted from a first two antenna port groups, 1 layer transmitted from a second two antenna port group, 4 layer transmitted from a third two antenna port. Alternately, 1 layer may be transmitted from a two antenna port group, 1 layer may be transmitted from a second two antenna port group, 2 layers may be transmitted from a third two antenna port group, and 3 layers may be transmitted from a fourth two antenna port group. This example may be represented as:
7 layer: 0 layer->2 Tx, 1 layers->2Tx, 2 layers->2Tx, 4 layers->2Tx; 1 layer->2 Tx, 1 layers->2Tx, 2 layers->2Tx, 3 layers->2Tx;

As an example, an 8 layer transmission may be transmitted with 1 layer transmitted from a first two antenna port group, 1 layer transmitted from a second two antenna port group, 2 layers transmitted from a third two antenna port group, and 4 layers transmitted from a fourth 2 antenna port group. Alternately, 1 layer may be transmitted from a two antenna port group, 1 layer may be transmitted from a second two antenna port group, 2 layers may be transmitted from a third two antenna port group, and 3 layers may be transmitted from a fourth two antenna port group. This example may be represented as:
8 layer: 1 layer->2 Tx, 1 layers->2Tx, 2 layers->2Tx, 4 layers->2Tx;

In some aspects, a UE may receive a two stage indication for TPMI and RI with multiple coherent antenna subsets. FIG. 55E illustrates an example communication flow between a UE 5506 and a network node 5522 such as a base station. As a first stage, the network may indicate which antenna groups are active, at 5524. A field size of the indication may be equal to the number of antenna groups. After indicating the active antenna groups, the network may transmit a TPMI and RI for each of the active antenna groups, at 5526. The network may skip providing the UE with TPMI or RI indications for inactive antenna groups.

For example, for the grouping option shown in FIG. 55C, e.g., 8Tx=2 Tx+2 Tx+4Tx, for a total rank of 5, and 0 layer->2 Tx, 2 layers->2Tx, 3 layers->2Tx configuration, for the first stage, e.g., at 5524, the network may use 3 bits to indicate the antenna group activity. As an example, “0 1 1” indicates the last two antenna groups are active and the first antenna group is inactive. Then, at the second stage, 3 bits may indicate the TPMI and RI for the second antenna group and 6 bits may indicate the TPMI and RI for the third antenna group. FIG. 55D illustrates an example table 5575 showing example bit field mappings for a 2 port TPMI. The following table illustrates shows example bit fields for a 4 port TPMI.

| | Codebook = | | Codebook | | Codebook |
|---|---|---|---|---|---|
| Bit field maps | FC and | Bit field maps | subset = | Bit field maps | subset = |
| to index | PC and NC | to index | PC and NC | to index | NC |
| 0 | 1 layer: TPMI = 0 | 0 | 1 layer: TPMI = 0 | 0 | 1 layer: TPMI = 0 |
| 1 | 1 layer: TPMI = 1 | 1 | 1 layer: TPMI = 1 | 1 | 1 layer: TPMI = 1 |
| . . . | . . . | . . . | . . . | . . . | . . . |
| 3 | 1 layer: TPMI = 3 | 3 | 1 layer: TPMI = 3 | 3 | 1 layer: TPMI = 3 |
| 4 | 2 layers: TPMI = 0 | 4 | 2 layers: TPMI = 0 | 4 | 2 layers: TPMI = 0 |
| . . . | . . . | . . . | . . . | . . . | . . . |
| 9 | 2 layers: TPMI = 5 | 9 | 2 layers: TPMI = 5 | 9 | 2 layers: TPMI = 5 |
| 10 | 3 layers TPMI = 0 | 10 | 3 layers TPMI = 0 | 10 | 3 layers TPMI = 0 |
| 11 | 4 layers TPMI = 0 | 11 | 4 layers TPMI = 0 | 11 | 4 layers TPMI = 0 |
| 12 | 1 layer TPMI = 4 | 12 | 1 layer TPMI = 4 | 12-15 | reserved |
| . . . | . . . | . . . | . . . | . . . | . . . |
| 19 | 1 layer TPMI = 11 | 19 | 1 layer TPMI = 11 | | |
| 20 | 2 layers: TPMI = 6 | 20 | 2 layers: TPMI = 6 | | |
| . . . | . . . | . . . | . . . | | |
| 27 | 2 layers: TPMI = 13 | 27 | 2 layers: TPMI = 13 | | |
| 28 | 3 layers: TPMI = 1 | 28 | 3 layers: TPMI = 1 | | |
| 29 | 3 layers: TPMI = 2 | 29 | 3 layers: TPMI = 2 | | |
| 30 | 4 layers: TPMI = 1 | 30 | 4 layers: TPMI = 1 | | |
| 31 | 4 layers: TPMI = 2 | 31 | 4 layers: TPMI = 2 | | |
| 32 | 1 layer TPMI = 12 | | | | |
| . . . | . . . | | | | |
| 47 | 1 layer TPMI = 27 | | | | |
| 48 | 2 layers: TPMI = 14 | | | | |
| . . . | . . . | | | | |
| 55 | 2 layers: TPMI = 21 | | | | |
| 56 | 3 layers: TPMI = 3 | | | | |
| . . . | . . . | | | | |
| 59 | 3 layers: TPMI = 6 | | | | |
| 60 | 4 layers: TPMI = 3 | | | | |
| 61 | 4 layers: TPMI = 4 | | | | |
| 62-63 | reserved | | | | |

In some aspects, in order to reduce the TPMI overhead, the bit width for the precoding information and number of layers fields can be reduced. For example, the precoding information and number of layers fields for 8Tx may have a reduced bit width relative to such fields for 4Tx. As an example, TPMI may be included that corresponds to the antenna ports, e.g., Tx ports, in the subset of coherent transmission ports.

In some aspects, the precoders for each antenna group can reuse the 2 port precoder or a 4 port precoder or a subset of codebooks for 2Tx or 4Tx rather than having independent precoders for 8T. The precoders in each antenna group may be scaled by a factor such as

$$\frac{1}{\sqrt{\frac{8}{{N}_{G}}}} ,$$

where N_{G} is the port number in the antenna group.

For example, for the grouping option in FIG. 55C, e.g., 8Tx=2 Tx+2 Tx+4Tx, the scaling factor that would be applied for transmissions the first group of two antenna ports 5508 and the second group of two antenna ports, e.g., 5512, would be ½, (e.g., 8/N_{G} being 4) and the scaling factor for the four antenna port group, e.g., 5510, would be

$$\frac{1}{\sqrt{2}} .$$

An example precoder for the two antenna port group, e.g., 5508, may be

$$\frac{1}{2} \{ \frac{1}{\sqrt{2}} [ \begin{matrix}1 \\ 1\end{matrix} ] \} .$$

An example precoder for the four antenna port group, e.g., 5510, may be

$$\frac{1}{\sqrt{2}} \{ \frac{1}{2} [ \begin{matrix}1 \\ 1 \\ 1 \\ 1\end{matrix} ] \} .$$

In some aspects, the UE may indicate a coherency assumption to the network. For example, in FIG. 55E, the UE 5506 may transmit an indication of a coherency assumption at 5523. In some aspects, the UE may indicate the coherency assumption in a report of the UE capability, e.g., the UE may indicate that it supports a coherency assumption capability.

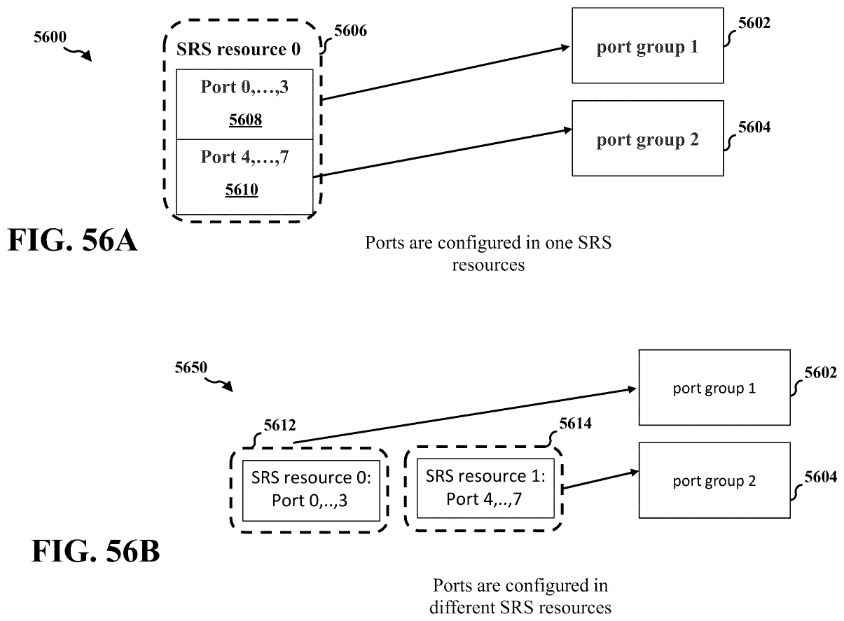

In some aspects, an SRS configuration for UL codebook-based PUSCH transmission may be based on antenna port groups. In some aspects, the ports from different antenna group can be configured in one SRS resource, and each port may be distinguished with a different cyclic shift and a different comb index. FIG. 56A illustrates a diagram 5600 of an SRS resource 5606 that is configured for antenna ports 5608 from antenna port group 1 5602 and is also configured for antenna ports 5610 from antenna port group 2 5604. In some aspects, the ports from different antenna group can be configured with different SRS resources separately. FIG. 56B illustrates a diagram 5650 of SRS resource 5612 that is separately configured for antenna ports from antenna port group 1 5602 and SRS resource 5614 that is configured for antenna ports from antenna port group 2 5604. This may enable a larger transmission power for each antenna port in comparison to the ports from different antenna groups being configured in one SRS resource.

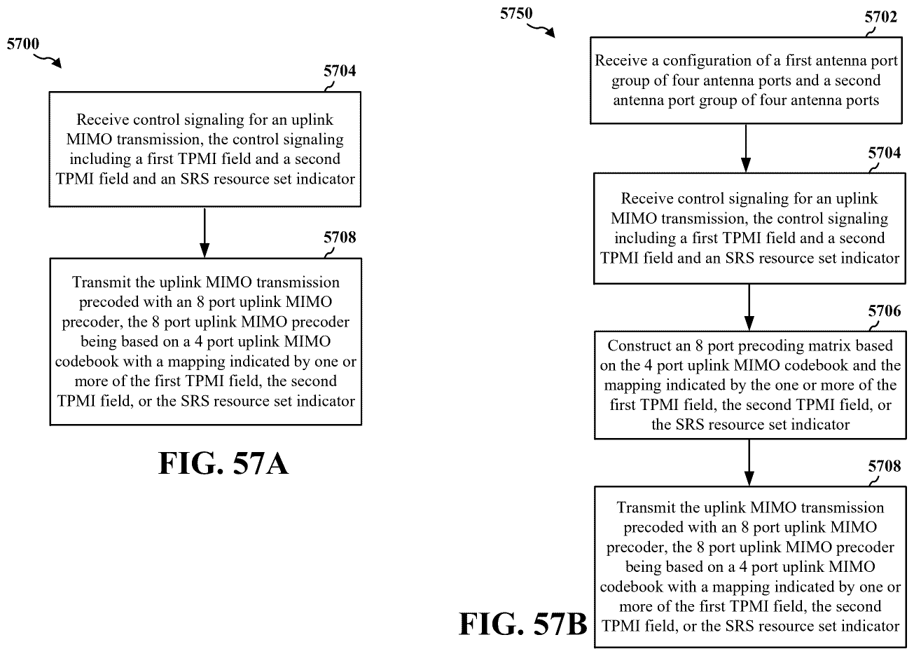

FIG. 57A is a flowchart 5700 of a method of wireless communication. The method may be performed by a UE (e.g., the UE 104, 350; the apparatus 5904). The method may enable the UE to transmit UL MIMO transmissions using various precoding options for 8Tx.

At 5704, the UE receives control signaling for an uplink MIMO transmission, the control signaling including a first TPMI field and a second TPMI field and an SRS resource set indicator. The reception may be performed, e.g., by the codebook handling component 198, the transceiver 5922 and/or the antenna 5980. The codebook handling component 198 may be a component of the UE 104, 350, or the apparatus 5904.

At 5708, the UE transmits the uplink MIMO transmission precoded with an 8 port uplink MIMO precoder, the 8 port uplink MIMO precoder being based on a 4 port uplink MIMO codebook with a mapping indicated by one or more of the first TPMI field, the second TPMI field, or the SRS resource set indicator. The transmission may be performed, e.g., by the codebook handling component 198, the transceiver 5922 and/or the antenna 5980. The codebook handling component 198 may be a component of the UE 104, 350, or the apparatus 5904. The transmission may be precoded based on any of the aspects described in connection with FIGS. 4-62.

FIG. 57B is a flowchart 5750 of a method of wireless communication. The method may be performed by a UE (e.g., the UE 104, 350; the apparatus 5904). The method may enable the UE to transmit UL MIMO transmissions using various precoding options for 8Tx.

At 5704, the UE receives control signaling for an uplink MIMO transmission, the control signaling including a first TPMI field and a second TPMI field and an SRS resource set indicator. The reception may be performed, e.g., by the codebook handling component 198, the transceiver 5922 and/or the antenna 5980. The codebook handling component 198 may be a component of the UE 104, 350, or the apparatus 5904.

At 5708, the UE transmits the uplink MIMO transmission precoded with an 8 port uplink MIMO precoder, the 8 port uplink MIMO precoder being based on a 4 port uplink MIMO codebook with a mapping indicated by one or more of the first TPMI field, the second TPMI field, or the SRS resource set indicator. The transmission may be performed, e.g., by the codebook handling component 198, the transceiver 5922 and/or the antenna 5980. The codebook handling component 198 may be a component of the UE 104, 350, or the apparatus 5904. The transmission may be precoded based on any of the aspects described in connection with FIGS. 4-62.

In some aspects, at 5706, the UE may construct an 8 port precoding matrix based on the 4 port uplink MIMO codebook and the mapping indicated by the one or more of the first TPMI field, the second TPMI field, or the SRS resource set indicator. The construction may be performed, e.g., by the codebook handling component 198. The codebook handling component 198 may be a component of the UE 104, 350, or the apparatus 5904.

The SRS resource set indicator may indicate a precoding matrix type, and the mapping from the 4 port uplink MIMO codebook to the 8 port precoding matrix may be indicated by a combination of the SRS resource set indicator, the first TPMI field, and the second TPMI field. The first TPMI field may indicate a first rank and a first precoding matrix indication, and the second TPMI field may indicate a second precoding matrix indication, a second rank being based on the first rank indicated in the first TPMI field and the precoding matrix type indicated by the SRS resource set indicator. In some aspects, the control signaling may further include a first SRI indicating a first SRS resource associated with the first TPMI field, and a second SRI indicating a second SRS resource associated with the second TPMI field.

In some aspects, the control signaling may further include a first SRI and a second SRI, and the mapping from the 4 port uplink MIMO codebook to the 8 port precoding matrix is indicated by a combination of the SRS resource set indicator, the first TPMI field, the second TPMI field, and the second SRI. The first SRI may indicate SRS resources, and the second SRI indicates a precoding matrix type. In some aspects, the precoding matrix type may be indicated jointly by the second SRI and the SRS resource set indicator. In some aspects, the first TPMI field indicates a first rank and a first precoding matrix indication, and the second TPMI field indicates a second precoding matrix indication, a second rank being based on the first rank indicated in the first TPMI field, the SRS resource set indicator, and the second SRI.

In some aspects, the control signaling may further include at least one SRI and the SRS resource set indicator at least partially indicates a precoding matrix type, and the mapping from the 4 port uplink MIMO codebook to the 8 port precoding matrix being indicated by at least a combination of the SRS resource set indicator, the first TPMI field, and the second TPMI field. The first TPMI field and the second TPMI field may independently indicate a first precoding matrix and a second precoding matrix. The first TPMI field may indicate a first rank and the first precoding matrix, and the second TPMI field indicates a second rank and the second precoding matrix. The SRS resource set indicator may indicate the precoding matrix type independent of a second SRI. The SRS resource set indicator may indicate the precoding matrix type jointly with a second SRI, and a first SRI indicates resources associated with the first precoding matrix and the second precoding matrix.

As illustrated at 5702, in some aspects, the UE may receive a configuration of a first antenna port group of four antenna ports and a second antenna port group of four antenna ports, wherein a first precoding matrix indicated by the first TPMI field is applied to the first antenna port group and a second precoding matrix indicated by the second TPMI field is applied to the second antenna port group. The reception may be performed, e.g., by the codebook handling component 198, the transceiver 5922 and/or the antenna 5980. The codebook handling component 198 may be a component of the UE 104, 350, or the apparatus 5904. The control signaling may include a precoding matrix type indicator, at least one SRI that indicates SRS resources for the first precoding matrix and the second precoding matrix, and the mapping from the 4 port uplink MIMO codebook to the 8 port precoding matrix being indicated by at least the precoding matrix type indicator, the first TPMI field, and the second TPMI field. In some aspects, the control signaling may further includes an additional bit that indicates the precoding matrix type in combination with the precoding matrix type indicator, and the mapping from the 4 port uplink MIMO codebook to the 8 port precoding matrix is further based on the additional bit. In some aspects the first antenna port group and the second antenna port group are indicated to the UE in a permutation matrix.

In some aspects, the control signaling may further include codebook subset indicator comprising at least one additional bit and indicating a subset from a set of codebook subsets including fully coherent transmission, partially coherent transmission, or non-coherent transmission. A first value of the codebook subset indicator may correspond to the partially coherent transmission or the non-coherent transmission and indicates an 8 port uplink MIMO codebook that is constructed based on the 4 port uplink MIMO codebook, and a second value of the codebook subset indicator may correspond to the fully coherent transmission using a precoding matrix that is not based on the 4 port uplink MIMO codebook and which is indicated jointly by the first TPMI field and the second TPMI field.

In some aspects, the control signaling may further include a first SRS resource indicator (SRI) that indicates an SRS resource and a second SRI that indicates a subset from a set of codebook subsets including fully coherent transmission, partially coherent transmission, or non-coherent transmission. In some aspects, a first value of the second SRI corresponds to the partially coherent transmission or the non-coherent transmission and indicates an 8 port uplink MIMO codebook that is constructed based on the 4 port uplink MIMO codebook, and a second value of the second SRI corresponds to the fully coherent transmission using a precoding matrix that has full non-zero entries and which is indicated jointly by the first TPMI field and the second TPMI field.

In some aspects, the SRS resource set indicator indicates the subset from the set of codebook subsets including fully coherent transmission, partially coherent transmission, or non-coherent transmission. In some aspects, a first three values of the SRS resource set indicator corresponds to the partially coherent transmission or the non-coherent transmission and indicates an 8 port uplink MIMO codebook that is constructed based on the 4 port uplink MIMO codebook, and a forth value of the SRS resource set indicator corresponds to the fully coherent transmission using a precoding matrix that has full non-zero entries and which is indicated jointly by the first TPMI field and the second TPMI field.

In some aspects, the 8 port uplink MIMO precoder of rank 1 is based on a rank 1 precoding matrix and a configuration of a first antenna port group of four antenna ports and a second antenna port group of four antenna ports, wherein the 8 port uplink MIMO precoder is indicated by one of: a single bit port group indicator and a single TPMI field having four states that indicate a non-coherent precoder, the single bit port group indicator and a single TPMI field having eight states that indicate a two antenna partial coherent precoder (PC-2), or the single bit port group indicator and a single TPMI field having sixteen states that indicate a four antenna partial coherent precoder (PC-4).

In some aspects, the 8 port uplink MIMO precoder of rank 2 that applies a rank 2 precoding matrix to a first antenna port group of four antenna ports or a second antenna port group of four antenna ports, wherein the 8 port uplink MIMO precoder is indicated by one of: a single bit port group indicator and a single TPMI field having six states that indicate a non-coherent precoder, or the single bit port group indicator and a single TPMI field having eight states for a two antenna partial coherent precoder (PC-2) or a four antenna partial coherent precoder (PC-4).

In some aspects, the 8 port uplink MIMO precoder of rank 2 is based on a first rank 1 precoding matrix applied to a first antenna port group of four antenna ports and a second rank 1 precoding matrix applied to a second antenna port group of four antenna ports, wherein the 8 port uplink MIMO precoder is indicated by one of: the first TPMI field and the second TPMI field, each TPMI field having four states that indicate a non-coherent precoder, the first TPMI field and the second TPMI field, each TPMI field having eight states that indicate a two antenna partial coherent precoder (PC-2), the first TPMI field and the second TPMI field, each TPMI field having sixteen states that indicate a four antenna partial coherent precoder (PC-4), or a single TPMI field in connection with use of a same precoder for both the first antenna port group and the second antenna port group.

In some aspects, the 8 port uplink MIMO precoder of rank 2 and a configuration of a first antenna port group of four antenna ports and a second antenna port group of four antenna ports, wherein the 8 port uplink MIMO precoder is indicated by one of: a two bit port group indicator and a single TPMI field having six states that indicate a non-coherent precoder based on a single rank 2 precoding matrix applied to the first antenna port group or the second antenna port group, the two bit port group indicator and a single TPMI field having eight states for a two antenna partial coherent precoder (PC-2) or a four antenna partial coherent precoder (PC-4) based on a single rank 2 precoding matrix applied to the first antenna port group or the second antenna port group, the two bit port group indicator, the first TPMI field, and the second TPMI field, each TPMI field having four states that indicate a non-coherent precoder based on two rank 1 precoding matrices applied to the first antenna port group or the second antenna port group, two bit port group indicator, the first TPMI field, and the second TPMI field, each TPMI field having eight states that indicate a two antenna partial coherent precoder (PC-2) based on two rank 1 precoding matrices applied to the first antenna port group or the second antenna port group, or two bit port group indicator, the first TPMI field, and the second TPMI field, each TPMI field having sixteen states that indicate a four antenna partial coherent precoder (PC-4) based on two rank 1 precoding matrices applied to the first antenna port group or the second antenna port group.

In some aspects, the 8 port uplink MIMO precoder of rank 2, wherein a rank 2 precoder is applied to either a first antenna port group or a second antenna port group or a same rank 1 precoder is applied to both the first antenna port group and the second antenna port group, the 8 port uplink MIMO precoder being indicated by one of: a two bit port group indicator and a single TPMI field having 6 states that indicate a non-coherent precoder based on the rank 2 precoder that is applied to either the first antenna port group or the second antenna port group, the two bit port group indicator and a single TPMI field having 8 states for a two antenna partial coherent precoder (PC-2) or a four antenna partial coherent precoder (PC-4) that applies a single rank 2 precoder to either the first antenna port group or the second antenna port group, the two bit port group indicator and a single TPMI field having 8 states that indicate a non-coherent precoder states for a two antenna partial coherent precoder (PC-2) in which the same rank 1 precoder is applied to both the first antenna port group and the second antenna port group, the two bit port group indicator and a single TPMI field having 8 states for a two antenna partial coherent precoder (PC-2) in which the same rank 1 precoder is applied to both the first antenna port group and the second antenna port group, or the two bit port group indicator and a single TPMI field having sixteen states that indicate a four antenna partial coherent precoder (PC-4) in which the same rank 1 precoder is applied to both the first antenna port group and the second antenna port group.

In some aspects, the 8 port uplink MIMO precoder of rank 3 and a configuration of a first antenna port group of four antenna ports and a second antenna port group of four antenna ports, wherein the 8 port uplink MIMO precoder being indicated by one of: a single bit port group indicator and a single TPMI field having a single state that indicates a non-coherent precoder that applies a single rank 3 precoding matrix to the first antenna port group or the second antenna port group, the single bit port group indicator and a single TPMI field having two states for a two antenna partial coherent precoder (PC-2) that applies the single rank 3 precoding matrix to the first antenna port group or the second antenna port group, the single bit port group indicator and a single TPMI field having four states for a four antenna partial coherent precoder (PC-4) that applies the single rank 3 precoding matrix to the first antenna port group or the second antenna port group, the first TPMI field having six states and the second TPMI field having four states that indicate a non-coherent precoder that applies a rank 2 precoding matrix to the first antenna port group and a rank 1 precoding matrix to the second antenna port group, the first TPMI field having eight states and the second TPMI field having 8 states that indicate a two antenna partial coherent precoder (PC-2) that applies a rank 2 precoding matrix to the first antenna port group and a rank 1 precoding matrix to the second antenna port group, the first TPMI field having eight states, and the second TPMI field having sixteen states that indicate a four antenna partial coherent precoder (PC-4) that applies a rank 2 precoding matrix to the first antenna port group and a rank 1 precoding matrix to the second antenna port group, the first TPMI field having four states and the second TPMI field having six states that indicate a non-coherent precoder that applies a rank 2 precoding matrix to the first antenna port group and a rank 1 precoding matrix to the second antenna port group, the first TPMI field having sixteen states, and the second TPMI field having eight states that indicate a four antenna partial coherent precoder (PC-4) that applies a rank 2 precoding matrix to the first antenna port group and a rank 1 precoding matrix to the second antenna port group, a two bit port group indicator and a single TPMI field having a single state that indicates a non-coherent precoder that applies the single rank 3 precoding matrix to the first antenna port group or the second antenna port group, the two bit port group indicator and a single TPMI field having two states that indicate a two antenna partial coherent precoder (PC-2) that applies the single rank 3 precoding matrix to the first antenna port group or the second antenna port group, the two bit port group indicator and a single TPMI field having four states that indicate a four antenna partial coherent precoder (PC-4) that applies the single rank 3 precoding matrix to the first antenna port group or the second antenna port group, the two bit port group indicator, the first TPMI field having six states and the second TPMI field having four states that indicate a non-coherent precoder that applies a rank 2 precoding matrix to the first antenna port group and a rank 1 precoding matrix to the second antenna port group, the two bit port group indicator, the first TPMI field having eight states and the second TPMI field having 8 states that indicate a two antenna partial coherent precoder (PC-2) that applies a rank 2 precoding matrix to the first antenna port group and a rank 1 precoding matrix to the second antenna port group, the two bit port group indicator, the first TPMI field having eight states, and the second TPMI field having sixteen states that indicate a four antenna partial coherent precoder (PC-4) that applies a rank 2 precoding matrix to the first antenna port group and a rank 1 precoding matrix to the second antenna port group, the two bit port group indicator, the first TPMI field having four states and the second TPMI field having six states that indicate a non-coherent precoder that applies a rank 2 precoding matrix to the first antenna port group and a rank 1 precoding matrix to the second antenna port group, or the two bit port group indicator, the first TPMI field having sixteen states, and the second TPMI field having eight states that indicate a four antenna partial coherent precoder (PC-4) that applies a rank 2 precoding matrix to the first antenna port group and a rank 1 precoding matrix to the second antenna port group.

In some aspects, the 8 port uplink MIMO precoder of rank 3 and a configuration of a first antenna port group of four antenna ports and a second antenna port group of four antenna ports, with a relationship between a precoding matrix applied to the first antenna port group and the precoding matrix applied to the second antenna port group, wherein the 8 port uplink MIMO precoder is indicated by a two bit port group indicator and one of: a single TPMI field having a single state that indicates a non-coherent precoder that applies a rank 3 precoding matrix to the first antenna port group or the second antenna port group, a single TPMI field having two states that indicate a two antenna partial coherent precoder (PC-2) that applies a rank 3 precoding matrix to the first antenna port group or the second antenna port group, a single TPMI field having four states that indicate a four antenna partial coherent precoder (PC-4) that applies a rank 3 precoding matrix to the first antenna port group or the second antenna port group, a single TPMI field having six states that indicate a non-coherent precoder that applies a rank 2 precoding matrix to the first antenna port group and a rank 1 precoding matrix to the second antenna port group, or a single TPMI field having eight states that indicate a two antenna partial coherent precoder (PC-2) or a four antenna partial coherent precoder (PC-4) that applies a rank 2 precoding matrix to the first antenna port group and a rank 1 precoding matrix to the second antenna port group.

In some aspects, the 8 port uplink MIMO precoder of rank 4 and a configuration of a first antenna port group of four antenna ports and a second antenna port group of four antenna ports, wherein the 8 port uplink MIMO precoder is indicated by one of: a single bit port group indicator and a single TPMI field having a single state that indicates a non-coherent precoder that applies a rank 4 precoding matrix to the first antenna port group or the second antenna port group, the single bit port group indicator and a single TPMI field having two states for a two antenna partial coherent precoder (PC-2) that applies a rank 4 precoding matrix to the first antenna port group or the second antenna port group, the single bit port group indicator and a single TPMI field having two states for a four antenna partial coherent precoder (PC-4) that applies a rank 4 precoding matrix to the first antenna port group or the second antenna port group, the first TPMI field and the second TPMI field each having six states that indicate a non-coherent precoder that applies a first rank 2 precoding matrix to the first antenna port group and a second rank 2 precoding matrix to the second antenna port group, the first TPMI field and the second TPMI field each having 8 states that indicate a two antenna partial coherent precoder (PC-2) or a four antenna partial coherent precoder (PC-4) that applies a first rank 2 precoding matrix to the first antenna port group and a second rank 2 precoding matrix to the second antenna port group, a two bit port group indicator and a single TPMI field having a single state that indicates a non-coherent precoder that applies a rank 4 precoding matrix to the first antenna port group or the second antenna port group, the two bit port group indicator and a single TPMI field having two states that indicate a two antenna partial coherent precoder (PC-2) or a four antenna partial coherent precoder (PC-4) that applies a rank 4 precoding matrix to the first antenna port group or the second antenna port group, the two bit port group indicator, the first TPMI field and the second TPMI field, each having six states that indicate a non-coherent precoder that applies a first rank 2 precoding matrix to the first antenna port group and a second rank 2 precoding matrix to the second antenna port group, or the two bit port group indicator, the first TPMI field having eight states and the second TPMI field having 8 states that indicate a two antenna partial coherent precoder (PC-2) or a four antenna partial coherent precoder (PC-4) that applies a first rank 2 precoding matrix to the first antenna port group and a second rank 2 precoding matrix to the second antenna port group.

In some aspects, the 8 port uplink MIMO precoder of rank 4 and a configuration of a first antenna port group of four antenna ports and a second antenna port group of four antenna ports, with a relationship between a precoding matrix applied to the first antenna port group and the precoding matrix applied to the second antenna port group, wherein the 8 port uplink MIMO precoder is indicated by a two bit port group indicator and one of: a single TPMI field having a single state that indicates a non-coherent precoder that applies a rank 4 precoding matrix to the first antenna port group or the second antenna port group, a single TPMI field having two states that indicate a two antenna partial coherent precoder (PC-2) that applies a rank 4 precoding matrix to the first antenna port group or the second antenna port group, a single TPMI field having four states that indicate a four antenna partial coherent precoder (PC-4) that applies a rank 4 precoding matrix to the first antenna port group or the second antenna port group, a single TPMI field having six states that indicate a non-coherent precoder that applies a first rank 2 precoding matrix to the first antenna port group and a second rank 2 precoding matrix to the second antenna port group, or a single TPMI field having eight states that indicate a two antenna partial coherent precoder (PC-2) or a four antenna partial coherent precoder (PC-4) that applies a first rank 2 precoding matrix to the first antenna port group and a second rank 2 precoding matrix to the second antenna port group.

In some aspects, the 8 port uplink MIMO precoder of rank 5 and a configuration of a first antenna port group of four antenna ports and a second antenna port group of four antenna ports, with a relationship between a precoding matrix applied to the first antenna port group and the precoding matrix applied to the second antenna port group, wherein the 8 port uplink MIMO precoder is indicated by one of: a one bit port group indicator and a single TPMI field having a single state that indicates a non-coherent precoder that applies a rank 3 precoding matrix to the first antenna port group and a rank 2 precoding matrix the second antenna port group or that applies a rank 4 precoding matrix to the first antenna port group and a rank 1 precoding matrix the second antenna port group, a one bit port group indicator and a single TPMI field having two states that indicate a two antenna partial coherent precoder (PC-2) that applies the rank 3 precoding matrix to the first antenna port group and the rank 2 precoding matrix the second antenna port group or that applies the rank 4 precoding matrix to the first antenna port group and the rank 1 precoding matrix the second antenna port group, a one bit port group indicator and a single TPMI field having four states that indicate a four antenna partial coherent precoder (PC-4) that applies the rank 3 precoding matrix to the first antenna port group and the rank 2 precoding matrix the second antenna port group or that applies the rank 4 precoding matrix to the first antenna port group and the rank 1 precoding matrix the second antenna port group, a one bit port group indicator and the first TPMI field having 1 state and the second TPMI field having 1 state that indicate a non-coherent precoder that applies the rank 3 precoding matrix to the first antenna port group and the rank 2 precoding matrix the second antenna port group, a one bit port group indicator and the first TPMI field having 2 states and the second TPMI field having 2 states that indicate a two antenna partial coherent precoder (PC-2) that applies the rank 3 precoding matrix to the first antenna port group and the rank 2 precoding matrix the second antenna port group or that applies the rank 4 precoding matrix to the first antenna port group and the rank 1 precoding matrix the second antenna port group, a one bit port group indicator and the first TPMI field having 4 states and the second TPMI field having 4 states that indicate a four antenna partial coherent precoder (PC-4) that applies the rank 3 precoding matrix to the first antenna port group and the rank 2 precoding matrix the second antenna port group or that applies the rank 4 precoding matrix to the first antenna port group and the rank 1 precoding matrix the second antenna port group, a one bit port group indicator and the first TPMI field having 2 states and the second TPMI field having 2 states that indicate a four antenna partial coherent precoder (PC-4) that applies the rank 4 precoding matrix to the first antenna port group and the rank 1 precoding matrix the second antenna port group, a one bit port group indicator and the first TPMI field having 1 state and the second TPMI field having 6 states that indicate a non-coherent precoder that applies the rank 3 precoding matrix to the first antenna port group and the rank 2 precoding matrix the second antenna port group, a one bit port group indicator and the first TPMI field having 2 states and the second TPMI field having 8 states that indicate a two antenna partial coherent precoder (PC-2) that applies the rank 3 precoding matrix to the first antenna port group and the rank 2 precoding matrix the second antenna port group or that applies the rank 4 precoding matrix to the first antenna port group and the rank 1 precoding matrix the second antenna port group, a one bit port group indicator and the first TPMI field having 4 states and the second TPMI field having 8 states that indicate a four antenna partial coherent precoder (PC-4) that applies the rank 3 precoding matrix to the first antenna port group and the rank 2 precoding matrix the second antenna port group, a one bit port group indicator and the first TPMI field having 2 states and the second TPMI field having 16 states that indicate a four antenna partial coherent precoder (PC-4) that applies the rank 4 precoding matrix to the first antenna port group and the rank 1 precoding matrix the second antenna port group, a two bit port group indicator and a single TPMI field having a single state that indicates a non-coherent precoder that applies the rank 3 precoding matrix to the first antenna port group and the rank 2 precoding matrix the second antenna port group or that applies the rank 4 precoding matrix to the first antenna port group and the rank 1 precoding matrix the second antenna port group, the two bit port group indicator and a single TPMI field having two states that indicate a two antenna partial coherent precoder (PC-2) that applies the rank 3 precoding matrix to the first antenna port group and the rank 2 precoding matrix the second antenna port group or that applies the rank 4 precoding matrix to the first antenna port group and the rank 1 precoding matrix the second antenna port group, the two bit port group indicator and a single TPMI field having four states that indicate a four antenna partial coherent precoder (PC-4) that applies the rank 3 precoding matrix to the first antenna port group and the rank 2 precoding matrix the second antenna port group, the two bit port group indicator and a single TPMI field having two states that indicate a four antenna partial coherent precoder (PC-4) that applies the rank 4 precoding matrix to the first antenna port group and the rank 1 precoding matrix the second antenna port group, a two bit port group indicator and the first TPMI field having 1 state and the second TPMI field having 1 state that indicate a non-coherent precoder that applies the rank 3 precoding matrix to the first antenna port group and the rank 2 precoding matrix the second antenna port group or that applies the rank 4 precoding matrix to the first antenna port group and the rank 1 precoding matrix the second antenna port group, a two bit port group indicator and the first TPMI field having 2 states and the second TPMI field having 2 states that indicate a two antenna partial coherent precoder (PC-2) or a four antenna partial coherent precoder (PC-4) that applies the rank 3 precoding matrix to the first antenna port group and the rank 2 precoding matrix the second antenna port group or that applies the rank 4 precoding matrix to the first antenna port group and the rank 1 precoding matrix the second antenna port group, a two bit port group indicator and the first TPMI field having 4 states and the second TPMI field having 4 states that indicate a four antenna partial coherent precoder (PC-4) that applies the rank 3 precoding matrix to the first antenna port group and the rank 2 precoding matrix the second antenna port group, a two bit port group indicator and the first TPMI field having 1 state and the second TPMI field having 6 states that indicate a non-coherent precoder that applies the rank 3 precoding matrix to the first antenna port group and the rank 2 precoding matrix the second antenna port group, a two bit port group indicator and the first TPMI field having 2 states and the second TPMI field having 8 states that indicate a two antenna partial coherent precoder (PC-2) that applies the rank 3 precoding matrix to the first antenna port group and the rank 2 precoding matrix the second antenna port group or that applies the rank 4 precoding matrix to the first antenna port group and the rank 1 precoding matrix the second antenna port group, a two bit port group indicator and the first TPMI field having 4 states and the second TPMI field having 8 states that indicate a four antenna partial coherent precoder (PC-4) that applies the rank 3 precoding matrix to the first antenna port group and the rank 2 precoding matrix the second antenna port group, or a two bit port group indicator and the first TPMI field having 2 states and the second TPMI field having 16 states that indicate a four antenna partial coherent precoder (PC-4) that applies the rank 4 precoding matrix to the first antenna port group and the rank 1 precoding matrix the second antenna port group.

In some aspects, the 8 port uplink MIMO precoder is of rank 6, with a relationship between a first precoding matrix applied to a first antenna port group and a second precoding matrix applied to a second antenna port group, wherein the 8 port uplink MIMO precoder is indicated by one of: a single TPMI field having a single state that indicates a non-coherent precoder that applies a first rank 3 precoding matrix to the first antenna port group and a second rank 3 precoding matrix the second antenna port group, a single TPMI field having two states that indicate a two antenna partial coherent precoder (PC-2) that applies a first rank 3 precoding matrix to the first antenna port group and a second rank 3 precoding matrix the second antenna port group or that applies a rank 4 precoding matrix to the first antenna port and a rank 2 precoding matrix to the second antenna port, a single TPMI field having four states that indicate a four antenna partial coherent precoder (PC-4) that applies a first rank 3 precoding matrix to the first antenna port group and a second rank 3 precoding matrix the second antenna port group or that applies a rank 4 precoding matrix to the first antenna port and a rank 2 precoding matrix to the second antenna port, a one bit port group indicator and the first TPMI field having 1 state and the second TPMI field having 1 state that indicate a non-coherent precoder that applies a rank 4 precoding matrix to the first antenna port and a rank 2 precoding matrix to the second antenna port, a one bit port group indicator and the first TPMI field having 2 states and the second TPMI field having 2 states that indicate a two antenna partial coherent precoder (PC-2) that applies a rank 4 precoding matrix to the first antenna port and a rank 2 precoding matrix to the second antenna port, a one bit port group indicator and the first TPMI field having 2 states and the second TPMI field having 2 states that indicate a four antenna partial coherent precoder (PC-4) that applies the rank 4 precoding matrix to the first antenna port group and the rank 1 precoding matrix the second antenna port group, the first TPMI field having 1 state and the second TPMI field having 1 state that indicate a non-coherent precoder that applies the first rank 3 precoding matrix to the first antenna port group and the second rank 3 precoding matrix the second antenna port group, the first TPMI field having 2 states and the second TPMI field having 2 states that indicate a two antenna partial coherent precoder (PC-2) that applies the first rank 3 precoding matrix to the first antenna port group and the second rank 3 precoding matrix the second antenna port group, the first TPMI field having 4 states and the second TPMI field having 4 states that indicate a four antenna partial coherent precoder (PC-4) that applies the first rank 3 precoding matrix to the first antenna port group and the second rank 3 precoding matrix the second antenna port group, the first TPMI field having 1 state and the second TPMI field having 6 states that indicate a non-coherent precoder that applies the rank 4 precoding matrix to the first antenna port group and the rank 2 precoding matrix the second antenna port group, the first TPMI field having 2 state and the second TPMI field having 8 states that indicate a two antenna partial coherent precoder (PC-2) that applies the rank 4 precoding matrix to the first antenna port group and the rank 2 precoding matrix the second antenna port group, the first TPMI field having 2 states and the second TPMI field having 8 states that indicate a four antenna partial coherent precoder (PC-4) that applies the rank 4 precoding matrix to the first antenna port group and the rank 2 precoding matrix the second antenna port group, a two bit port group indicator and a single TPMI field having a single state that indicates a non-coherent precoder that applies the first rank 3 precoding matrix to the first antenna port group and the second rank 3 precoding matrix the second antenna port group or that applies the rank 4 precoding matrix to the first antenna port group and the rank 2 precoding matrix the second antenna port group, the two bit port group indicator and a single TPMI field having two states that indicate a two antenna partial coherent precoder (PC-2) that applies the first rank 3 precoding matrix to the first antenna port group and the second rank 3 precoding matrix the second antenna port group or that applies the rank 4 precoding matrix to the first antenna port group and the rank 2 precoding matrix the second antenna port group, the two bit port group indicator and a single TPMI field having four states that applies the first rank 3 precoding matrix to the first antenna port group and the second rank 3 precoding matrix the second antenna port group, the two bit port group indicator and a single TPMI field having two states that indicate a four antenna partial coherent precoder (PC-4) that applies the rank 4 precoding matrix to the first antenna port group and the rank 2 precoding matrix the second antenna port group, a two bit port group indicator and the first TPMI field having 1 state and the second TPMI field having 1 state that indicate a non-coherent precoder that applies the first rank 3 precoding matrix to the first antenna port group and the second rank 3 precoding matrix the second antenna port group or that applies the rank 4 precoding matrix to the first antenna port group and the rank 2 precoding matrix the second antenna port group, a two bit port group indicator and the first TPMI field having 2 states and the second TPMI field having 2 states that indicate a two antenna partial coherent precoder (PC-2) or a four antenna partial coherent precoder (PC-4) that applies the first rank 3 precoding matrix to the first antenna port group and the second rank 4 precoding matrix the second antenna port group or that applies the rank 4 precoding matrix to the first antenna port group and the rank 2 precoding matrix the second antenna port group, a two bit port group indicator and the first TPMI field having 4 states and the second TPMI field having 4 states that indicate a four antenna partial coherent precoder (PC-4) that applies the first rank 3 precoding matrix to the first antenna port group and the second rank 3 precoding matrix the second antenna port group, two bit port group indicator and the first TPMI field having 1 state and the second TPMI field having 6 states that indicate a non-coherent precoder that applies the rank 4 precoding matrix to the first antenna port group and the rank 2 precoding matrix the second antenna port group, or a two bit port group indicator and the first TPMI field having 2 states and the second TPMI field having 8 states that indicate a two antenna partial coherent precoder (PC-2) or a four antenna partial coherent precoder (PC-4) that applies the rank 4 precoding matrix to the first antenna port group and the rank 2 precoding matrix the second antenna port group.

In some aspects, the 8 port uplink MIMO precoder is of rank 7, with a relationship between a first precoding matrix applied to a first antenna port group and a second precoding matrix applied to a second antenna port group, wherein the 8 port uplink MIMO precoder is indicated by one of: a single TPMI field having a single state that indicates a non-coherent precoder that applies a rank 4 precoding matrix to the first antenna port group and a second rank 3 precoding matrix the second antenna port group, a single TPMI field having two states that indicate a two antenna partial coherent precoder (PC-2) or a four antenna partial coherent precoder (PC-4) that applies a rank 4 precoding matrix to the first antenna port group and a second rank 3 precoding matrix the second antenna port group, the first TPMI field having 1 state and the second TPMI field having 1 state that indicate a non-coherent precoder that applies a rank 4 precoding matrix to the first antenna port group and a second rank 3 precoding matrix the second antenna port group, the first TPMI field having 2 states and the second TPMI field having 2 states that indicate a two antenna partial coherent precoder (PC-2) that applies a rank 4 precoding matrix to the first antenna port group and a second rank 3 precoding matrix the second antenna port group, the first TPMI field having 4 states and the second TPMI field having 4 states that indicate a four antenna partial coherent precoder (PC-4) that applies a rank 4 precoding matrix to the first antenna port group and a second rank 3 precoding matrix the second antenna port group, a one bit port group indicator and the first TPMI field having 1 state and the second TPMI field having 1 state that indicate a non-coherent precoder that applies a rank 4 precoding matrix to the first antenna port group and a second rank 3 precoding matrix the second antenna port group, a one bit port group indicator and the first TPMI field having 2 states and the second TPMI field having 2 states that indicate a two antenna partial coherent precoder (PC-2) that applies a rank 4 precoding matrix to the first antenna port group and a second rank 3 precoding matrix the second antenna port group, or a one bit port group indicator and the first TPMI field having 4 states and the second TPMI field having 4 states that indicate a four antenna partial coherent precoder (PC-4) that applies a rank 4 precoding matrix to the first antenna port group and a second rank 3 precoding matrix the second antenna port group. In some aspects, the 8 port uplink MIMO precoder is of rank 8, with a relationship between a first precoding matrix applied to a first antenna port group and a second precoding matrix applied to a second antenna port group, wherein the 8 port uplink MIMO precoder is indicated by one of: a single TPMI field having 1 state that indicates a non-coherent precoder that applies a first rank 4 precoding matrix to the first antenna port group and a second rank 4 precoding matrix to the second antenna port group, a single TPMI field having two states that indicate a two antenna partial coherent precoder (PC-2) or a four antenna partial coherent precoder (PC-4) that applies the first rank 4 precoding matrix to the first antenna port group and the second rank 4 precoding matrix to the second antenna port group, the first TPMI field having 1 state and the second TPMI field having 1 state that indicate a non-coherent precoder that applies the first rank 4 precoding matrix to the first antenna port group and the second rank 4 precoding matrix to the second antenna port group, the first TPMI field having 2 states and the second TPMI field having 2 states that indicate a two antenna partial coherent precoder (PC-2) that applies the first rank 4 precoding matrix to the first antenna port group and the second rank 4 precoding matrix to the second antenna port group, or the first TPMI field having 2 states and the second TPMI field having 2 states that indicate a four antenna partial coherent precoder (PC-4) that applies the first rank 4 precoding matrix to the first antenna port group and the second rank 4 precoding matrix to the second antenna port group.

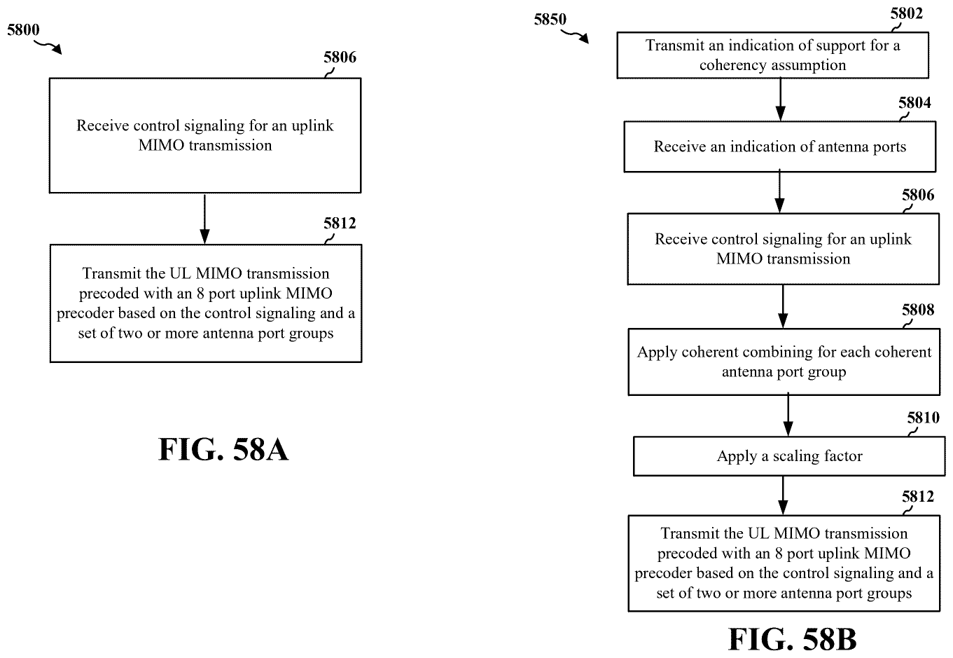

FIG. 58A is a flowchart 5800 of a method of wireless communication. The method may be performed by a UE (e.g., the UE 104, 350; the apparatus 5904). The method may enable the UE to transmit UL MIMO transmissions using various precoding options for 8Tx.

At 5806, the UE receives control signaling for an UL transmission. The reception may be performed, e.g., by the codebook handling component 198, the transceiver 5922 and/or the antenna 5980. The codebook handling component 198 may be a component of the UE 104, 350, or the apparatus 5904.

At 5812, the UE transmits the UL MIMO transmission precoded with an 8 port uplink MIMO precoder based on the control signaling and a set of two or more antenna port groups. The transmission may be performed, e.g., by the codebook handling component 198, the transceiver 5922 and/or the antenna 5980. The codebook handling component 198 may be a component of the UE 104, 350, or the apparatus 5904.

In some aspects, the precoder may be based on a rank of the UL MIMO transmission, a single precoder being provided for each of rank 5, rank 6, rank 7, or rank 8 of the 8 port uplink MIMO precoder. In some aspects, the 8 port uplink MIMO precoder may be based on a discrete Fourier transform (DFT) codebook with an oversampling factor of 2 and having co-phasing. In some aspects, the 8 precoders may be provided for each of rank 5 and rank 6 and 4 precoders are provided for each of rank 7 and rank 8. In some aspects, the 8 precoders may be provided for each of rank 5, rank 6, rank 7, and rank 8. In some aspects, the 8 port uplink MIMO precoder may be based on a codebook that is optimized for spatially uncorrelated channels. In some aspects, the codebook may be based on a combination of two 4×4 Householder matrices, and wherein co-phasing is applied between two antenna port groups. In some aspects, the 8 port uplink MIMO precoder may be based on an 8 Tx precoders that are based on co-phasing a precoder for a less than 8 antenna ports. In some aspects, a subset of the 8 Tx precoders may be used according to a rank of the UL MIMO transmission. In some aspects, the multiple layers may be transmitted with one or more groups of coherent antenna ports. In some aspects, the one or more groups of coherent antenna ports may include a first subset of four coherent antenna ports and a second subset of four coherent antenna ports. In some aspects, the one or more groups of coherent antenna ports may include a first subset of two coherent antenna ports, a second subset of two coherent antenna ports, and a third subset of four coherent antenna ports. In some aspects, the one or more groups of coherent antenna ports may include a first subset of two coherent antenna ports, a second subset of two coherent antenna ports, a third subset of two coherent antenna ports, and a fourth subset of two coherent antenna ports. In some aspects, the UL MIMO transmission may be a combination of a partially coherent transmission and a non-coherent transmission, and wherein the one or more groups of coherent antenna ports includes a first subset of one antenna port, a second subset of one antenna port, a third subset of two coherent antenna ports, and a fourth subset of four coherent antenna ports. In some aspects, antenna ports from different antenna port groups may be configured in a single sounding reference signal (SRS) resource, each antenna port group having at least one of a different cyclic shift or a different comb index. In some aspects, antenna ports from different antenna port groups may be configured with different SRS resources.

FIG. 58B is a flowchart 5850 of a method of wireless communication. The method may be performed by a UE (e.g., the UE 104, 350; the apparatus 5904). The method may enable the UE to transmit UL MIMO transmissions using various precoding options for 8Tx.

At 5806, the UE receives control signaling for an UL transmission. The reception may be performed, e.g., by the codebook handling component 198, the transceiver 5922 and/or the antenna 5980. The codebook handling component 198 may be a component of the UE 104, 350, or the apparatus 5904.

At 5812, the UE transmits the UL MIMO transmission precoded with an 8 port uplink MIMO precoder based on the control signaling and a set of two or more antenna port groups. The transmission may be performed, e.g., by the codebook handling component 198, the transceiver 5922 and/or the antenna 5980. The codebook handling component 198 may be a component of the UE 104, 350, or the apparatus 5904.

In some aspects, the precoder may be based on a rank of the UL MIMO transmission, a single precoder being provided for each of rank 5, rank 6, rank 7, or rank 8 of the 8 port uplink MIMO precoder. In some aspects, the 8 port uplink MIMO precoder may be based on a discrete Fourier transform (DFT) codebook with an oversampling factor of 2 and having co-phasing. In some aspects, the 8 precoders may be provided for each of rank 5 and rank 6 and 4 precoders are provided for each of rank 7 and rank 8. In some aspects, the 8 precoders may be provided for each of rank 5, rank 6, rank 7, and rank 8. In some aspects, the 8 port uplink MIMO precoder may be based on a codebook that is optimized for spatially uncorrelated channels. In some aspects, the codebook may be based on a combination of two 4×4 Householder matrices, and wherein co-phasing is applied between two antenna port groups. In some aspects, the 8 port uplink MIMO precoder may be based on an 8 Tx precoders that are based on co-phasing a precoder for a less than 8 antenna ports. In some aspects, a subset of the 8 Tx precoders may be used according to a rank of the UL MIMO transmission. In some aspects, the multiple layers may be transmitted with one or more groups of coherent antenna ports. In some aspects, the one or more groups of coherent antenna ports may include a first subset of four coherent antenna ports and a second subset of four coherent antenna ports. In some aspects, the one or more groups of coherent antenna ports may include a first subset of two coherent antenna ports, a second subset of two coherent antenna ports, and a third subset of four coherent antenna ports. In some aspects, the one or more groups of coherent antenna ports may include a first subset of two coherent antenna ports, a second subset of two coherent antenna ports, a third subset of two coherent antenna ports, and a fourth subset of two coherent antenna ports. In some aspects, the UL MIMO transmission may be a combination of a partially coherent transmission and a non-coherent transmission, and wherein the one or more groups of coherent antenna ports includes a first subset of one antenna port, a second subset of one antenna port, a third subset of two coherent antenna ports, and a fourth subset of four coherent antenna ports. In some aspects, antenna ports from different antenna port groups may be configured in a single sounding reference signal (SRS) resource, each antenna port group having at least one of a different cyclic shift or a different comb index. In some aspects, antenna ports from different antenna port groups may be configured with different SRS resources.

In some aspects, the precoder may be based on a rank of the UL MIMO transmission, a single precoder being provided for each of rank 5, rank 6, rank 7, or rank 8 of the 8 port uplink MIMO precoder. In some aspects, at 5804, the UE may receive an indication selecting four antenna ports from a set of 8 antenna ports and selecting one or more additional antenna ports according to the rank for the UL MIMO transmission, the one or more additional antenna ports having lowest port indices from 4 unindicated antenna ports from the set of 8 antenna ports. The reception may be performed, e.g., by the codebook handling component 198, the transceiver 5922 and/or the antenna 5980. The codebook handling component 198 may be a component of the UE 104, 350, or the apparatus 5904.

In some aspects, the UE may receive, at 5804, an indication of a first set of four antenna ports from a set of 8 antenna ports and a second set of four antenna ports from the set of 8 antenna ports, wherein the UE applies the 8 port uplink MIMO precoder to the first set of four antenna ports and one or more additional antenna ports from the second set of four antenna ports according to the rank for the UL MIMO transmission, the one or more additional antenna ports from the second set of four antenna ports being applied in a set order in which the second set of four antenna ports is indicated. The reception may be performed, e.g., by the codebook handling component 198, the transceiver 5922 and/or the antenna 5980. The codebook handling component 198 may be a component of the UE 104, 350, or the apparatus 5904.

In some aspects, two precoders may be provided for rank 5, rank 6, rank 7, or rank 8 of the 8 port uplink MIMO precoder that applied to one or more sets of coherent antenna port pairs for a set of 8 antenna ports, the UE may apply coherent combining for each coherent antenna port pair, e.g., as at 5808.

In some aspects, the UE may receive, at 5804, an indication selecting two sets of coherent antenna port pairs from the set of 8 antenna ports and selecting one or more additional antenna ports according to a rank for the UL MIMO transmission, the one or more additional antenna ports selected from remaining coherent antenna port pairs. The reception may be performed, e.g., by the codebook handling component 198, the transceiver 5922 and/or the antenna 5980. The codebook handling component 198 may be a component of the UE 104, 350, or the apparatus 5904.

In some aspects, the UE may receive, at 5804, an indication of a first set of two coherent antenna port pairs and a second set of two coherent antenna port pairs from the set of 8 antenna ports, wherein the UE applies the 8 port uplink MIMO precoder to the first set of two coherent antenna port pairs and one or more additional antenna ports from the second set of two coherent antenna port pairs according to a rank for the UL MIMO transmission, the one or more additional antenna ports from the second set of two antenna ports being applied in a set order in which the second set of two coherent antenna port pairs is indicated. The reception may be performed, e.g., by the codebook handling component 198, the transceiver 5922 and/or the antenna 5980. The codebook handling component 198 may be a component of the UE 104, 350, or the apparatus 5904.

In some aspects, precoders may be provided for rank 5, rank 6, rank 7, or rank 8 of the 8 port uplink MIMO precoder, the two precoders being applied to a first group of four coherent antenna ports and a second group of four coherent antenna ports. As shown at 5808, the UE may apply coherent combining for each coherent antenna port group with a length-4 orthogonal sequence, wherein one of: a first set of layers is based on the first group of four coherent antenna ports and a second set of layers is based on the second group of four coherent antenna ports according to a rank of the 8 port uplink MIMO transmission, or a first four layers of the UL MIMO transmission are based on the first group of four coherent antenna ports and additional one or more layers are based on the second group of four coherent antenna ports according to the rank of the 8 port uplink MIMO transmission. The application may be performed, e.g., by the codebook handling component 198, which may be a component of the UE 104, 350, or the apparatus 5904.

In some aspects, the 8 port uplink MIMO precoder may be based on a DFT)codebook with an oversampling factor of 2 and having co-phasing. In some aspects, the 8 precoders may be provided for each of rank 5 and rank 6 and 4 precoders are provided for each of rank 7 and rank 8. In some aspects, the 8 precoders may be provided for each of rank 5, rank 6, rank 7, and rank 8. In some aspects, the 8 port uplink MIMO precoder may be based on a codebook that is optimized for spatially uncorrelated channels. In some aspects, the codebook may be based on a combination of two 4×4 Householder matrices, and wherein co-phasing is applied between two antenna port groups. In some aspects, the 8 port uplink MIMO precoder may be based on an 8 Tx precoders that are based on co-phasing a precoder for a less than 8 antenna ports. In some aspects, a subset of the 8 Tx precoders may be used according to a rank of the UL MIMO transmission. In some aspects, the multiple layers may be transmitted with one or more groups of coherent antenna ports. In some aspects, the one or more groups of coherent antenna ports may include a first subset of four coherent antenna ports and a second subset of four coherent antenna ports. In some aspects, the one or more groups of coherent antenna ports may include a first subset of two coherent antenna ports, a second subset of two coherent antenna ports, and a third subset of four coherent antenna ports. In some aspects, the one or more groups of coherent antenna ports may include a first subset of two coherent antenna ports, a second subset of two coherent antenna ports, a third subset of two coherent antenna ports, and a fourth subset of two coherent antenna ports. In some aspects, the UL MIMO transmission may be a combination of a partially coherent transmission and a non-coherent transmission, and wherein the one or more groups of coherent antenna ports includes a first subset of one antenna port, a second subset of one antenna port, a third subset of two coherent antenna ports, and a fourth subset of four coherent antenna ports.

In some aspects, the UE may receive an indication of an active antenna port group, e.g., at 5804, and receive a TPMI and a rank indicator for the active antenna port group, e.g., at 5806. The reception may be performed, e.g., by the codebook handling component 198, the transceiver 5922 and/or the antenna 5980. The codebook handling component 198 may be a component of the UE 104, 350, or the apparatus 5904. A number of bits in a TPMI field for the 8 port UL MIMO transmission may be reduced in comparison to a 4 port UL MIMO transmission.

A precoder for each antenna port group is based on a codebook for a 2 port UL MIMO transmission or a 4 port UL MIMO transmission, and as shown at 5810, the UE may apply a scaling factor based on a number of antenna ports in a corresponding antenna port group to which the precoder is applied. The application may be performed, e.g., by the codebook handling codebook handling component 198, which may be a component of the UE 104, 350, or the apparatus 5904.

In some aspects, as shown at 5802, the UE may transmit an indication of support for a coherency assumption for antenna port groups. The transmission may be performed, e.g., by the codebook handling codebook handling component 198, the transceiver 5922 and/or the antenna 5980. The codebook handling codebook handling component 198 may be a component of the UE 104, 350, or the apparatus 5904.

In some aspects, antenna ports from different antenna port groups may be configured in a single SRS resource, each antenna port group having at least one of a different cyclic shift or a different comb index. In some aspects, antenna ports from different antenna port groups may be configured with different SRS resources.

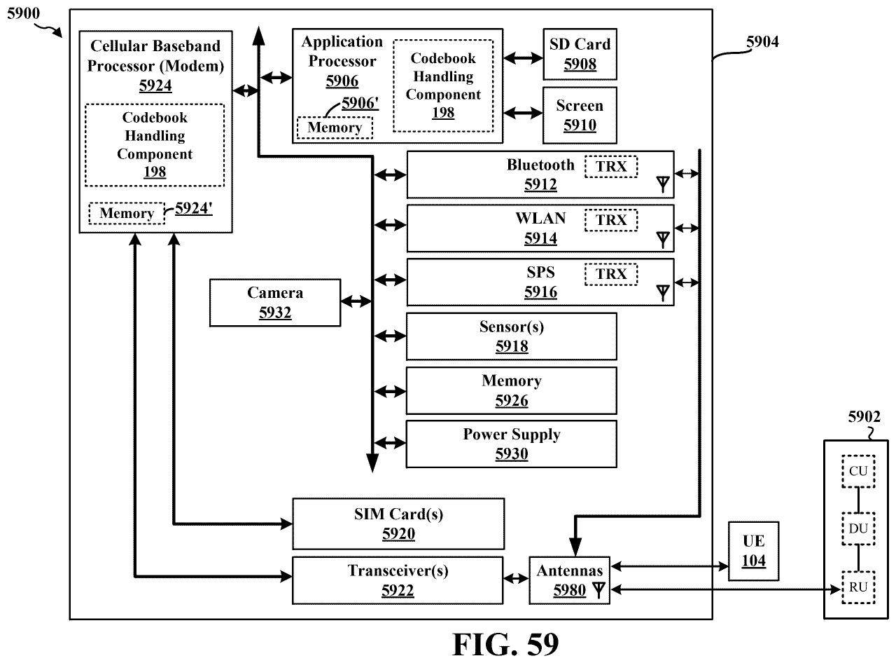

FIG. 59 is a diagram 5900 illustrating an example of a hardware implementation for an apparatus 5904. The apparatus 5904 may be a UE, a component of a UE, or may implement UE functionality. In some aspects, the apparatus 5004 may include a cellular baseband processor 5924 (also referred to as a modem) coupled to one or more transceivers 5922 (e.g., cellular RF transceiver). The cellular baseband processor 5924 may include on-chip memory 5924′. In some aspects, the apparatus 5904 may further include one or more subscriber identity modules (SIM) cards 5920 and an application processor 5906 coupled to a secure digital (SD) card 5908 and a screen 5910. The application processor 5906 may include on-chip memory 5906′. In some aspects, the apparatus 5904 may further include a Bluetooth module 5912, a WLAN module 5914, an SPS module 5916 (e.g., GNSS module), one or more sensor modules 5918 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 5926, a power supply 5930, and/or a camera 5932. The Bluetooth module 5912, the WLAN module 5914, and the SPS module 5916 may include an on-chip transceiver (TRX) (or in some cases, just a receiver (RX)). The Bluetooth module 5912, the WLAN module 5914, and the SPS module 5916 may include their own dedicated antennas and/or utilize the antennas 5980 for communication. The cellular baseband processor 5924 communicates through the transceiver(s) 5922 via one or more antennas 5980 with the UE 104 and/or with an RU associated with a network entity 5902. The cellular baseband processor 5924 and the application processor 5906 may each include a computer-readable medium/memory 5924′, 5906′, respectively. The additional memory modules 5926 may also be considered a computer-readable medium/memory. Each computer-readable medium/memory 5924′, 5906′, 5926 may be non-transitory. The cellular baseband processor 5924 and the application processor 5906 are each responsible for general processing, including the execution of software stored on the computer-readable medium/memory. The software, when executed by the cellular baseband processor 5924/application processor 5906, causes the cellular baseband processor 5924/application processor 5906 to perform the various functions described supra. The computer-readable medium/memory may also be used for storing data that is manipulated by the cellular baseband processor 5924/application processor 5906 when executing software. The cellular baseband processor 5924/application processor 5906 may be a component of the UE 350 and may include the memory 360 and/or at least one of the TX processor 368, the RX processor 356, and the controller/processor 359. In one configuration, the apparatus 5904 may be a processor chip (modem and/or application) and include just the cellular baseband processor 5924 and/or the application processor 5906, and in another configuration, the apparatus 5904 may be the entire UE (e.g., see 350 of FIG. 3) and include the additional modules of the apparatus 5904.

As discussed supra, the codebook handling codebook handling component 198 may be configured to receive control signaling for an uplink MIMO transmission, the control signaling including a first TPMI field and a second TPMI field and an SRS resource set indicator; and transmit the uplink MIMO transmission precoded with an 8 port uplink MIMO precoder, the 8 port uplink MIMO precoder being based on a 4 port uplink MIMO codebook with a mapping indicated by one or more of the first TPMI field, the second TPMI field, or the SRS resource set indicator. In some aspects, the codebook handling codebook handling component 198 may be further configured to construct an 8 port precoding matrix based on the 4 port uplink MIMO codebook and the mapping indicated by the one or more of the first TPMI field, the second TPMI field, or the SRS resource set indicator and/or to receive a configuration of a first antenna port group of four antenna ports and a second antenna port group of four antenna ports, wherein a first precoding matrix indicated by the first TPMI field is applied to the first antenna port group and a second precoding matrix indicated by the second TPMI field is applied to the second antenna port group. The codebook handling codebook handling component 198 may be further configured to receive control signaling for an UL transmission and transmit the UL MIMO transmission precoded with an 8 port uplink MIMO precoder based on the control signaling and a set of two or more antenna port groups. The codebook handling codebook handling component 198 may be within the cellular baseband processor 5924, the application processor 5906, or both the cellular baseband processor 5924 and the application processor 5906. The codebook handling codebook handling component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 5904 may include a variety of components configured for various functions. In one configuration, the apparatus 5904, and in particular the cellular baseband processor 5924 and/or the application processor 5906, includes means for receiving control signaling for an uplink MIMO transmission, the control signaling including a first TPMI field and a second TPMI field and an SRS resource set indicator; and means for transmitting the uplink MIMO transmission precoded with an 8 port uplink MIMO precoder, the 8 port uplink MIMO precoder being based on a 4 port uplink MIMO codebook with a mapping indicated by one or more of the first TPMI field, the second TPMI field, or the SRS resource set indicator. In some aspects, the apparatus 5904 may further include means for constructing an 8 port precoding matrix based on the 4 port uplink MIMO codebook and the mapping indicated by the one or more of the first TPMI field, the second TPMI field, or the SRS resource set indicator and/or means for receiving a configuration of a first antenna port group of four antenna ports and a second antenna port group of four antenna ports, wherein a first precoding matrix indicated by the first TPMI field is applied to the first antenna port group and a second precoding matrix indicated by the second TPMI field is applied to the second antenna port group. In some aspects, the apparatus 5904 may include means for receiving control signaling for an UL transmission and means for transmitting the UL MIMO transmission precoded with an 8 port uplink MIMO precoder based on the control signaling and a set of two or more antenna port groups. The apparatus 5904 may include means for performing any of the aspects described in connection with FIG. 57A, 57B, 58A, or 58B. The means may be the codebook handling codebook handling component 198 of the apparatus 5904 configured to perform the functions recited by the means. As described supra, the apparatus 5904 may include the TX processor 368, the RX processor 356, and the controller/processor 359. As such, in one configuration, the means may be the TX processor 368, the RX processor 356, and/or the controller/processor 359 configured to perform the functions recited by the means.

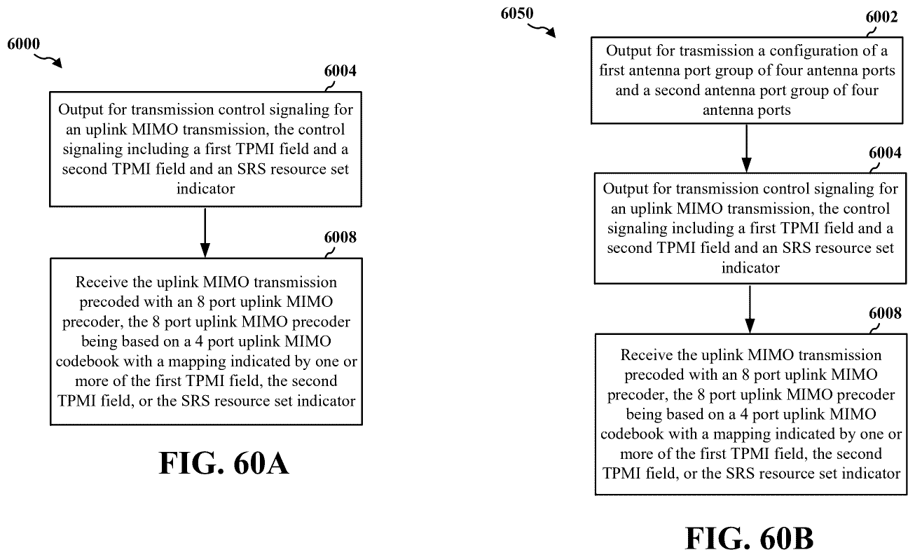

FIG. 60A is a flowchart 6000 of a method of wireless communication. The method may be performed by a network node such as a base station or a component of a base station (e.g., the base station 102, 310; the CU 110; the DU 130; the RU 140; the network entity 6202). The method may enable the scheduling and transmission of UL MIMO transmissions using various precoding options for 8Tx.

At 6004, the network node outputs for transmission control signaling for an uplink MIMO transmission, the control signaling including a first TPMI field and a second TPMI field and an SRS resource set indicator. The output may be performed, e.g., by the codebook signaling component 199, which may be a component of the base station 102, 310, or the network entity 6202.

At 6008, the network node obtains, e.g., receives, the uplink MIMO transmission precoded with an 8 port uplink MIMO precoder, the 8 port uplink MIMO precoder being based on a 4 port uplink MIMO codebook with a mapping indicated by one or more of the first TPMI field, the second TPMI field, or the SRS resource set indicator. The obtaining may be performed, e.g., by the codebook signaling component 199, which may be a component of the base station 102, 310, or the network entity 6202. The transmission may be precoded based on any of the aspects described in connection with FIGS. 4-62.

FIG. 60B is a flowchart 6050 of a method of wireless communication. The method may be performed by a UE (e.g., the UE 104, 350; the apparatus 5904). The method may enable the UE to transmit UL MIMO transmissions using various precoding options for 8Tx.

At 6004, the network node outputs for transmission control signaling for an uplink MIMO transmission, the control signaling including a first TPMI field and a second TPMI field and an SRS resource set indicator. The output may be performed, e.g., by the codebook signaling component 199, which may be a component of the base station 102, 310, or the network entity 6202.

At 6008, the network node obtains, e.g., receives, the uplink MIMO transmission precoded with an 8 port uplink MIMO precoder, the 8 port uplink MIMO precoder being based on a 4 port uplink MIMO codebook with a mapping indicated by one or more of the first TPMI field, the second TPMI field, or the SRS resource set indicator. The obtaining may be performed, e.g., by the codebook signaling component 199, which may be a component of the base station 102, 310, or the network entity 6202. The transmission may be precoded based on any of the aspects described in connection with FIGS. 4-62.

In some aspects, the 8 port precoding matrix may be constructed based on the 4 port uplink MIMO codebook and the mapping indicated by the one or more of the first TPMI field, the second TPMI field, or the SRS resource set indicator. The construction may be performed, e.g., by the codebook handling codebook handling component 198. The codebook handling codebook handling component 198 may be a component of the UE 104, 350, or the apparatus 5904.

The SRS resource set indicator may indicate a precoding matrix type, and the mapping from the 4 port uplink MIMO codebook to the 8 port precoding matrix may be indicated by a combination of the SRS resource set indicator, the first TPMI field, and the second TPMI field. The first TPMI field may indicate a first rank and a first precoding matrix indication, and the second TPMI field may indicate a second precoding matrix indication, a second rank being based on the first rank indicated in the first TPMI field and the precoding matrix type indicated by the SRS resource set indicator. In some aspects, the control signaling may further include a first SRI indicating a first SRS resource associated with the first TPMI field, and a second SRI indicating a second SRS resource associated with the second TPMI field.

In some aspects, the control signaling may further include a first SRI and a second SRI, and the mapping from the 4 port uplink MIMO codebook to the 8 port precoding matrix is indicated by a combination of the SRS resource set indicator, the first TPMI field, the second TPMI field, and the second SRI. The first SRI may indicate SRS resources, and the second SRI indicates a precoding matrix type. In some aspects, the precoding matrix type may be indicated jointly by the second SRI and the SRS resource set indicator. In some aspects, the first TPMI field indicates a first rank and a first precoding matrix indication, and the second TPMI field indicates a second precoding matrix indication, a second rank being based on the first rank indicated in the first TPMI field, the SRS resource set indicator, and the second SRI.

In some aspects, the control signaling may further include at least one SRI and the SRS resource set indicator at least partially indicates a precoding matrix type, and the mapping from the 4 port uplink MIMO codebook to the 8 port precoding matrix being indicated by at least a combination of the SRS resource set indicator, the first TPMI field, and the second TPMI field. The first TPMI field and the second TPMI field may independently indicate a first precoding matrix and a second precoding matrix. The first TPMI field may indicate a first rank and the first precoding matrix, and the second TPMI field indicates a second rank and the second precoding matrix. The SRS resource set indicator may indicate the precoding matrix type independent of a second SRI. The SRS resource set indicator may indicate the precoding matrix type jointly with a second SRI, and a first SRI indicates resources associated with the first precoding matrix and the second precoding matrix.

As illustrated at 6002, in some aspects, the network node may output for transmission a configuration of a first antenna port group of four antenna ports and a second antenna port group of four antenna ports, wherein a first precoding matrix indicated by the first TPMI field is applied to the first antenna port group and a second precoding matrix indicated by the second TPMI field is applied to the second antenna port group. The output may be performed, e.g., by the codebook signaling component 199, which may be a component of the base station 102, 310, or the network entity 6202. The control signaling may include a precoding matrix type indicator, at least one SRI that indicates SRS resources for the first precoding matrix and the second precoding matrix, and the mapping from the 4 port uplink MIMO codebook to the 8 port precoding matrix being indicated by at least the precoding matrix type indicator, the first TPMI field, and the second TPMI field. In some aspects, the control signaling may further includes an additional bit that indicates the precoding matrix type in combination with the precoding matrix type indicator, and the mapping from the 4 port uplink MIMO codebook to the 8 port precoding matrix is further based on the additional bit. In some aspects the first antenna port group and the second antenna port group are indicated to the UE in a permutation matrix.

In some aspects, the control signaling may further include codebook subset indicator comprising at least one additional bit and indicating a subset from a set of codebook subsets including fully coherent transmission, partially coherent transmission, or non-coherent transmission. A first value of the codebook subset indicator may correspond to the partially coherent transmission or the non-coherent transmission and indicates an 8 port uplink MIMO codebook that is constructed based on the 4 port uplink MIMO codebook, and a second value of the codebook subset indicator may correspond to the fully coherent transmission using a precoding matrix that is not based on the 4 port uplink MIMO codebook and which is indicated jointly by the first TPMI field and the second TPMI field.

In some aspects, the control signaling may further include a first SRS resource indicator (SRI) that indicates an SRS resource and a second SRI that indicates a subset from a set of codebook subsets including fully coherent transmission, partially coherent transmission, or non-coherent transmission. In some aspects, a first value of the second SRI corresponds to the partially coherent transmission or the non-coherent transmission and indicates an 8 port uplink MIMO codebook that is constructed based on the 4 port uplink MIMO codebook, and a second value of the second SRI corresponds to the fully coherent transmission using a precoding matrix that has full non-zero entries and which is indicated jointly by the first TPMI field and the second TPMI field.

In some aspects, the SRS resource set indicator indicates the subset from the set of codebook subsets including fully coherent transmission, partially coherent transmission, or non-coherent transmission. In some aspects, a first three values of the SRS resource set indicator corresponds to the partially coherent transmission or the non-coherent transmission and indicates an 8 port uplink MIMO codebook that is constructed based on the 4 port uplink MIMO codebook, and a forth value of the SRS resource set indicator corresponds to the fully coherent transmission using a precoding matrix that has full non-zero entries and which is indicated jointly by the first TPMI field and the second TPMI field.

In some aspects, the 8 port uplink MIMO precoder of rank 1 is based on a rank 1 precoding matrix and a configuration of a first antenna port group of four antenna ports and a second antenna port group of four antenna ports, wherein the 8 port uplink MIMO precoder is indicated by one of: a single bit port group indicator and a single TPMI field having four states that indicate a non-coherent precoder, the single bit port group indicator and a single TPMI field having eight states that indicate a two antenna partial coherent precoder (PC-2), or the single bit port group indicator and a single TPMI field having sixteen states that indicate a four antenna partial coherent precoder (PC-4).

In some aspects, the 8 port uplink MIMO precoder of rank 2 that applies a rank 2 precoding matrix to a first antenna port group of four antenna ports or a second antenna port group of four antenna ports, wherein the 8 port uplink MIMO precoder is indicated by one of: a single bit port group indicator and a single TPMI field having six states that indicate a non-coherent precoder, or the single bit port group indicator and a single TPMI field having eight states for a two antenna partial coherent precoder (PC-2) or a four antenna partial coherent precoder (PC-4).

In some aspects, the 8 port uplink MIMO precoder of rank 2 is based on a first rank 1 precoding matrix applied to a first antenna port group of four antenna ports and a second rank 1 precoding matrix applied to a second antenna port group of four antenna ports, wherein the 8 port uplink MIMO precoder is indicated by one of: the first TPMI field and the second TPMI field, each TPMI field having four states that indicate a non-coherent precoder, the first TPMI field and the second TPMI field, each TPMI field having eight states that indicate a two antenna partial coherent precoder (PC-2), the first TPMI field and the second TPMI field, each TPMI field having sixteen states that indicate a four antenna partial coherent precoder (PC-4), or a single TPMI field in connection with use of a same precoder for both the first antenna port group and the second antenna port group.

In some aspects, the 8 port uplink MIMO precoder of rank 2 and a configuration of a first antenna port group of four antenna ports and a second antenna port group of four antenna ports, wherein the 8 port uplink MIMO precoder is indicated by one of: a two bit port group indicator and a single TPMI field having six states that indicate a non-coherent precoder based on a single rank 2 precoding matrix applied to the first antenna port group or the second antenna port group, the two bit port group indicator and a single TPMI field having eight states for a two antenna partial coherent precoder (PC-2) or a four antenna partial coherent precoder (PC-4) based on a single rank 2 precoding matrix applied to the first antenna port group or the second antenna port group, the two bit port group indicator, the first TPMI field, and the second TPMI field, each TPMI field having four states that indicate a non-coherent precoder based on two rank 1 precoding matrices applied to the first antenna port group or the second antenna port group, two bit port group indicator, the first TPMI field, and the second TPMI field, each TPMI field having eight states that indicate a two antenna partial coherent precoder (PC-2) based on two rank 1 precoding matrices applied to the first antenna port group or the second antenna port group, or two bit port group indicator, the first TPMI field, and the second TPMI field, each TPMI field having sixteen states that indicate a four antenna partial coherent precoder (PC-4) based on two rank 1 precoding matrices applied to the first antenna port group or the second antenna port group.

In some aspects, the 8 port uplink MIMO precoder of rank 2, wherein a rank 2 precoder is applied to either a first antenna port group or a second antenna port group or a same rank 1 precoder is applied to both the first antenna port group and the second antenna port group, the 8 port uplink MIMO precoder being indicated by one of: a two bit port group indicator and a single TPMI field having 6 states that indicate a non-coherent precoder based on the rank 2 precoder that is applied to either the first antenna port group or the second antenna port group, the two bit port group indicator and a single TPMI field having 8 states for a two antenna partial coherent precoder (PC-2) or a four antenna partial coherent precoder (PC-4) that applies a single rank 2 precoder to either the first antenna port group or the second antenna port group, the two bit port group indicator and a single TPMI field having 8 states that indicate a non-coherent precoder states for a two antenna partial coherent precoder (PC-2) in which the same rank 1 precoder is applied to both the first antenna port group and the second antenna port group, the two bit port group indicator and a single TPMI field having 8 states for a two antenna partial coherent precoder (PC-2) in which the same rank 1 precoder is applied to both the first antenna port group and the second antenna port group, or the two bit port group indicator and a single TPMI field having sixteen states that indicate a four antenna partial coherent precoder (PC-4) in which the same rank 1 precoder is applied to both the first antenna port group and the second antenna port group.

In some aspects, the 8 port uplink MIMO precoder of rank 3 and a configuration of a first antenna port group of four antenna ports and a second antenna port group of four antenna ports, wherein the 8 port uplink MIMO precoder being indicated by one of: a single bit port group indicator and a single TPMI field having a single state that indicates a non-coherent precoder that applies a single rank 3 precoding matrix to the first antenna port group or the second antenna port group, the single bit port group indicator and a single TPMI field having two states for a two antenna partial coherent precoder (PC-2) that applies the single rank 3 precoding matrix to the first antenna port group or the second antenna port group, the single bit port group indicator and a single TPMI field having four states for a four antenna partial coherent precoder (PC-4) that applies the single rank 3 precoding matrix to the first antenna port group or the second antenna port group, the first TPMI field having six states and the second TPMI field having four states that indicate a non-coherent precoder that applies a rank 2 precoding matrix to the first antenna port group and a rank 1 precoding matrix to the second antenna port group, the first TPMI field having eight states and the second TPMI field having 8 states that indicate a two antenna partial coherent precoder (PC-2) that applies a rank 2 precoding matrix to the first antenna port group and a rank 1 precoding matrix to the second antenna port group, the first TPMI field having eight states, and the second TPMI field having sixteen states that indicate a four antenna partial coherent precoder (PC-4) that applies a rank 2 precoding matrix to the first antenna port group and a rank 1 precoding matrix to the second antenna port group, the first TPMI field having four states and the second TPMI field having six states that indicate a non-coherent precoder that applies a rank 2 precoding matrix to the first antenna port group and a rank 1 precoding matrix to the second antenna port group, the first TPMI field having sixteen states, and the second TPMI field having eight states that indicate a four antenna partial coherent precoder (PC-4) that applies a rank 2 precoding matrix to the first antenna port group and a rank 1 precoding matrix to the second antenna port group, a two bit port group indicator and a single TPMI field having a single state that indicates a non-coherent precoder that applies the single rank 3 precoding matrix to the first antenna port group or the second antenna port group, the two bit port group indicator and a single TPMI field having two states that indicate a two antenna partial coherent precoder (PC-2) that applies the single rank 3 precoding matrix to the first antenna port group or the second antenna port group, the two bit port group indicator and a single TPMI field having four states that indicate a four antenna partial coherent precoder (PC-4) that applies the single rank 3 precoding matrix to the first antenna port group or the second antenna port group, the two bit port group indicator, the first TPMI field having six states and the second TPMI field having four states that indicate a non-coherent precoder that applies a rank 2 precoding matrix to the first antenna port group and a rank 1 precoding matrix to the second antenna port group, the two bit port group indicator, the first TPMI field having eight states and the second TPMI field having 8 states that indicate a two antenna partial coherent precoder (PC-2) that applies a rank 2 precoding matrix to the first antenna port group and a rank 1 precoding matrix to the second antenna port group, the two bit port group indicator, the first TPMI field having eight states, and the second TPMI field having sixteen states that indicate a four antenna partial coherent precoder (PC-4) that applies a rank 2 precoding matrix to the first antenna port group and a rank 1 precoding matrix to the second antenna port group, the two bit port group indicator, the first TPMI field having four states and the second TPMI field having six states that indicate a non-coherent precoder that applies a rank 2 precoding matrix to the first antenna port group and a rank 1 precoding matrix to the second antenna port group, or the two bit port group indicator, the first TPMI field having sixteen states, and the second TPMI field having eight states that indicate a four antenna partial coherent precoder (PC-4) that applies a rank 2 precoding matrix to the first antenna port group and a rank 1 precoding matrix to the second antenna port group.

In some aspects, the 8 port uplink MIMO precoder of rank 3 and a configuration of a first antenna port group of four antenna ports and a second antenna port group of four antenna ports, with a relationship between a precoding matrix applied to the first antenna port group and the precoding matrix applied to the second antenna port group, wherein the 8 port uplink MIMO precoder is indicated by a two bit port group indicator and one of: a single TPMI field having a single state that indicates a non-coherent precoder that applies a rank 3 precoding matrix to the first antenna port group or the second antenna port group, a single TPMI field having two states that indicate a two antenna partial coherent precoder (PC-2) that applies a rank 3 precoding matrix to the first antenna port group or the second antenna port group, a single TPMI field having four states that indicate a four antenna partial coherent precoder (PC-4) that applies a rank 3 precoding matrix to the first antenna port group or the second antenna port group, a single TPMI field having six states that indicate a non-coherent precoder that applies a rank 2 precoding matrix to the first antenna port group and a rank 1 precoding matrix to the second antenna port group, or a single TPMI field having eight states that indicate a two antenna partial coherent precoder (PC-2) or a four antenna partial coherent precoder (PC-4) that applies a rank 2 precoding matrix to the first antenna port group and a rank 1 precoding matrix to the second antenna port group.

In some aspects, the 8 port uplink MIMO precoder of rank 4 and a configuration of a first antenna port group of four antenna ports and a second antenna port group of four antenna ports, wherein the 8 port uplink MIMO precoder is indicated by one of: a single bit port group indicator and a single TPMI field having a single state that indicates a non-coherent precoder that applies a rank 4 precoding matrix to the first antenna port group or the second antenna port group, the single bit port group indicator and a single TPMI field having two states for a two antenna partial coherent precoder (PC-2) that applies a rank 4 precoding matrix to the first antenna port group or the second antenna port group, the single bit port group indicator and a single TPMI field having two states for a four antenna partial coherent precoder (PC-4) that applies a rank 4 precoding matrix to the first antenna port group or the second antenna port group, the first TPMI field and the second TPMI field each having six states that indicate a non-coherent precoder that applies a first rank 2 precoding matrix to the first antenna port group and a second rank 2 precoding matrix to the second antenna port group, the first TPMI field and the second TPMI field each having 8 states that indicate a two antenna partial coherent precoder (PC-2) or a four antenna partial coherent precoder (PC-4) that applies a first rank 2 precoding matrix to the first antenna port group and a second rank 2 precoding matrix to the second antenna port group, a two bit port group indicator and a single TPMI field having a single state that indicates a non-coherent precoder that applies a rank 4 precoding matrix to the first antenna port group or the second antenna port group, the two bit port group indicator and a single TPMI field having two states that indicate a two antenna partial coherent precoder (PC-2) or a four antenna partial coherent precoder (PC-4) that applies a rank 4 precoding matrix to the first antenna port group or the second antenna port group, the two bit port group indicator, the first TPMI field and the second TPMI field, each having six states that indicate a non-coherent precoder that applies a first rank 2 precoding matrix to the first antenna port group and a second rank 2 precoding matrix to the second antenna port group, or the two bit port group indicator, the first TPMI field having eight states and the second TPMI field having 8 states that indicate a two antenna partial coherent precoder (PC-2) or a four antenna partial coherent precoder (PC-4) that applies a first rank 2 precoding matrix to the first antenna port group and a second rank 2 precoding matrix to the second antenna port group.

In some aspects, the 8 port uplink MIMO precoder of rank 4 and a configuration of a first antenna port group of four antenna ports and a second antenna port group of four antenna ports, with a relationship between a precoding matrix applied to the first antenna port group and the precoding matrix applied to the second antenna port group, wherein the 8 port uplink MIMO precoder is indicated by a two bit port group indicator and one of: a single TPMI field having a single state that indicates a non-coherent precoder that applies a rank 4 precoding matrix to the first antenna port group or the second antenna port group, a single TPMI field having two states that indicate a two antenna partial coherent precoder (PC-2) that applies a rank 4 precoding matrix to the first antenna port group or the second antenna port group, a single TPMI field having four states that indicate a four antenna partial coherent precoder (PC-4) that applies a rank 4 precoding matrix to the first antenna port group or the second antenna port group, a single TPMI field having six states that indicate a non-coherent precoder that applies a first rank 2 precoding matrix to the first antenna port group and a second rank 2 precoding matrix to the second antenna port group, or a single TPMI field having eight states that indicate a two antenna partial coherent precoder (PC-2) or a four antenna partial coherent precoder (PC-4) that applies a first rank 2 precoding matrix to the first antenna port group and a second rank 2 precoding matrix to the second antenna port group.

In some aspects, the 8 port uplink MIMO precoder of rank 5 and a configuration of a first antenna port group of four antenna ports and a second antenna port group of four antenna ports, with a relationship between a precoding matrix applied to the first antenna port group and the precoding matrix applied to the second antenna port group, wherein the 8 port uplink MIMO precoder is indicated by one of: a one bit port group indicator and a single TPMI field having a single state that indicates a non-coherent precoder that applies a rank 3 precoding matrix to the first antenna port group and a rank 2 precoding matrix the second antenna port group or that applies a rank 4 precoding matrix to the first antenna port group and a rank 1 precoding matrix the second antenna port group, a one bit port group indicator and a single TPMI field having two states that indicate a two antenna partial coherent precoder (PC-2) that applies the rank 3 precoding matrix to the first antenna port group and the rank 2 precoding matrix the second antenna port group or that applies the rank 4 precoding matrix to the first antenna port group and the rank 1 precoding matrix the second antenna port group, a one bit port group indicator and a single TPMI field having four states that indicate a four antenna partial coherent precoder (PC-4) that applies the rank 3 precoding matrix to the first antenna port group and the rank 2 precoding matrix the second antenna port group or that applies the rank 4 precoding matrix to the first antenna port group and the rank 1 precoding matrix the second antenna port group, a one bit port group indicator and the first TPMI field having 1 state and the second TPMI field having 1 state that indicate a non-coherent precoder that applies the rank 3 precoding matrix to the first antenna port group and the rank 2 precoding matrix the second antenna port group, a one bit port group indicator and the first TPMI field having 2 states and the second TPMI field having 2 states that indicate a two antenna partial coherent precoder (PC-2) that applies the rank 3 precoding matrix to the first antenna port group and the rank 2 precoding matrix the second antenna port group or that applies the rank 4 precoding matrix to the first antenna port group and the rank 1 precoding matrix the second antenna port group, a one bit port group indicator and the first TPMI field having 4 states and the second TPMI field having 4 states that indicate a four antenna partial coherent precoder (PC-4) that applies the rank 3 precoding matrix to the first antenna port group and the rank 2 precoding matrix the second antenna port group or that applies the rank 4 precoding matrix to the first antenna port group and the rank 1 precoding matrix the second antenna port group, a one bit port group indicator and the first TPMI field having 2 states and the second TPMI field having 2 states that indicate a four antenna partial coherent precoder (PC-4) that applies the rank 4 precoding matrix to the first antenna port group and the rank 1 precoding matrix the second antenna port group, a one bit port group indicator and the first TPMI field having 1 state and the second TPMI field having 6 states that indicate a non-coherent precoder that applies the rank 3 precoding matrix to the first antenna port group and the rank 2 precoding matrix the second antenna port group, a one bit port group indicator and the first TPMI field having 2 states and the second TPMI field having 8 states that indicate a two antenna partial coherent precoder (PC-2) that applies the rank 3 precoding matrix to the first antenna port group and the rank 2 precoding matrix the second antenna port group or that applies the rank 4 precoding matrix to the first antenna port group and the rank 1 precoding matrix the second antenna port group, a one bit port group indicator and the first TPMI field having 4 states and the second TPMI field having 8 states that indicate a four antenna partial coherent precoder (PC-4) that applies the rank 3 precoding matrix to the first antenna port group and the rank 2 precoding matrix the second antenna port group, a one bit port group indicator and the first TPMI field having 2 states and the second TPMI field having 16 states that indicate a four antenna partial coherent precoder (PC-4) that applies the rank 4 precoding matrix to the first antenna port group and the rank 1 precoding matrix the second antenna port group, a two bit port group indicator and a single TPMI field having a single state that indicates a non-coherent precoder that applies the rank 3 precoding matrix to the first antenna port group and the rank 2 precoding matrix the second antenna port group or that applies the rank 4 precoding matrix to the first antenna port group and the rank 1 precoding matrix the second antenna port group, the two bit port group indicator and a single TPMI field having two states that indicate a two antenna partial coherent precoder (PC-2) that applies the rank 3 precoding matrix to the first antenna port group and the rank 2 precoding matrix the second antenna port group or that applies the rank 4 precoding matrix to the first antenna port group and the rank 1 precoding matrix the second antenna port group, the two bit port group indicator and a single TPMI field having four states that indicate a four antenna partial coherent precoder (PC-4) that applies the rank 3 precoding matrix to the first antenna port group and the rank 2 precoding matrix the second antenna port group, the two bit port group indicator and a single TPMI field having two states that indicate a four antenna partial coherent precoder (PC-4) that applies the rank 4 precoding matrix to the first antenna port group and the rank 1 precoding matrix the second antenna port group, a two bit port group indicator and the first TPMI field having 1 state and the second TPMI field having 1 state that indicate a non-coherent precoder that applies the rank 3 precoding matrix to the first antenna port group and the rank 2 precoding matrix the second antenna port group or that applies the rank 4 precoding matrix to the first antenna port group and the rank 1 precoding matrix the second antenna port group, a two bit port group indicator and the first TPMI field having 2 states and the second TPMI field having 2 states that indicate a two antenna partial coherent precoder (PC-2) or a four antenna partial coherent precoder (PC-4) that applies the rank 3 precoding matrix to the first antenna port group and the rank 2 precoding matrix the second antenna port group or that applies the rank 4 precoding matrix to the first antenna port group and the rank 1 precoding matrix the second antenna port group, a two bit port group indicator and the first TPMI field having 4 states and the second TPMI field having 4 states that indicate a four antenna partial coherent precoder (PC-4) that applies the rank 3 precoding matrix to the first antenna port group and the rank 2 precoding matrix the second antenna port group, a two bit port group indicator and the first TPMI field having 1 state and the second TPMI field having 6 states that indicate a non-coherent precoder that applies the rank 3 precoding matrix to the first antenna port group and the rank 2 precoding matrix the second antenna port group, a two bit port group indicator and the first TPMI field having 2 states and the second TPMI field having 8 states that indicate a two antenna partial coherent precoder (PC-2) that applies the rank 3 precoding matrix to the first antenna port group and the rank 2 precoding matrix the second antenna port group or that applies the rank 4 precoding matrix to the first antenna port group and the rank 1 precoding matrix the second antenna port group, a two bit port group indicator and the first TPMI field having 4 states and the second TPMI field having 8 states that indicate a four antenna partial coherent precoder (PC-4) that applies the rank 3 precoding matrix to the first antenna port group and the rank 2 precoding matrix the second antenna port group, or a two bit port group indicator and the first TPMI field having 2 states and the second TPMI field having 16 states that indicate a four antenna partial coherent precoder (PC-4) that applies the rank 4 precoding matrix to the first antenna port group and the rank 1 precoding matrix the second antenna port group.

In some aspects, the 8 port uplink MIMO precoder is of rank 6, with a relationship between a first precoding matrix applied to a first antenna port group and a second precoding matrix applied to a second antenna port group, wherein the 8 port uplink MIMO precoder is indicated by one of: a single TPMI field having a single state that indicates a non-coherent precoder that applies a first rank 3 precoding matrix to the first antenna port group and a second rank 3 precoding matrix the second antenna port group, a single TPMI field having two states that indicate a two antenna partial coherent precoder (PC-2) that applies a first rank 3 precoding matrix to the first antenna port group and a second rank 3 precoding matrix the second antenna port group or that applies a rank 4 precoding matrix to the first antenna port and a rank 2 precoding matrix to the second antenna port, a single TPMI field having four states that indicate a four antenna partial coherent precoder (PC-4) that applies a first rank 3 precoding matrix to the first antenna port group and a second rank 3 precoding matrix the second antenna port group or that applies a rank 4 precoding matrix to the first antenna port and a rank 2 precoding matrix to the second antenna port, a one bit port group indicator and the first TPMI field having 1 state and the second TPMI field having 1 state that indicate a non-coherent precoder that applies a rank 4 precoding matrix to the first antenna port and a rank 2 precoding matrix to the second antenna port, a one bit port group indicator and the first TPMI field having 2 states and the second TPMI field having 2 states that indicate a two antenna partial coherent precoder (PC-2) that applies a rank 4 precoding matrix to the first antenna port and a rank 2 precoding matrix to the second antenna port, a one bit port group indicator and the first TPMI field having 2 states and the second TPMI field having 2 states that indicate a four antenna partial coherent precoder (PC-4) that applies the rank 4 precoding matrix to the first antenna port group and the rank 1 precoding matrix the second antenna port group, the first TPMI field having 1 state and the second TPMI field having 1 state that indicate a non-coherent precoder that applies the first rank 3 precoding matrix to the first antenna port group and the second rank 3 precoding matrix the second antenna port group, the first TPMI field having 2 states and the second TPMI field having 2 states that indicate a two antenna partial coherent precoder (PC-2) that applies the first rank 3 precoding matrix to the first antenna port group and the second rank 3 precoding matrix the second antenna port group, the first TPMI field having 4 states and the second TPMI field having 4 states that indicate a four antenna partial coherent precoder (PC-4) that applies the first rank 3 precoding matrix to the first antenna port group and the second rank 3 precoding matrix the second antenna port group, the first TPMI field having 1 state and the second TPMI field having 6 states that indicate a non-coherent precoder that applies the rank 4 precoding matrix to the first antenna port group and the rank 2 precoding matrix the second antenna port group, the first TPMI field having 2 state and the second TPMI field having 8 states that indicate a two antenna partial coherent precoder (PC-2) that applies the rank 4 precoding matrix to the first antenna port group and the rank 2 precoding matrix the second antenna port group, the first TPMI field having 2 states and the second TPMI field having 8 states that indicate a four antenna partial coherent precoder (PC-4) that applies the rank 4 precoding matrix to the first antenna port group and the rank 2 precoding matrix the second antenna port group, a two bit port group indicator and a single TPMI field having a single state that indicates a non-coherent precoder that applies the first rank 3 precoding matrix to the first antenna port group and the second rank 3 precoding matrix the second antenna port group or that applies the rank 4 precoding matrix to the first antenna port group and the rank 2 precoding matrix the second antenna port group, the two bit port group indicator and a single TPMI field having two states that indicate a two antenna partial coherent precoder (PC-2) that applies the first rank 3 precoding matrix to the first antenna port group and the second rank 3 precoding matrix the second antenna port group or that applies the rank 4 precoding matrix to the first antenna port group and the rank 2 precoding matrix the second antenna port group, the two bit port group indicator and a single TPMI field having four states that applies the first rank 3 precoding matrix to the first antenna port group and the second rank 3 precoding matrix the second antenna port group, the two bit port group indicator and a single TPMI field having two states that indicate a four antenna partial coherent precoder (PC-4) that applies the rank 4 precoding matrix to the first antenna port group and the rank 2 precoding matrix the second antenna port group, a two bit port group indicator and the first TPMI field having 1 state and the second TPMI field having 1 state that indicate a non-coherent precoder that applies the first rank 3 precoding matrix to the first antenna port group and the second rank 3 precoding matrix the second antenna port group or that applies the rank 4 precoding matrix to the first antenna port group and the rank 2 precoding matrix the second antenna port group, a two bit port group indicator and the first TPMI field having 2 states and the second TPMI field having 2 states that indicate a two antenna partial coherent precoder (PC-2) or a four antenna partial coherent precoder (PC-4) that applies the first rank 3 precoding matrix to the first antenna port group and the second rank 4 precoding matrix the second antenna port group or that applies the rank 4 precoding matrix to the first antenna port group and the rank 2 precoding matrix the second antenna port group, a two bit port group indicator and the first TPMI field having 4 states and the second TPMI field having 4 states that indicate a four antenna partial coherent precoder (PC-4) that applies the first rank 3 precoding matrix to the first antenna port group and the second rank 3 precoding matrix the second antenna port group, two bit port group indicator and the first TPMI field having 1 state and the second TPMI field having 6 states that indicate a non-coherent precoder that applies the rank 4 precoding matrix to the first antenna port group and the rank 2 precoding matrix the second antenna port group, or a two bit port group indicator and the first TPMI field having 2 states and the second TPMI field having 8 states that indicate a two antenna partial coherent precoder (PC-2) or a four antenna partial coherent precoder (PC-4) that applies the rank 4 precoding matrix to the first antenna port group and the rank 2 precoding matrix the second antenna port group.

In some aspects, the 8 port uplink MIMO precoder is of rank 7, with a relationship between a first precoding matrix applied to a first antenna port group and a second precoding matrix applied to a second antenna port group, wherein the 8 port uplink MIMO precoder is indicated by one of: a single TPMI field having a single state that indicates a non-coherent precoder that applies a rank 4 precoding matrix to the first antenna port group and a second rank 3 precoding matrix the second antenna port group, a single TPMI field having two states that indicate a two antenna partial coherent precoder (PC-2) or a four antenna partial coherent precoder (PC-4) that applies a rank 4 precoding matrix to the first antenna port group and a second rank 3 precoding matrix the second antenna port group, the first TPMI field having 1 state and the second TPMI field having 1 state that indicate a non-coherent precoder that applies a rank 4 precoding matrix to the first antenna port group and a second rank 3 precoding matrix the second antenna port group, the first TPMI field having 2 states and the second TPMI field having 2 states that indicate a two antenna partial coherent precoder (PC-2) that applies a rank 4 precoding matrix to the first antenna port group and a second rank 3 precoding matrix the second antenna port group, the first TPMI field having 4 states and the second TPMI field having 4 states that indicate a four antenna partial coherent precoder (PC-4) that applies a rank 4 precoding matrix to the first antenna port group and a second rank 3 precoding matrix the second antenna port group, a one bit port group indicator and the first TPMI field having 1 state and the second TPMI field having 1 state that indicate a non-coherent precoder that applies a rank 4 precoding matrix to the first antenna port group and a second rank 3 precoding matrix the second antenna port group, a one bit port group indicator and the first TPMI field having 2 states and the second TPMI field having 2 states that indicate a two antenna partial coherent precoder (PC-2) that applies a rank 4 precoding matrix to the first antenna port group and a second rank 3 precoding matrix the second antenna port group, or a one bit port group indicator and the first TPMI field having 4 states and the second TPMI field having 4 states that indicate a four antenna partial coherent precoder (PC-4) that applies a rank 4 precoding matrix to the first antenna port group and a second rank 3 precoding matrix the second antenna port group. In some aspects, the 8 port uplink MIMO precoder is of rank 8, with a relationship between a first precoding matrix applied to a first antenna port group and a second precoding matrix applied to a second antenna port group, wherein the 8 port uplink MIMO precoder is indicated by one of: a single TPMI field having 1 state that indicates a non-coherent precoder that applies a first rank 4 precoding matrix to the first antenna port group and a second rank 4 precoding matrix to the second antenna port group, a single TPMI field having two states that indicate a two antenna partial coherent precoder (PC-2) or a four antenna partial coherent precoder (PC-4) that applies the first rank 4 precoding matrix to the first antenna port group and the second rank 4 precoding matrix to the second antenna port group, the first TPMI field having 1 state and the second TPMI field having 1 state that indicate a non-coherent precoder that applies the first rank 4 precoding matrix to the first antenna port group and the second rank 4 precoding matrix to the second antenna port group, the first TPMI field having 2 states and the second TPMI field having 2 states that indicate a two antenna partial coherent precoder (PC-2) that applies the first rank 4 precoding matrix to the first antenna port group and the second rank 4 precoding matrix to the second antenna port group, or the first TPMI field having 2 states and the second TPMI field having 2 states that indicate a four antenna partial coherent precoder (PC-4) that applies the first rank 4 precoding matrix to the first antenna port group and the second rank 4 precoding matrix to the second antenna port group.

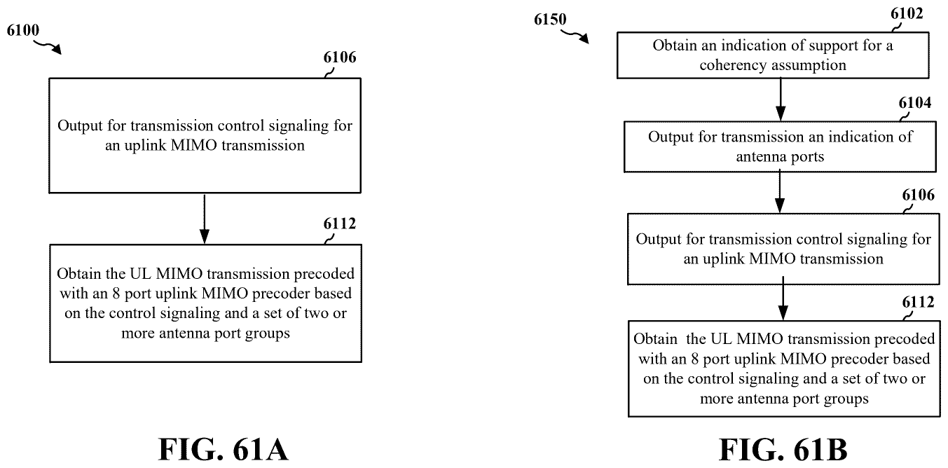

FIG. 61A is a flowchart 6100 of a method of wireless communication. The method may be performed by a network node such as a base station or a component of a base station (e.g., the base station 102, 310; the CU 110; the DU 130; the RU 140; the network entity 6202). The method may enable the scheduling and transmission of UL MIMO transmissions using various precoding options for 8Tx.

At 6106, the network node outputs for transmission control signaling for an UL transmission. The output may be performed, e.g., by the codebook signaling component 199, which may be a component of the base station 102, 310, or the network entity 6202.

At 6112, the network node obtains the UL MIMO transmission precoded with an 8 port uplink MIMO precoder based on the control signaling and a set of two or more antenna port groups. The obtaining may be performed, e.g., by the codebook signaling component 199, which may be a component of the base station 102, 310, or the network entity 6202.

In some aspects, the precoder may be based on a rank of the UL MIMO transmission, a single precoder being provided for each of rank 5, rank 6, rank 7, or rank 8 of the 8 port uplink MIMO precoder. In some aspects, the 8 port uplink MIMO precoder may be based on a DFT codebook with an oversampling factor of 2 and having co-phasing. In some aspects, the 8 precoders may be provided for each of rank 5 and rank 6 and 4 precoders are provided for each of rank 7 and rank 8. In some aspects, the 8 precoders may be provided for each of rank 5, rank 6, rank 7, and rank 8. In some aspects, the 8 port uplink MIMO precoder may be based on a codebook that is optimized for spatially uncorrelated channels. In some aspects, the codebook may be based on a combination of two 4×4 Householder matrices, and wherein co-phasing is applied between two antenna port groups. In some aspects, the 8 port uplink MIMO precoder may be based on an 8 Tx precoders that are based on co-phasing a precoder for a less than 8 antenna ports. In some aspects, a subset of the 8 Tx precoders may be used according to a rank of the UL MIMO transmission. In some aspects, the multiple layers may be transmitted with one or more groups of coherent antenna ports. In some aspects, the one or more groups of coherent antenna ports may include a first subset of four coherent antenna ports and a second subset of four coherent antenna ports. In some aspects, the one or more groups of coherent antenna ports may include a first subset of two coherent antenna ports, a second subset of two coherent antenna ports, and a third subset of four coherent antenna ports. In some aspects, the one or more groups of coherent antenna ports may include a first subset of two coherent antenna ports, a second subset of two coherent antenna ports, a third subset of two coherent antenna ports, and a fourth subset of two coherent antenna ports. In some aspects, the UL MIMO transmission may be a combination of a partially coherent transmission and a non-coherent transmission, and wherein the one or more groups of coherent antenna ports includes a first subset of one antenna port, a second subset of one antenna port, a third subset of two coherent antenna ports, and a fourth subset of four coherent antenna ports. In some aspects, antenna ports from different antenna port groups may be configured in a single SRS resource, each antenna port group having at least one of a different cyclic shift or a different comb index. In some aspects, antenna ports from different antenna port groups may be configured with different SRS resources.

FIG. 61B is a flowchart 6150 of a method of wireless communication. The method may be performed by a network node such as a base station or a component of a base station (e.g., the base station 102, 310; the CU 110; the DU 130; the RU 140; the network entity 6202). The method may enable the scheduling and transmission of UL MIMO transmissions using various precoding options for 8Tx.

At 6106, the network node outputs for transmission control signaling for an UL transmission. The output may be performed, e.g., by the codebook signaling component 199, which may be a component of the base station 102, 310, or the network entity 6202.

At 6112, the network node obtains the UL MIMO transmission precoded with an 8 port uplink MIMO precoder based on the control signaling and a set of two or more antenna port groups. The obtaining may be performed, e.g., by the codebook signaling component 199, which may be a component of the base station 102, 310, or the network entity 6202.

In some aspects, the precoder may be based on a rank of the UL MIMO transmission, a single precoder being provided for each of rank 5, rank 6, rank 7, or rank 8 of the 8 port uplink MIMO precoder. In some aspects, the 8 port uplink MIMO precoder may be based on a DFT codebook with an oversampling factor of 2 and having co-phasing. In some aspects, the 8 precoders may be provided for each of rank 5 and rank 6 and 4 precoders are provided for each of rank 7 and rank 8. In some aspects, the 8 precoders may be provided for each of rank 5, rank 6, rank 7, and rank 8. In some aspects, the 8 port uplink MIMO precoder may be based on a codebook that is optimized for spatially uncorrelated channels. In some aspects, the codebook may be based on a combination of two 4×4 Householder matrices, and wherein co-phasing is applied between two antenna port groups. In some aspects, the 8 port uplink MIMO precoder may be based on an 8 Tx precoders that are based on co-phasing a precoder for a less than 8 antenna ports. In some aspects, a subset of the 8 Tx precoders may be used according to a rank of the UL MIMO transmission. In some aspects, the multiple layers may be transmitted with one or more groups of coherent antenna ports. In some aspects, the one or more groups of coherent antenna ports may include a first subset of four coherent antenna ports and a second subset of four coherent antenna ports. In some aspects, the one or more groups of coherent antenna ports may include a first subset of two coherent antenna ports, a second subset of two coherent antenna ports, and a third subset of four coherent antenna ports. In some aspects, the one or more groups of coherent antenna ports may include a first subset of two coherent antenna ports, a second subset of two coherent antenna ports, a third subset of two coherent antenna ports, and a fourth subset of two coherent antenna ports. In some aspects, the UL MIMO transmission may be a combination of a partially coherent transmission and a non-coherent transmission, and wherein the one or more groups of coherent antenna ports includes a first subset of one antenna port, a second subset of one antenna port, a third subset of two coherent antenna ports, and a fourth subset of four coherent antenna ports. In some aspects, antenna ports from different antenna port groups may be configured in a single SRS resource, each antenna port group having at least one of a different cyclic shift or a different comb index. In some aspects, antenna ports from different antenna port groups may be configured with different SRS resources.

In some aspects, the precoder may be based on a rank of the UL MIMO transmission, a single precoder being provided for each of rank 5, rank 6, rank 7, or rank 8 of the 8 port uplink MIMO precoder. In some aspects, at 6104, the network node may output for transmission an indication selecting four antenna ports from a set of 8 antenna ports and selecting one or more additional antenna ports according to the rank for the UL MIMO transmission, the one or more additional antenna ports having lowest port indices from 4 unindicated antenna ports from the set of 8 antenna ports. The output may be performed, e.g., by the codebook signaling component 199, which may be a component of the base station 102, 310, or the network entity 6202.

In some aspects, the network node may output for transmission, at 6104, an indication of a first set of four antenna ports from a set of 8 antenna ports and a second set of four antenna ports from the set of 8 antenna ports, wherein the 8 port uplink MIMO precoder is applied to the first set of four antenna ports and one or more additional antenna ports from the second set of four antenna ports according to the rank for the UL MIMO transmission, the one or more additional antenna ports from the second set of four antenna ports being applied in a set order in which the second set of four antenna ports is indicated. The output may be performed, e.g., by the codebook signaling component 199, which may be a component of the base station 102, 310, or the network entity 6202.

In some aspects, two precoders may be provided for rank 5, rank 6, rank 7, or rank 8 of the 8 port uplink MIMO precoder that applied to one or more sets of coherent antenna port pairs for a set of 8 antenna ports, coherent combining may be applied for each coherent antenna port pair.

In some aspects, the network node may output for transmission, at 6104, an indication selecting two sets of coherent antenna port pairs from the set of 8 antenna ports and selecting one or more additional antenna ports according to a rank for the UL MIMO transmission, the one or more additional antenna ports selected from remaining coherent antenna port pairs. The output may be performed, e.g., by the codebook signaling component 199, which may be a component of the base station 102, 310, or the network entity 6202.

In some aspects, the network node may output for transmission, at 6104, an indication of a first set of two coherent antenna port pairs and a second set of two coherent antenna port pairs from the set of 8 antenna ports, wherein the UE applies the 8 port uplink MIMO precoder to the first set of two coherent antenna port pairs and one or more additional antenna ports from the second set of two coherent antenna port pairs according to a rank for the UL MIMO transmission, the one or more additional antenna ports from the second set of two antenna ports being applied in a set order in which the second set of two coherent antenna port pairs is indicated. The output may be performed, e.g., by the codebook signaling component 199, which may be a component of the base station 102, 310, or the network entity 6202.

In some aspects, precoders may be provided for rank 5, rank 6, rank 7, or rank 8 of the 8 port uplink MIMO precoder, the two precoders being applied to a first group of four coherent antenna ports and a second group of four coherent antenna ports. Coherent combining may be applied for each coherent antenna port group with a length-4 orthogonal sequence, wherein one of: a first set of layers is based on the first group of four coherent antenna ports and a second set of layers is based on the second group of four coherent antenna ports according to a rank of the 8 port uplink MIMO transmission, or a first four layers of the UL MIMO transmission are based on the first group of four coherent antenna ports and additional one or more layers are based on the second group of four coherent antenna ports according to the rank of the 8 port uplink MIMO transmission. The application may be performed, e.g., by the codebook signaling component 199, which may be a component of the base station 102, 310, or the network entity 6202.

In some aspects, the 8 port uplink MIMO precoder may be based on a DFT codebook with an oversampling factor of 2 and having co-phasing. In some aspects, the 8 precoders may be provided for each of rank 5 and rank 6 and 4 precoders are provided for each of rank 7 and rank 8. In some aspects, the 8 precoders may be provided for each of rank 5, rank 6, rank 7, and rank 8. In some aspects, the 8 port uplink MIMO precoder may be based on a codebook that is optimized for spatially uncorrelated channels. In some aspects, the codebook may be based on a combination of two 4×4 Householder matrices, and wherein co-phasing is applied between two antenna port groups. In some aspects, the 8 port uplink MIMO precoder may be based on an 8 Tx precoders that are based on co-phasing a precoder for a less than 8 antenna ports. In some aspects, a subset of the 8 Tx precoders may be used according to a rank of the UL MIMO transmission. In some aspects, the multiple layers may be transmitted with one or more groups of coherent antenna ports. In some aspects, the one or more groups of coherent antenna ports may include a first subset of four coherent antenna ports and a second subset of four coherent antenna ports. In some aspects, the one or more groups of coherent antenna ports may include a first subset of two coherent antenna ports, a second subset of two coherent antenna ports, and a third subset of four coherent antenna ports. In some aspects, the one or more groups of coherent antenna ports may include a first subset of two coherent antenna ports, a second subset of two coherent antenna ports, a third subset of two coherent antenna ports, and a fourth subset of two coherent antenna ports. In some aspects, the UL MIMO transmission may be a combination of a partially coherent transmission and a non-coherent transmission, and wherein the one or more groups of coherent antenna ports includes a first subset of one antenna port, a second subset of one antenna port, a third subset of two coherent antenna ports, and a fourth subset of four coherent antenna ports.

In some aspects, the network node may output an indication of an active antenna port group, e.g., at 6104, and receive a TPMI and a rank indicator for the active antenna port group, e.g., at 6106. The output may be performed, e.g., by the codebook signaling component 199, which may be a component of the base station 102, 310, or the network entity 6202. A number of bits in a TPMI field for the 8 port UL MIMO transmission may be reduced in comparison to a 4 port UL MIMO transmission.

A precoder for each antenna port group is based on a codebook for a 2 port UL MIMO transmission or a 4 port UL MIMO transmission, and a scaling factor may be applied based on a number of antenna ports in a corresponding antenna port group to which the precoder is applied.

In some aspects, as shown at 6102, the network node may obtain an indication of support for a coherency assumption for antenna port groups. The obtaining may be performed, e.g., by the codebook signaling component 199, which may be a component of the base station 102, 310, or the network entity 6202.

In some aspects, antenna ports from different antenna port groups may be configured in a single SRS resource, each antenna port group having at least one of a different cyclic shift or a different comb index. In some aspects, antenna ports from different antenna port groups may be configured with different SRS resources.

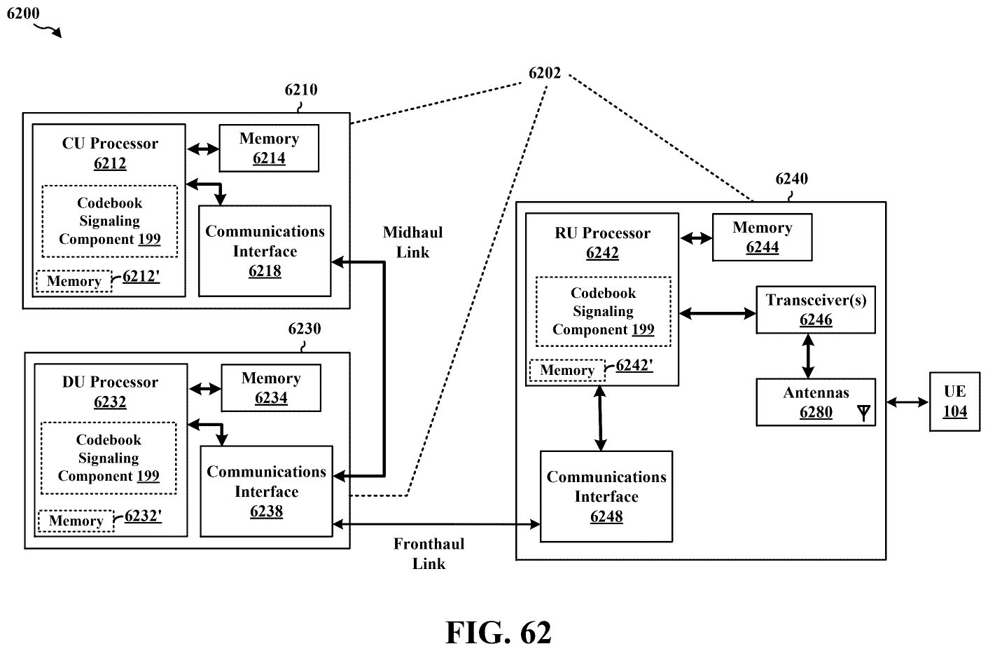

FIG. 62 is a diagram 6200 illustrating an example of a hardware implementation for a network entity 6202. The network entity 6202 may be a BS, a component of a BS, or may implement BS functionality. The network entity 6202 may include at least one of a CU 6210, a DU 6230, or an RU 6240. For example, depending on the layer functionality handled by the codebook signaling component 199, the network entity 6202 may include the CU 6210; both the CU 6210 and the DU 6230; each of the CU 6210, the DU 6230, and the RU 6240; the DU 6230; both the DU 6230 and the RU 6240; or the RU 6240. The CU 6210 may include a CU processor 6212. The CU processor 6212 may include on-chip memory 6212′. In some aspects, the CU 6210 may further include additional memory modules 6214 and a communications interface 6218. The CU 6210 communicates with the DU 6230 through a midhaul link, such as an F1 interface. The DU 6230 may include a DU processor 6232. The DU processor 6232 may include on-chip memory 6232′. In some aspects, the DU 6230 may further include additional memory modules 6234 and a communications interface 6238. The DU 6230 communicates with the RU 6240 through a fronthaul link. The RU 6240 may include an RU processor 6242. The RU processor 6242 may include on-chip memory 6242′. In some aspects, the RU 6240 may further include additional memory modules 6244, one or more transceivers 6246, antennas 6280, and a communications interface 6248. The RU 6240 communicates with the UE 104. The on-chip memory 6212′, 6232′, 6242′ and the additional memory modules 6214, 6234, 6244 may each be considered a computer-readable medium/memory. Each computer-readable medium/memory may be non-transitory. Each of the processors 6212, 6232, 6242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the codebook signaling component 199 is configured to output for transmission control signaling for an uplink MIMO transmission, the control signaling including a first TPMI field and a second TPMI field and an SRS resource set indicator; and receive the uplink MIMO transmission precoded with an 8 port uplink MIMO precoder, the 8 port uplink MIMO precoder being based on a 4 port uplink MIMO codebook with a mapping indicated by one or more of the first TPMI field, the second TPMI field, or the SRS resource set indicator. In some aspects, the codebook handling codebook handling component 198 may be further configured to construct an 8 port precoding matrix based on the 4 port uplink MIMO codebook and the mapping indicated by the one or more of the first TPMI field, the second TPMI field, or the SRS resource set indicator and/or to output for transmission a configuration of a first antenna port group of four antenna ports and a second antenna port group of four antenna ports, wherein a first precoding matrix indicated by the first TPMI field is applied to the first antenna port group and a second precoding matrix indicated by the second TPMI field is applied to the second antenna port group. The codebook signaling component 199 may be configured to output for transmission control signaling for an UL transmission and obtain the UL MIMO transmission precoded with an 8 port uplink MIMO precoder based on the control signaling and a set of two or more antenna port groups. The codebook signaling component 199 may be within one or more processors of one or more of the CU 6210, DU 6230, and the RU 6240. The codebook signaling component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 6202 may include a variety of components configured for various functions. In one configuration, the network entity 6202 includes means for outputting for transmission control signaling for an uplink MIMO transmission, the control signaling including a first TPMI field and a second TPMI field and an SRS resource set indicator; and means for receiving the uplink MIMO transmission precoded with an 8 port uplink MIMO precoder, the 8 port uplink MIMO precoder being based on a 4 port uplink MIMO codebook with a mapping indicated by one or more of the first TPMI field, the second TPMI field, or the SRS resource set indicator. In some aspects, the apparatus 5904 may further include means for constructing an 8 port precoding matrix based on the 4 port uplink MIMO codebook and the mapping indicated by the one or more of the first TPMI field, the second TPMI field, or the SRS resource set indicator and/or means for outputting for transmission a configuration of a first antenna port group of four antenna ports and a second antenna port group of four antenna ports, wherein a first precoding matrix indicated by the first TPMI field is applied to the first antenna port group and a second precoding matrix indicated by the second TPMI field is applied to the second antenna port group. In some aspects, the network entity 6202 may further include means for outputting for transmission control signaling for an UL transmission and means for obtaining the UL MIMO transmission precoded with an 8 port uplink MIMO precoder based on the control signaling and a set of two or more antenna port groups. The network entity may further include means for performing any of the aspects described in connection with FIGS. 60A, 51B, 52A, 52B. The means may be the codebook signaling component 199 of the network entity 6202 configured to perform the functions recited by the means. As described supra, the network entity 6202 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

1-40. (canceled)

41. An apparatus for wireless communication at a user equipment (UE), comprising:
a memory; and
at least one processor coupled to the memory and, based at least in part on information stored in the memory, the at least one processor is configured to:
receive control signaling scheduling an uplink multiple input multiple output (MIMO) transmission for 8 antenna ports, the control signaling including a first part based on a rank, a second part based on a precoding matrix type, and a third part based on a transmitted precoding matrix indicator (TPMI) associated with one or two 4 antenna port precoding matrices; and
transmit the uplink MIMO transmission precoded with an 8 port uplink MIMO precoder, the 8 port uplink MIMO precoder being based on a 4 port uplink MIMO codebook with a mapping indicated by a combination of the first part, the second part, or the third part of the control signaling.

42. The apparatus of claim 41, wherein for a single layer transmission with the 8 antenna ports, the precoding matrix type is indicated from a set including:
$$\frac{1}{\sqrt{2}} [ \begin{matrix}{W}_{4 Tx , r = 1} \\ 0\end{matrix} ] , or$$
$$\frac{1}{\sqrt{2}} [ \begin{matrix}0 \\ {W}_{4 Tx , r = 1}\end{matrix} ] ,$$
wherein W_{4Tx,r=l}corresponds to a 4 antenna precoding matrix for rank 1.

43. The apparatus of claim 41, wherein for a two layer transmission with the 8 antenna ports, the precoding matrix type is indicated from a set including:
$$\frac{1}{\sqrt{2}} [ \begin{matrix}{W}_{4 Tx , r = 2} \\ 0\end{matrix} ] ,$$
$$\frac{1}{\sqrt{2}} [ \begin{matrix}0 \\ {W}_{4 Tx , r = 2}\end{matrix} ] , or$$
$$\frac{1}{\sqrt{2}} [ \begin{matrix}{W}_{4 Tx , r = 1} & 0 \\ 0 & {W}_{4 Tx , r = 1}^{′}\end{matrix} ] ,$$
wherein W_{4Tx,r=2} corresponds to a 4 antenna precoding matrix for rank 2, W_{4Tx,r=1} corresponds to a first 4 antenna precoding matrix for rank 1, and W_{4Tx,r=1} corresponds to a second 4 antenna precoding matrix for rank 1.

44. The apparatus of claim 41, wherein for a three layer transmission with the 8 antenna ports, the precoding matrix type is indicated from a set including:
$$\frac{1}{\sqrt{2}} [ \begin{matrix}{W}_{4 Tx , r = 3} \\ 0\end{matrix} ] ,$$
$$\frac{1}{\sqrt{2}} [ \begin{matrix}0 \\ {W}_{4 Tx , r = 3}\end{matrix} ] ,$$
$$\frac{1}{\sqrt{2}} [ \begin{matrix}{W}_{4 Tx , r = 2} & 0 \\ 0 & {W}_{4 Tx , r = 1}\end{matrix} ] , or$$
$$\frac{1}{\sqrt{2}} [ \begin{matrix}{W}_{4 Tx , r = 1} & 0 \\ 0 & {W}_{4 Tx , r = 2}\end{matrix} ] ,$$
wherein W_{4Tx,r=3} corresponds to a 4 antenna precoding matrix for rank 3, W_{4Tx,r=2} corresponds to a 4 antenna precoding matrix for rank 2, and W_{4Tx,r=1} corresponds to a 4 antenna precoding matrix for rank 1.

45. The apparatus of claim 41, wherein for a four layer transmission with the 8 antenna ports, the precoding matrix type is indicated from a set including:
$$\frac{1}{\sqrt{2}} [ \begin{matrix}{W}_{4 Tx , r = 4} \\ 0\end{matrix} ] ,$$
$$\frac{1}{\sqrt{2}} [ \begin{matrix}0 \\ {W}_{4 Tx , r = 4}\end{matrix} ] , or$$
$$\frac{1}{\sqrt{2}} [ \begin{matrix}{W}_{4 Tx , r = 2} & 0 \\ 0 & {W}_{4 Tx , r = 2}\end{matrix} ] ,$$
wherein W_{4Tx,r=4} corresponds to a 4 antenna precoding matrix for rank 4, W_{4Tx,r=2} corresponds to a first 4 antenna precoding matrix for rank 2, and W_{4Tx,r=2} corresponds to a second 4 antenna precoding matrix for rank 2.

46. The apparatus of claim 41, wherein for a five layer transmission with the 8 antenna ports, the precoding matrix type includes:
$$\frac{1}{\sqrt{2}} [ \begin{matrix}{W}_{4 Tx , r = 2} & 0 \\ 0 & {W}_{4 Tx , r = 3}\end{matrix} ] ,$$
wherein W_{4Tx,r=2} corresponds to a 4 antenna precoding matrix for rank 2, and W_{4Tx,r=3} corresponds to a 4 antenna precoding matrix for rank 3.

47. The apparatus of claim 41, wherein for a six layer transmission with the 8 antenna ports, the precoding matrix type:
$$\frac{1}{\sqrt{2}} [ \begin{matrix}{W}_{4 Tx , r = 3} & 0 \\ 0 & {W}_{4 Tx , r = 3}^{′}\end{matrix} ] ,$$
wherein W_{4Tx,r=3} corresponds to a first 4 antenna precoding matrix for rank 3, and W_{4Tx,r=3} corresponds to a second 4 antenna precoding matrix for rank 3.

48. The apparatus of claim 41, wherein for a seven layer transmission with the 8 antenna ports, the precoding matrix type includes:
$$\frac{1}{\sqrt{2}} [ \begin{matrix}{W}_{4 Tx , r = 3} & 0 \\ 0 & {W}_{4 Tx , r = 4}\end{matrix} ] ,$$
wherein W_{4Tx,r=3} corresponds to a first 4 antenna precoding matrix for rank 3, and W_{4Tx,r=4} corresponds to a second 4 antenna precoding matrix for rank 3.

49. The apparatus of claim 41, wherein for an eight layer transmission with the 8 antenna ports, the precoding matrix type includes:
$$\frac{1}{\sqrt{2}} [ \begin{matrix}{W}_{4 Tx , r = 4} & 0 \\ 0 & {W}_{4 Tx , r = 4}^{′}\end{matrix} ] ,$$
wherein W_{4Tx,r=4} corresponds to a first 4 antenna precoding matrix for rank 4, and W_{4Tx,r=4} corresponds to a second 4 antenna port matrix for rank 4.

50. The apparatus of claim 41, wherein the 8 antenna ports are grouped into a first group of 4 antenna ports and a second group of 4 antenna ports that map to the 8 port uplink MIMO precoder.

51. The apparatus of claim 50, wherein the first group of 4 antenna ports includes ports 0, 1, 4, and 5, and wherein the second group of 4 antenna ports includes ports 2, 3, 6, and 7.

52. The apparatus of claim 50, wherein a grouping into the first group of 4 antenna ports and the second group of 4 antenna ports is based on a permutation operation.

53. The apparatus of claim 41, wherein the control signaling comprises downlink control information (DCI).

54. A method of wireless communication at a user equipment (UE), comprising:
receiving control signaling scheduling an uplink multiple input multiple output (MIMO) transmission for 8 antenna ports, the control signaling including a first part based on a rank, a second part based on a precoding matrix type, and a third part based on a transmitted precoding matrix indicator (TPMI) associated with one or two 4 antenna port precoding matrices; and
transmitting the uplink MIMO transmission precoded with an 8 port uplink MIMO precoder, the 8 port uplink MIMO precoder being based on a 4 port uplink MIMO codebook with a mapping indicated by a combination of the first part, the second part, or the third part of the control signaling.

55. The method of claim 54, wherein for a single layer transmission with the 8 antenna ports, the precoding matrix type is indicated from a set including:
$$\frac{1}{\sqrt{2}} [ \begin{matrix}{W}_{4 Tx , r = 1} \\ 0\end{matrix} ] , or$$
$$\frac{1}{\sqrt{2}} [ \begin{matrix}0 \\ {W}_{4 Tx , r = 1}\end{matrix} ] ,$$
wherein W_{4Tx,r=l}corresponds to a 4 antenna precoding matrix for rank 1.

56. The method of claim 54, wherein for a two layer transmission with the 8 antenna ports, the precoding matrix type is indicated from a set including:
$$\frac{1}{\sqrt{2}} [ \begin{matrix}{W}_{4 Tx , r = 2} \\ 0\end{matrix} ] ,$$
$$\frac{1}{\sqrt{2}} [ \begin{matrix}0 \\ {W}_{4 Tx , r = 2}\end{matrix} ] , or$$
$$\frac{1}{\sqrt{2}} [ \begin{matrix}{W}_{4 Tx , r = 1} & 0 \\ 0 & {W}_{4 Tx , r = 1}^{′}\end{matrix} ] ,$$
wherein W_{4Tx,r=2} corresponds to a 4 antenna precoding matrix for rank 2, W_{4Tx,r=1} corresponds to a first 4 antenna precoding matrix for rank 1, and W_{4Tx,r=1} corresponds to a second 4 antenna precoding matrix for rank 1.

57. The method of claim 54, wherein for a three layer transmission with the 8 antenna ports, the precoding matrix type is indicated from a set including:
$$\frac{1}{\sqrt{2}} [ \begin{matrix}{W}_{4 Tx , r = 3} \\ 0\end{matrix} ] ,$$
$$\frac{1}{\sqrt{2}} [ \begin{matrix}0 \\ {W}_{4 Tx , r = 3}\end{matrix} ] ,$$
$$\frac{1}{\sqrt{2}} [ \begin{matrix}{W}_{4 Tx , r = 2} & 0 \\ 0 & {W}_{4 Tx , r = 1}\end{matrix} ] , or$$
$$\frac{1}{\sqrt{2}} [ \begin{matrix}{W}_{4 Tx , r = 1} & 0 \\ 0 & {W}_{4 Tx , r = 2}\end{matrix} ] ,$$
wherein W_{4Tx,r=3} corresponds to a 4 antenna precoding matrix for rank 3, W_{4Tx,r=2} corresponds to a 4 antenna precoding matrix for rank 2, and W_{4Tx,r=1} corresponds to a 4 antenna precoding matrix for rank 1.

58. The method of claim 54, wherein for a four layer transmission with the 8 antenna ports, the precoding matrix type is indicated from a set including:
$$\frac{1}{\sqrt{2}} [ \begin{matrix}{W}_{4 Tx , r = 4} \\ 0\end{matrix} ] ,$$
$$\frac{1}{\sqrt{2}} [ \begin{matrix}0 \\ {W}_{4 Tx , r = 4}\end{matrix} ] , or$$
$$\frac{1}{\sqrt{2}} [ \begin{matrix}{W}_{4 Tx , r = 2} & 0 \\ 0 & {W}_{4 Tx , r = 2}^{′}\end{matrix} ] ,$$
wherein W_{4Tx,r=4} corresponds to a 4 antenna precoding matrix for rank 4, W_{4Tx,r=2} corresponds to a first 4 antenna precoding matrix for rank 2, and W_{4Tx,r=2} corresponds to a second 4 antenna precoding matrix for rank 2.

59. The method of claim 54, wherein for a five layer transmission with the 8 antenna ports, the precoding matrix type includes:
$$\frac{1}{\sqrt{2}} [ \begin{matrix}{W}_{4 Tx , r = 2} & 0 \\ 0 & {W}_{4 Tx , r = 3}\end{matrix} ] ,$$
wherein W_{4Tx,r=2} corresponds to a 4 antenna precoding matrix for rank 2, and W_{4Tx,r=3} corresponds to a 4 antenna precoding matrix for rank 3.

60. The method of claim 54, wherein for a six layer transmission with the 8 antenna ports, the precoding matrix type:
$$\frac{1}{\sqrt{2}} [ \begin{matrix}{W}_{4 Tx , r = 3} & 0 \\ 0 & {W}_{4 Tx , r = 3}^{′}\end{matrix} ] ,$$
wherein W_{4Tx,r=3} corresponds to a first 4 antenna precoding matrix for rank 3, and W_{4Tx,r=3} corresponds to a second 4 antenna precoding matrix for rank 3.

61. The method of claim 54, wherein for a seven layer transmission with the 8 antenna ports, the precoding matrix type includes:
$$\frac{1}{\sqrt{2}} [ \begin{matrix}{W}_{4 Tx , r = 3} & 0 \\ 0 & {W}_{4 Tx , r = 4}\end{matrix} ] ,$$
wherein W_{4Tx,r=3} corresponds to a first 4 antenna precoding matrix for rank 3, and W_{4Tx,r=4} corresponds to a second 4 antenna precoding matrix for rank 3.

62. The method of claim 54, wherein for an eight layer transmission with the 8 antenna ports, the precoding matrix type includes:
$$\frac{1}{\sqrt{2}} [ \begin{matrix}{W}_{4 Tx , r = 4} & 0 \\ 0 & {W}_{4 Tx , r = 4}^{′}\end{matrix} ] ,$$
wherein W_{4Tx,r=4} corresponds to a first 4 antenna precoding matrix for rank 4, and W_{4Tx,r=4} corresponds to a second 4 antenna port matrix for rank 4.

63. The method of claim 54, wherein the 8 antenna ports are grouped into a first group of 4 antenna ports and a second group of 4 antenna ports that map to the 8 port uplink MIMO precoder.

64. The method of claim 63, wherein the first group of 4 antenna ports includes ports 0, 1, 4, and 5, and wherein the second group of 4 antenna ports includes ports 2, 3, 6, and 7.

65. The method of claim 63, wherein a grouping into the first group of 4 antenna ports and the second group of 4 antenna ports is based on a permutation operation.

66. The method of claim 54, wherein the control signaling comprises downlink control information (DCI).

67. An apparatus for wireless communication at a network node, comprising:
a memory; and
at least one processor coupled to the memory and, based at least in part on information stored in the memory, the at least one processor is configured to:
transmit control signaling scheduling an uplink multiple input multiple output (MIMO) transmission for 8 antenna ports, the control signaling including a first part based on a rank, a second part based on a precoding matrix type, and a third part based on a transmitted precoding matrix indicator (TPMI) associated with one or two 4 antenna port precoding matrices; and
receive the uplink MIMO transmission precoded with an 8 port uplink MIMO precoder, the 8 port uplink MIMO precoder being based on a 4 port uplink MIMO codebook with a mapping indicated by a combination of the first part, the second part, or the third part of the control signaling.

68. The apparatus of claim 67, wherein for a single layer transmission with the 8 antenna ports, the precoding matrix type is indicated from a set including:
$$\frac{1}{\sqrt{2}} [ \begin{matrix}{W}_{4 Tx , r = 1} \\ 0\end{matrix} ] , or$$
$$\frac{1}{\sqrt{2}} [ \begin{matrix}0 \\ {W}_{4 Tx , r = 1}\end{matrix} ] ,$$
wherein W_{4Tx,r=l}corresponds to a 4 antenna precoding matrix for rank 1.

69. The apparatus of claim 67, wherein for a two layer transmission with the 8 antenna ports, the precoding matrix type is indicated from a set including:
$$\frac{1}{\sqrt{2}} [ \begin{matrix}{W}_{4 Tx , r = 2} \\ 0\end{matrix} ] ,$$
$$\frac{1}{\sqrt{2}} [ \begin{matrix}0 \\ {W}_{4 Tx , r = 2}\end{matrix} ] , or$$
$$\frac{1}{\sqrt{2}} [ \begin{matrix}{W}_{4 Tx , r = 1} & 0 \\ 0 & {W}_{4 Tx , r = 1}^{′}\end{matrix} ] ,$$
wherein W_{4Tx,r=2} corresponds to a 4 antenna precoding matrix for rank 2, W_{4Tx,r=1} corresponds to a first 4 antenna precoding matrix for rank 1, and W_{4Tx,r=1} corresponds to a second 4 antenna precoding matrix for rank 1.

70. The apparatus of claim 67, wherein the 8 antenna ports are grouped into a first group of 4 antenna ports and a second group of 4 antenna ports that map to the 8 port uplink MIMO precoder.

71. The apparatus of claim 70, wherein the first group of 4 antenna ports includes ports 0, 1, 4, and 5, and wherein the second group of 4 antenna ports includes ports 2, 3, 6, and 7.

72. A method of wireless communication at a network node, comprising:
transmitting control signaling scheduling an uplink multiple input multiple output (MIMO) transmission for 8 antenna ports, the control signaling including a first part based on a rank, a second part based on a precoding matrix type, and a third part based on a transmitted precoding matrix indicator (TPMI) associated with one or two 4 antenna port precoding matrices; and
receiving the uplink MIMO transmission precoded with an 8 port uplink MIMO precoder, the 8 port uplink MIMO precoder being based on a 4 port uplink MIMO codebook with a mapping indicated by a combination of the first part, the second part, or the third part of the control signaling.

73. The method of claim 72, wherein for a single layer transmission with the 8 antenna ports, the precoding matrix type is indicated from a set including:
$$\frac{1}{\sqrt{2}} [ \begin{matrix}{W}_{4 Tx , r = 1} \\ 0\end{matrix} ] , or$$
$$\frac{1}{\sqrt{2}} [ \begin{matrix}0 \\ {W}_{4 Tx , r = 1}\end{matrix} ] ,$$
wherein W_{4Tx,r=1}corresponds to a 4 antenna precoding matrix for rank 1.

74. The method of claim 72, wherein the 8 antenna ports are grouped into a first group of 4 antenna ports and a second group of 4 antenna ports that map to the 8 port uplink MIMO precoder.

75. The method of claim 74, wherein the first group of 4 antenna ports includes ports 0, 1, 4, and 5, and wherein the second group of 4 antenna ports includes ports 2, 3, 6, and 7.
